(19) United States
(12) Patent Application Publication
(10) Pub. No.: US 2026/0349960 A1
(43) Pub. Date: Nov. 5, 2026

(54) ARTIFICIAL INTELLIGENCE MANAGER SYSTEMS

(71) Applicant: Mark Taylor, Falls Church, VA (US)

(72) Inventor: Mark Taylor, Falls Church, VA (US)

(21) Appl. No.: 19/700,098

(22) Filed: Jun. 5, 2026

Related U.S. Application Data
(63) Continuation-in-part of application No. 19/468,814, filed on Feb. 3, 2026.
Application No. 19/468,814 is a continuation of application No. 18/676,325, filed on May 28, 2024, now Pat. No. 12,572,504.
(63) Continuation-in-part of application No. 19/686,606, filed on May 22, 2026.
Application No. 19/686,606 is a continuation-in-part of application No. 19/680,833, filed on May 18, 2026.
Application No. 19/680,833 is a continuation-in-part of application No. 19/673,888, filed on May 11, 2026.
Application No. 19/673,888 is a continuation-in-part of application No. 19/665,840, filed on May 1, 2026.
(60) Provisional application No. 63/469,303, filed on May 26, 2023.

(51) Int. Cl. G06F 16/13; G06F 16/16

(52) U.S. Cl. CPC G06F 16/13; G06F 16/164

(57) ABSTRACT

Artificial Intelligence Manager System (AIMS) provides a method and system for managing inference on synthetic electronic neural networks. The system receives a main task objective including one or more sub-tasks that reinforce the processing efficiency of the objective and one or more sub-tasks that countervail it. From an analysis of the main objective and learning from previously processed tasks, the system proactively predicts processing requirements. Countervailing sub-tasks are identified, separated, and dispatched to one or more dedicated AI model instances operating within a blinkered purview and processed in isolation until sub-task results are generated. The disparate sub-task results are then collated and merged to form a composite result, from which the overall task result and any output products are produced. By resolving countervailing objectives separately, AIMS prevents internal contradictions that would otherwise waste computations and degrade their efficacy, potentially improving model accuracy and efficiency.

### CROSS REFERENCE TO RELATED APPLICATIONS

This application claims benefit under 35 U.S.C. § 119 U.S. application Ser. No. 19/468,814 filed Feb. 3, 2026, which is a continuation of application Ser. No. 18/676,325, filed May 28, 2024, which claimed benefit of priority from U.S. Provisional having Ser. No. 63/469,303 filed May 26, 2023. This application also claims benefit under 35 U.S.C. § 119 of U.S. application Ser. No. 19/686,606, filed May 22, 2026, which is a continuation-in-part of U.S. application Ser. No. 19/680,833, filed May 18, 2026, which is a continuation-in-part of U.S. application Ser. No. 19/673,888, filed May 11, 2026, which is a continuation-in-part of U.S. application Ser. No. 19/665,840, filed on May 1, 2026.

### FIELD

The subject disclosure relates to information technology, artificial intelligence, file management and storage, interrogation of files and file contents and relational databases. Including applicable system architectures, classical logic controllers, expert systems, machine learning, and synthetic electronic neural networks. The operation of token-based language models within finite context windows. By necessity, these technologies include related and enabling technologies for the extraction, compilation, recording and retrieval of information, in support of context preparation for artificial intelligence-based processing, hallucination mitigation, and neural network optimization.

### BACKGROUND

The number of data producing and handling devices is expanding, including many portable platforms. Most of which are now more than mere word processing and analytical tools. Many of the growing number of devices most people use include computer processors and are capable of data acquisition, file creation, and storage. These devices include personal computers, tablets, scanners, cameras, and smart phones. From which proliferation of data producing and handling devices, there has been a corresponding proliferation of personal, and work-related digital information. Some of which is stored on those devices, and/or over networks, including the Internet in a growing number of file formats and types; often including within them meta-data that pertains to their characteristics.

There is also often an intermixing of personal and work-related data in and across devices due to overlaps between the work and personal lives of users. This cross-population of user data on devices can be a particular problem for people whose work is of a confidential, sensitive, or secret nature. For example, in 2016 the Inventor suffered a large loss of personal data when his motel room was accessed by some hands-on cyber criminals who damaged his computer in the process of stealing intellectual property from him. Some of that personal data which was damaged or lost was truly precious and irreplaceable. More recently the Inventor has suffered both a ransomware attack and another breach of his security that included attempts to gain control of his online accounts. The effects of which on his personal data were mitigated by backups and cloud storage.

However, fixing the data breach, removing the high-end trojan applications left behind on his systems necessitated various resetting and data wiping processes. After which the Inventor then had to reinstall those systems, and to reconstruct both his personal, business, and investment related files from an assortment of devices and drives. Which takes a lot of time and effort over several days.

Our devices are increasingly connected to cellular networks and other data handling networks. Which provide Internet access, there is also a return to the old paradigm of wide area networked (WAN) devices. With much user data being backed up to and/or wholly stored into online “Cloud” storage. Which is reminiscent of the intuitively interfaced local storage users have become used to working with on their devices.

As connectivity and the bandwidth thereof expands all the moreso the trend back towards the WAN paradigm, reborn in Cloud computing is leading to the creation of vast data centers to store the mountains of data being produced. The trend-growth of which may be exponential for the foreseeable future. Large amounts of data are being warehoused now, for later decryption, once Quantum Computing becomes economically capable of cracking the math of encryption in the state of the art. Evidence of crimes happening now may thus become available to law enforcement agencies in the future. This stockpiling of data in bulk may also be a long-term project for intelligence agencies.

For all these reasons, the task of storing data, and/organizing it into meaningful, easy to use structures has created a time-consuming job, that is escalating in magnitude. Which individual users as well as large corporations and government agencies have to endure. Often different versions of personal files and folders tend to get proliferated in similar but non-identical versions as users try to recreate a similar experience across different devices. This process entails much manual viewing, assessing, sorting and sifting and lost time in performing those chores. As well as sadness, frustration, and economic costs caused by permanently losing valuable files. Leading to a real cost to individual users and to the economy, comprising lost files, lost precious memories, lost documents and lost time spent trying to preserve, organize, and migrate user and/or organization data over their lifetime's worth of legacy and new replacement devices and systems. But at least for individual users they mostly can recall the gist of where they put their favorite pictures and important documents, as well as their idiosyncratic uses of file names etc.

However, pity the poor legal secretary who inherits a vast filing system from retired staff. Which systems have been absorbing new user files in new matters for decades. As well as being subjected to the idiosyncrasies of every lawyer and secretary who ever worked at the firm and where some employees may have saved work into local hard drives rather than the firm's networked resources. This is a potential nightmare of lost files and economic damage to the law firm and to clients.

Indeed, other professional services firms in fields as diverse as medical doctors, accountants, and consulting engineers may all have their own versions of these data preservation and management problems. Furthermore, in some sectors such as banking there may be statutory minima for which data must be retained, and accessible. For example, if an accountant's clients fall under IRS audit; or where a civil engineering project becomes subject to litigation on aspects of its designed architectures. In aviation the burdens may be critical, and lives may depend on accurate data logging, analysis, and retrieval. Such as where flight-data is streamed from avionics instrumentation for safety critical analysis, and in the event an accident were to occur. Then the abilities to manage and retrieve such critical data may be vital to large organizations including the aviation operating corporates, their aviation systems manufacturers and maintenance contractors. This is true for civilian and military aviation. More examples of the uses and benefits of these subject technologies could be added though not all have been included here.

USB (universal serial bus) drives, and SD card (secure digital card, a proprietary non-volatile, flash memory card format, licensed by SD-3C LLC) drives can and do fail. Which may be typical of a mobile phone user's experience, in which many un-printed but precious pictures may become lost or inaccessible over time. Followed most recently by newer applications also allowing devices to backup or duplicate some files to cloud drives such as Microsoft's® OneDrive®. The rather clunky and unreliable ability to back up one device to a cloud-based location assisted by a helper application is just about the current state of the art for smart phones.

The Inventor has suffered a lot of data theft aimed at his intellectual property, as well as related collateral damage to his systems, disruption and loss of secret and personal data over many years. Causing the very costly loss of valuable inventions that appear to have been stolen and then sold on the black market. Some of which have been infuriatingly laundered and become commercially successful. QR (quick reference) codes (previously called by the Inventor Variable Information Service Transaction Area “VISTA”) are one such stolen and laundered technology. Wherein the Inventor designed the layout and purpose of the visual codes we all scan with our phones without thinking. Others include aspects of multi-factor identification and Internet banking, online banking, and randomization of data addressing for improved security. This is not even a full list of all the various technologies Invented by and stolen from the Inventor.

What appears to have happened was that the Inventor's defense related inventions drew attention from hostile spies of adversary states such as Russia. Unfortunately, it seems to be the case that they steal everything they can. The defense related thefts go to the hostile state, but the non-defense related thefts however seem to get laundered to create a pedigree backstory, from where they can wind up being purchased by big tech. Like laundered money may be unwittingly accepted by honest people. Those adverse events in some ways created the necessity and hence have been “mother of invention” for these subject technologies.

In 2022 the Inventor suffered another intrusion event which prompted another cycle of data restoration from backups and a massive effort to reconcile files. The disentangling of secret data and personal data across various devices has been a long and arduous but necessary task. As has been the attempt to impose order on important documents, and photographs of friends and family from a lifetime of 59 years. Which is the point at which the Inventor said to himself. “There has to be a better, less time intensive, and tedious way to do this.”

Artificial intelligence systems operating on the basis of token-based language models are subject to fundamental computational constraints. Each inference operation consumes a finite budget of tokens within a context window of limited capacity. The size of that context window bounds the volume of information that can be presented to the model for any given inference. Where the information supplied within that context window contains irrelevant material—content that does not bear on the task at hand—computational resources are consumed processing tokens that contribute nothing to the accuracy or utility of the output. At scale across large numbers of users, devices, and inference operations, the aggregate waste of computational resources attributable to the ingestion of irrelevant tokens represents a significant and growing burden on energy consumption, computing infrastructure, and the economic cost of operating artificial intelligence systems. Another problem in the art is that no systems or methods exist that are capable of identifying and extracting only the information that is relevant to a given task, and of confining the informational field of view of an artificial intelligence model to that relevant information prior to inference. This is the needle in a haystack problem. How to find the needle without ingesting the entire haystack. To avoid wasting the finite token budget of a context window.

A further problem in the art arises from a competing and countervailing requirement: the need to supply sufficient context for an artificial intelligence model to perform accurately. Providing too little context risks omitting information necessary for a correct or complete output. Providing too much context introduces irrelevant information that degrades inference performance, wastes token budget, and increases the risk of model confusion and erroneous outputs. This tension—between context starvation on one side and context bloat on the other—represents a fundamental and unresolved conflict in the art that cannot be resolved by minimizing context input alone.

A further and related problem in the art arises from the phenomenon of model drift over larger context windows. As the volume of information presented within a context window increases, token-based artificial intelligence models are susceptible to progressive drift away from the specific requirements of a task. This drift manifests as outputs that diverge from accuracy, relevance, or internal consistency as the model's effective attention is diluted across a greater volume of contextual material. Model drift of this kind is associated with, and may contribute to, the generation of hallucinated outputs—outputs that are factually incorrect, internally inconsistent, or unsupported by the information provided to the model. Hallucinated outputs are not merely inaccurate in an abstract sense. Where hallucinated outputs are acted upon in downstream processes or real-world applications, they may cause tangible harm—including erroneous decisions, wasted resources expended in the correction of bad outputs, damage to persons or property relying on the accuracy of artificial intelligence-generated information, and erosion of confidence in artificial intelligence systems.

The optimization of artificial intelligence models presents a further set of problems in the art. The performance of neural network-based models is dependent upon access to sufficient and relevant training data and upon the accumulation of task-based operational experience. Systems that lack structured mechanisms for capturing, organizing, indexing, and retrieving such data are limited in their capacity for self-directed improvement. Trained models do not learn per se outside of their pre-deployment training. They do not get smarter with experience. Rather they perform sessions from the same contextless baseline at the start of every new session context window.

Neural network-based models, and in particular large language models, have a problem in the art in that they excel at pattern recognition, generative tasks, and the synthesis of information from diverse sources, but are susceptible to hallucination, drift, and outputs that conflict with established facts or operational rules. Rule-based expert systems and logical machine learning approaches have a different problem in the art in that, while they offer structured, deterministic, and highly reliable reasoning within well-defined domains—and have demonstrated the capacity to surpass human performance in the complex rule-governed game of Chess—they lack the generative flexibility, adaptive capacity, and breadth of application of neural network-based approaches.

A further and distinct problem in the art arises where an overall task contains sub-goals that are in genuine tension with one another—that is, where the successful pursuit of one sub-goal is in conflict with the successful pursuit of another. Where such countervailing objectives are presented to a token-based language model within a single context window session, the model must process the conflicting objectives simultaneously within the same inference operation. The pursuit of one sub-goal undermines the model's ability to achieve the other: instructions oriented toward constraint, accuracy, and ground truth enforcement interfere with the generative and probabilistic reasoning required for creative or inferential outputs, while generative context weakens the deterministic discipline required for reliable constraint enforcement. This mutual undermining—hereinafter referred to as bleed-through—occurs because a single inference process operating within one context window session cannot simultaneously optimize for countervailing objectives without each diminishing the model's capacity to achieve the other.

A skilled human expert may address a comparable conflict through deliberate compartmentalization, by applying constraint as a separate evaluative act, performed after and independently of the generative act. Rather than attempting to satisfy countervailing objectives within the same operation.

Current artificial intelligence systems operating within a single context window session do not possess this capacity for compartmentalization between countervailing objectives. There is a problem in the art in that no mechanism exists within a single context window session inference architecture to prevent this bleed-through between countervailing objectives, or to enforce a clean separation between generative and evaluative phases of a task in which those objectives are in conflict. The observable consequence of this bleed-through is a degradation of the quality, accuracy, and purposive coherence of the model's outputs across all of the countervailing objectives that are simultaneously present within the context window. Neither objective receives the full computational commitment that it would receive if processed in isolation, because the mathematical operations serving each objective may interfere with and dilute the operations serving every other.

This problem in the art compounds with the number and severity of the countervailing objectives present within a single context window session, and is not addressed by increasing the size of the context window, because the degradation arises not from insufficient token capacity but from the simultaneous presence of conflicting optimization targets within a single inference operation.

### SUMMARY

In one aspect, the subject technology provides a method for operating an intelligent computing system that comprises one or more synthetic electronic neural networks. A main task objective comprising a plurality of sub-tasks, wherein there is at least a first sub-task and a second sub-task is received. A processing requirement of the task is predicted, based on a semantic classification of the main task objective and on accumulated experiential learning derived from a plurality of previously processed tasks, before the processing requirement arises during processing of the main task objective. In anticipation of the predicted processing requirement, one or more of the following is performed: identifying the first sub-task as reinforcing a processing efficiency of the task objective; identifying the second sub-task as countervailing the processing efficiency of the task objective relative to the first sub-task; dispatching the second sub-task to an instantiation of an artificial intelligence model operating with a blinkered purview restricted to the second sub-task and separated from a processing of the first sub-task; receiving a result of the processing of the second sub-task from the instantiation; merging the result of the processing of the second sub-task with a result of the processing of the first sub-task to generate a combined result; and generating a task result based on the combined result and processing of the main task objective by the one or more synthetic electronic neural networks.

In a further aspect, the subject technology provides a non-transitory computer-readable storage medium storing instructions that, when executed by a processor, cause the processor to perform operations for operating an intelligent computing system that comprises one or more synthetic electronic neural networks. The operations comprise receiving a main task objective comprising a plurality of sub-tasks, wherein there is at least a first sub-task and a second sub-task; predicting, based on a semantic classification of the main task objective and on accumulated experiential learning derived from a plurality of previously processed tasks, a processing requirement of the task before the processing requirement arises during processing of the main task objective; and, in anticipation of the predicted processing requirement, performing one or more of: identifying the first sub-task as reinforcing a processing efficiency of the task objective; identifying the second sub-task as countervailing the processing efficiency of the task objective relative to the first sub-task; dispatching the second sub-task to an instantiation of an artificial intelligence model operating with a blinkered purview restricted to the second sub-task and separated from a processing of the first sub-task; receiving a result of the processing of the second sub-task from the instantiation; merging the result of the processing of the second sub-task with a result of the processing of the first sub-task to generate a combined result; and generating a task result based on the combined result and processing of the main task objective by the one or more synthetic electronic neural networks.

In a further aspect, the subject technology provides a computing device comprising a processor, a memory coupled to the processor, and one or more synthetic electronic neural networks. The memory stores instructions that, when executed by the processor, cause the server to receive a main task objective comprising a plurality of sub-tasks, wherein there is at least a first sub-task and a second sub-task; to predict, based on a semantic classification of the main task objective and on accumulated experiential learning derived from a plurality of previously processed tasks, a processing requirement of the task before the processing requirement arises during processing of the main task objective; and, in anticipation of the predicted processing requirement, to perform one or more of: identifying the first sub-task as reinforcing a processing efficiency of the task objective; identifying the second sub-task as countervailing the processing efficiency of the task objective relative to the first sub-task; dispatching the second sub-task to an instantiation of an artificial intelligence model operating with a blinkered purview restricted to the second sub-task and separated from a processing of the first sub-task; receiving a result of the processing of the second sub-task from the instantiation; merging the result of the processing of the second sub-task with a result of the processing of the first sub-task to generate a combined result; and generating a task result based on the combined result and processing of the main task objective by the one or more synthetic electronic neural networks

It should be understood that many other possible configurations and combinations of the subject technology will become readily apparent to those skilled in the art from this specification generally and the following detailed description, wherein various configurations of the subject technology are shown and described by way of illustration. As will be realized, the subject technology is capable of other and different configurations or combinations and its several details are capable of modification in various other respects, all without departing from the scope of the subject technology. Accordingly, the drawings and detailed description are to be regarded as illustrative in nature and not restrictive.

### BRIEF DESCRIPTION OF THE DRAWINGS

FIG. 1 is a mixed schematic and system block-flow diagram, providing an overview of various aspects of the subject technologies.

FIG. 1A is a system diagram of a defined process according to the subject technologies.

FIG. 1B is a mixed schematic and system block-flow diagram, providing an overview of aspects of the machine-based intelligence aspects of the subject technologies.

FIG. 2 is a system block-flow diagram, of aspects of the subject technologies.

FIG. 3 is a mixed schematic and system block-flow diagram of an aspect of the subject technologies.

FIG. 4 is a system block-flow diagram, of aspects of the subject technologies.

FIG. 5 is a system block-flow diagram, according to aspects of the subject technologies.

FIG. 6 is a mixed schematic and system block-flow diagram of a database according to aspects of the subject technologies.

FIG. 7 is a mixed schematic system block-flow diagram of a record according to aspects of the subject technologies.

FIG. 8 is a schematic diagram of relational data according to an aspect of the subject technologies.

FIG. 9 is a system block diagram of an array according to the subject technologies.

FIG. 10 is a system block diagram of search results according to the subject technologies.

FIG. 11 is a schematic diagram of linked files according to an aspect of the subject technologies.

FIG. 12 is a system block-flow diagram, of various aspects of the subject technologies.

FIG. 13 is a system block-flow diagram, of various aspects of the subject technologies.

FIG. 14 is a relational database record according to an aspect of the subject technologies.

FIG. 15 is a relational database record according to an aspect of the subject technologies.

FIG. 16 is a system block-flow system diagram of an interface according to the subject technologies.

FIG. 16A is an interface display screen according to the subject technologies.

FIG. 17 is a system block-flow system diagram of an interface according to the subject technologies.

FIG. 17A is an interface display screen according to the subject technologies.

FIG. 18 is a system block-flow system diagram of an interface according to the subject technologies.

FIG. 18A is an interface display screen according to the subject technologies.

FIG. 19 is a system block-flow diagram, of various aspects of the subject technologies.

FIG. 20 is mixed schematic and system block-flow diagram, detailing an aspect of operation on data within a directory structure according to the subject technologies.

FIG. 21 is a mixed schematic and system block-flow diagram, detailing an aspect of operation on data within a directory structure according to the subject technologies.

FIG. 22 is a mixed schematic and system block flow diagram of operations in accord with aspects of the subject technologies.

FIG. 22A is a mixed schematic and system block flow diagram of operations in accord with aspects of the subject technologies.

FIG. 22B is a mixed schematic and system block flow diagram of operations in accord with aspects of the subject technologies.

FIG. 22C is a system block flow diagram of a defined process in accord with aspects of the subject technologies.

FIG. 23 is a mixed schematic and system block-flow diagram, detailing an aspect of operation on data within a directory structure according to the subject technologies.

FIG. 23A is a mixed schematic and system block-flow diagram, detailing an aspect of operation on data within a directory structure according to the subject technologies.

FIG. 24 is a system block-flow system diagram of an interface according to the subject technologies.

FIG. 24A is an interface display screen according to the subject technologies.

FIG. 25 is a system block-flow system diagram of an interface according to the subject technologies.

FIG. 25A is an interface display screen according to the subject technologies.

FIG. 26 is a system block-flow system diagram of an interface according to the subject technologies.

FIG. 26A is an interface display screen according to the subject technologies.

FIG. 27 is a mixed schematic and system block-flow diagram, detailing an aspect of operation on data within a directory structure according to the subject technologies.

FIG. 28 is a system block-flow system diagram of an interface according to the subject technologies.

FIG. 28A is an interface display screen according to the subject technologies.

FIG. 29 is a mixed schematic and system block-flow diagram, detailing an aspect of operation on data within a directory structure according to the subject technologies.

FIG. 30 is a system block-flow system diagram of an interface according to the subject technologies.

FIG. 30A is an interface display screen according to the subject technologies.

FIG. 31 is a mixed schematic and system block-flow diagram, detailing an aspect of operation on data within a directory structure according to the subject technologies.

FIG. 32 is a system block-flow system diagram of an interface according to the subject technologies.

FIG. 32A is an interface display screen according to the subject technologies.

FIG. 33 is a mixed schematic and system block-flow diagram, detailing an aspect of operation on data within a directory structure according to the subject technologies.

FIG. 34 is a mixed schematic and system block-flow diagram, detailing an aspect of operation on a database according to the subject technologies.

FIG. 35 is a mixed schematic and system block-flow diagram, detailing an aspect of operation on a database according to the subject technologies.

FIG. 36 is a mixed schematic and system block-flow diagram, detailing an aspect of operation on a database according to the subject technologies.

FIG. 37 is a mixed schematic and system block-flow diagram, detailing an aspect of operation on data within a directory structure according to the subject technologies.

FIG. 38 is an interface view of a DOS directory operated according to an aspect of the subject technologies.

FIG. 39 is a schematic view of file attributes according to an aspect of the subject technologies.

FIG. 40 is a mixed schematic and system block flow diagram of an aspect of the subject technologies.

FIG. 41 is a mixed schematic and system block flow diagram of a dataset grouping aspect of the subject technologies.

FIG. 41A is a mixed schematic and system block flow diagram of the dataset extraction, refining and usage aspect of the subject technologies.

FIG. 42 is a block flow diagram of a modular application of the subject technologies.

FIG. 42A is a block flow diagram of a modular application of the subject technologies.

FIG. 42B is a block flow diagram of a modular application of the subject technologies.

FIG. 42C is a block flow diagram of a modular application of the subject technologies.

FIG. 42D is a block flow diagram of an artificial intelligence orchestration layer in a modular implementation of the subject technologies.

FIG. 42E is a block flow diagram of a modular application of the subject technologies.

FIG. 43 is an interface and block flow diagram of devices performing an operation according to the subject technologies.

FIG. 43A is an interface and block flow diagram of devices performing an operation according to the subject technologies.

FIG. 44 is an interface and block flow diagram of devices performing an operation according to the subject technologies.

FIG. 45 is an interface and block flow diagram of devices performing an operation according to the subject technologies.

FIG. 46 is an interface and dialogue view of performing operations according to an aspect of the subject technologies.

FIG. 47 is a block and flow diagram of a system according to the subject technologies.

FIG. 47A is a schematic diagram of cosine similarity determination according to the subject technologies.

FIG. 47B is a schematic diagram of cosine similarity determination according to the subject technologies.

FIG. 47C is a schematic diagram of magnitude disparity with cosine similarity determination according to the subject technologies.

FIG. 47D is a schematic diagram of tool selection based on computed non-word similarity determination according to the subject technologies.

FIG. 47E is a schematic diagram of semantic pruning path analysis according to the subject technologies.

FIG. 48 is a block flow diagram of a defined process according to an aspect of the subject technologies.

FIG. 49 is a block flow diagram view of an intelligent structure according to an aspect of the subject technologies.

FIG. 50 is a tabular view of an intelligent relational database structure according to an aspect of the subject technologies.

FIG. 51 is a mixed schematic block flow diagram of an intelligent structure operating according to an aspect of the subject technologies.

FIG. 52 is a mixed schematic block flow diagram of a learning system operating according to an aspect of the subject technologies.

FIG. 52A is a mixed schematic block flow diagram of a model session manager orchestrating multiple model instantiations according to an aspect of the subject technologies.

FIG. 52B is a mixed schematic block flow diagram of continuously chained model instantiations operating within a long process embodiment according to an aspect of the subject technologies.

FIG. 53 is a mixed schematic block flow diagram of an intelligent motion system operating according to an aspect of the subject technologies.

FIG. 54 is a mixed schematic block flow diagram of an artificial intelligence and quantum hybrid system according to the subject technologies.

FIG. 55 is a block flow diagram of a defined process according to an aspect of the subject technologies.

FIG. 56 is a mixed schematic block flow diagram of a synthetic electronic neural network.

FIG. 57 is a mixed schematic block flow diagram of a synthetic electronic neural network according to an aspect of the subject technologies.

FIG. 58 is a plan view of a meshed synthetic electronic neural network topology according to an aspect of the subject technologies.

FIG. 58A is a side elevation view of the meshed synthetic electronic neural network topology of FIG. 58 according to an aspect of the subject technologies.

FIG. 59 is a mixed schematic and system block-flow diagram of a three-layer architecture according to the subject technologies.

FIG. 60 is a schematic diagram of complementary efficiency mechanisms according to aspects of the subject technologies.

FIG. 61 is a block flow diagram of a semantic focus deployment process according to an aspect of the subject technologies.

FIG. 62 is a mixed schematic and block flow diagram of a callable expert library according to an aspect of the subject technologies.

FIG. 63 is a mixed schematic and block flow diagram of a security and threat detection scanning engine according to an aspect of the subject technologies.

FIG. 63A is a block flow diagram of threat detection methods and response actions according to an aspect of the subject technologies.

FIG. 64 is a block flow diagram of an integer computation module according to an aspect of the subject technologies.

FIG. 65 is a schematic diagram of a quantization spectrum for neural network weight representations according to an aspect of the subject technologies.

FIG. 66 is a block flow diagram of standard resolution inference processing according to an aspect of the subject technologies.

FIG. 66A is a block flow diagram of dynamic resolution scaling of inference processing according to an aspect of the subject technologies.

FIG. 67 is a mixed schematic and block flow diagram of a sentinel operating mode according to an aspect of the subject technologies.

FIG. 67A is a schematic diagram of a conventional resource allocation model for comparison with the sentinel operating mode of FIG. 67.

FIG. 68 is a schematic diagram of a conventional datacenter resource allocation model according to an aspect of the subject technologies.

FIG. 68A is a schematic diagram of a predictive switchable datacenter according to an aspect of the subject technologies.

### DETAILED DESCRIPTION

The detailed description set forth below is intended as a description of various configurations and/or combinations of the subject technologies and is not intended to represent the only possible configurations and/or combinations in which the subject technologies may be practiced. The appended drawings are incorporated herein and constitute part of the detailed description. The detailed description includes specific details for the purpose of providing a thorough understanding of the subject technology. However, it will be apparent to those skilled in the art that the subject technologies may be practiced without these specific details. Like or similar components may be labeled with identical element numbers for ease of understanding.

In general, embodiments of the subject technologies improve upon the state of the art, and/or their applications. Other possible embodiments may also improve upon the state of the art. In the drawings this symbol “&” means “and”, this symbol “/” means “or” and this combination “&” means “and/or”. The drawings make use of flowchart conventions and nomenclatures as will be appreciated by persons skilled in the art of information technology and systems design, including the use of rectangular elements to denote process steps, rounded-corner elements to denote alternate or variable outcomes, and solid and dashed connectors to denote primary and alternative process flows respectively.

The subject technology includes the aggregation and migration of data and files from and/or to a plurality of sources and systems, referred to herein as data organizer optimizing relational systems (“DOORS”). Including porting data from legacy systems into newer systems and/or networked resources. Specific functions of which may include making backups, describing, comparisons, cataloging, other analysis, aggregation, preservation, or reproduction, organization, optimization, reconciliation of versions etc., and the presentation of data.

In the art, many of these functions are accomplished in part by methods controlled and/or operated by users. Human users may vary over time in the case of personal habits and idiosyncrasies, which tendencies and variations may be more pronounced in corporate systems that are operated by multiple users. This disclosure also includes the use of artificial intelligence (AI) and/or machine learning (ML). It is also envisaged and intended that an artificial intelligence may also become a user of these subject technologies within the life of this patent.

As used herein, reconcile or reconciliation may mean to take a plurality of data sets with a relationship, spread over one or multiple devices and moving those data sets into one file system. Reconcile or reconciliation may sometimes mean having different versions of a same file and naming the related but different files similarly InventionX.v.1.docx, InventionX.v.101 and also with multiple versions of a file comparing them internally (for example, through image recognition, to recognize different versions of the same image/video etc.). Some embodiments of reconciliation may include the destruction of 100% duplicates and obsolete versions of a file via applying policies: for example, retaining only the last two versions of a document, and deleting earlier versions older than a predetermined time (e.g., 1 year). So that over time redundant files are removed, but final/last versions remain available.

To provide a logical, and intuitively accessible filing system the AI/ML elements may learn naming and file placement habits and rules of systems operated by corporate users so that it should be apparent to a human user and an AI engine where any file should be kept and approximately what the file will be named.

The reconciliation aspect of which may entail reconciling a plurality of data sets of related files that are in disparate locations within the storage systems of multiple devices. Reconciling those data sets by merging them into a file system structure is a first type of reconciliation. Reconciliation may include the steps of identifying related directories and files from multiple sources, then either creating a library of links to them (which may be within a relational database) and/or creating a new directory and/or database structure into which those files or links to them are copied. A naming convention may be applied to the reconciled files, where aspects such as their date and editing history may be used to set them into order, which order may be capable of providing different views by switching parameters. The attributes of files and directories including relationships between them and to real world facts, may be interpreted and used to make inferences from which to suggest or operate the elimination of duplicates and merging of versions of files; as well as deciding where to store them within a hierarchical directory and/or database structure, including the names of directories or nested structures and files.

Reconciliation may also include the destruction of duplicates and obsolete versions via applying policies; with more intuitive embodiments that may include AI or ML and may be capable of making those choices autonomously. By way of example policies may include naming conventions and the use of a parameter being set to retain only the last two versions of a document, and/or deletion of earlier versions older than an age parameter. So that over time redundant files may be identified and removed or preserved according to user preferences. Furthermore, an AI or ML helper module may learn such policies from observing user habits and preferences over time, or from a stock of training data, or even by mining legacy data. Such as corporate backups as well as current working datasets.

Furthermore, reconciliation may include the reconciliation of versions of files entailing identifying them from their contents or filenames or both, then naming them similarly. For example, files might be reconciled into files with the names InventionX.v.1.docx, InventionX.v.101.docx and also with multiple versions of a file, and may include comparing them internally to ascertain intrinsic attributes. As used herein, “intrinsic” refers to attributes inside a file (for example, pixels that may be used for facial recognition, or text/machine language that may be recognized as metadata or used for document analysis (e.g. keywords)). As may be appropriate in the further example of image recognition, and recognizing different versions of the same image, video, or sound recording whether in a regular user's smartphone or a movie editing business. The corollary of which is that “extrinsic” refers to attributes on the outside of the file per se such as its location within a hierarchy, and details of files that are related to it in some way. Some examples of intrinsic and extrinsic attributes are provided in FIG. 39.

To provide a logical, and intuitively accessible filing system the AI or ML engine may learn naming and file placement habits, conventions, and rules of systems operated by smartphone users on up through corporates and everything in between. So that in each case of a DOORS implementation it should be discernable to its human user, or corporate user and/or an AI module where any file should probably be kept within a system's directory structures, and approximately what the file is likely to be named.

The subject technologies may be used for aggregating data from one device or from a diverse plurality of sources and devices. So that a user's data from their digital lifetime as recorded in multiple devices over many years may be sensibly and intuitively aggregated and/organized into a database and/or directory structure that is in a style and nomenclature that is optimally based on the user's own style and habits of naming conventions and storage locations and structures. Like, similar, or related files and directory structures may be merged according to these principles to form a DOORS Master copy of the sum total or a subset of the user's data. The DOORS Master copy may replace all other versions of their data which may be fragmented across a plurality of legacy devices and systems, and/or to back up their data as is, or into an organized optimized and reconciled DOORS Master copy to provide a more readily functional and useable data storage, handling, processing, and retrieval capability. Which in turn may save users a great deal of time and inconvenience in the tasks of comparing file versions, directory structure versions, with duplicates, partial duplicates, similar, and varying versions of the same directories and/or files and related directories and files. A virtualized DOORS master view may be super-imposed onto user data before any files are moved to demonstrate the intended result to aid user decision making. Furthermore, such a virtualized version of all the DOORS functionality may be created and used as a file manager having aspects of the same functionality. Which virtualized implementations of the DOORS may also provide a trial version of these subject technologies. That may be operated under different licensing terms. Wherein a virtualized version may perform many of its operations within the structures of relational databases, that hold links to user files and data objects. Though most users prefer to create backups and to distill their digital lives into master datasets some may prefer to use the DOORS on the files they have in situe where they are. An example of which may be a young person just starting out on their digital life.

In most use cases the saving of time spent doing this very tedious chore for individual users as well as corporate entities may free up personal time for recreation, and free up worker time for more productive and gainful activities. Consequently, a DOORS may increase the utility that users gain from operating their devices and more effectively finding, accessing, and using their data. Increase their leisure time, and with those things increase quality of life for users. While also helping to improve the efficiency and hence profitability of corporations that may benefit also from productivity gains. Because employees may spend less time finding files, wading through similar and/or related directory structures. Leaving them with more time for higher value activities. Thus, helping to improve productivity.

The more efficient use of time and resources provided by a DOORS may also increase the efficiency of information technology (IT) systems by reducing the time spent interrogating them, and in duplication of effort plus duplication of redundant duplicates of files and directories, as well as reducing the need to search for and compare multiple versions of directories and files. That is often caused by the proliferation of messy and fragmented data both within and across multiple devices and systems. In the ways that people function both at leisure and in work situations. As well as assisting user access times for finding and using their data. With directory structures and naming conventions based on the user's prior practices which may be used to train artificial intelligence or develop machine learning expert helper modules within the DOORS.

Furthermore, alternative ways of presenting files, by type, date, location, or by their cross-referenced relationships, or class—to other aspects such as their function or purpose of the user data may all help DOORS processing to achieve new levels of efficacy.

Artificial intelligence and/or machine learning is likely to also improve in efficacy and capabilities over the life of these subject technologies. Those improvements in such enabling technologies will if anything complement these subject technologies. Because DOORS may incorporate improvements in the supporting and enabling technologies without deviating from the subject technologies.

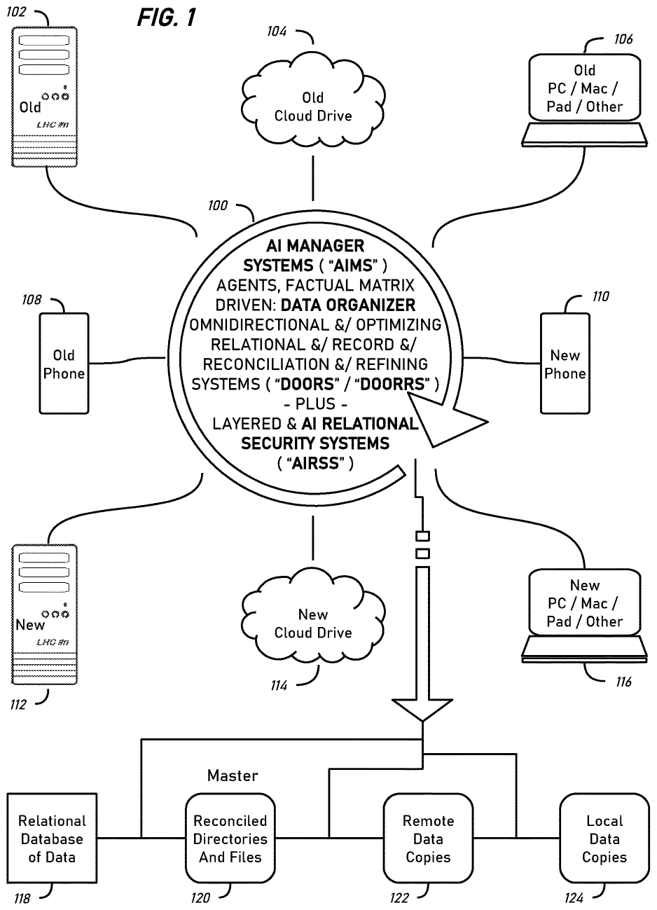

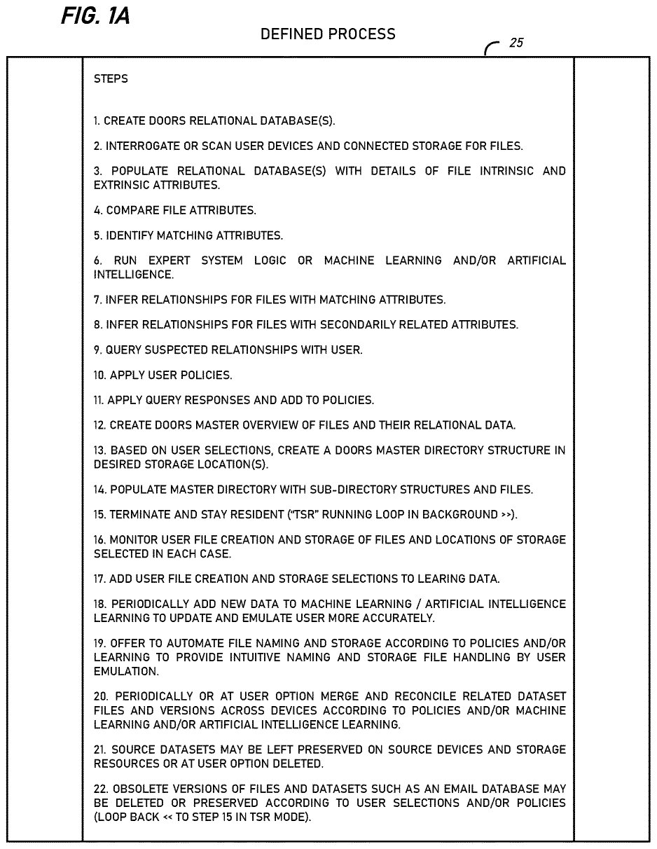

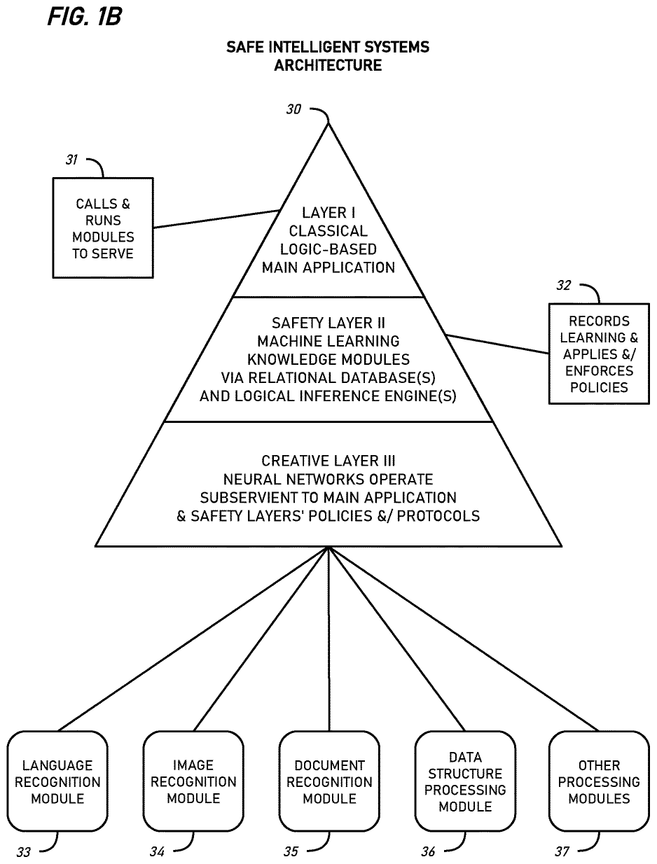

FIG. 1 provides a top-level schematic and system view of one embodiment of DOORS 100. DOORS 100 compares, catalogs, merges, and reconciles data set structures and files locally, and/or on mutually connected systems and data storage resources. DOORS 100 may be run on any smart device with the necessary computational power, interfaces and connectivity (explained in more detail in relation to later figures). Typically, connectivity may be via the Internet, but it may also be via other coupling means such as RJ45 connectors on an Ethernet based local area network (LAN) or wide area network (WAN), USB drives or cables, Wi-Fi or Blue-Tooth. Generally, the faster these connections are the better.

The connections are indicated in each case by the connecting lines from the above identified devices and resources that couple them to the device on which a DOORS 100 runs. Details of the precise nature of these connections in each case may vary and does not impact the operation of the DOORS. In this example embodiment it should be understood that DOORS may be running on one of the devices shown, and operating on the storage resources of one or all of those devices plus the cloud storage locations 104, 114. A DOORS 100 may be installed and run on the new devices and to use cloud storage as data may be processed. However, these subject technologies may also be installed and run upon any device including a legacy older device or system provided it has the necessary resources of compatible operating environment, processing power, data handling, storage, and connectivity.

Using a DOORS, data may be migrated over from older legacy devices and reproduced into one or more new devices where it may then be organized, optimized, and reconciled. Equally a DOORS may be used to migrate and reconcile data from an old device to another old device, or a combination of devices provided they have connectivity to enable necessary operations such as between two new devices. A DOORS may be capable of operating on any device new or old in any suitably connected configuration provided the system on which the DOORS application is running has sufficient computational processing power, memory buffering and/or file handling capacity, and storage capabilities. The nomenclature of old and new devices is used only because in practice users may generally be migrating from older to newer devices more often than the other way around. Though this is not material per se to the operation of a DOORS nor to the creation of a DOORS Master directory for user data.

Indeed, a DOORS Master directory may be virtualized and operated over networks without moving files per se, and/or virtualized locally using cloud data storage or any combination thereof. In the case of a virtualized operation of DOORS, the Master directory may operate on remote files over networks as though they are located locally or within the DOORS Master directory. However, as a matter of good practice, users may prefer to leave files on legacy devices unaltered and to create the DOORS Master directory from them by duplicating their contents into a local storage location or a cloud infrastructure-based storage location. Then perhaps unplugging those legacy devices (to preserve them as is as backups) and then working off the files held in the DOORS Master directory from then onwards.

Preserving legacy devices with their files intact after creation of the DOORS Master directory may be useful for some users. Once the DOORS Master is created those old legacy devices may be retained as backups, or in some situations where data is of a sensitive nature they may be securely erased, and/or disposed of.

The DOORS 100 may be run on any of the devices: old phone 108, new phone 110, old desktop computer 102, new desktop computer 112, old laptop computer PC, Mac, iPad, or other 106, new laptop PC, Mac, iPad, or other computing device 116. Data and directory structures from any of these, as well as from an old cloud drive 104 that is being replaced by a new cloud drive 114 may be processed from, through, on, and to any one of those locations to any other of those locations; and it may reproduce and/or merge their data sets, to create from a synergy of them a DOORS Master directory structure or backup that may be populated with the sum of the data found on some selected devices, or from all of them.

This process may create and populate a relational database of data 118 from those alternative sources or all of them comprised of local copies 124 and remote copies 122. Which may then be processed by the DOORS 100 application into the newly organized, optimized, and reconciled directories and files. To provide a DOORS Master copy file that may be comprised of a relational database of data 118 and a co-operable set of reconciled directories and files 120 or another lesser or partial set of reconciled directories and files 120.

FIG. 1A shows a defined process comprising steps of a method for operating a DOORS 100 comprising the following steps:

1. Create DOORS relational database(s).
2. Interrogate or scan user devices and connected storage for files.
3. Populate relational database(s) with details of file intrinsic and extrinsic attributes.
4. Compare file attributes.
5. Identify matching attributes.
6. Run expert system logic or machine learning and / or artificial intelligence.
7. Infer relationships for files with matching attributes.
8. Infer relationships for files with secondarily related attributes.
9. Query suspected relationships with user.
10. Apply user policies.
11. Apply query responses and add to policies.
12. Create DOORS master overview of files and their relational data.
13. Based on user selections, create a DOORS master directory structure in desired
storage location(s).
14. Populate master directory with sub-directory structures and files.
15. Terminate and / or stay resident (“TSR” running loop in background>>).
16. Monitor user file creation and storage of files and locations of storage selected in each
case.
17. Add user file creation and storage selections to learning data.
18. Periodically add new data to machine learning / artificial intelligence learning to
update and emulate user more accurately.
19. Offer to automate file naming and storage according to policies and / or learning to
provide intuitive naming and storage file handling by user emulation.
20. Periodically or at user option merge and reconcile related dataset files and versions
across devices according to policies and / or machine learning and / or artificial
intelligence learning.
21. Source datasets may be left preserved on source devices and storage resources or at
user option deleted.
22. Obsolete versions of files and datasets such as an email database may be deleted or
preserved according to user selections and / or policies (loop back << to step 15 in TSR
mode).

In the current state of the art there are some problems with artificial intelligence systems that are based upon the operation of synthetic electronic neural networks (SENN). Firstly, it may be impossible to see into the operational states of the neurons that comprise the networks to see how they are operating, and what they are operating on. Sometimes, they make mistakes for which persons skilled in the art have coined the term “hallucinating”. Artificial intelligence applications that are trusted with high level tasks could thus operate in dangerous and unsafe ways, by suffering from hallucinations that cause them to produce unwanted and possibly disastrous results. No user would be pleased if a DOORS 100 for example decided to wipe all their data by mistake. And that's not nearly as dangerous as some of the things that could go wrong with defense and medical applications of synthetic electronic neural network based artificial intelligence.

FIG. 1B is an overview of a solution to error-trap and prevent damage being caused by an artificial intelligence's hallucinations. This overview shows a machine-based intelligence of an embodiment of the subject technologies. There are three layers of the machine intelligence main application 30 (which may be operated as a module within a DOORS): layer one is a classical logic-based main application as most programmers who are schooled in modern modular programming and software engineering would understand it; safety layer two is based on machine learning knowledge modules, which may operate via relational database(s) and logical inference engine(s); and the creative layer three wherein neural networks operate-subservient to the main application and the policies and/or protocols of the safety layer. In operation the main application of layer one calls and runs modules to serve 31 its processing needs; the safety layer two records and applies and/or enforces policies (or rules); which may override the creative layer three, which is comprised of neural networks which operate subservient to the main application, and are governed by the safety layer's policies (rules) and/or protocols.

An intelligence engine, according to the subject technology, refers to any system, module, or combination of modules configured to process data to produce inferences, classifications, decisions, or actions exhibiting purposeful, goal-directed behavior in the management and comprehension of digital files. The intelligence engine may also encompass one or more of: a classical logic-based main controller that may operate as a first layer and be configured to call and run modules; an expert system and/or machine learning module may operate as a second layer, encoded within or linked to cooperating database structures and configured to record, apply, and enforce rules and policies. Which operations may include overriding the outputs of a synthetic electronic neural network (SENN) module that may operate as a third layer. So that if those outputs conflict with established rules and ground truths of the expert system and/or machine learning modules, the second layer may override them.

The intelligence engine may be implemented to operate as an embodiment of the safe intelligent systems architecture of the subject technology as described herein and FIG. 1B. The term ‘intelligence engine’ is intended broadly to encompass implementations based on any one or more of the foregoing components, including without limitation artificial intelligence systems, machine learning systems, expert systems, hybrid architectures combining two or more of the foregoing, and future implementations of equivalent capability. A cooperating intelligence engine, as used herein, refers to an intelligence engine that may be a module within the same computing system as the file management process, or a separate system or service operating in cooperation therewith.

Within and below layer three the safe intelligent systems architecture may run various neural network modules. Which modules may be optimized for specific tasks. These subject technologies may also use modules comprised of various other configurations of neural networks. For example in the art neural networks based on the gradients of curves that represent the vectors of relative motion have been found to be good for control systems in real world kinetic motion such as self-driving vehicles; there are deeper neural networks with more layers in the large language models (LLM), and there are shallower neural networks which leverage a sort of math co-processor with each neuron (based on biological neurons extracted from slug brains), which are known as “Liquid” neural networks because of the way the data is pushed through the shallow network. In these subject technologies neural networks may be arranged into modules, and called to run by the main application, to run their specialist task; in much the same way as classical program coded modules may be called and passed parameters on which to operate and return to the main application. In relation to those Which may include also releasing resources back to the system once they have performed their task. So that in relation to these subject technologies one or more of those neural network modules 33, 34, 35, 36, and 37 may be created and/or operated and managed in some aspect by the artificial intelligence aspect of the subject technologies.

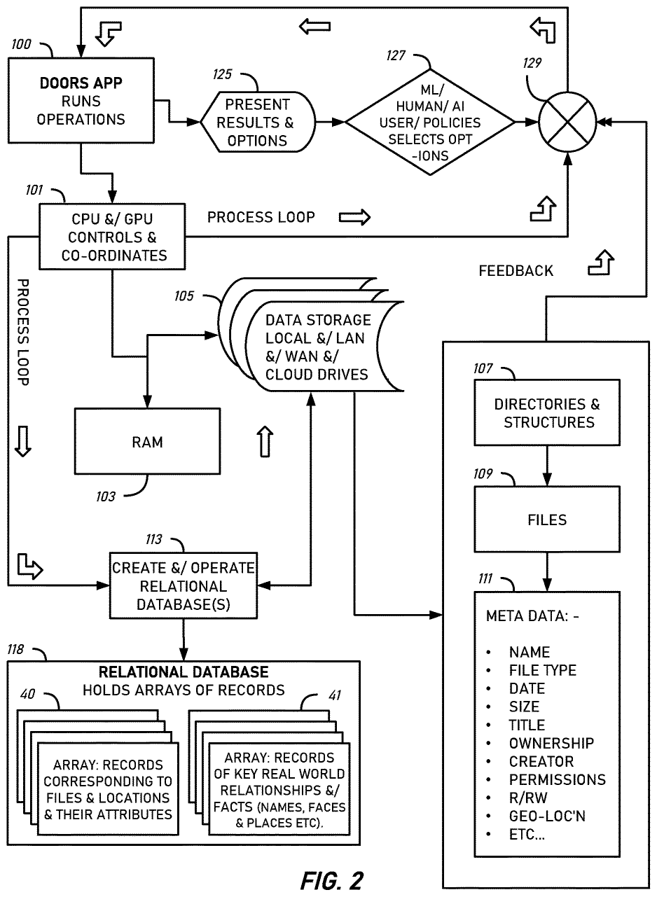

FIG. 2 shows a system embodiment that integrated DOORS 100. The DOORS application/system 100 runs operations. It presents results and options 125, and the human and/or artificial intelligence user selects and/or policies are applied to select 127 from those options. Which selection choices may be provided as feedback 129 to the DOORS 100. This feedback loop may run whenever needed within the processing of data.

The DOORS 100 may execute its method via instructions in the form of an application (App) or software product or computer program that may be loaded into and run on a central processor unit 101 (CPU) and/or graphics processor unit(s) (GPU) which controls and coordinates a system that performs the process in cooperation with a random-access memory (RAM) module 103. They act upon the connected data storage resources 105 and supporting hardware that may be accessed on local internal storage and/or LAN, and/or WAN, and/or Cloud drives. As the DOORS application runs by operating these resources, they may be interrogated to obtain details of their directories and file handling structures 107, including details of nested sub-structures or sub-directories and of the files or links to files held in them 109, and their characteristic meta-data: name, file type, creation date, last modified date, size, title, ownership, creator, permissions, read and write status, geo-location, and other features 111. Which information may be fed-back 129 to the DOORS application 100.

In order to perform the file handling and processing operations described herein, the intelligence engine of the DOORS 100 may gain administrative control over the actual files or copies of the files identified within the interrogated data sources. Administrative control means a level of access to the file sufficient to perform file management operations which may include reading the file and its attributes; writing to or modifying the file; moving or copying the file to a different storage location; renaming the file or assigning an alias or mask name to the file; creating a pointer to the file within the relational database 118; and performing operations on the file so that it is available to be worked upon such as loading it into memory.

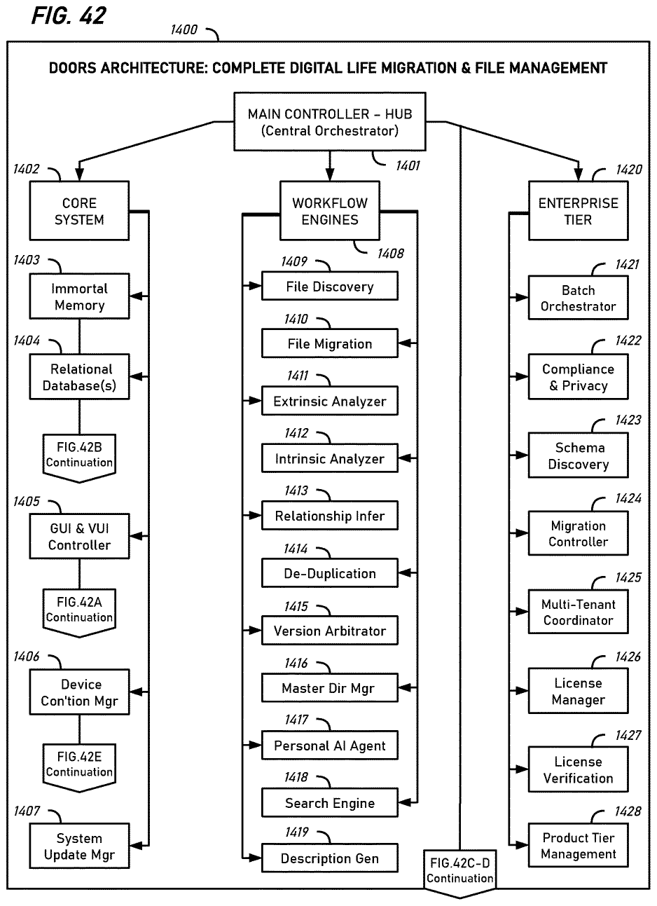

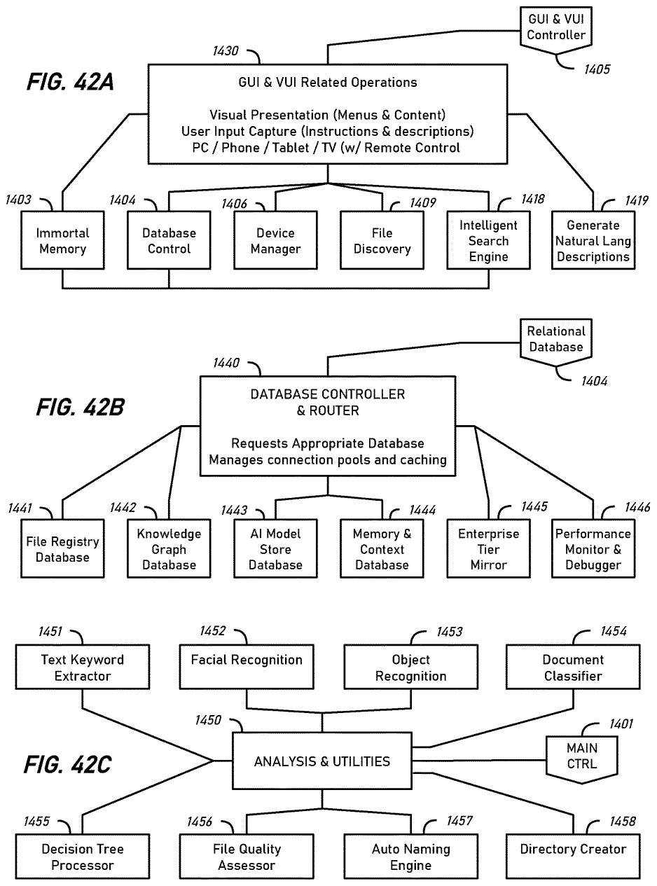

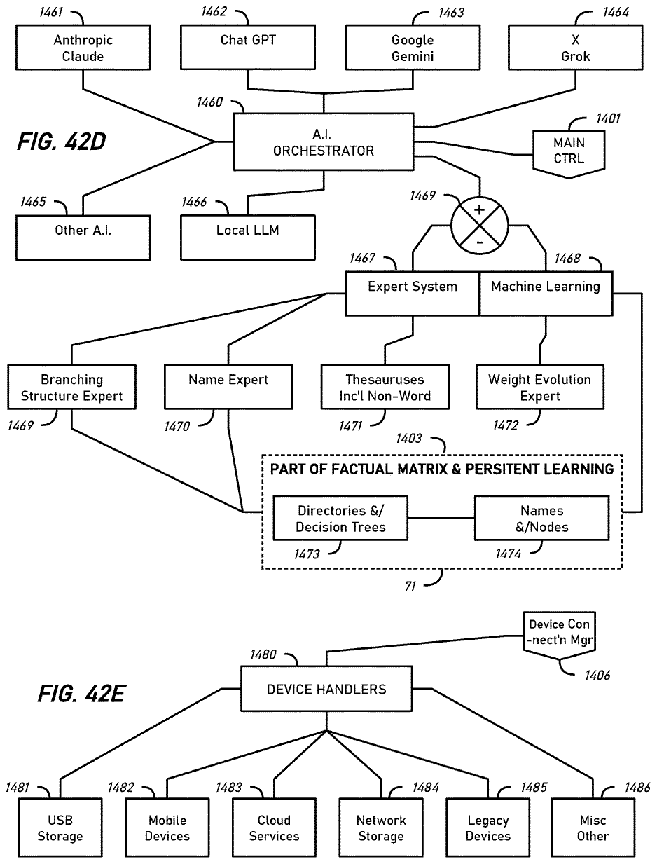

Having determined the file type of a file, the intelligence engine of the DOORS 100 selects a compatible file handling and processing tool for that file, based on its file type and the attributes of that file. The selection of a compatible tool may be performed by the main controller 1401 (FIG. 42), which may coordinate the analysis and utilities modules 1450 (FIG. 42C) to identify the module or modules whose processing capabilities are suited to the file type and the operation to be performed. For example, a text-based file of the ‘.DOCX’, ‘.TXT’, or ‘.PDF’ type may be matched to the text extractor module 1451; an image file of the ‘.JPG’ or ‘.PNG’ type may be matched to the facial recognition module 1452 and/or the object recognition module 1453; and a file whose type or content indicates specialist data may be matched to the document classifier module 1454, the quality assessor module 1456, or one or more specialist processing modules as appropriate. The selection may further be informed by the capabilities encoded in the expert system of the second layer, and by the policies and rules applied and operated by that layer, such that the tool selected for each file is appropriate both to its type and to the operational context in which it is being processed.

This feedback data may then be used by the DOORS application 100 operating the processor(s) 101, in combination with the random-access memory 103 which may then create and/or operate an existing relational database 113. That may be populated with the data fed back to it 129, from interrogation of data storage 105, directories and structures 107 including their files 109 and any meta-data pertaining to those files 111. In which relational database the positional or locations data are combined with and cross-referenced to discernable relations between data items. So that the relational database 118 created and operated 113. The relational database 118 may include arrays of records corresponding to files, file locations and their attributes 40; which may be supported by an array of records comprised of more key facts and real world relationships (such as details of names, faces, and places) 41 that may also be used to categorize and/or record data object attributes including placing them within classes which is explained further in relation to later figures and which may be used to produce a DOORS Master directory within a storage location.

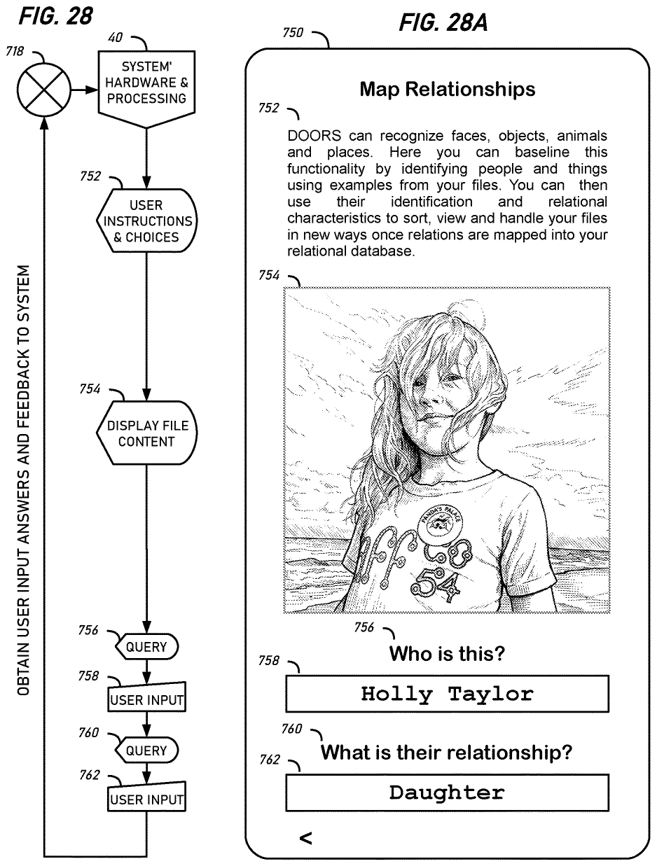

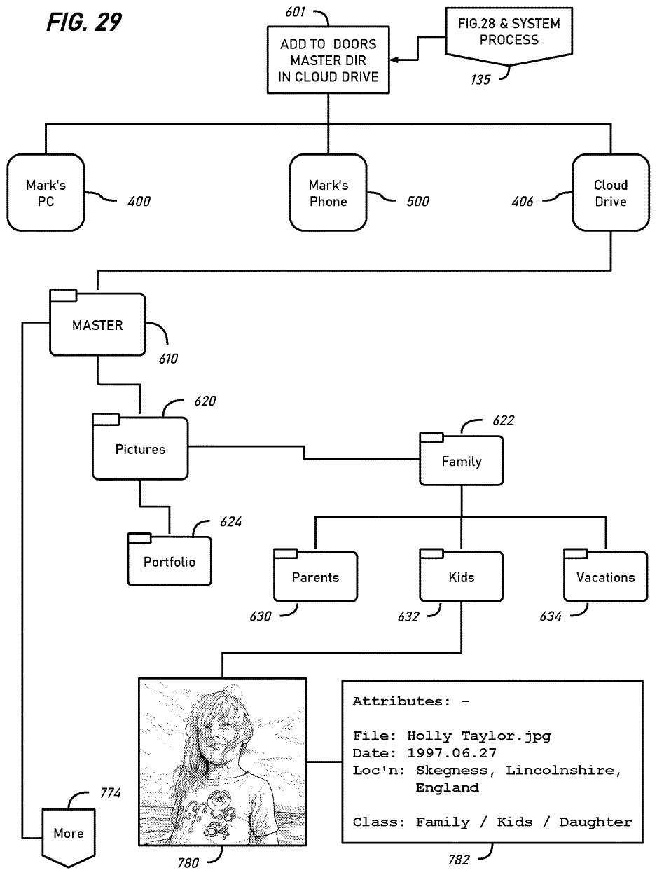

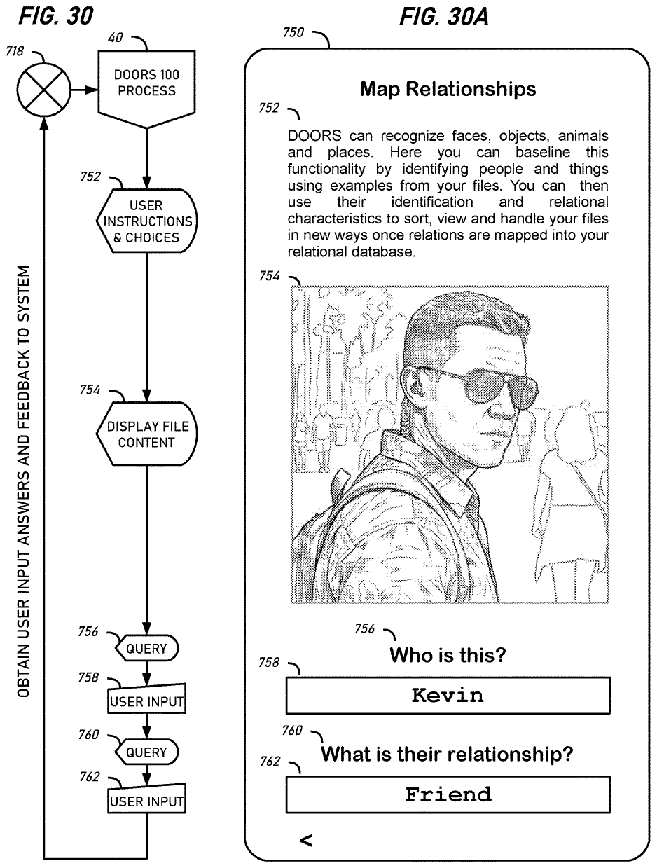

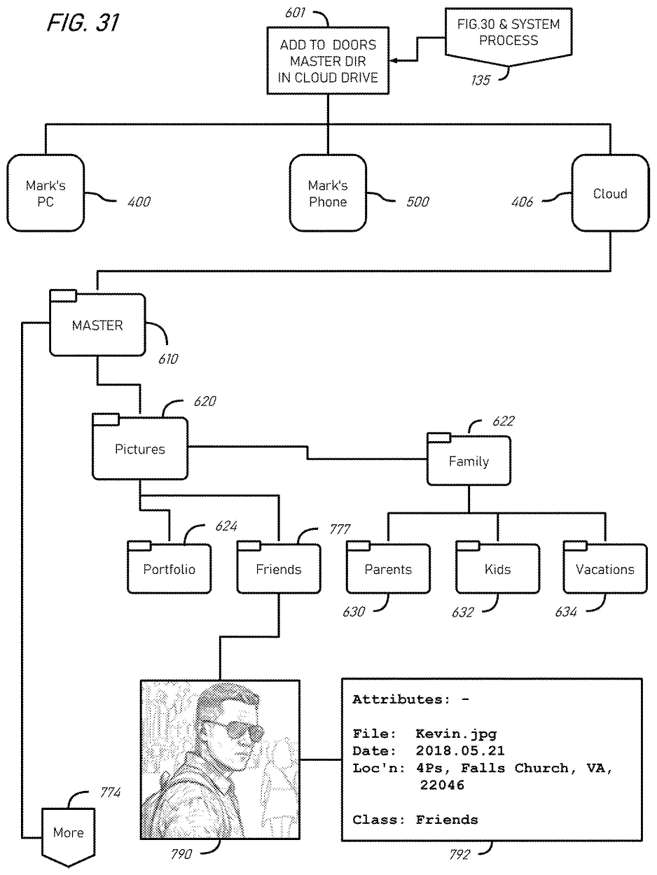

Key facts, for example may be a person's identity and other information associated with the person. As shown in the later figures (FIG. 28A, FIG. 29), there is a picture 754 of Holly Taylor 780, and that Holly's relationship 762 is that she is the DOORS owner's/user's daughter which puts her in the relational classes “Family”, “Kids”, and “Daughter” recorded in attributes 782; all of which may be identified as key facts associated with Holly and the user. Another key record or field of such a record may include all image or facial recognition data from all available pictures of Holly, and of the user (or others linked to the user). This issue of the types of relationships that may be used and cross-referenced by relational databases and processing is a feature of the DOORS 100 that is likely to expand in the total number of types and sophistication during the life of this patent. So that with the progress of artificial intelligence, and machine learning, if a picture of a new child of the user's were to be analyzed by a future DOORS application, the DOORS may be able to detect the new relationship (fact) using facial recognition plus other inferential, and fact pattern data that a picture of another person may be related to the user and/or to Holly and to attempt a guess, or hypothesis as to a possible relationship, that is based on reasonable assumptions and probabilities. So, the system may detect a picture of an unknown new image of a person and place the picture file into a directory for family, or children of the user. Furthermore, when a new face is encountered, as well as trying to deduce and infer as much as possible, DOORS may then prompt the user to describe the unknown person's relationship to the user or to Holly or to some other person. Again, in later FIGS. 30 and 31, a picture (as user input) 758 of Kevin 790 is identified in his attributes 792 as being a member of the class “Friends” and may be placed by DOORS into another directory associated with the user, for example, a “Friends” directory, automatically based on previous recognition of Kevin as a friend; or the user Mark may be prompted 760 to input Kevin's relationship 762. Then, depending on further analysis, his picture could be included into a library of friends, or friends and family, which may be determined by the DOORS application based on previous user choices. Every choice the user makes for the naming and storage of every file on every device connected to the DOORS 100 may thus be used as learning or training data that DOORS 100 may use to learn the user's habits and preferences as well as real world relational facts. So that while DOORS may be installed new with generic settings or been trained on generic training data, of generic file naming and data handling practices and conventions, also known as policies as the user makes choices, these can be incorporated (or learned) to personalize the DOORS. The effects of which over a lifetime of digital data creation, handling, processing, and storage may enable a DOORS 100 to take over those choices from the user and for the user to be able to access them as intuitively as though he or she created the file names and chose the storage locations. Because the locations and names given by the DOORS 100 helper application are sufficiently similar or the same as the human data owner would have made them.

A DOORS 100 may thus become an essential life-long helper application for users, and help to improve the accessibility, retention, and hence the sum total of the utility of human user data and hence improve our economic wellbeing and happiness. As well as freeing up user time for other more enjoyable and/or profitable activities.

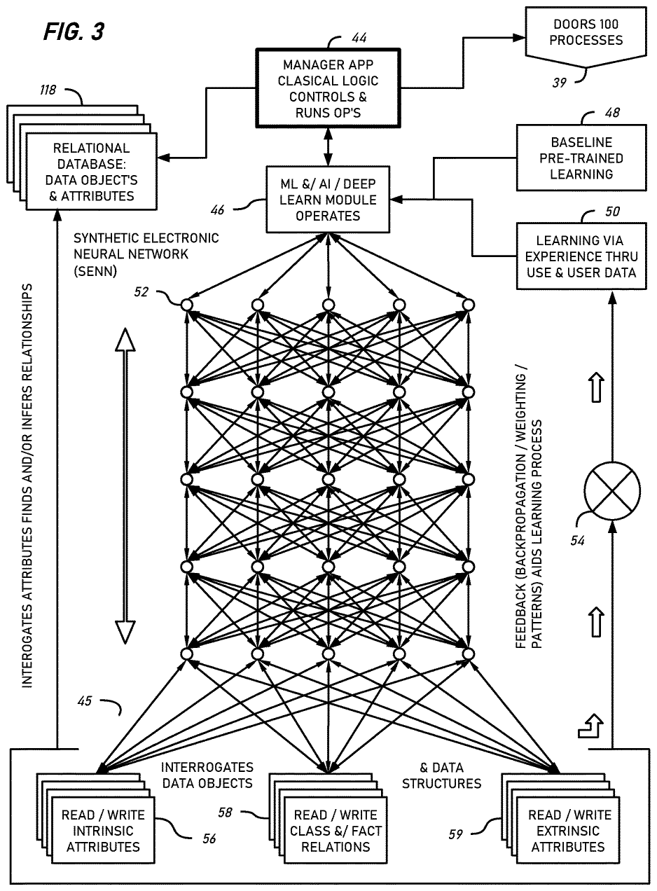

FIG. 3 may be a component part of an embodiment of a DOORS 100, or part of another embodiment of the subject technology that includes an artificial intelligence/machine learning module 46, that operates using a neural network 52, under the control of manager application 44. It shows an artificial intelligence/machine learning module that is employed within an embodiment of a DOORS 100, or which is connected to and running on system(s) hardware and processing 39 operations, under the control of a manager application 44, that controls and runs operations. The manager application 44 may control an artificial intelligence or machine learning helper module 46, which may include a neural network 52, that may be installed to a baseline specification that may be pre-trained or may include a copy of pre-trained learning 48 of the neural network. Thereby enabling a desired baseline level of functionality to be provided to users by the DOORS from the first installation and boot-up of the subject technology.

The neural network 52 of the artificial intelligence helper module, even though it may be imbued with prior learning datasets 48, may be further improved to suit the practices and preferences of a user. Which may be achieved by performing interrogation 45 (represented by lines leading to nodes of the neural network 52) of data objects and data structures, as may be comprised of data objects held on user devices from which naming conventions for files and directories as well as their structures may be obtained and used to populate a database. So that an artificial intelligence or machine learning helper module may access that data to obtain feedback 54 to aid in learning naming conventions for files and directories as well as structures as may be used to house files of varying types, and for various purposes.

Furthermore, in the case of corporate users, who may prefer to create strict policies for their naming, and structural conventions these may be directly stipulated via input into such a database or other record for this training purpose, similarly, a clean new filing system may be operated according to these subject technologies, and may record those same attributes of naming conventions for files and directories as well as structures. This recording may include naming conventions for files and directories as well as structures which may be created as feedback 54 as the user operates on files while using a device or system in their work tasks; while a DOORS application may also be operating according to these subject technologies; or it may be recorded afterwards, or periodically on a historical basis. Such as during regular corporate IT housekeeping jobs such as performing backups etc., over weekends and vacations.

The subject technologies may be operated using inference data obtained based on experience gained through observing usage of the user's data, of things such as naming and directory structuring conventions, and habits, learned from historic data as well as from the real time creation and management of new data objects 50 in the form of directory and file names, combined with their locations and other attributes. As may be obtained from connected data storage that is capable of being interrogated (scanned) then mapped into a database, that may be a relational database 118; where they may be recorded as data entries into fields, within records, of the relational database 118. All of which data may then be used to determine where the DOORS may suggest or by default would seek to create a new directory or file, plus any learned feedback 54 into the machine learning process that may be gained from a user's actual choices.

Feedback in the context of neural networks 52 may be based on recording the successful outcomes of accurately predicting where a user would be most likely to place a file within a directory structure, and what names the user would be most likely to apply to a particular file, and similarly from the names chosen for directories, and their structure, placement of files within that structure or within existing pre-named directory structures. Feedback may be recorded into weightings of neurons which may be derived from back-propagation of correct outcomes in a form of pattern recognition of pathways of neurons that produce a correct outcome, and vice versa. A correct outcome would be achieved where a new filename and storage location within directory structures is made by the DOORS after having studied and learned from the user's legacy data, in the creation of the DOORS Master directory, and the supporting relational database that is populated with details of the attributes of files.

So, for example a DOORS may suggest a filename, and location for a file that has been recorded in historical data, or a seed data. The DOORS may then check the actual file name and directory location in the data to test how accurately the AI/ML helper's suggested names and locations were. Then depending on how close the suggested answers were to the training data or real data, the feedback via back propagation adjusts the weights of neurons, so that over time with more data, those suggestions should tend to be closer to the actual or training data examples.

Furthermore, the user from whose data the file naming and storage preferences had been learned, would be highly likely to know intuitively where that file would be stored and would be highly likely to be able to identify it by the name that DOORS had given it, if DOORS had been instructed to automate file storage and naming. Similarly, if a user was trying to find a file a DOORS would be likely to be able to predict where it may be and provide an approximation of what it may have been named.

Returning to FIG. 3, also in the context of training data, the DOORS may work through legacy files stored on connected devices, and as it interrogates their attributes it may operate the neural network to record a data pattern of neurons and weights that correspond to that filename, with its unique attributes, and the location it was found in, as test conditions. By ingesting and processing sufficient training data they can learn to approximate and create new naming and storage locations according to the same style or habits of a user by predicting an approximation to the most likely choices of a particular user. So that a human user's idiosyncrasies good and bad may be reproduced to provide a very personally tailored functionality. That may be unique to users and in their own style of nomenclature.

In the later FIG. 22, DOORS creates an alias or mask name 584, within a field of the database records arrays 578 without changing the original 581. In this way a DOORS can allow users to work with files using their alias or mask name without needing to change an original name, and also if users desire, they may harmonize the two into a desired name which could be either original or an alias or mask or something else user specified.

Using an alias or mask name 584 may allow files to be presented to users with their alias names, that may be more intuitive and helpful than obscure names such as the ones cameras often produce by default such as “IMG8474.JPG” which are meaningless to most users. If a user prefers the DOORS alias or mask name, then the DOORS alias or mask name can be applied and made permanent. But it does not have to be made permanent to use the improved intuitive functionality provided by a DOORS in file handling and presentation visualization views.

A reason why a user may wish to preserve the original name 581 but use the alias 583 in processing could be situations such as crime scene photographs taken by law enforcement agencies. Where it matters in Court to prove the original file name in a chain of custody sense. The DOORS may also make the alias or mask name the actual name by renaming a file, and the original name may be also retained by the DOORS as an alias or mask.

The DOORS feedback process 54 may then provide this to aid learning, over time user preferences may be reinforced and the accuracy with which they are reflected by the names and structures a DOORS may produce may be improved with experience.

In the case of corporate users, they may wish to impose naming and storage policies for consistency across and/organization. A DOORS based on such bassline policies may be preferred in some corporate applications such as management of medical records, and lawyer's files. In such cases logical naming and structuring may be precisely set by policies, which policies may be entered by users, and then stored.

The neural network 52 may run testing against historic data as well as new data, to generate the feedback 54 with which to modify itself by adjusting the weightings of the neural network. Which feedback may then become learned and incorporated into the choices the DOORS may make. So that over time, through use and the processing and analysis of historic data and/or newly created data the neural network 52 may learn and improve its outcomes to more closely match user habits and preferences.

A relational database, as used herein, is a type of database that stores and provides access to data points that are related to one another. Relational databases are based on the relational model, an intuitive, straightforward way of representing data in tables. In a relational database, each row in the table is a record with a unique identifier sometimes called the key. The columns of the table hold attributes of the data, and each record usually has a value for each attribute, making it easy to establish the relationships among data points.

Returning to FIG. 3 the relational database 118 that records a data object's attributes that are intrinsic or internal 56, examples of which internal data may be provided by meta-data, or file formats that suggest a particular file type, such as data pertaining to pixels, and their color. As may be utilized in facial recognition aspects of the subject technologies which may identify a person who may be the user or have a relationship to a user. Extrinsic data may also be identified and used to determine relationships. “Extrinsic” as used herein, may refer to data external from the content of a document. For example, data object attributes may pertain to a class or category of data such as text-based word processing files, and the relationships of files with similar names, or file-type extensions such as “.DOCX”, “.TXT”, and “.RTF”, all being text-based file types 58 and examples of extrinsic attributes. Furthermore, extrinsic or external attributes of data objects may be file names, directory names, locations of files and directories, their structures and locations 59. Which characteristic attributes may all be analyzed to record and indeed to help the DOORS artificial intelligence or machine learning module 46 to infer and/or comprehend the relationships of data objects with users, their wider factual matrix and/or their context and with each other, and relative to a whole data set, or set of sets as in the case of a DOORS Master directory. Which is why in the embodiments shown in many of the figures a relational database 118 is used, that is capable of recording attributes as well as inferred relationships and applying these plus any directly input relationship data points. Such as the user flagging photographs of a relative and recording a relationship class such as “family” for a daughter, or mother, or a class of “friends” for a friend, or a class of “colleagues” for a colleague. Then when populating the relational database 118 with data relating to image files are processed, and perhaps in idle time the DOORS may work on deep-scanning through the content of image files using image recognition a subset of which is facial recognition and other discernible data points to build-out the relationship-based data as between the various aspects of the user's data. Consequently, the performance, capabilities, and utility of the DOORS 100 may improve over time via the accumulation, and processing of the user's factual matrix of data points. The more a DOORS learns and adds facts to its matrix of data points the better it may serve the user.

A fact-based data entity, according to the subject technology, is any real-world entity whose factual attributes are relevant to the comprehension of one or more members of the plurality of digital files that are processed by the intelligence engine. Fact-based data entities may include, without limitation, persons such as the owner, author, or subject of a file or the individual depicted within it; organizations such as a company, institution, agency, or other body; places such as a physical address, geographic location, or named venue; events such as a date-specific occurrence, occasion, or meeting; objects such as a physical item, product, or artifact; and any other entity in the real world whose factual characteristics may be inferred from or linked to the intrinsic or extrinsic attributes of one or more files in the plurality that is being processed.

The relational database nomenclature of these subject technologies is without limitation any database that records relationships between data entities or data objects. As provided in FIG. 2, the relational database may include an array of records, and/or pointers to records of key real-world relationships and facts, such as names, faces, and places, pertaining to fact-based data entities associated with the file collection. The real-world ground truths pertaining to fact-based data entities or data objects may be received by the intelligence engine via user input through the user interface, via inference by the intelligence engine from the intrinsic or extrinsic attributes of the files, or via a combination of both. Once recorded into the factual matrix, the real-world ground truths pertaining to fact-based data entities enrich the comprehension of the file collection and enable the inference of relationships between files and between files and real-world entities that would not be apparent from file attributes alone.

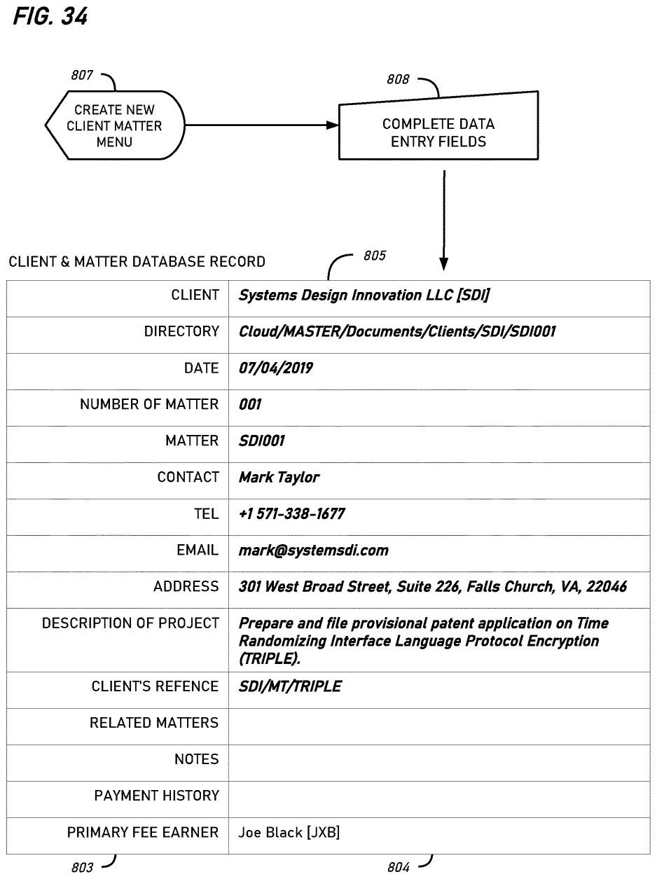

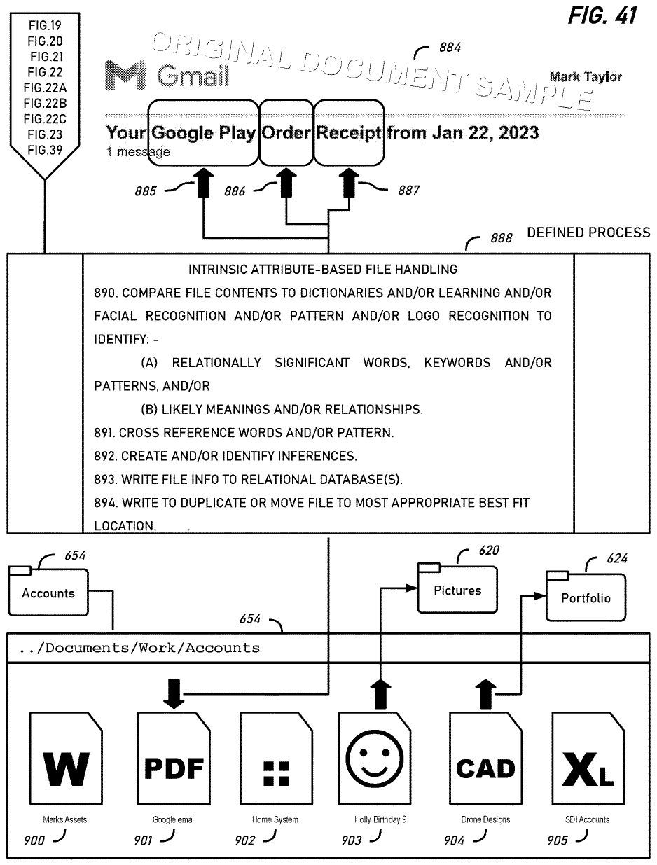

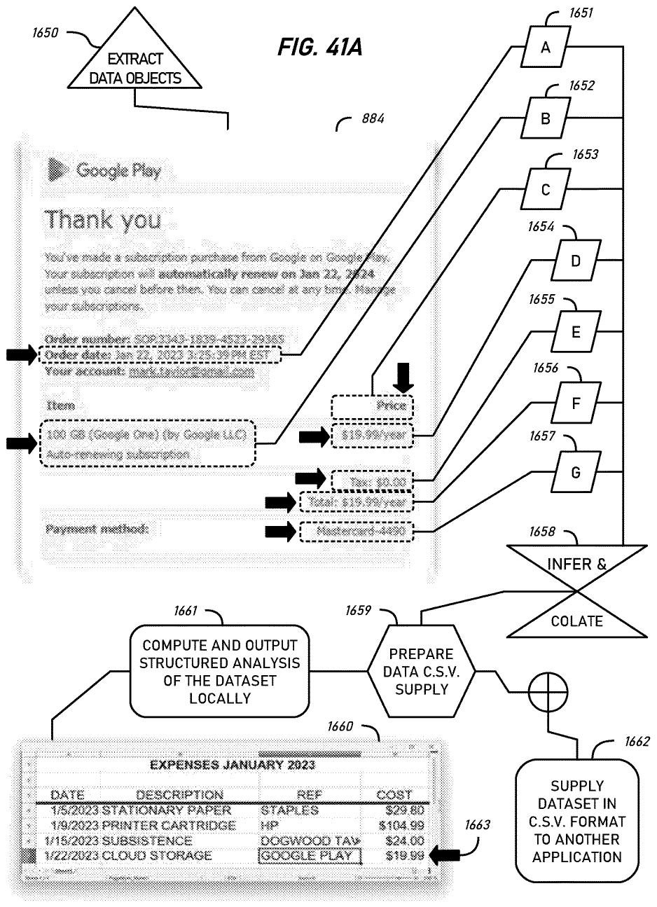

Persons skilled in the art will understand that many types of files may be managed using a database according to the subject technologies. Indeed, some files have a database embedded within them: a table within a word processing document constitutes a structured dataset within the file; and a spreadsheet, such as a file of the “.XLS” or “.XLSX” type, is essentially tabular in character and may itself be treated as a file-embedded database. The principal illustrative embodiments set out in this specification employ graphical user interface views of heterogeneous collections of files because that form of embodiment provides an effective and widely comprehensible demonstration of how the DOORS 100 operates on and manages a collection of files of mixed types in a form that most persons will readily understand. However, the subject technologies are not so limited. This specification also describes and illustrates an alternative embodiment comprising a client management database for a professional services practice-specifically a patent attorney's firm operating a DOORS-organized client matter file system as shown in FIGS. 34 through 40. The management of an email database is additionally described herein, referenced at step 20 of FIG. 1A, wherein an email database may be operated according to the subject technologies and obsolete versions thereof deleted or preserved according to user selections and/or policies. FIG. 41 provides a further embodiment showing the processing of an individual email file to interrogate and extract a subset of data from within it: in that embodiment the sample document—a Google Play Order Receipt received by the inventor by email and residing in a database—is processed by the defined process 888 to identify relationally significant keywords within the file's intrinsic content and to infer therefrom that the file is a member of the classes “expenses” and “financial”, which inference is then used to reconcile the file to the appropriate location within its database structure. That embodiment exemplifies the key inventive concept of determining the intrinsic attributes of a file to comprehend its meaning and direct its management, applied to an actual real-world sample document.

The subject technologies may be applied to any digital files and data objects that are susceptible to management within a database, without limitation or qualification. As used in this specification, a relational database means any database that includes a relational aspect in its handling of data or within that data. Embodiments of the subject technologies may accordingly be applied to, without limitation: heterogeneous file collections comprising a plurality of mixed file types; homogeneous file collections comprising files of a single type; word processing document collections; spreadsheet collections; presentation file collections; portable document format (PDF) collections; email collections and email databases; instant messaging archives; SMS and text message archives; calendar and appointment databases; contact databases and address books; photograph and image libraries; video file collections; audio and music libraries; mixed media collections; computer-aided design (CAD) and engineering drawing file collections; three-dimensional model and digital twin libraries; source code repositories and software project file collections; geographic information system (GIS) and geospatial data collections; scientific dataset collections and research data repositories; academic and scholarly paper collections; medical patient record systems; pharmaceutical and clinical trial data collections; insurance record systems; human resources and personnel record systems; financial record collections comprising receipts, invoices, bank statements, and tax documents; customer relationship management (CRM) databases; inventory and asset management databases; legal case files and professional client matter files; log file and system event record collections; Internet of Things (IoT) sensor data streams and telemetry logs; graphic design and creative asset libraries; game and interactive media asset libraries; broadcast and production media asset management systems; digital forensic evidence collections; bookmark and web archive collections; website and webpage collections including files of the .htm, .html, and .mhtml types; e-commerce product cataloguing and display systems; inventory management databases; supply chain and stock management systems; directory and folder structures; and any other structured or semi-structured collection of data objects that is susceptible to the relational, inferential, and organizational operations of the DOORS 100.

The use of a relational database in combination with an artificial intelligence or machine learning helper module, may thus provide a very powerful tool for understanding user data structures at new deeper levels than was attempted in the art. The DOORS 100 then may use this deeper level of understanding to assist users with suggestions and/or to make autonomous choices for file naming and file storage locations. Including the creation of appropriate file names, directory structures and names. Where these are helpful and are consistent with the learned preferences and practices of a user. So that the user may be enabled to intuitively find where the DOORS 100 has autonomously created new data, as easily as if he or she had made those decisions. This harmonization and personalization of DOORS may help to make it an invaluable helper application that users may wish to port to every new device for the whole of their digital lives, capable of harmonizing data handling and storage across a range of devices, and resources. As well as providing a full DOORS Master copy and/or backups of the user's entire digital life's work, and their digital legacy that may be suitable for inheritance by the user's heirs and assigns ad litem or post mortem. Children inheritors or corporate successor entities may clone a DOORS Master copy and/or the artificial intelligence helper module's learning for use on their data.

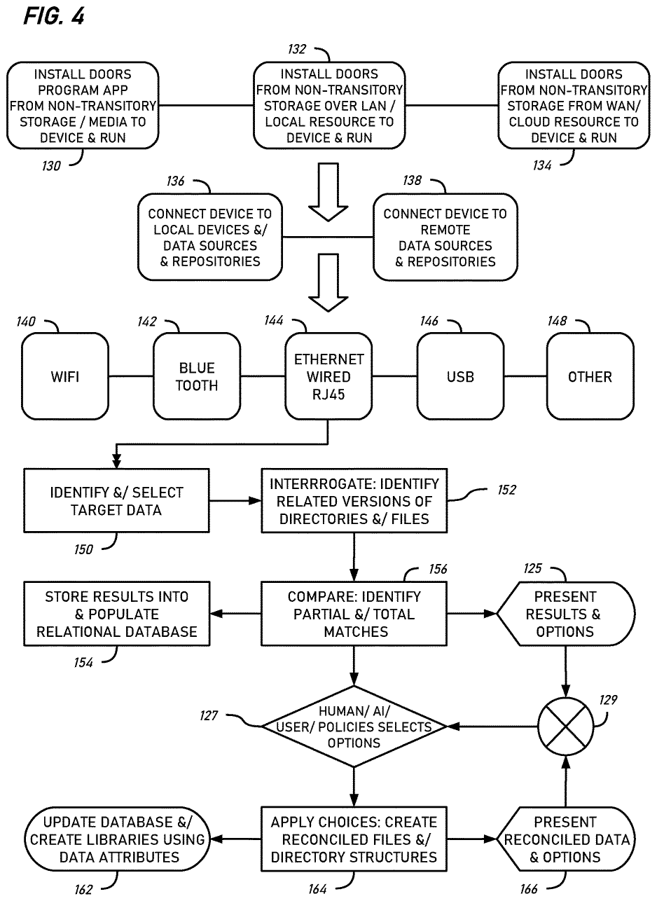

FIG. 4 shows further detail of the installation and operation of the DOORS application. A DOORS software product or program, containing a set of machine-readable and non-transitory instructions executable by a processor may be installed and run on a device locally 130; alternatively, DOORS may be run from or on a local area networked (LAN) resource 132; or alternatively DOORS may be remotely run from or on a wide area networked (WAN) or Cloud resource 134. Suffice to say that the DOORS application may be run on or from any suitable platform device in combination with any other connected platform device or storage resource of a platform or device. In what may be a swappable and poly-connectable manner.

However, and wherever from the DOORS may be run, it may be connected to local devices and/or data sources and repositories 136, and/or alternatively it may be connected to remote data sources and repositories 138. Furthermore, in either case local sources 136 and remote data sources 138 may be connected in parallel together.

Connections of the DOORS application running device, or resource, to sources, may include any or all of the alternatives of Wi-Fi 140, Blue Tooth 142, Ethernet (wired) with RJ45 connections 144, USB 146, or other 148 and even yet to be invented connection mechanisms—to or through or LAN 132, WAN, Internet or Cloud 134.

After which the DOORS 100 may identify and/or select target data 150 in various connected resources, then interrogate those repositories and identify related versions of directories and/or files 152. The DOORS 100 may then compare related files and/or directories seeking to identify partial and total matches 156. The output of which may be stored 154 into a relational database and/or go to be output in the presentation 125 of results and options to a user. A human user or artificial intelligence module or user or policies may select options 127, from the options menu presented 125.

The DOORS may apply those choices to create reconciled files and/or directory structures 164. As well as presenting the reconciled data and options to a user 166, and as a result of which the database and/or libraries may be created and/or updated 162 using the newly discovered data 152 attributes and user entries or choices 127.

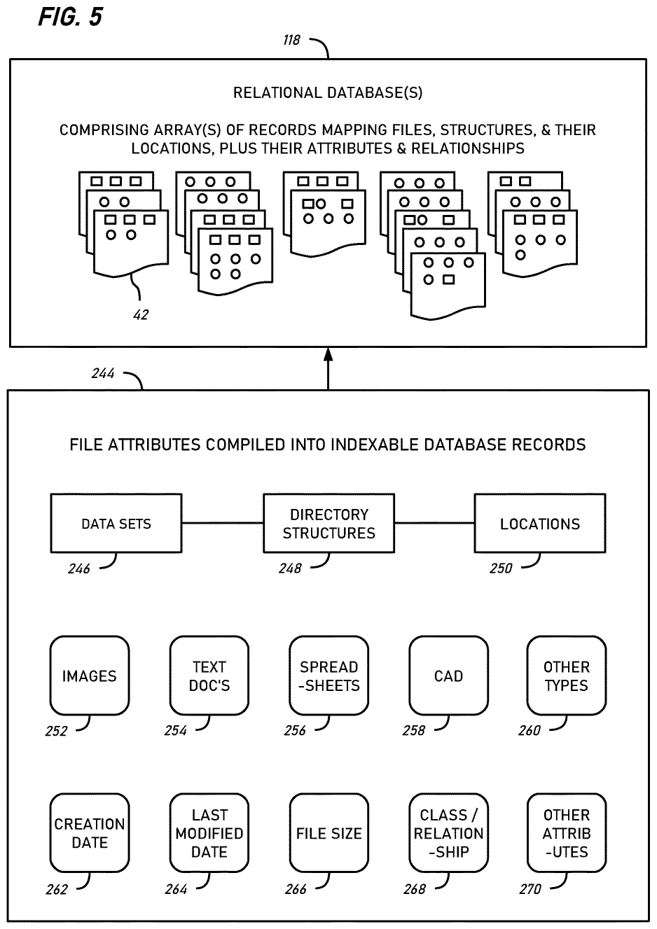

FIG. 5 shows in block system form a relational database 118, that is comprised of multiple arrays of records, mapping files, structures, and their locations, plus their attributes and relationships 42. Which records have various fields that detail their attributes as they may pertain to a particular record within an array of the relational database. This is illustrative but not an exhaustive or exclusive list of all the possible file attributes that may be compiled into indexable database records 244 that may be usefully included within those of a DOORS database capable of detailing data that is meaningful and may allow relationships to be recorded and/or inferred from the fields. Files and their locations may be understood by a DOORS using relational aspects that may be evaluated and inferred based on fields detailing data sets 246, directory structures 248, locations 250 of the files and the directories in which they are stored. Furthermore, other alternative aspects of files may be used to associate them with other files by the DOORS 100 into a master directory or libraries. That may be used by users or by a DOORS to group, handle and present files or selections of files. Such alternative and complementary attributes as may be populated into a DOORS database may include data entry fields for: images 252, text documents 254, spreadsheets 256, computer aided designs (CAD) 258, other file and data types of which there are potentially many 260, creation date 262, last modified date 264 which can be useful for inferring the latest version, which aspect will be noticed by both artificial intelligence as well as by human users as a very useful data aspect, file size 266 which also may be very useful for determining between differing drafts and versions of the same document or file such as cropped or photoshopped images.

Class or relationship 268 is a very useful field that may be populated by the user and/or machine learning and/or an artificial intelligence module that may for example be able to recognize faces, recognizing that Holly is Mark's daughter, and may be able to suggest that other pictures may be of relatives of Mark and/or Holly, etc. Relationships may also be discernable by strings within document names and other file names. For example, a work project may be named Mars Mission, and its file types may include pictures, videos, documents, and computer aided engineering designs for spaceships, as well as budgetary spreadsheets. The DOORS 100 may notice that many disparate documents include the text “MARS”, “Mars”, “mars” and other variations of “mission” in common in the folders and/or filenames. A DOORS may decide to query the user regarding the relationships of these documents having found them in both work and personal devices and file structures. Furthermore, the DOORS 100 may then be able to disentangle these from other files within the DOORS Master copy file and move them all over to the “Employers' VPN Drive” 228 or save them into a “Work” directory within the DOORS Master copy file. From where the user may later choose to move them to his Employers' VPN drive and perhaps remove them from his personal data structures and files. This is likely to be one of the most used features of any DOORS as users are enabled to disentangle different but intermingled data sets from across a plurality of devices.

Other attributes 270 is a field that might usefully allow sub-branches of fields within it as well as allowing limitless alternative fields that may be useful for the DOORS. This feature covers not only the fields that could be listed now, but also those that can't be listed yet because the technologies and applications they may relate to may not exist yet. But may come to be widely used within the life of the DOORS patent without departing from the subject technology.

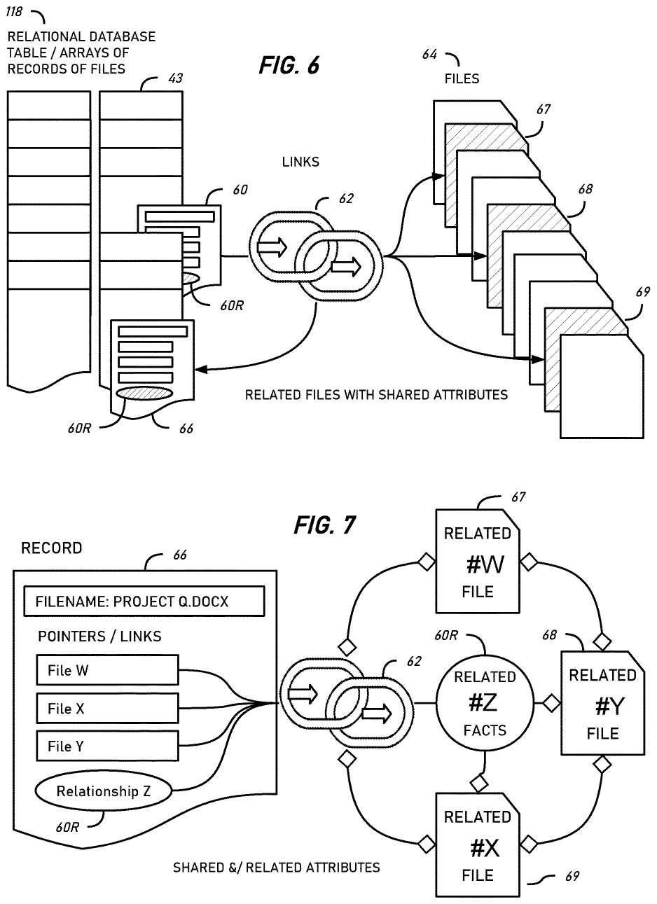

FIG. 6 shows a relational database 118 that may include a table containing arrays of records 43 of files 64. Which may include a selected record 60 that may contain links 62, that may be comprised of pointers, that point to the files 67, 68, and 69 which have been identified by the DOORS 100 as having shared attributes that may include relationships determined by A.I. Furthermore, one link points back to another record because of a shared relationship with another record 66 which has been identified within the record 60, as sharing a relationship 60R with the related record 66 which may share a relationship as one of its attributes. This mechanism of identifying and recording the relationships between data objects may include relationships to real world facts, which may serve to help build a comprehension model. Such a comprehension model which records relationships may provide a similar sort of machine learning in the comprehension of data, as may be created within synthetic essentially electronic information technology based neural networks. A key benefit of using relational databases is their transparency to humans. Which may make them auditable by reading and checking against textual records of facts. This is desirable because neural networks can sometimes malfunction and “hallucinate” in the creation of inferences which are incorrect. Which is why in these subject technologies, which handle critical files, and real-world facts may benefit from persistent non-transient storage.

For these reasons the mechanism of linking relationships in these subject technologies may be suited for use safety critical systems. So that safety critical information pertaining to relationships is auditable and is correctable. The hallucination and forgetting risks of neural networks may be mitigated by the use of machine learning which is stored in auditable, verifiable, and correctable fields, within the records of a relational database.

As expressly labeled in FIG. 6, the relational database 118 of the DOORS 100 is structured as a “RELATIONAL DATABASE TABLE/ARRAYS OF RECORDS OF FILES”, represented in the drawings by the stacked-table icon 43. This labeling captures the dual architectural nature of the data structure: the records of the relational database 118 are organized as one or more arrays 580, each array constituting an ordered and extensible collection of records 60 for individual files or data entities; and those arrays are in turn embodied within a table structure which associates each record 60 with named fields for its respective attributes, including addressable pointers 62 to related files 67, 68, 69 and to related records 66, as shown in FIG. 7. The array 580 of records within the relational database 118 is capable of being extended to accommodate as many records as may be needed to represent the complete file collections interrogated by the DOORS 100, without fixed upper limit. Each record 60 within the array 580 may contain a further nested array of fields 582, extensible in the same manner to accommodate as many attributes as may be discovered or inferred for the corresponding file or data entity. FIG. 5 further shows the range of file attribute categories that may be compiled into indexable records 244 of the relational database 118, comprising data sets 246, directory structures 248, locations 250, images 252, text documents 254, spreadsheets 256, computer aided design files 258, other file and data types 260, creation date 262, last modified date 264, file size 266, class or relationship 268, and other attributes 270, thereby illustrating the breadth of attribute data that may be recorded within each record 60 of the array 580. This multi-dimensional array architecture—an array 580 of records, each containing a nested array of fields 582—constitutes one embodiment of the Factual Matrix 71 as a data structure capable of recording the full range of intrinsic attributes, extrinsic attributes, real-world ground truths, inferred relationships, class memberships 268, alias and mask names 584, and addressable file pointers 62 needed to support the relationship inference and file management operations of the DOORS 100.

The Factual Matrix 71 of the DOORS 100 may be located and partially or fully loaded into the working memory of the computing system during processing operations, as a data structure comprising one or more of: a one-dimensional array of records; a multi-dimensional array of records, as shown in FIG. 6 (item 118, labeled RELATIONAL DATABASE TABLE/ARRAYS OF RECORDS OF FILES); and a table structure comprising rows and columns of records and fields. The Factual Matrix may comprise a plurality of class-specific tables or similar and identifiable structures, each recording fact-based data entities of a particular class or other grouping together with their relationships, synonyms, and associated attributes, as shown in FIG. 14 (RELATIONAL DATABASE RECORDS FOR CLASS: FAMILY, item 395) and FIG. 15 (RELATIONAL DATABASE RECORDS FOR CLASS: FRIENDS, item 396). The Factual Matrix may further comprise one or more arrays or tables nested within a document file, including but not limited to a word processing document and a spreadsheet document, wherein the content of such a document file may itself constitute or contribute to the data structure that forms part of the Factual Matrix. A vector graph database or pointers into one may also be incorporated within the Factual Matrix.

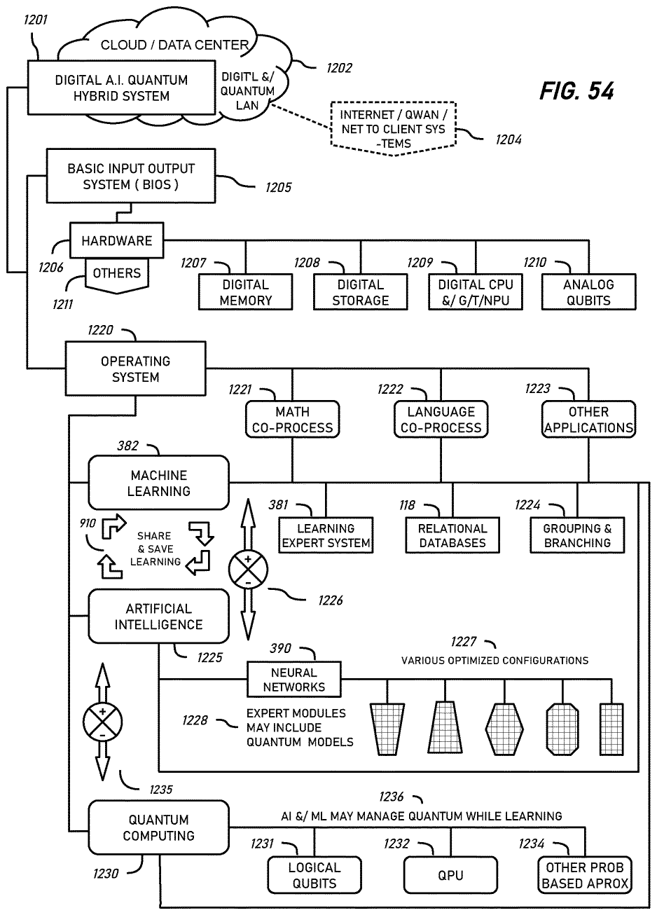

The Factual Matrix may additionally hold addressable pointers to one or more procedural tools such as executable code modules, sequences of processing instructions, and processing routines, each associated with an identified fact-based data entity or an operational task and indexed within the knowledge tree for retrieval by name or by functional similarity. A Factual Matrix or part that is loaded in working memory during operations may be retrieved from and written back to non-transient digital storage (item 1208, FIG. 54) at any point during or after processing, by the Immortal Memory mechanism (item 1403, FIGS. 42, 42A, and 42D), so that the accumulated knowledge of the DOORS 100 persists across sessions and accumulates over time.

The cross-referencing of the Factual Matrix 71 is omnidirectional: the links 62 implemented as addressable pointers within the relational database 118 are not constrained to any single direction or hierarchy of traversal. A pointer may link from any file record to any other file record; from a file record to any data entity or data object recorded within the Factual Matrix, including fact-based data entities such as persons, places, events, and organizations; from a file record to a data object that has been extracted from within the intrinsic content of another file, such as a face identified within an image, a keyword extracted from a document, or a factual datum identified within an email; from a data entity or data object within the Factual Matrix to any file record whose attributes bear a recorded relationship to that entity or object; from any record within an array structure of the relational database to any other record within the same or a different array structure; and from any node within the knowledge tree to any record, file, data entity, data object, or procedural tool stored anywhere within the database structures of the system. The pointer linkages 62 may be bidirectional: where a link exists from a first record to a second record, a reciprocal link may exist from the second record back to the first, so that the relationship may be traversed in either direction. The omnidirectional character of the Factual Matrix means that no record, file, data entity, or data object within the system is reachable only through a single path or from a single direction: any item identified within the Factual Matrix may be reached from any other item to which it bears a recorded relationship, by following one or more pointer links in any applicable direction through the relational database structures. This omnidirectional linking provides the structural foundation for the compound comprehension, inference crystallization, and meaning-chain traversal operations described elsewhere herein. To provide a DOORS that really knows the user and may be able to infer non-obvious relationships. Which capability may be particularly helpful when conducting research on a dataset.

In one embodiment, the DOORS 100 may create a new data set or sub-set by assembling extracted data objects from one or more of the digital files within the interrogated collection, as shown in FIGS. 40 and 41. The intelligence engine may extract data objects from within files by applying the defined process 888 of FIG. 41, comprising: comparing file contents to dictionaries, learning, facial recognition, and/or pattern recognition to identify relationally significant words, keywords, patterns, and likely meanings (step 890); cross-referencing identified words and patterns (step 891); creating and/or identifying inferences from the cross-referenced data (step 892); writing file information to the relational database (step 893); and writing to, duplicating, or moving the file to the most appropriate best-fit location (step 894). As demonstrated by the Google Play Order Receipt embodiment of FIG. 41, the data objects extracted from a file may include named entities (items 885, 886, 887), date references, financial identifiers, and any other relationally significant data discernible from the file's intrinsic content.

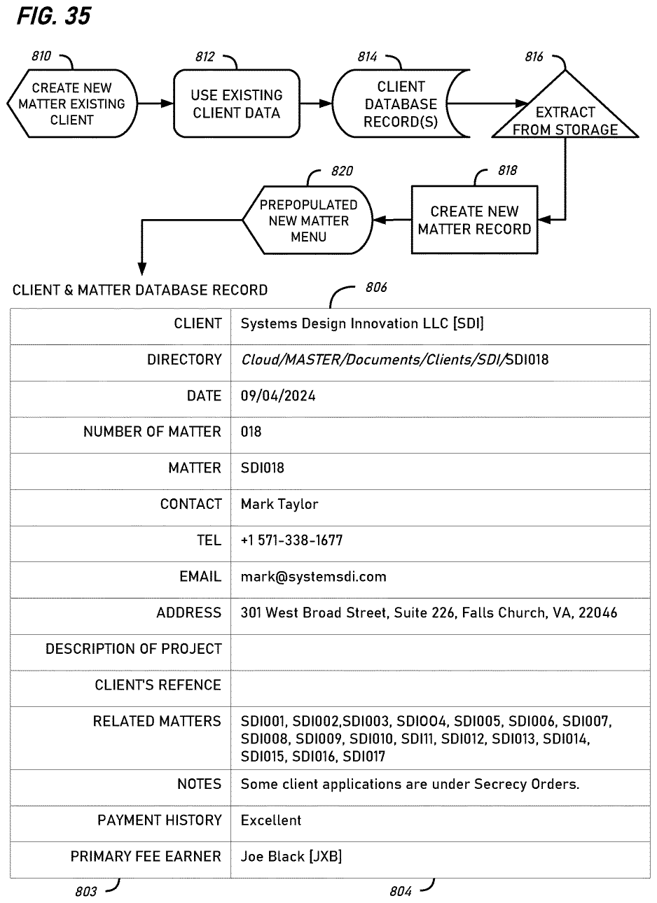

The system may identify the related attributes of extracted data objects from within the Factual Matrix 71 (item 880 in FIG. 40), and may assign a new name or alias to the assembled data sub-set using the Auto Naming Engine (item 1457 in FIG. 42C), wherein the new name encodes the relationships and data type category of the assembled sub-set. The new data set or sub-set may be recorded into a database structure comprising one or more of: a one-dimensional array, a multi-dimensional array, and a table structure, by the Directory Creator module (item 1458 in FIG. 42C). The new data set or sub-set may be configured in a standardized format selected to enable streamlined ingestion by a further data processing application without requiring reformatting by that application, as demonstrated by the pre-populated new matter form (item 820 in FIG. 35) into which extracted client and matter data objects are supplied directly.

Users who may wish to operate a DOORS 100 in some aspect of fact critical or safety critical activities such as aviation or medicine may thus prefer and be reassured by the machine learning approach of these subject technologies leveraging relational databases, that may support and hold accurate factual matrices, and hold these in non-volatile storage.

In terms of the relational database 118, the links 62 may relate to files that share a “class” such as a work project name. The attribution of a class to relationships may help in the contribution of meaning and hence comprehension of user data objects. Machine learning that leverages logic to generate inferences that may trigger actions can be specific and may be used to impose hard rules for processing. Which may be very useful and desirable in a DOORS that is used within a professional services firm such as accountancy, law, and in defense applications.

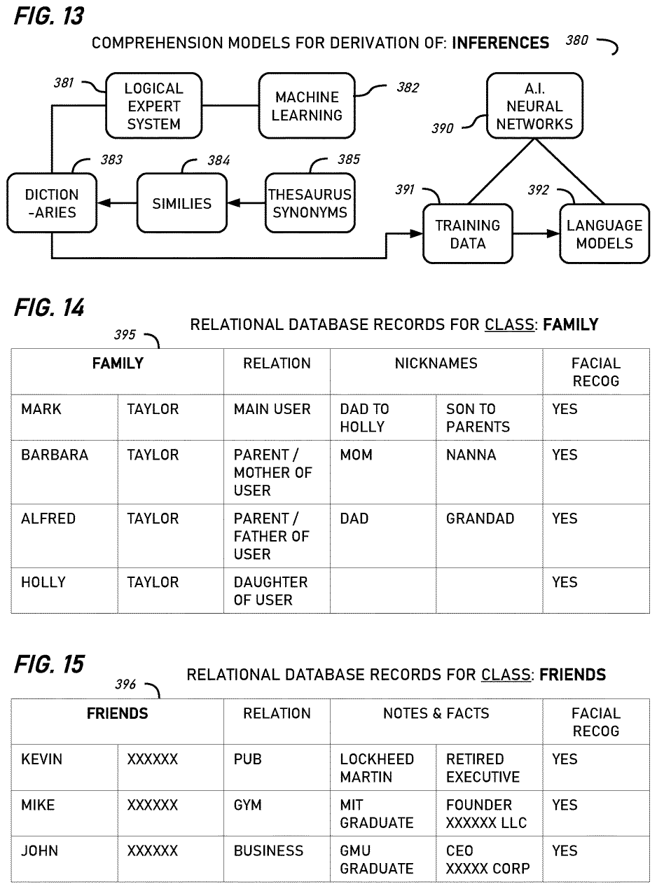

FIG. 7 follows on from the previous FIG. 6, and shows the record 66, from within the array 43 of the relational database 118. The record 66 contains the fields “FILENAME” which has the value “PROJECT Q.DOCX”, and an internal nested array of fields each holding pointers enabled links 62 to files and/or other records having one or more shared attributes with “File W” 67, “File X” 69, “File Y 68”, and/or to their shared “Relationship Z” 60R. These relationships are essentially part of the learned factual matrix that the DOORS 100 has learned from user input, and from working with those files, some of which may have also been inferred using synonyms or similes and related words. Which learning may have been achieved by operating language models by artificial intelligence 390, and/or machine learning 382, and/or logical processing-based inferences as may be produced by an expert system 381 (see FIG. 13 regarding comprehension models for derivation of inferences 380) operating within a DOORS 100. Which processing has led to the population of the relational database 118. A group of candidate files that have been assembled based on relationships determined by artificial intelligence 390, and/or machine learning 381 may be presented to a user. Once a selection of one of the candidate related files (for example, a file representing the group is received, a filename associated with the selection may be generated, that denotes a relationship between the group of identified candidate related files.

The precise details of which may vary with applications. For example, the needs of a CGI studio operating a DOORS 100 in a moviemaking studio, is likely to be skewed towards handling motion picture files more than handling text documents; and a teenager with a mobile phone may be focused on her selfies and social media posting pictures. Relational databases may be tailored in terms of their internal structuring of records, fields, and links to their data storage facilities according to such specific needs without deviating from these subject technologies.

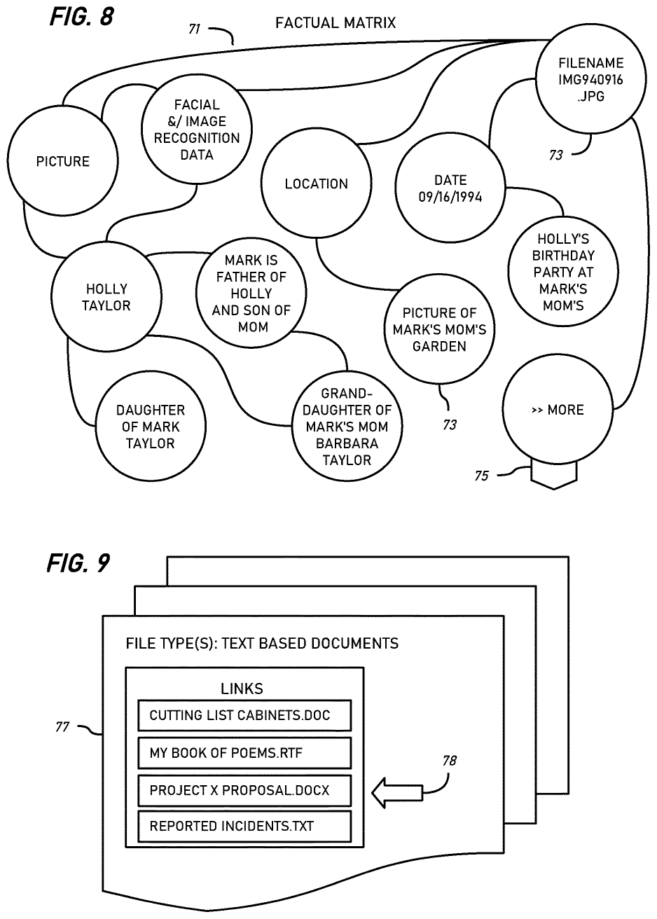

FIG. 8 shows a visualization of a factual matrix 71, which the DOORS 100 has been able to build from its relational database of knowledge (learning) and from the file named “IMG940916.JPG” 73. The file creation date is Sep. 16, 1994 which is a match for Holly's birthday. So, the DOORS has been able to infer or has been told by user input that this is a picture taken at Holly's birthday party. Similarly, DOORS has photographs of Mom's Garden, and it may have been able to deduce the location of the birthday picture was Mom's Garden from the intrinsic image data, or from geolocation metadata, or from user input. As will be seen in the user interfaces DOORS may ask questions of users to help it to build out its factual knowledge base so as to be better able to help the user in future. The more facts the user provides through those interfaces the better.

The knowledge DOORS may amass may be really helpful for people with poor memory recall, and perhaps there may be new fields of application for DOORS in helping memory impaired people; perhaps drawing on data from times before a user became memory impaired, so that persons skilled in the art may appreciate the power of these fact matrices, as being capable to add a lot of leverage to our ability to use our own information and information about our data through the lens of our digital life, and the data it produces and which grows with us over the course of our lifetimes. We can see also in the factual matrix 71 that Holly is the daughter of Mark, and that Mark is the son of Barbara and either the DOORS has been able to infer or has been told through a user input interface that Holly Taylor is the granddaughter of Barbara Taylor, and that Barbara Taylor is grandmother to Holly Taylor, and mother to Mark Taylor. (In related figures it is shown that these relationships may be used in processing to group data objects or factual data points relating to Holly, Mark, or Barbara as sharing the attribute: “family”). In building this knowledge base of data points DOORS may create a powerful tool through which we may all see, comprehend, appreciate, and remember our lived experience of life and the events in it better than we otherwise would. Which is why the Inventor fervently believes the ability to build these factual matrices within the context of management of our digital lives and legacies using a DOORS may provide many more life improving applications and benefits.

FIG. 9 is of a record 77 from within an array of records detailing the type and/or class of “text” files which may include similes and/synonyms “txt”, or “text-based” files DOORS 100 has found in a specific location in response to a user search query. The user may be trying to gather together related files for a project that have become fragmented over multiple devices such as a mobile phone, plus a personal computer at home, and a work computer. The file the user wants from within this list may be identified in a further search query, indicated here by the arrow 78 as “PROJECT X PROPOSAL.DOCX”. The user may then use this file and its intrinsic and extrinsic attributes to help find other files that may be related to it. Which is what the user has done in the next figure by executing the query to request the DOORS to find and display files that have a relationship to the file “PROJECT X PROPOSAL.DOCX” 78R as indicated by the arrow.

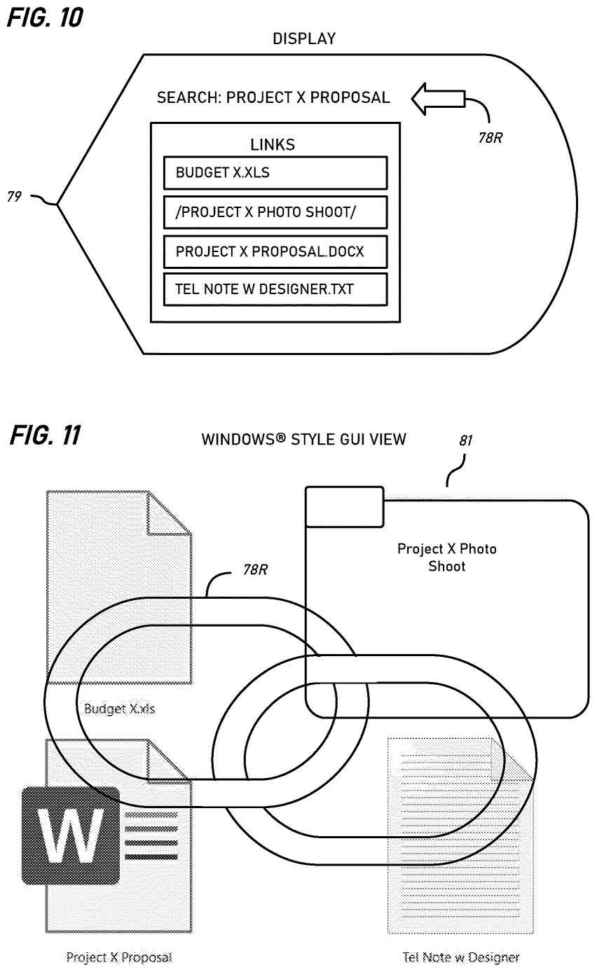

FIG. 10 is the response to that query comprising a display 79 of the results of that search the user told the DOORS 100 to perform, using the search term “PROJECT X PROPOSAL” 78R which has interrogated its attributes, found and/or inferred relationships, and returned details of the files “BUDGET X.XLS”, “PROJECT X PHOTO SHOOT”, “PROJECT X PROPOSAL.DOCX”, “TEL NOTE W DESIGNER. TXT”.

It is important to note that the DOORS 100 has returned one file “BUDGET X.XLS” that only mentions “X” and another file “TEL NOTE W DESIGNER.TXT” which searches in the prior art would not have been capable of finding because they don't contain enough extrinsic clues on the outside that they are linked to the search term. How the DOORS 100 has achieved this is by looking inside the documents and searching inside them for the search terms, and by leveraging its relational database along with one or more of an expert system logic, machine learning, or neural network artificial intelligence. Which has allowed the DOORS to find or infer relationships that would not have been found otherwise. How these example cases may have been achieved is the use of a partial synonym match or simile inference in the case of file “BUDGET X.XLS”, and by interrogating the internal contents of the file “TEL NOTE W DESIGNER. TXT”, which may have contained a synonym, a true match, and/or partial match, and/or simile to the searched term, file name, and/or to a relationship fact associated with the searched term. More details of this aspect of the subject technologies regarding deep scanning into the intrinsic attributes (including contents) of files (and file reconciliation) are addressed in more detail in the description below and in particular FIG. 38, FIG. 39, FIG. 40 and FIG. 41.

This is a powerful feature which may be capable to allow a busy businesswoman to ask a DOORS 100 to find all the receipts from a given tax year and sort them into her expenses folder. So that they may be used to help complete her tax return. Indeed, using the capability to deep-scan for intrinsic attributes inside documents, a specialist embodiment of DOORS may be used to interrogate those documents and retrieve the totals from invoices and receipts. Then use those totals to calculate her expenses. So that the user may ask her DOORS to compile all my receipts for office supplies for 2023, postage, telephone bills, gasoline, and marketing. Then import those totals into a spreadsheet or pass them to an accountancy application in an appropriate format. Persons skilled in the art will appreciate that a DOORS may be used in many ways too numerous to list here, and able to help the user better leverage and process their data to save time and make life easier. Leaving more time for more enjoyable activities than bookkeeping and preparing tax returns.

FIG. 11 shows a Windows® GUI style screen view 81 of how DOORS may represent on a device screen that it has found those linkages 78R and linked those four documents to the search term “PROJECT X PROPOSAL”.

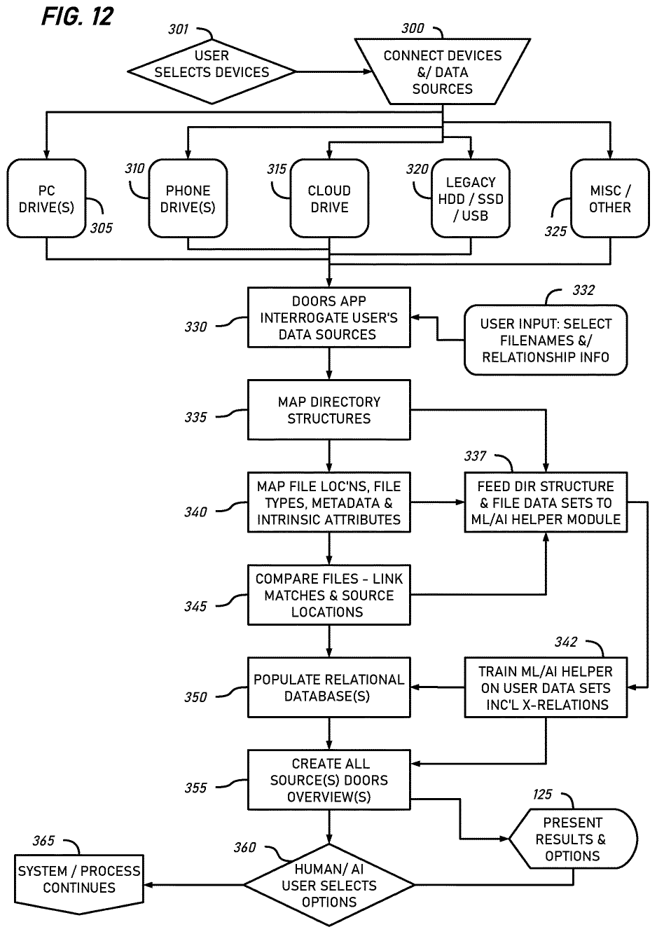

FIG. 12 shows a method of copying and reconciling files between different devices using DOORS according to an embodiment. In a DOORS 100, the user selects devices 301, and connects those devices and/or data sources 300, which may include for example, PC Drives 305, Phone Drives 310, Cloud Drive 315, Legacy hard disc drive (HDD) which may be either a rotating disc-type or a solid-state drive (SSD), or universal serial bus (USB) variants or backup drives of any type that connect via USB 320, or other miscellaneous alternative data storage drives that are not directly referenced or may not yet exist at the time of creation of this specification 325.

The DOORS 100 interrogates 330 the user's data sources, in an another or additional step the process may be augmented with user input to select 332 filename and/or relationship information, map directory structures 335, and map files located in those directory structures 340, including file types and meta-data and intrinsic attributes. Files and source structure locations comprising directories, directory trees, and the names of their branches may be compared and matches, or partial matches of directory structures, names, and file data sets obtained 345, all of which data sets may then also be fed 337 to an artificial intelligence or machine learning helper module. Which helper module of the DOORS may then use to train itself on these user data sets 342; that may include the intrinsic data from within actual files. Such as details of human faces and physical places that may be subsequently used in facial recognition for people, and spatial or object recognition for geo-location. Other intrinsic aspects of intrinsic file data may be used to assist in the recognition of other objects such as cars, balls, bats, buildings, and animals such as the family pet or zoo animals. Then both the logic-based data, and the artificial intelligence training and learning events which may be gained while operating the DOORS 100, including the cross-relations and classifications of data objects may be used to populate 350 the relational database, and aided thereby the DOORS may create 355 overviews of data from all available and interrogated sources. The results of which and further options may then be presented 125 to a user. From which a human user or artificial intelligence or human assisted by artificial intelligence may select options.

When run for the first time a DOORS 100 may begin from a baseline. Having been initially installed as pre-trained using generic and widely accepted data handling and naming conventions, norms and rules. Over time the baseline out of the box versions of the DOORS application software will likely improve in the detail and sophistication that is achievable. Learning may be copied from one iteration and then built upon by the DOORS in ways that the user should find are intuitive because the DOORS has learned the user's preferences. So that over time users will recognize directory structures and naming conventions as being in their own style and may not be able to determine whether they or DOORS created a specific directory structure or file name. Which may make accessing user data more intuitive and efficient for users.

Other features such as the ability to impose libraries that present file locations, and files in alternate views based on other relationships or attributes may further leverage the power of the relational database at the heart of the DOORS 100. All of which should make it much easier to find files, to use them and not lose them over time and across a lifetime's worth of devices, porting data across a wide variety of storage locations and platforms. Including some technologies that probably don't even exist yet. This sequence of steps in this aspect of a DOORS 100 embodiment may continue within a larger system or process 365.

FIG. 13 explains the relationship between comprehension models for the derivation of inferences 380. Logical expert systems 381, may be aided by machine learning 382. Machine learning may be achieved by various routes, it may be obtained by menus that ask the user to provide input data, which may be added to the learning of the fact matrices 71 (FIG. 8), comprised of user related data points and data related data points; intrinsic and extrinsic input data may also be gleaned from or written into the user data itself during processing. There are no particularly hard and fast rules by which a DOORS 100 may gain its stock of relational data from which to build fact matrices. An expert logical system 381 may both use and record relational data and fact matrices that constitute an aspect of machine learning, which is recorded into and accessed in relational databases. Other databases which may be used in comprehension models are dictionaries 383, including the subsets of similes 384, and synonyms within a thesaurus 385. All of which may be used also by artificial intelligence based on neural networks 390, as training data 391, and to help form, language models 392.

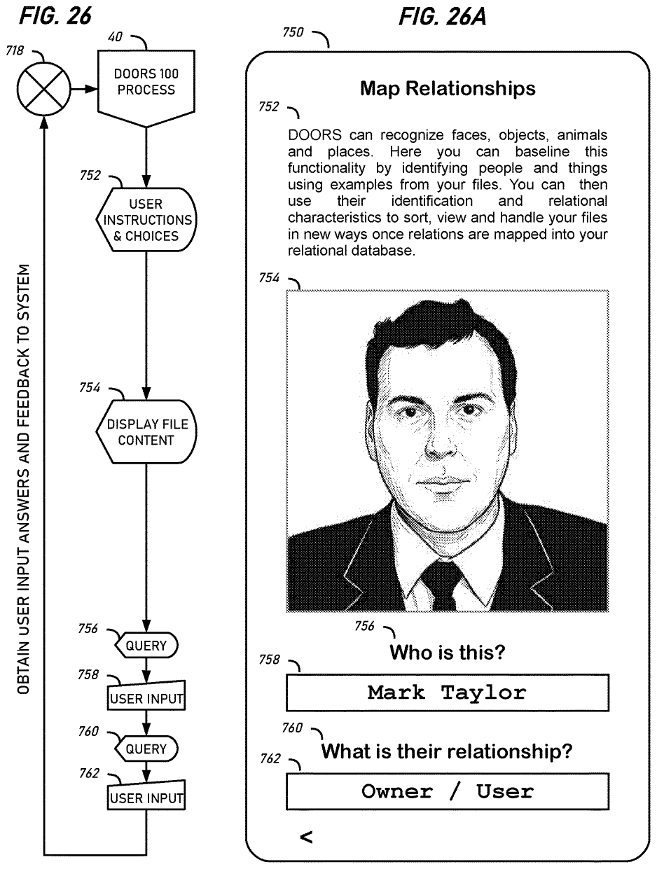

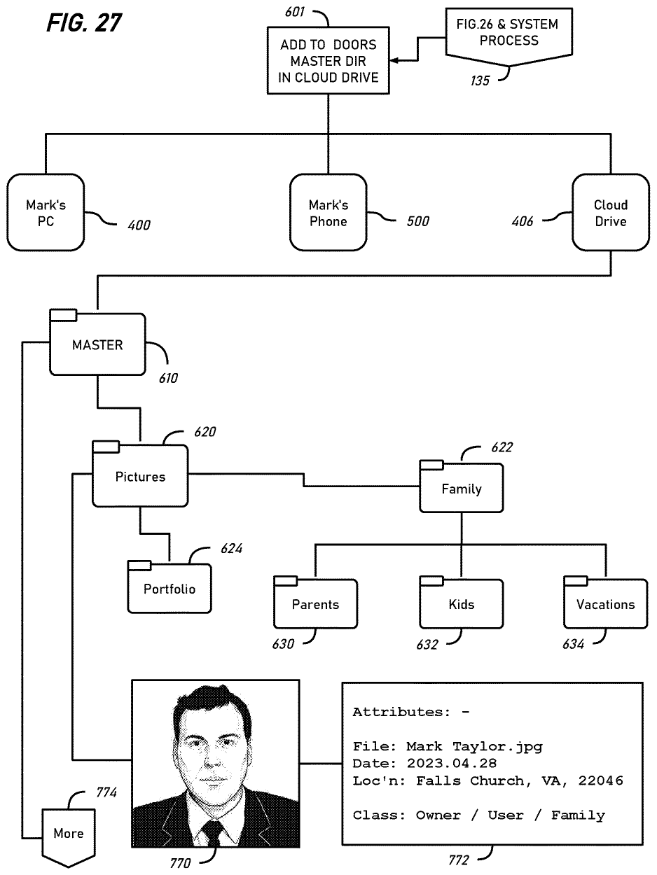

FIG. 14 is an extract from a relational database record for a class known as “family” 395, data objects may relate to persons who are related to the user. Image recognition may assist the DOORS 100 to recognize members of the class “family” from intrinsic data comprised of patterns of pixels, and/or from meta data, or from clues in file names. The DOORS in the interface 750 of FIGS. 26 through 32A, shows an image 754, and asks the user questions such as “who is this” 756, to elicit a user input answer 758, and “what is their relationship” 760, to which user input answers 762 provided in the figures below include the class “daughter” which is a subset of the class family 395. The DOORS 100 relational database may thus obtain this relationship data via various routes which may be derived from either intrinsic data or extrinsic data.

FIG. 15 is an extract from a relational database record for a class known as “friends” 396, data objects may relate to persons who are friends of the user. Image recognition may assist the DOORS 100 to recognize members of the class “friends” from intrinsic data comprised of patterns of pixels, and/or from meta data, or from clues in file names. The DOORS in the interface 750 of FIGS. 26 through 32A, shows an image 754, and asks the user questions such as “who is this” 756, to elicit a user input answer 758, and “what is their relationship” 760, to which user input answers provided in the FIG. 762 include the class “friend” which is a member of the class friends 396.

As shown in FIGS. 14 and 15, the Factual Matrix 71 of the DOORS 100 is implemented and operated primarily as a relational database. Data within the Factual Matrix 71 may be stored as rows of records organized within tables, wherein each table constitutes an array of records and the Factual Matrix may comprise a plurality of such tables constituting an array of arrays, consistent with the “RELATIONAL DATABASE TABLE/ARRAYS OF RECORDS OF FILES” architecture 43 described with reference to FIG. 6. The class-specific tables 395 and 396 of FIGS. 14 and 15 are class-indexed embodiments of this architecture: in each table, every row is a record for a distinct named data entity of that class, and every column is a named attribute field for that data entity. The fields within each record may include, without limitation: a relationship descriptor field recording the class membership and the connection of the data entity to the user; one or more nickname fields recording synonymous or informal identifiers by which the data entity is known; a facts field recording ground truth data points that form that data entity's portion of the factual matrix 71; and a facial recognition data field recording image pattern data for use by the image recognition module 34 in identifying that data entity within the content of image files. Cross-references between records within the Factual Matrix 71 are held as pointers 62 to storage or memory locations, as shown in FIG. 7, enabling the intelligence engine to traverse chains of related records and to retrieve associated files 67, 68, 69 by following pointer chains 62 without scanning the full database. The Factual Matrix 71 may be read out and presented as a human-readable document for user review or audit purposes; however its primary mode of operation is as a pointer-accessed relational database, interrogated and updated by the DOORS 100 intelligence engine at runtime using pointer access and text search of stored records.

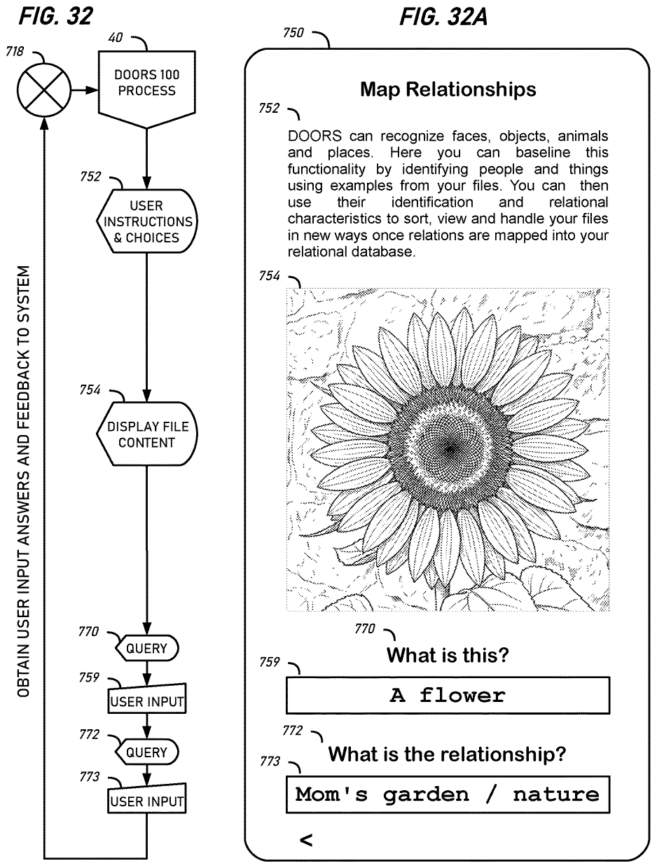

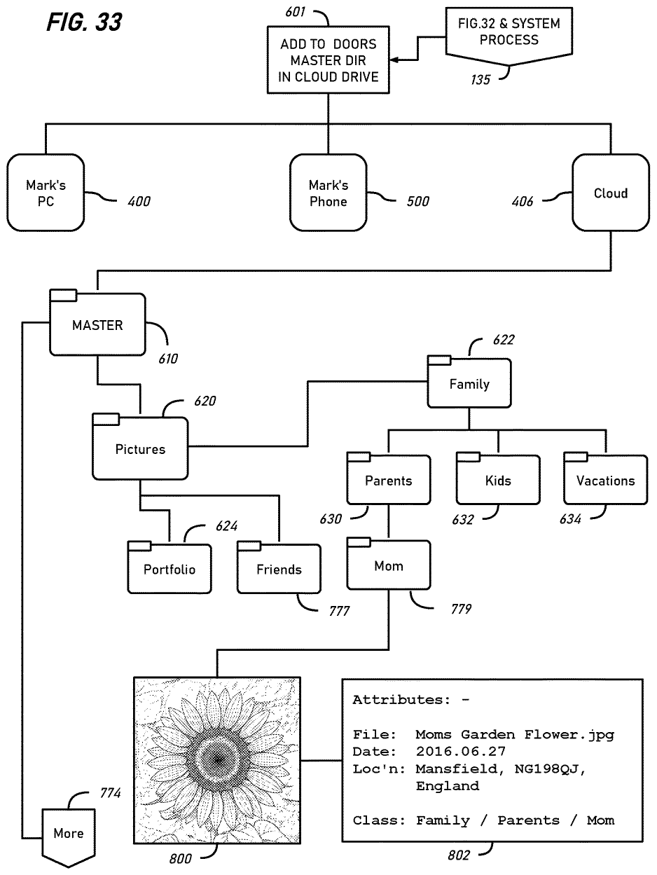

The Factual Matrix 71 is populated from two principal sources. The first source is direct user input: ground truth data points—including the identity, class membership, and relationships of persons, objects, events, and places encountered in the file collection—are entered by the user through the feedback interfaces shown throughout the drawings and recorded into the Factual Matrix via the user feedback loop 718. These interfaces elicit user responses in natural language to queries of the form “who is this?” 756, “what is their relationship?” 760 (FIGS. 26 through 32A), and equivalently “what is this?” 770 (FIG. 32A), recording the responses directly into the class records 395, 396 of the Factual Matrix as named data entities with their attributes. These user-supplied ground truths are recorded immediately upon receipt and are thereafter available for retrieval by text search or pointer access without any inference computation. The second source is the intelligence engine of the DOORS 100: inferences computed by the intelligence engine from the intrinsic and extrinsic attributes of files are written as natural language into the records and structures of the Factual Matrix 71 via the write mechanisms shown in FIGS. 3, 12, 19, 22, 42D, 47, 52, 54, and 58, which are described further herein. Once so written, those inference results are available to future operations of the DOORS 100 by text search of the Factual Matrix or by pointer access, without requiring the intelligence engine to repeat the inference computation that originally produced them. The inference crystallization property that this gives rise to—whereby expensive intelligence engine computation is performed once and thereafter retrieved cheaply as stored text—is described in detail in a dedicated section below.

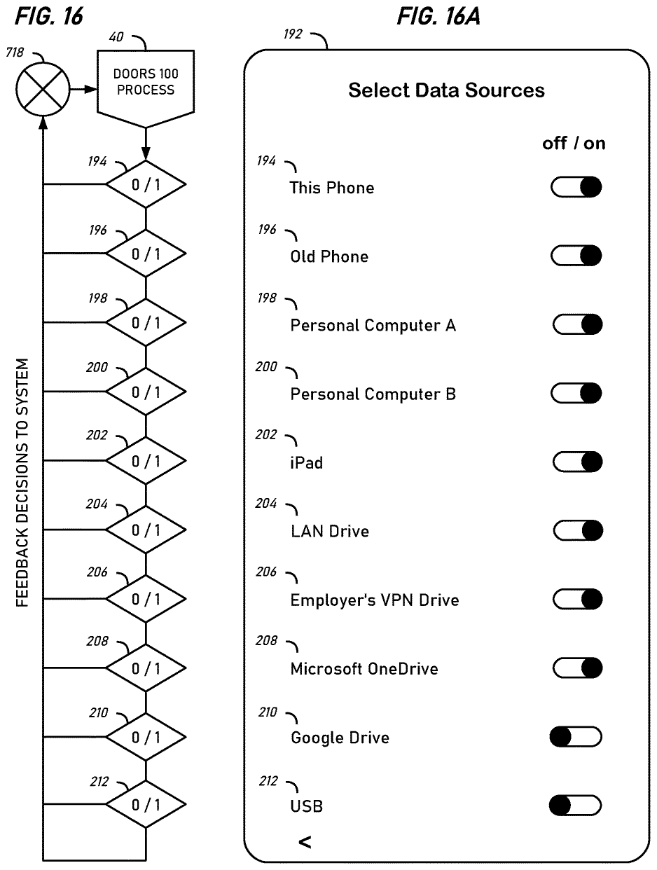

The figures that follow show mobile phone user interfaces 170, 192, 214, 700, 750, which share some common features. When a selection is made or changed, all the devices with a connected status may be accessed by the DOORS to interrogate, modify, create, or update files so that all files have matching content and/or filename (including filenames that are newly generated or suggested by the DOORS). Persons skilled in the art will appreciate that other similar variant embodiments such as ones configured for a personal computer or other devices may be created to perform the same or similar functions without departing from the scope of the subject technology. As is also the case with all the figures being cross-compatible with various other embodiments that it is not necessary and may be unhelpful to clutter this specification up with too many exemplary embodiments. FIG. 16, should be read alongside and across side to side with FIG. 16A Which is one possible embodiment of an interface 192 suitable for the selection of data sources from which a DOORS 100 may build a DOORS Master directory or other user defined repository. It shows a DOORS user interface 192 is a continuing process 40 of a DOORS 100, relating to presentation of options to the user via the view screen user interface 192, in which the user is asked to select data sources via a button slider switch capable to toggle between the “off” to the left and “on” to the right positions. In the system flow diagram these decisions 194, 196, 198, 200, 202, 204, 206, 208, 210, and 212 may be operated by the DOORS according to Boolean logic when zero “0” is returned for a user input selection of “off” and one “1” is returned for a user input selection of “on”, the results of which decisions are returned via a feedback loop 718 and may be passed-on as values to the DOORS 100 according to system parameters.

FIG. 16A shows a DOORS user interface 192, including a menu entitled with the instructive title “Select Data Sources” being displayed on a mobile phone touchscreen. The user interface may include options of which data sources associated with the user's storage device network may be selected are displayed with a current status as being connected, and/or detected. The user interfaces may include toggle or other selectable feature that may switch a selected device from being connected to file storage updates and reconciliation of files in DOORS. In the illustration shown, the device 194 on which the user interface 192 is displayed “This Phone” 194 is set to “on”, meaning that the device 194 is or will be actively running the DOORS 100 application, or connected to a device running the DOORS 100 application and that the storage on “This Phone” will be interrogated and used as a data source.

“Old Phone” 196 is set to “on”, meaning that the storage on the device 196 will be interrogated and used as a data source. “Personal Computer A” 198 is set to “on”, meaning that the storage on the device 198 will be interrogated and used as a data source.

“Personal Computer B” 200 is set to “on”, meaning that the storage on the device 200 will be interrogated and used as a data source.

“iPad” 202 is set to “on”, meaning that the storage on the device 202 will be interrogated and used as a data source.

“LAN Drive” 204 is set to “on”, meaning that the storage on the device 204 will be interrogated and used as a data source.

“Employers VPN Drive” 206 is set to “on”, meaning that the storage resource 206 will be interrogated and used as a data source.

“Microsoft OneDrive” 208 is set to “on”, meaning that the storage resource 208 will be interrogated and used as a data source.

“Google Drive” 210 is set to “off”, meaning that the storage resource 210 will not be interrogated or used as a data source.

“USB” 212 is set to off, meaning that the storage resource 212 will not be interrogated or used as a data source.

There may be a “<” back button to exit the screen interface once these selections are completed.

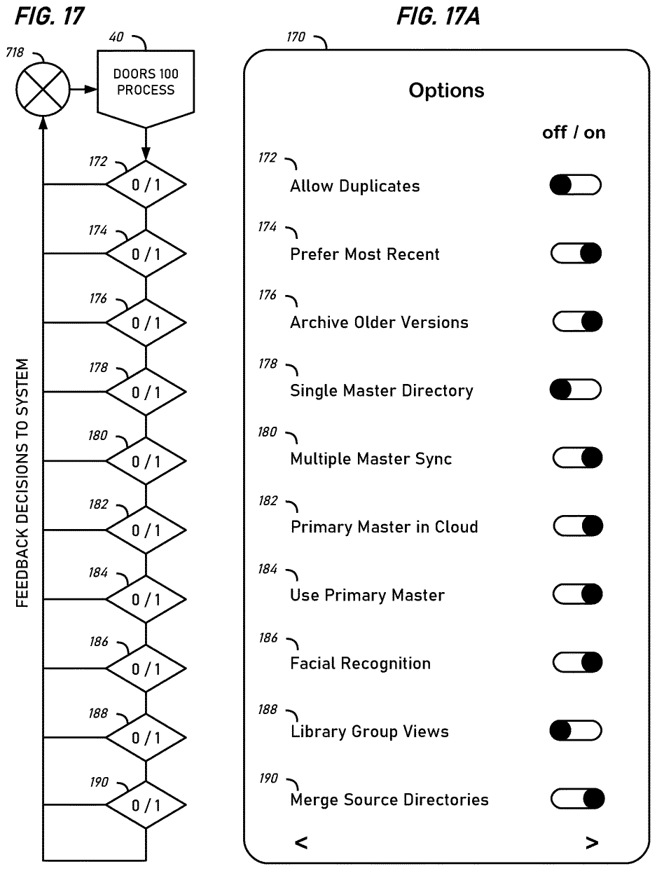

FIG. 17 should be read alongside and across side to side with FIG. 17A which shows a DOORS user interface 170 is a continuing process 40 of a DOORS 100, relating to presentation of options to the user via the view screen user interface 170, in which the user is offered various options via a button slider switch capable to toggle between the “off” to the left and “on” to the right positions. In the system flow diagram these decisions 172, 174, 176, 178, 180, 182, 184, 186, 188, and 190 may be operated by the DOORS according to Boolean logic when zero “0” is returned for a user input selection of “off” and one “1” is returned for a user input selection of “on”, the results of which decisions are returned via a feedback loop 718 and may be passed-on as values to the DOORS 100 according to system parameters.

FIG. 17A shows another user interface 170 informatively titled “Options” operating on a mobile phone through its touch-screen display, that also employs “off” and “on” sliding (or toggle) switches on menu items. The options settings may include “Allow Duplicates” 172 that is set to “off”, meaning that duplicate copies of files may not be reproduced, so that only one copy of any identical file that may be found within the source datasets may be created into a master copy of the datasets that are being merged and/or reconciled.

“Prefer Most Recent” 174 that is set to “on”, meaning that if different versions of a file are found in the source datasets only the most recent version of such files will be reproduced into the master copy of the datasets that are being merged and/or reconciled.

“Archive Older Versions” 176 that is set to “on”, meaning that the DOORS will archive older versions of any file that may be reproduced into the master copy of the datasets being merged and/or reconciled.

“Single Master Directory” 178 that is set to “off”, meaning that multiple copies of the master directory and its contents may be created into selected locations.

“Multiple Master Synch” 180 that is set to “on”, meaning that the DOORS may monitor multiple master directory contents and synchronize any changes across the affected master directories. This may be a useful way of ensuring that data is constantly being backed up into duplicates of the master. For busy IT staff in the corporate world, this may be used to reduce the workload on staff time in the creation of backups.

“Primary Master in Cloud” 182 that is set to “on”, meaning that when a master directory is created it may be set as “primary”, meaning that it may be used to control synchronized duplicates or backups of itself, and that a master directory will be created into a cloud storage resource.

“Use Primary Master” 184 that is set to “on”, meaning that when the user is working with files through a DOORS, on a device where the DOORS application is running then the user will be using (retrieving, working on, and saving back to storage in the primary master with any changes) the files stored within the primary master.

“Facial Recognition” 186 that is set to “on”, meaning that when images are being interrogated for their intrinsic attributes that the DOORS 100 may call and run an image processing module capable to search within the contents of the image for data patterns that may be comprised of faces, and also to compare any potential faces found with facial recognition pattern data for persons who are contained in images that DOORS has processed previously; then to lookup any matches to interrogate and return any relational data. Such as an image found (for example facial recognition may be used to determine where best to place into storage an image file 780 of FIG. 29 or another one which contains a match for the facial recognition data of Holly Taylor, who has the attributes associated with her factual matrix that she is a member of the classes “family”, “kids”, and “daughter” 782; so that the DOORS may place the matched image into the directory “Kids” 632, which is a sub-directory of the master 610, which is stored in the cloud drive 406.)

“Library Group Views” 188 that is set to “off”, meaning that views of files grouped by relationships that may be inferred from file attributes as the DOORS may produce to display related files in interesting new ways in not be enabled, so that files will be presented within the actual directories where they are placed by the DOORS. An example is provided in FIG. 10 and FIG. 11 of displays 79, and 81, both showing in differing view files that the DOORS has found to be related that are linked 78R to a particular project proposal (“PROJECT X PROPOSAL”) even though residing in disparate locations. The user might be advised to set this option to provide “Library Group Views” 188 to “on”, as he or she is missing out on this great feature on the current selections made.

“Merge Source Directories” 190 that is set to “on”, meaning that where possible which is where two directories are the same or similar they will be merged and reconciled, rather than being reconciled to other parameters such as removing duplicates. An example of which may be the merging of two directories with names that are not identical but which the DOORS inference engine, and/or artificial intelligence engine may identify as synonyms or similes “my kids”, “children” and “the kids” and merge them into one directory.

There may also be forward “>” and backward “<” menu buttons capable to help users move between screen views in the interface. In addition, the features and settings above may present process steps invoked by a computer processor and/or a host platform server administering the services provided by the DOORS 100.

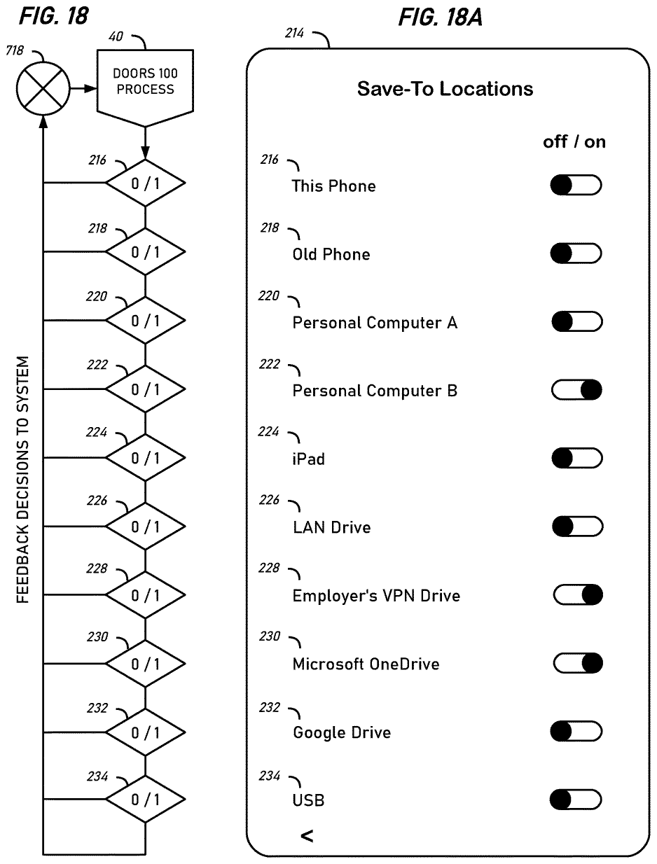

FIG. 18 should be read alongside and across side to side with FIG. 18A which shows a DOORS user interface 214 is a continuing process 40 of a DOORS 100, relating to presentation of locations as “save to locations” to the user via the view screen user interface 214, in which the user is offered various options via a button slider switch capable to toggle between the “off” to the left and “on” to the right positions. In the system flow diagram these decisions 216, 218, 220, 222, 224, 226, 228, 230, 232, and 234 may be operated by the DOORS according to Boolean logic when zero “0” is returned for a user input selection of “off” and one “1” is returned for a user input selection of “on”, the results of which decisions are returned via a feedback loop 718 and may be passed-on as values to the DOORS 100 according to system parameters.

FIG. 18A is a user interface 214 informatively titled “Save-To Locations” 214 operating on a mobile phone through its touch-screen display, that also employs “off” and “on” sliding switches on menu items to determine where to save the DOORS Master copy file to: “This Phone” 216 that is set to “off”, meaning that a master copy directory and contents will not be saved to the phone on which it appears to be running.

“Old Phone” 218 that is set to “off”, meaning that a master copy directory and contents will not be saved to the device known as “Old Phone”.

“Personal Computer A” 220 that is set to “off”, meaning a master copy directory and contents will not be saved to the device known as “Personal Computer A”.

“Personal Computer B” 222 that is set to “on”, meaning that a master copy directory and contents will be saved to the device known as “Personal Computer B”.

“iPad” 224 that is set to “off”, meaning that a master copy directory and contents will not be saved to the device known as “iPad”.

“LAN Drive” 226 that is set to “off”, meaning that a master copy directory and contents will not be saved to the device known as “LAN Drive”.

“Employers VPN Drive” 228 that is set to “on”, meaning that a master copy directory and contents will be saved to the device known as “Employers VPN Drive”.

“Microsoft OneDrive” 230 that is set to “on”, meaning that that a master copy directory and contents will be saved to the storage resource known as “Microsoft OneDrive”.

“Google Drive” 232 that is set to “off”, meaning that a master copy directory and contents will not be saved to the storage resource known as “Google Drive”.

“USB” 234 that is set to “off”, meaning that a master copy directory and contents will not be saved to the device known as “USB”.

There is also “<” back button to exit this screen of the interface once these selections are completed.

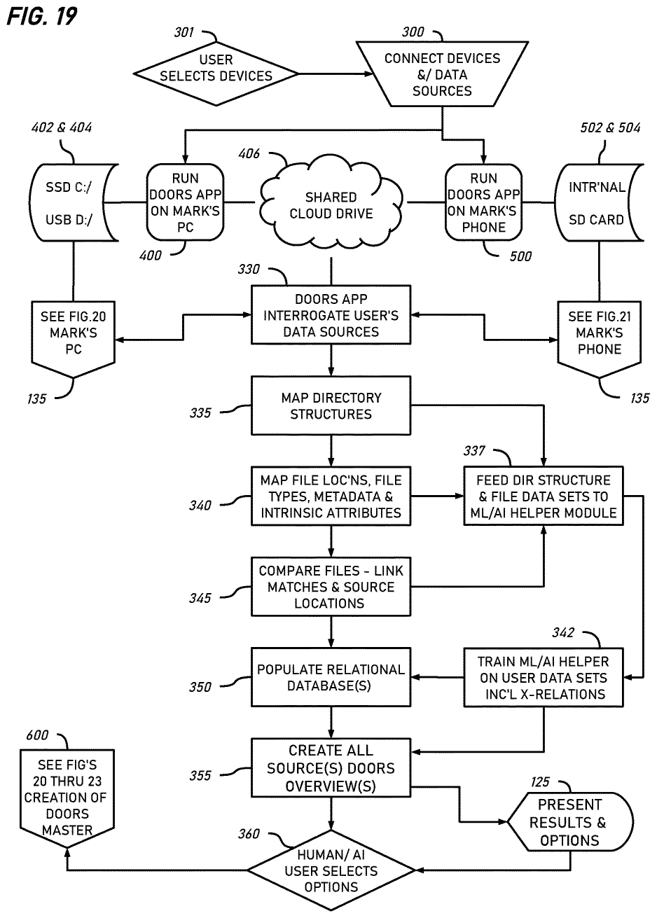

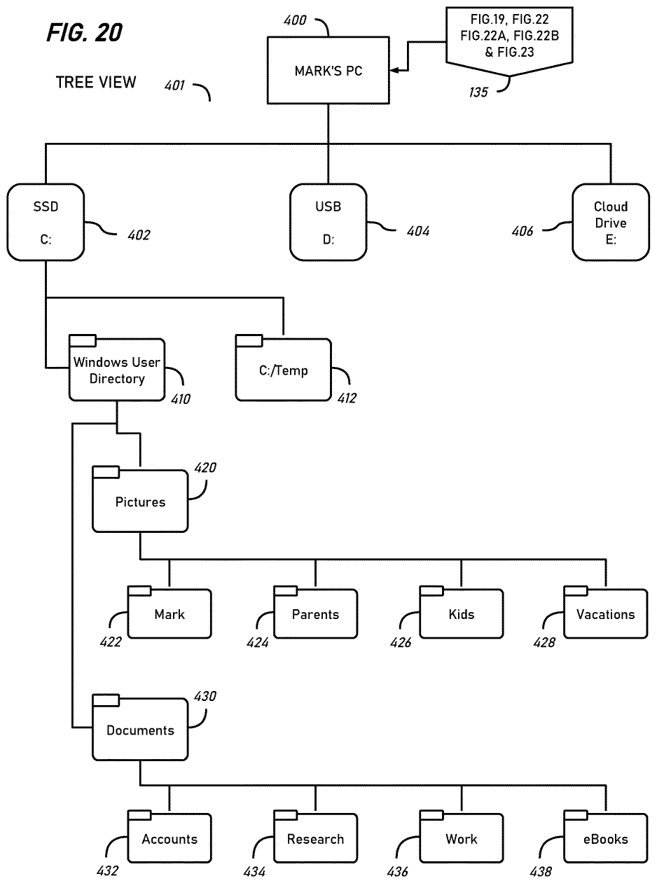

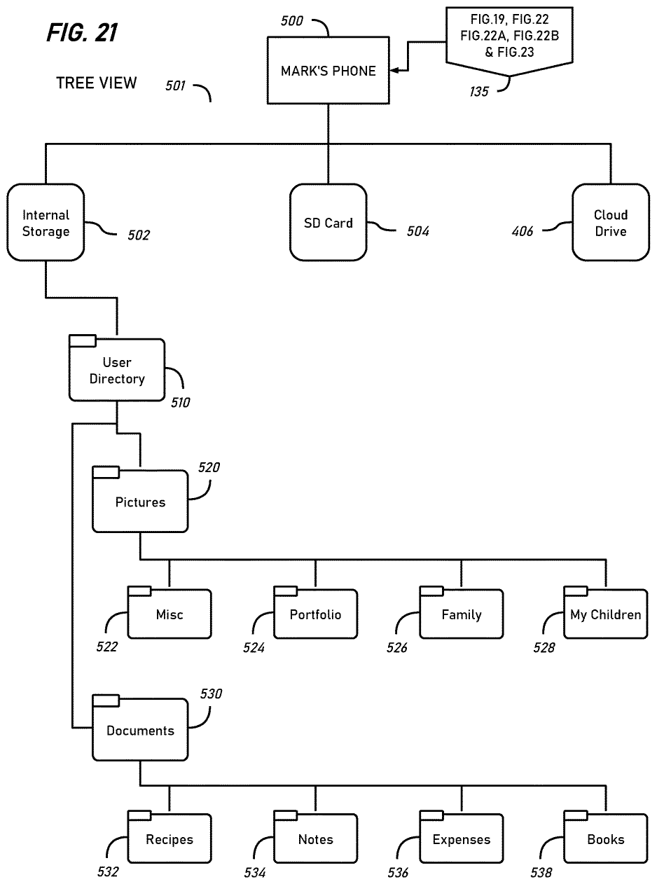

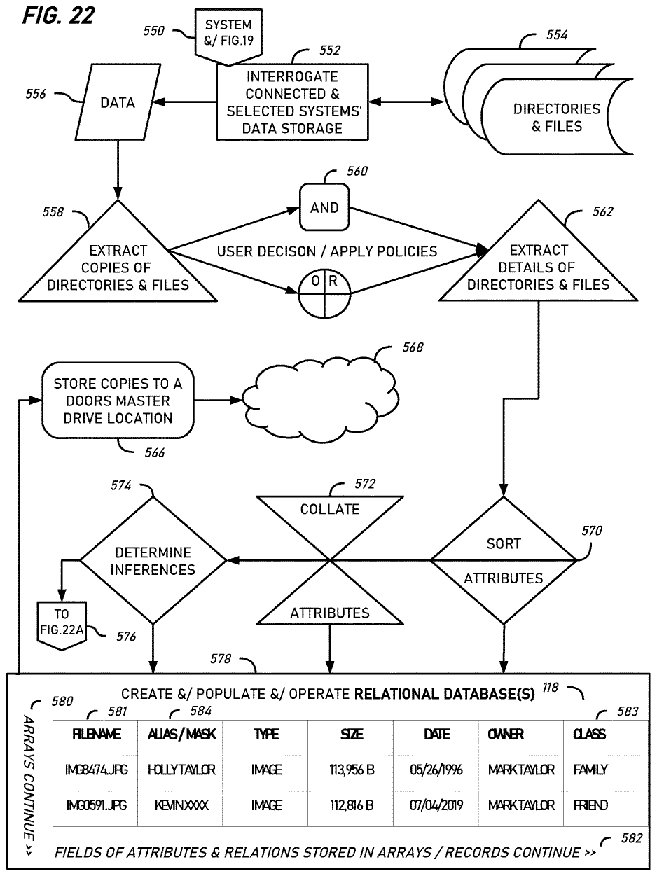

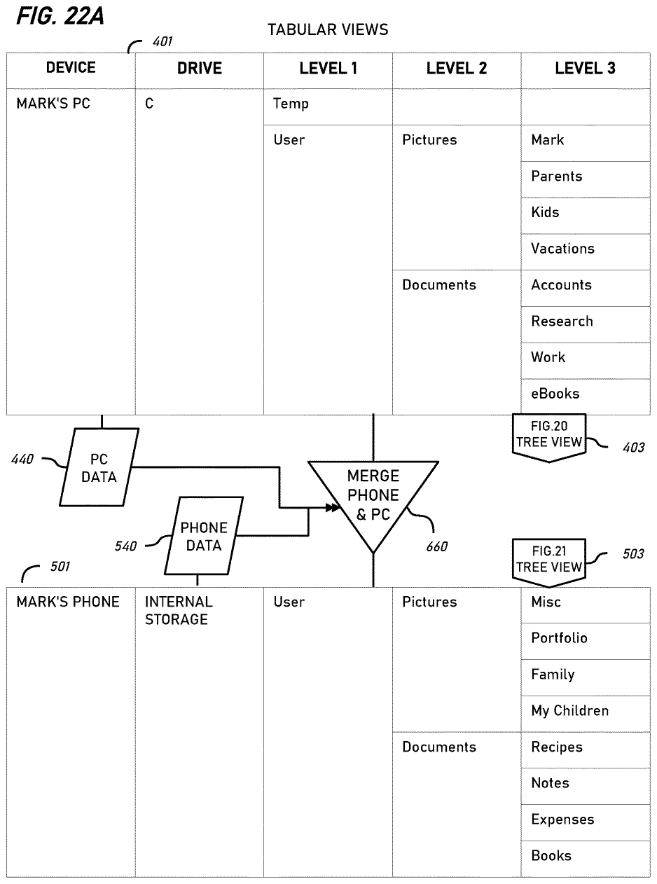

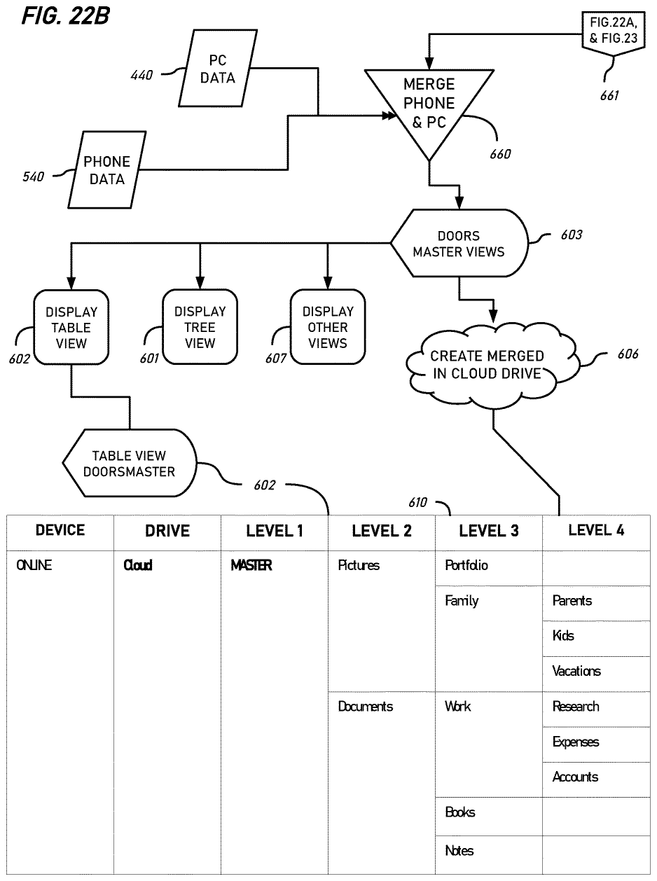

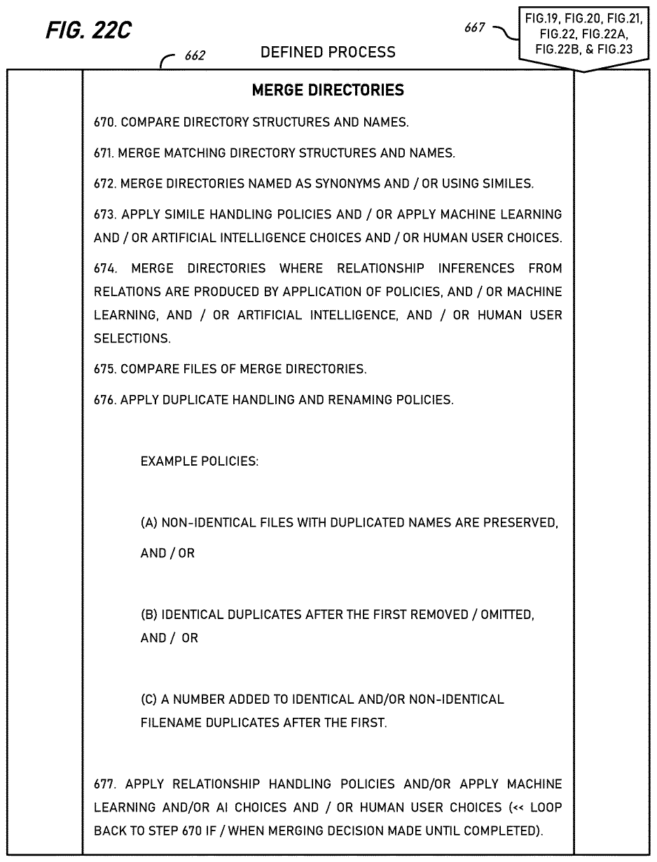

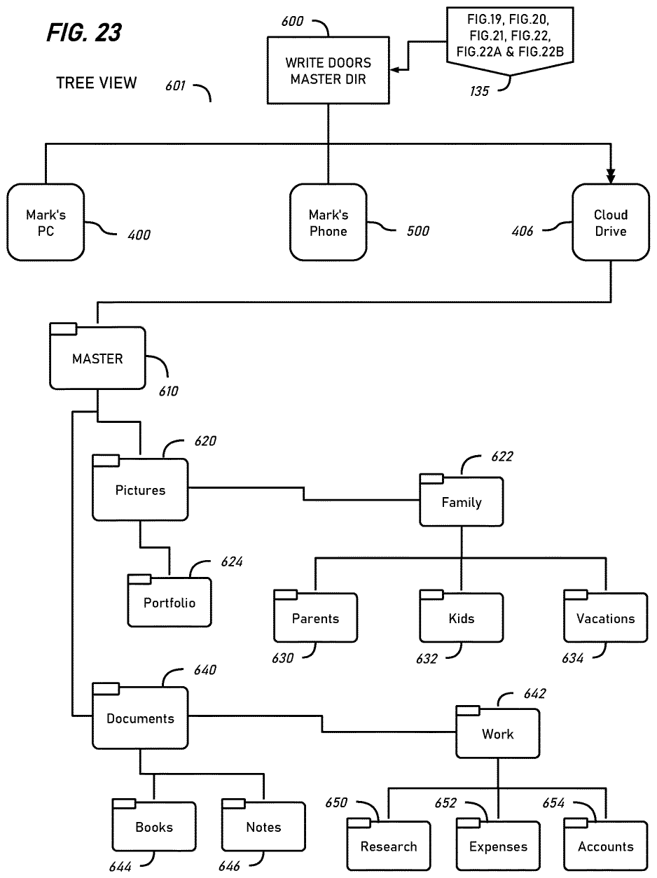

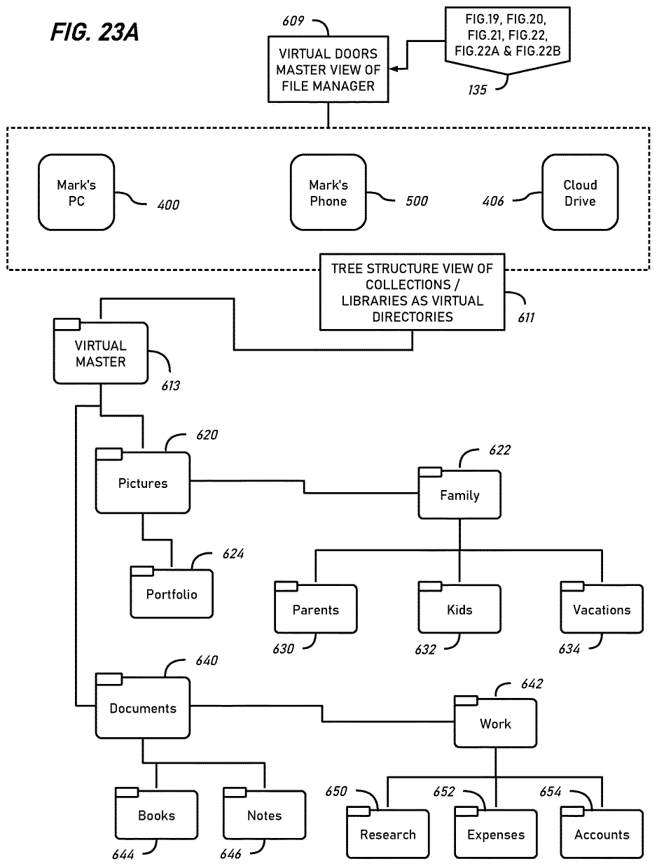

FIG. 19 is similar to FIG. 12 and similarly shows a method of copying and reconciling files between different devices using a DOORS according to a specific embodiment. In a DOORS 100, the user selects devices 301 and connects those devices and/or data sources 300. Which may then run the DOORS application on either: (a) Mark's PC 400, which has a solid-state drive (SSD) drive C:/ 402, and a universal serial bus (USB) drive D:/ 404, or (b) run the DOORS application on Mark's phone 500, which has an internal storage 502, and an SD card 504 (secure digital card, is a proprietary non-volatile, flash memory card format, licensed by SD-3C LLC). Both Mark's PC 400, and Mark's Phone 500 link off page 135 to the system aspects shown in FIG. 20, and FIG. 21 respectively.

The DOORS 100 interrogates 330 the user's data sources, then proceeds to map 335 directory structures, and maps 340 files located in those directory structures, including file types and meta-data and intrinsic attributes. Files and source structure locations comprising directories, directory trees, and the names of their branches may be compared and matches, or partial matches of directory structures, names, and file data sets obtained 345, all of which data sets may then also be fed 337 to an artificial intelligence or machine learning helper module. Which helper module of the DOORS may then use to train itself on these user data sets 342; that may include the intrinsic data from within actual files. Such as details of human faces and physical places that may be subsequently used in facial recognition for people, and spatial or object recognition for geo-location. Other intrinsic aspects of intrinsic file data may be used to assist in the recognition of other objects such as cars, balls, bats, buildings, and animals such as the family pet or zoo animals. Then both the logic-based data, and the artificial intelligence training and learning events which may be gained while operating the DOORS 100, including the cross-relations and classifications of data objects may be used to populate 350 the relational database, and aided thereby the DOORS may create 355 overviews of data from all available and interrogated sources. The results of which and further options may then be presented 125 to a user. From which a human user or artificial intelligence or human assisted by artificial intelligence may select options 360.

When run for the first time a DOORS 100 may begin from a baseline. Having been initially installed as pre-trained using generic and widely accepted data handling and naming conventions, norms and rules. Over time the baseline out of the box versions of the DOORS application software may improve in the detail and sophistication that is achievable from the first installation. Learning may be copied from one iteration and then built upon by the DOORS in ways that the user should find are intuitive because the DOORS has learned the user's preferences. So that over time users will recognize directory structures and naming conventions as being in their own style and may not be able to determine whether they or DOORS created a specific directory structure or file name. Which may make accessing user data more intuitive and efficient for users.

Other features such as the ability to impose libraries that present file locations, and files in various views based on other relationships or attributes may further leverage the power of the relational database at the heart of the DOORS 100. All of which should make it much easier to find files, to use them and not lose them over time and across a lifetime's worth of devices, porting data across a wide variety of storage locations and platforms. Including some technologies that probably don't even exist yet. This sequence of steps in this aspect of a DOORS 100 embodiment may continue within a larger system or process, please see FIG. 20, FIG. 21, FIG. 22, FIG. 22A, FIG. 22B, FIG. 22C, on through FIG. 23 inclusive for details of the creation of a DOORS master, which continues the method and which is applied in this example of its processing. In later figures all the way through to FIG. 33 examples are also provided of the user adding files, via interfaces, and of relationship mapping as may be used to place them appropriately and intuitively into the DOORS master directory from a mobile phone interface and assisted by the DOORS 100. Though not shown similar equivalent interfaces as between those shown for display screens of phones, computers, and other devices may be used on compatible devices or systems on which a DOORS 100 may run.

FIG. 20 shows a tree view 401 of an aspect of a DOORS operating within a continuing system or process which connects off page with FIG. 19, FIG. 22, FIG. 22A, FIG. 22B, and FIG. 23, 135. In actual disc operating system DOS interfaces as used on IBM® PCs and IBM clone devices spaces are not allowed. The naming conventions and nomenclature of Microsoft's® pseudo-DOS as used in their Windows® operating system (OS) graphical user interface (GUI), which is similar to that used for IBM PCs and IBM clone PCs may be used where it is helpful in describing disc drives and directory structures. The “/” symbol in this context indicates the division between a directory and an object within a directory, objects may be sub-directories or files. Spaces have been left in this description for reasons of clarity and compatibility with the graphical user interface (GUI) based examples in the drawings in which directories are indicated by folder icons.

The device upon which the DOORS is operating is Mark's PC 400, the alternative data sources and storage locations attached are the local HDD which is in fact an SSD with the DOS label “C:” 402, USB drive with DOS label “D:” 404, and Cloud drive with DOS label “E:” 406. In this view the directory structures and files of drives D; and E: are not shown or may be assumed to be empty for present purposes. But the directory structure of drive C: 402 is shown down to three levels.

The directory structure of drive C: 402 at level one, has two nested directories comprised of C:/Windows User Directory 410, and C:/Temp 412 further details of which are not shown. On the next level down into the directory structure within there is shown C:/Windows User Directory/Pictures 420, and C:/Windows User Directory/Documents 430. Both of which directories contain the nested directories C:/Windows User Directory/Pictures/Mark 422, C:/Windows User Directory/Pictures/Parents 424, C:/Windows User Directory/Pictures/Kids 426, and C:/Windows User Directory/Pictures/Vacations 428, plus C:/Windows User Directory/Documents/Accounts 432, C:/Windows User Directory/Documents/Research 434, C:/Windows User Directory/Documents/Work 436, and C:/Windows User Directory/Documents/eBooks 438. Comprising the directory structures on drive C: down to three levels as having been scanned and discovered or created by a DOORS 100.

FIG. 21 shows a tree view 501 with a block and flow-link off page connector 135 to FIG. 19, FIG. 20, FIG. 22A, FIG. 22B, and FIG. 23 of a continuing DOORS 100 embodiment or process that may be running upon or operating locally on or remotely upon the data storage within and/or connected to Mark's Phone 500. Here we see only one part of the wider DOORS.

The drives that may be present include, for example, the phone's Internal Storage 502, SD Card 504, and Cloud Drive 406. In this view the directory structures and files of SD Card 502, and Cloud drive 504 are not shown, and/or they may be assumed to be empty. But the directory structure of Internal Storage: 502 is shown down to three levels. The first level has one directory Internal Storage/User Directory 510, which at the next second level has two directories Internal Storage/User Directory/Pictures 520, and Internal Storage/User Directory/Documents 530. At the third level there are the directories Internal Storage/User Directory/Pictures/Misc 522, Internal Storage/User Directory/Pictures/Portfolio 524, Internal Storage/User Directory/Pictures/Family 526, and Internal Storage/User Directory/Pictures/My Children 528 plus Internal Storage/User Directory/Documents/Recipes 532, Internal Storage/User Directory/Documents/Notes 534, Internal Storage/User Directory/Documents/Expenses 536, and Internal Storage/User Directory/Documents/Books 538. Which may be a picture of the directory structures in Mark's Phone Internal Storage down to three levels as either scanned and discovered or created by a DOORS 100.

(In the next similar tree view FIG. 23 a DOORS 100 may be running concurrently across Mark's PC 400 and Mark's Phone 500 so that directories, directory structures, and files are being aggregated, reconciled, and merged by the DOORS 100 to create a DOORS Master directory 600 into a Cloud Drive 406.)

FIG. 22 shows an off-page connection to the wider system, and/or specifically to FIG. 19, system 550. The DOORS interrogates connected and selected systems' data storage 552, reading into data and files within the storage 554, the data 556 is retrieved and processed to extract copies of directories and files 558, the user which may be human and/or an artificial intelligence engine makes the decision(s) 560 to apply policies, and whether to also extract details of directories and files 562, then to sort data object attributes 570, to collate attributes 572, and determine inferences 574 (with an off page link to the process continuation is FIG. 22A, 576). Then taking those categorized data points creates 578 and/or populates and/or operates relational database(s) 118 to record data and data points of the factual matrices such as a class 583, such as “family” having been found and including inferred relationships. The file records may be in the form of arrays 580, which arrays of records may be infinitely extendable (and not finite or limited to a specific number) to suit the number of records needed scaling to the size of the datasets from which they are derived. Similarly, these records may have nested within them more arrays of fields 582 the number of which arrays of field may be infinitely extendable (and not finite or limited to a specific number) to permit further scaling to suit the numbers of attributes found or inferred for each file which is recorded into its record within the array of records 580 of the relational database 118. Files may be recorded by their filenames 581, and the DOORS may also create for them an alias or mask name 584 based on the application of policies, and/or by intelligent generation via a machine learning and/or artificial intelligence module 46, as shown in FIG. 3. The use of an alias or mask name 584 may permit files to be handled by the DOORS, users may choose to replace the actual filename with a well-designed alias or mask name for easier more intuitive and inference engine friendly processing of files by the DOORS as well as user. Indeed, the original filename 581 may be swapped with the alias or mask name. So that a records of previous names for the same file can be preserved to permit greater utility and traceability of files. Which may be really useful in some cases, perhaps in law enforcement, project management, and perhaps safety critical applications where audit trails of historical data may be helpful.

FIG. 22A provides tabular views of the same structures of directories, and the with the same names as shown in tree and/or GUI views 401 in FIG. 20, and 501 in FIG. 21 as indicated by the off-page connectors 403, and 503. These tabular views provide a different view of those data structures. Which is compatible with the nomenclature and use of relational databases 118 displayed in rows and columns in tabular form, which may be more compatible with comprehension as components of relational database processes. To merge 660, data 540 from Mark's Phone, with data 440 from Mark's PC. Which process continues in more detail in the next figure.

FIG. 22B provides a tabular view of the same structures of directories, and the with the same names as shown in tree and/or GUI view 601 in FIG. 23 as indicated by the off-page connector 661. The tabular view provides a different view of those data structures, which is compatible with the nomenclature and use of relational databases 118 displayed in rows and columns in tabular form. Which may be more compatible with comprehension as components of relational database processes. In this case the process steps are merge 660, PC data 440, with Phone data 540, which may be displayed in any of the alternate DOORS master views 603 which may be to display table view 602, or display a tree view 601, or other alternate views 607 which could be GUI views for example. Which process continues, for merging directories and files into a new DOORS master, shown in tabular form here 602, to create the merged DOORS master directory 610, that is merged and reconciled and then written 600 into a cloud drive 406. (In FIG. 23 below the same merged DOORS master and the decision made in reconciliation is shown in what may be a more readily accessible intuitive GUI and tree format view 601 which is functionally representing the same directory structures as this figure provides in tabular form 602.)

FIG. 22C begins with off-page connections to FIG. 19, FIG. 20, FIG. 21, FIG. 22, FIG. 22A, FIG. 22B, and FIG. 23; and continues with a defined process of a method for operating a DOORS 100. Comprising the following process steps to merge directories:

```
670. Compare directory structures and names.
671. Merge matching directory structures and names.
672. Merge directories named as synonyms and / or using similes.
673. Apply simile handling policies and / or apply machine learning and / or artificial
intelligence choices and / or human user choices.
674. Merge directories where relationship inferences from relations are produced by
application of policies, and / or machine learning, and / or artificial intelligence, and / or
human user selections.
675. Compare files of merge directories.
676. Apply duplicate handling and renaming policies.
  Example policies:
  (a) non-identical files with duplicated names are preserved,
  and /or
  (b) identical duplicates after the first removed / omitted, and / or
  (c) a number added to identical and / or non-identical filename
  duplicates after the first.
677. Apply relationship handling policies and / or apply machine learning and / or AI
choices and / or human user choices (<< loop back to step 670 if/when merging decision
made until completed).
```

In step 670 of the defined process of FIG. 22C, the DOORS 100 compares the directory structures 662 and directory names 667 of all source directories across all connected and interrogated data sources. In step 671, directory structures and names that are determined to be matching are merged into unified structures within the emerging DOORS Master directory 610. In step 672, directories whose names, while not identical, are determined by the intelligence engine to be synonyms or to share a simile relationship with one another are merged into unified structures; examples of which include the merging of directories named “Kids” 426 (FIG. 20) and “My Children” 528 (FIG. 21) into a unified “Kids” sub-directory 632 (FIG. 23) by reference to the thesaurus synonym groupings and simile relationships recorded within the relational database 118. In step 673, the intelligence engine applies simile-handling policies and/or machine learning and/or artificial intelligence-derived choices and/or human user choices, to resolve cases where a simile rather than a strict synonym relationship is inferred between directory names that are candidates for merging. In step 674, the DOORS 100 merges directories where the relationship between their contents is inferred by the intelligence engine from the relational attributes of the files held within those directories and from the factual matrix records 71 within the relational database 118, even where no direct name-based synonym or simile match exists between the directory names themselves. In step 675, the files within the now-merged directories are compared to identify identical duplicates and files whose names are matching but whose content is not identical. In step 676, one or more of the following duplicate handling and renaming policies is applied: policy (a)—non-identical files sharing a name are preserved as separate entries within the merged collection; policy (b)—identical duplicates after the first occurrence are removed or omitted from the merged collection; or policy (c)—a distinguishing numerical suffix is appended to duplicate filenames after the first occurrence within the merged collection. In step 677, relationship handling policies and/or machine learning and/or artificial intelligence choices and/or human user choices are applied to each merged directory, and the defined process loops back to step 670 if and when further merging decisions remain outstanding, continuing until all directories across all connected and interrogated sources have been processed. The completed merge process produces the unified DOORS Master directory 610 organized according to the determined relationships, which may be written to the relational database 118 as a virtual master, and/or created as a physical directory structure within the selected target storage location, and/or supplied as structured input to a further data processing application.

FIG. 23 should be read and considered along with the similar FIG. 23A. These show key aspects of a likely screen presentation of directory structures within a user interface, wherein the creation of a DOORS Master directory 600 into a Cloud Drive 406 has been or is being executed. By a DOORS 100 running in the local device or on a connected device 135 with access to all three of the alternative source devices and/or locations of resources shown; comprised of Mark's PC 400, Mark's Phone 500, and Cloud Drive 406.

The directories from Mark's PC 400 as shown in FIG. 20, and Mark's Phone 500 as shown in FIG. 10 are being processed by the DOORS 100 application, to create a new DOORS Master directory in the Cloud Drive 406. The DOORS 100 analyzes the two source directories seeking to discover the contents and relationships between the contents and purposes of the data sets that are to be organized, optimized, and reconciled into one master data set, that includes both source data sets, and which is designed to follow the reasoning, storage, naming, and other patterns of the source directories. To understand this process FIG. 19, FIG. 20, FIG. 21, FIG. 22, FIG. 22A and FIG. 22B are considered together, as the DOORS works its way through the process of creating a DOORS Master to build the merged master directory structure and placement of files within its hierarchical structures.

The logic, nesting, names and groupings of which encode meaning and learning. So that those structures become part of the branching logic of the intuitive expert system. Which structures may first be designed by the DOORS intelligence engine and written to a relational database 118. Which may be presented to the user visually 603 before the command to execute the physical creation of the DOORS Master directory 610 or used to support a similar virtualized process 609 (FIG. 23A) in which the DOORS master is virtualized 613 by operations using the relational database to represent the collections of files as appearing in virtual directories 611 as may be preferred in a different installation model and/or trial version of the DOORS. Which modes of operation and models may be licensed to users according to a diversity of revenue models and use cases. From trial users through to enterprise tier super-users whose processing needs may vary with the needs of the user in each case.

The DOORS navigates or crawls through and interrogates the structures of names and groupings of root and branch directories of attached source devices. In the root directory of Mark's PC 400, of the SSD 402 there are found the C:/Windows User Directory 410 and C:/Temp 412, the latter of which is found to be empty and is thus ignored. The root directory of Mark's Phone 500, Internal Storage 502 is then similarly interrogated, and only the Internal Storage/User Directory 510 is found. So, the DOORS compares these two source directories. The two directories may be merged to create in the Cloud Drive 406 the DOORS Master directory Cloud Drive/DOORS MASTER 610 at the first level. Into which all the source files and any sub-directories may subject to user choices and/or DOORS's pre-set policies be duplicated, or moved, or represented virtually with a placeholder that may contain a link to a file location.

Subject to whichever use case is operating at the second level, the DOORS 100 creates the new directories Cloud Drive/MASTER/Pictures 620, by merging the Pictures 420 directory from Mark's PC 400, and the Pictures 520 directory from Mark's Phone 500. As an example, DOORS 100 was able to detect that these directory names are a direct and total match, furthermore that their contents are mainly or exclusively comprised of file formats that are used for images and have file extensions of known image data file types such as “.JPG”, and “.PNG”, plus there is intrinsic recognizable image data, and meta-data in the files they contain.

The new directory Cloud Drive/MASTER/Documents 640, is created by merging the Documents 430 directory from Mark's PC 400, and the Documents 530 directory from Mark's Phone 500. In this case the DOORS 100 was again able to detect that these directory names are a direct and total match, furthermore that their contents are mainly or exclusively comprised of file formats that are used for various documents such as text-based word-processed files with extensions such as “.DOCX”, “.RTF”, “.TXT”, spreadsheet files such as “.XLS”, and portable document files “.PDF”. So far so good, the DOORS is merging these folders logically and sensibly just as a user would by operating the process or applying the method in person.

However, it is at the next level of directories that directories are encountered in one source location on one device that have no direct match on the other device and vice versa. This increases the difficulty level of the decisions that the DOORS 100 has to make to effectively design a truly new intuitive data structure—with no direct equivalent in any of the source drives of the connected devices. This is where the DOORS 100 has to get smart, and where it can take not only the tedium out of looking after and managing user's precious data, but also at this level DOORS 100 may be used to free the user of the mental work needed to make and implement those choices.

In the current example the DOORS artificial intelligence helper module has detected that in Mark's PC 400 the Pictures directory 400 there are sub-directories named “Mark” 422, “Parents” 424, “Kids” 426, and “Vacations” 428, and found filenames such as “mom 2016.jpg” and inferred that this is probably a photograph of the user's mother. “DadsBirthday2000.jpg” and inferred this is probably a photograph of the user's father. In the Pictures directory 520 of Mark's Phone 500 there are sub-directories “Misc” 522, “Portfolio” 524, “Family” 526, and “My Children” 528.

The DOORS 100 has also detected that the “Misc” 522 directory is empty and hence decides to record its presence, but not to bother reproducing it into the Master. The directory “Portfolio” 524 contains images of paintings, some of which have been signed with the name “B. A. Taylor” and DOORS 100 knows from its previous interactions with user data and with the user that B. A. Taylor is Barbara Ann Taylor, who is the user's mother, also known as “mum” or “mom”, and that she is a member of the class “Family”. Which data and relationships are already recorded in the relational database 118. The DOORS processing of the data of the source directories continues to work its way through them to notice that “Family” 526 is also a directory within Mark's Phone. Reading further along the next directory “My Children” 528 is a name that is a simile or contextual synonym of the “Kids” 426 directory name, and the file names found in both directories are pictures of Mark's children. At this point the DOORS is able to decide to create within the DOORS Master 610, the “Pictures” 620 directory, with the sub-directories “Portfolio” 624 and “Family” 622 which are reproduced there as is. Then to nest within the “Family” directory the sub-directories “Parents” 630, and “Kids” 632 which is comprised of the merged contents of the “Kids” 426, and “My Children” 528 directories. Finally, inside the new “Pictures” 620 directory the DOORS artificial intelligence helper module having noticed and connected the relationships that the “Vacations” 428 directory from Mark's PC contains mainly photographs also of identifiable “Family” class members in vacation locations. For this reason, the DOORS is able to infer that this directory would probably be intuitively easy to find if it were kept with the others that include a “Family” member, and so the new “Vacations” 634 directory is created also as a sub-directory within the “Family” 622 directory. Whereas the contents of the “Mark” directory 422 are reproduced to the root directory of “Pictures” 620 because the DOORS has noticed that there are already other images of the user Mark in the root directory, and this seems to be his preferred or default place to store the majority of the pictures of himself on his phone.

When trying to understand how the DOORS has reconciled the data from Mark's PC and Mark's Phone to create the Master 610 in his Cloud Drive 406, it is helpful to look at FIG. 20, FIG. 21 and FIG. 23 or FIG. 23A together because they are presented in a graphical user interface (GUI) format, which will greatly aid the reader's ready comprehension of how in practice the subject technology operates in the intuitive ways to which we are now accustomed to interacting with data. There it may be understood that the “Documents” 430 directory from Mark's PC is merged with the “Documents” 530 directory from Mark's Phone, to create duplicates of their files in the merged Master as the sub-directory “Documents” 640, with sub-directories “Work” 642, that has its own further sub-directories “Research” 650, “Expenses” 652, and “Accounts” 654. While “Books” 644, and “Notes” 646 are sub-directories of “Documents” 640 on the same level within the structure as the “Work” 642 directory. The DOORS has created this merged master Documents directory and/or a virtualized version 602 of it using the same principles, logic, artificial intelligence helper module and relational database 118 in the same way according to the same method as it did with the “Pictures” 620 directory, explained in detail (above).

The organized collection of files and data depicted in FIG. 23 and FIG. 23A having been assembled from files accessed across one or more storage sources and structured according to the relationships inferred by the intelligence engine, is an example of an organized and optimized collection of files and may be regarded as refined data set according to the subject technologies. A refined data set, as used herein, is a curated and organized output produced by the intelligence engine from a collection of one or more digital files. The refining process comprises the interrogation of the digital files, the identification of their extrinsic attributes and intrinsic attributes, the inference of relationships that become inferred attributes, and the recording of those attributes into the database. A refined data set may be extracted from the database responsive to an instruction, and may be supplied to a further process. The further process may be, for example, a specialist downstream application such as an accounting process, a legal process, an image analytical process, a medical data processing application, or any other process that consumes organized data. The refined data set may take various forms depending on the instruction and the nature of the further process: it may comprise a structured file collection, arranged according to a specified format, such as a tabular dataset of comma-separated values file, a set of high-dimensional vectors, a natural language description applicable to one or more of the digital files, or one or more addressable pointers to the locations of digital files that meet a desired specification.

The refined data set may be supplied to a further process. The supply may take the form of a data transfer, a file export, an API response, a database query result, a formatted report, or any other mode of delivering organized data from the intelligence engine to a downstream consumer. The further process may operate on the same computing device as the intelligence engine, on a remote device connected via a network, or on any combination of local and remote computing resources. The further process may be a specialist application configured to consume the refined data set for a particular purpose, such as a financial accounting process, a legal research or drafting process, a medical data processing application, an image or speech analytical process, a mathematical or scientific computation, an artificial intelligence learning process, an audio-visual processing application, or a physical artificial intelligence training process for vehicle control, autonomous navigation, flight control, or targeting systems. The further process may also be a file management operation such as relocation, deletion, quarantine, archival, or synchronization of the digital files based on the inferred attributes recorded in the database.

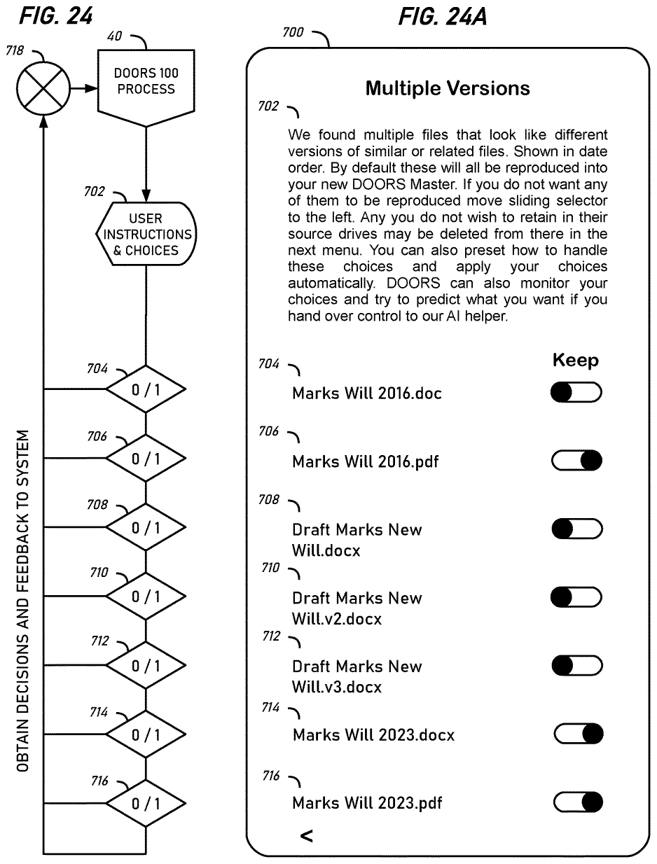

FIG. 24 should be read alongside and across side to side with FIG. 24A which shows a DOORS user interface for handling “multiple versions” of files 700 is a continuing process 40 of a DOORS 100, relating to presentation of options and obtaining the user's decisions via the view screen user interface 700, in which the user is offered various options via a button slider switch capable to toggle between the “off” to the left and “on” to the right positions to select to “keep” a file. In the system flow diagram these decisions 704, 706, 708, 710, 712, 714, and 716 may be operated by the DOORS according to Boolean logic when zero “0” is returned for a user input selection of “off” and one “1” is returned for a user input selection of “on”, the results of which decisions are returned via a feedback loop 718 and may be passed-on as values to the DOORS 100 according to system parameters.

FIG. 24A is a mobile phone touch-screen interface operating as the platform the DOORS 100 interface for obtaining user choices in relation to “Multiple Versions” 700. It presents this message to the user:

“We found multiple files that look like different versions of similar or related files.
Shown in date order. By default, these will all be reproduced into your new DOORS
Master. If you do not want any of them to be reproduced move sliding selector to
the left. Any you do not wish to retain in their source drives may be deleted from
there in the next menu. You can also preset how to handle these choices and apply
your choices automatically. DOORS can also monitor your choices and try to
predict what you want if you hand over control to our AI helper.” 702

The files shown may have been identified by the DOORS 100 in the process of interrogating source repositories and creating then populating the relational database 118 and/or creating a virtualized or physical DOORS master set of directories and files and/or master copy. Which process may be assisted by a language recognition module 33, and/or document recognition module 35 and/or other inference engine as may operate on the relational database 118. So that using intrinsic and/or extrinsic attributes they may be identified as versions of the same original file.

A slider button is provided that the DOORS 100 may set to the right by default, which indicates the version will be reproduced into a new central master data set that may be stored within or associated with a master directory structure, unless the user swipes (toggles) the slider to the left to omit that particular file. The decisions made by the user are: —“Marks Will 2016.doc” 704, is set to the left meaning do not reproduce this file into the master; “Marks Will 2016.pdf” 706, is set to the right meaning reproduce this file into the master; “Draft Marks New Will.docx” 708, is set to the left meaning do not reproduce this file into the master; “Draft Marks New Will.v2.docx” 710, is set to the left meaning do not reproduce this file into the master; “Draft Marks New Will.v3.docx” 712, is set to the left meaning do not reproduce this file into the master; “Marks Will 714 2023.docx” 714, is set to the right meaning reproduce this file into the master; “Marks Will 2023.pdf” 716, is set to the right meaning reproduce this file into the master; Mark's reasons for these choices are that he only needs portable document (.pdf) version of his old Will, plus the new 2023 Will in both the Microsoft Word (.docx) version for editing and rewrites plus the portable document format (.pdf) version for a read only record of the final version that is to be signed and notarized. From which choices the artificial intelligence helper module may record them in the relational database 118 and from this experiential data the DOORS 100 may learn the user's preference for retaining copies of historic documents in portable document format and also keeping current working versions of files in both word processing format and in portable document format.

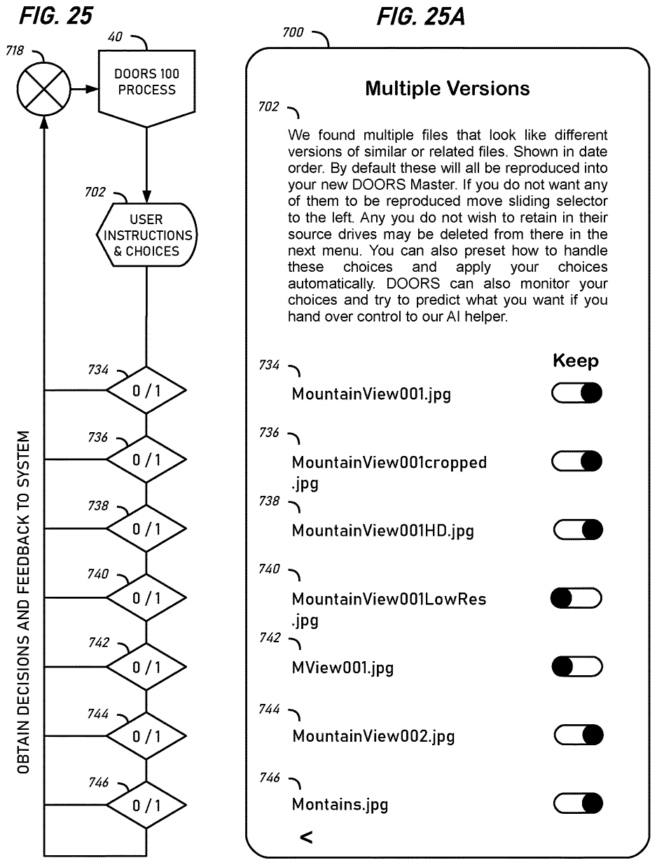

FIG. 25 should be read alongside and across side to side with FIG. 25A which shows a DOORS user interface for handling “Multiple Versions” of files 700 is a continuing process 40 of a DOORS 100, relating to presentation of options and obtaining the user's decisions via the view screen user interface 700, in which the user is offered various options via a button slider switch capable to toggle between the “off” to the left and “on” to the right positions to select to “keep” a file. In the system flow diagram these decisions 734, 736, 738, 740, 742, 744, and 746 may be operated by the DOORS according to Boolean logic when zero “0” is returned for a user input selection of “off” and one “1” is returned for a user input selection of “on”, the results of which decisions are returned via a feedback loop 718 and may be passed-on as values to the DOORS 100 according to system parameters.

FIG. 25A contains another example of the “Multiple Versions” interface 700, which is similar to FIG. 24, in relation to building a master data set and master directory structure. Except that the former related to multiple versions of similar or related documents, and this one relates to similar or related image files (with the extrinsic attribute the “.jpg” extension). With other extrinsic attributes in the form of machine learning or artificial intelligence using such attributes to infer one or more of their relationships, and hence that they have been identified as probable variants of files due to inter alia their file names on the theme of mountains: “MountainView001.jpg” 734, “MountainView001cropped.jpg” 736, “MountainView001LowRes.jpg” 740, “MView001.jpg” 742, which may be categorized as abbreviated versions of a first image file, which may be inferred by the DOORS 100 by textual analysis and the identification of similarities in their extrinsic attributes of their file names and type; and also by image recognition of their intrinsic pixel data in which patterns may be recognized as common to them all, which may be assisted by a language recognition module 33, and/or image recognition module 34 and/or other inference engine as may operate on the relational database 118. So that interrogating and using their intrinsic and/or extrinsic attributes they may be identified as versions of the same original file. The DOORS has also successfully recognized the file with misspelled named “Montains.jpg” 746, as probably a misspelled form of the word mountains as an extrinsic attribute, again this decision may have been reinforced by image recognition 34, and the various decisions made regarding whether or not to reproduce them in each case. Again, the user's decisions as are provided as feedback 718 to the DOORS 100 may be recorded and/or used as learning experience through use 50, and thereafter added to the stock of training data 48, for a neural network 52 as part of the artificial intelligence engine and/or recorded into the relational database 118. From where feedback data 718 may be used by an inference engine, that may be based on machine learning 46, and be assisted by condition matching classical logic-based 30, computing module 44, of a DOORS 100.

The user instructions and choices depicted at item 702 in FIGS. 24 and 25 represent an instruction received by the system. The intelligence engine, responsive to the instruction, queries the database to identify files and attributes that satisfy the instruction, and extracts the responsive information for presentation to the user or for supply to a further process. This instruction-triggered extraction pattern is a general operational mode of the subject technology. An instruction may originate from a user interacting with a user interface, from an application programming interface call issued by another application, from a scheduled or automated process, or from any other source capable of communicating a request to the system. The instruction may specify target data types, content criteria, sub-group selection criteria, output format requirements, or any combination thereof. Responsive to the instruction, the system extracts from the database a refined data set that satisfies the instruction, drawing upon the recorded extrinsic attributes, intrinsic attributes, and inferred attributes to identify the responsive files and data.

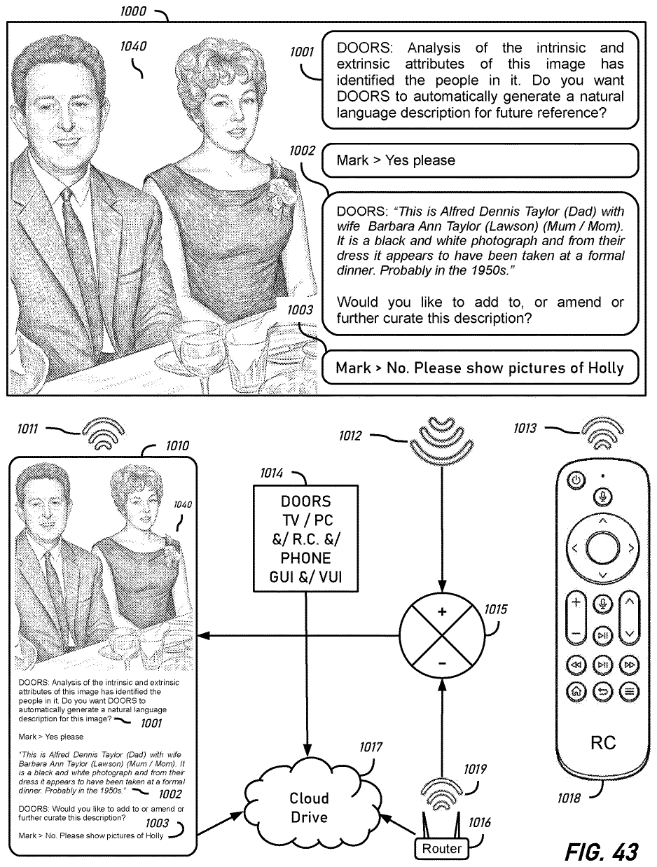

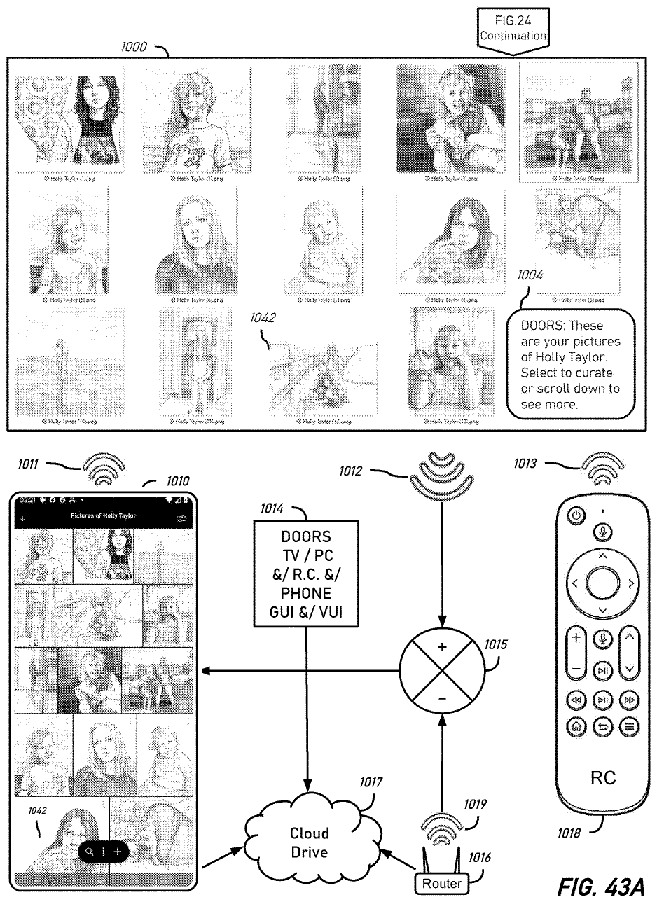

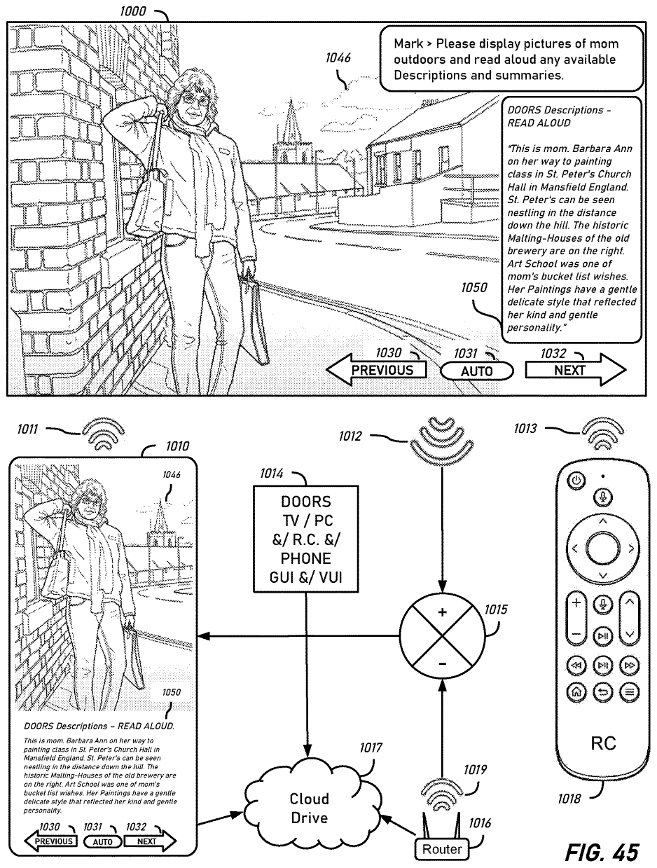

A refinement specification, according to the subject technology, is a set of criteria that governs how a refined data set is to be formed. Defining the parameters according to which the DOORS 100 intelligence engine selects, extracts, and organizes the data into a refined data set. A refinement specification may specify target data types, identifying the categories or kinds of data to be included; content criteria, identifying the subject matter, keywords, attributes, or relationships that the extracted data must satisfy; sub-group selection criteria, identifying which groups, classes, or subsets of files are to be used; and output format requirements, identifying how the resulting data should be structured, arranged, or formatted for supply to the downstream process. The refinement specification may be provided by a user through a natural language description input via a graphical or voice user interface—as demonstrated in FIGS. 43, 43A, and 45, where the user's spoken or typed requests direct the DOORS intelligence engine to retrieve, organize, and present specific data according to stated criteria- or through user selections made via interface controls such as those depicted in FIGS. 24 and 25. The refinement specification may also be provided programmatically. For example, as parameters within an application programming interface call, or as a set of pre-defined rules or policies applied by a scheduled or automated process.

In the embodiment of FIG. 41A, the refinement specification governing the production of the expense report entry 1663 comprises content criteria directing the intelligence engine to extract financial data objects from the classified email, and output format requirements directing the extracted data to be transformed and organized into a structured tabular format for supply to the expense accounting application. In the embodiment of FIG. 35, the refinement specification comprises the record field structure of the pre-populated new matter form 820, into which extracted client and matter data objects are supplied directly according to the field requirements of that form. Forming the refined data set in accordance with the refinement specification may comprise extracting data from the one or more digital files and transforming data into a required format, as demonstrated by the reformatting of date, vendor name, and description data in the expense report embodiment of FIG. 41A. The refinement specification may be obtained by the system explicitly from a user or calling application, or may be inferred by the intelligence engine from the context of the instruction and the nature of the downstream process.

In the embodiment of FIG. 40, the intelligence engine extracts factual data entities from the intrinsic content of the filing confirmation document 874—including the invention title 876, the inventor name 878, and the customer number 878—and uses those extracted entities to generate the structured alias name “SDI018.DOORS.PROVISIONAL.FILED.PDF” 882, which encodes the client identifier, matter number, document type, and filing event in plain language. The extraction of the target data types from within the document, and the assembly of the extracted data entities into a structured file name according to an established naming protocol, are each instances of forming a refined output in accordance with a refinement specification: the naming protocol defines the target data types to be extracted and the output format requirements governing how those data types are to be structured within the generated file name. The generation and application of the structured file name 882 to the document is furthermore an example of making the file itself conform to the refinement specification, so that the file's identifier reflects the criteria by which it was classified and placed.

In the embodiment of FIG. 41, the intelligence engine applies a refinement specification comprising sub-group selection criteria to classify files within the interrogated collection into groups of similar and related files: financial and accounting files are identified and grouped into the Accounts directory 654, while files that do not belong in that group—such as the personal photograph “Holly Birthday 9” 903 and the computer-aided design file “Drone Designs” 904—are identified as misplaced and relocated to their correct groups within the Pictures directory 620 and the Portfolio directory 624 respectively. The classification, grouping, and relocation of files into the directories where they belong with similar and related files is a data set refining operation governed by a refinement specification in which the sub-group selection criteria and content criteria direct the intelligence engine to organize the file population according to the determined relationships and attributes recorded in the database.

FIG. 26 should be read alongside and across side to side with FIG. 26A which shows the same system component parts organized and implemented to operate as a DOORS user interface on a mobile phone, capable of assisting to “Map Relationships” 750, which is a continuing process 40 of a DOORS 100, relating to presentation of instructions and choices 752. The interface presents this message to the user:

“DOORS can recognize faces, objects, animals and places. Here you can baseline
this functionality by identifying people and things using examples from your files.
You can then use their identification and relational characteristics to sort, view and
handle your files in new ways once relations are mapped into your relational
database.” 752

The interface continues by displaying file contents 754, which in this case includes an image of a person 754, then reading down the screen presenting the query “Who is this?” 756, is presented as a prompt for user input 758, to which the user has replied “Mark Taylor” 758 and the query “What is their relationship?” 760, as a prompt for user input 762, to which the user has replied “Owner/User” 762; which inputs are returned to the system via a feedback loop 718 and may be passed-on as strings of text to the DOORS 100 according to system parameters.

FIG. 26A, shows the “Map Relationships” user interface 750. Which may have been presented because the DOORS 100 may have been running the background (in terminate and stay resident (TSR) mode 15). So that it may interject within user operations as and when desirable. Which condition may have been triggered because the user has just used his mobile phone to take a new selfie, for use in a user profile for some random purpose. So that the DOORS 100 while running in the background, may have been triggered so the user may be prompted to use the “Map Relationships” interface 750, operating on the touchscreen of his mobile phone.

It may be that the DOORS 100 would be able to infer the identity of a person in an image without invoking the “Map Relationships” interface 750 if it already has experienced an image of that same person, and has mapped pixel data patterns into its relational database 118, for machine learning, and/or added its experiences 50, to train the weightings of a synthetic neural network 52 of an artificial intelligence module 46.

The more user-based input the DOORS can obtain at apposite times, when the user is engaged with the data in question—the better and more comprehensive the image processing and/or learning may be made. Especially, because the DOORS is designed to customize itself to the user, so that it may more perfectly emulate his or her file naming, placement, and other preferences. Persons skilled in the art will appreciate that a similar interface configured for and used with a computer, and monitor screen interface when encountering a new file or image could perform the same functions as these interface embodiments shown here which are configured for use in combination with mobile phones.

Referring to the image displayed 754, and using the question “Who is this?” 756 the DOORS seeks and gains the answer “Mark Taylor” 758 from the user, then asks “What is their relationship?” 760 in seeking to obtain the class or relationship of the person in the image 754, and he has replied “Owner/User” 762. These are just a few of the relationships that DOORS has been able to discover and then map into machine learning, and/or into a relational database, and/or into the learning of a synthetic neural network. Furthermore, the DOORS may learn and/or generate inferences from the files and data structures the user may create for this image and/or obtain from correctly relating it to other files 62, and/or related facts 60R, and/or fact matrices 71 as may be found on Mark's PC, and Mark's Phone or other devices and data repositories in this example of operations using a DOORS.

FIG. 27 shows the image file for “Mark Taylor” 758, being saved or reproduced by the DOORS into the “Pictures” 620 directory (a database structure that may also be known as a folder) of the “MASTER” 610 directory or folder. Readers may recognize the DOORS MASTER directory 610, in the Cloud Drive 406 from previous figures, and may also recall that the user's preference from previous menus was to store such image files into the Pictures 620 directory. The image file 770 is stored with the name “Mark Taylor.jpg”, and other attributes recorded including the date, location, and class 772 inspection of which reveals that the classes that apply to the user are “Owner/User/Family”. These classes are useful when building out a factual matrix 71 for a data entity. Data entities may be comprised of just about anything, such as an event, a person, corporation, or place. Data entities may be useful in building a bigger factual matrix 71 for the whole of a DOORS 100 knowledge base which may be recorded and stored within the machine learning data and data patterns as may be stored or linked to from within a relational database 118, and/or be recorded and stored within the weightings of neuron nodes within synthetic electronic neural networks (SENN) 52. Diverse examples of which SENN may be found in FIG. 3 above 52.

FIG. 28 should be read alongside and across side to side with FIG. 28A which shows a DOORS user interface for handling “Map Relationships” 750 is a continuing process 40 of a DOORS 100, relating to presentation of instructions and choices 752, displaying file contents 754, presenting the query “Who is this?” 756, to obtain user input 758, and the query “What is their relationship?” 760, to obtain user input 762, which inputs are returned via a feedback loop 718 and may be passed-on as strings of text to the DOORS 100 according to system parameters.

FIG. 28A shows the “Map Relationships” screen interface 750 of a DOORS 100 running on a mobile phone. It may be that DOORS is running a periodic routine update to a DOORS Master, stored in a Cloud Drive, or perhaps the user may be creating a new DOORS master or virtual master. In such a process an unknown picture has been found and displayed 754, and the user is being prompted with the question “Who is this?” 756 and “What is their relationship?” 760. To which interrogation questions the user replied “Holly Taylor” 758, and “Daughter” 762 respectively.

FIG. 29 shows the DOORS 100 having performed its relational inferencing and applying its prior learning, so that the DOORS is seen adding the newly discovered image of “Holly Taylor” 780, with relationship 762 “Daughter” to the DOORS master 601 directory which is unsurprisingly named “MASTER” 610, in the Cloud Drive 406.

To accomplish this fete the DOORS 100 checks the attributes 782 of the image file 780, noticing that the extrinsic relationship “Daughter” is included within the factual matrix 71 which contains the data points and/or factoids “Holly Taylor”, “Daughter of Mark Taylor”, “Mark is father of Holly and son of Mom”, “Granddaughter of Mark's Mom, Barbara Taylor” as well as including “Facial and/or image recognition data” which may be linked to or recorded in a field of the records for classes (see FIG. 14, which shows the records of the relational database for the class “family” 395, and includes a field confirming the presence of facial recognition data for Holly) matching the person in the image file. From class of relationships the DOORS is able to infer that the image file should be given the alias or mask name and/or if no naming collisions will be created by using that name, then the file should be renamed “Holly Taylor” and added to the classes: “Family”, “Kids”, and “Daughter” in the relational database 118, and/or run on the SENN as and recorded into the weighted learning aspect of the nodes of the SENN as a pattern match for Holly Taylor. So that in future the DOORS may more efficiently and easily identify other images of the person in the image Holly Taylor, and be able to store them into the most appropriate location within the hierarchy of a master index or tree of a master copy of the user's data. In this example that's the directory labeled “MASTER” 610, in the user's Cloud Drive 406.

Hence the applicable main class is “Family”, and the sub-sets are “Kids” the synonym and simile “Children” and “Daughter”. The DOORS 100 then checks the available directories for a match to the inferred relationships from the factual matrix 71 and/or class or classes 583 recorded in the structures of the relational database 118.

The directory “Pictures” 620, includes the sub-directory “Family” 622, which includes the sub-directory or folder “Kids” 632. Which is the best match that the DOORS 100 can find in which to put the image file “Holly Taylor.jpg” 780, with those attributes 782. Which process steps are executed, before the process moves on, to more 774 next steps in the DOORS processes that are off page.

FIG. 30 should be read alongside and across side to side with FIG. 30A which shows a DOORS user interface for handling “Map Relationships” 750 is a continuing process 40 of a DOORS 100, relating to presentation of instructions and choices (shown above in full) 752, displaying file contents comprised of an image file 754, presenting the query “Who is this” 756, seeking user input (as a text string) 758, and the query “What is their relationship” 760, user input 762, which inputs are returned via a feedback back loop 718 and may be passed-on as strings of text to the DOORS 100 according to system parameters.

FIG. 30A shows a touchscreen interface on a mobile phone with the same interface dialogue 750 for the next image file and displays the image 754. Which the DOORS has found and which is to be relationally mapped to assist the naming and placement of the file within a DOORS master copy of the user's files, which is to be stored into a Cloud infrastructure. Asking “Who is this?” 756, and “What is their relationship?” 760. To which interrogatory questions the user has replied “Kevin” 758, and “Friend” 762 respectively.

FIG. 31 shows the DOORS 100 adding the new image of “Kevin” 758, with relationship 762 “Friend” which is also a class 583, recorded in a field of the relational database records the records for the class “Friends” 396 (see FIG. 22, and FIG. 15 respectively) recorded 578 in the relational database 118. Which attributes are used by the DOORS to determine where to place the file within the hierarchy of the master directory tree structures, which is unsurprisingly labeled “MASTER” 601 and can be seen as a directory 610, inside the Cloud drive 406. The DOORS 100 checks the attributes 792 of the image file 790, noticing that the relationship 762 “Friend” to identify that this relationship is included within the class of relationships designated “Friends” within the relations and classes recorded in relational database 118. Hence the DOORS 100 knows that the applicable class 583, for pictures of Kevin is “Friends”. The DOORS 100 then checks among the available directories of the cloud drive for a match to the inferred relationships and/or classes. The directory “Pictures” 620, includes the sub-directory “Friends” 777. Which is the best match that the DOORS 100 can find, in fact a perfect match into which to store the image file “Kevin.jpg” 790, with those attributes 792. Additional relational location attributes are also recorded with other details of the file into the relational database 118, that may help build a fact matrix around the file and Kevin. This Kevin is a partial match with the “Kevin XXXX” found in the relational database and these files thus become linked with other files which have some nexus with Kevin. Which process steps are executed, before the process moves on, to more next steps in the DOORS process that are connected 774.

FIG. 32 should be read alongside and across side to side with FIG. 32A which shows a DOORS user interface for handling “Map Relationships” 750 is a continuing process 40 of a DOORS 100, relating to presentation of instructions and choices 752, displaying file contents 754, presenting the query “What is this?” 770, seeking user input 759, and the query “What is the relationship?” 772, seeking user input 773, which inputs are returned to via a feedback back loop 718 for processing and may be passed-on as strings of text to the DOORS 100 according to system parameters.

FIG. 32A shows the same interface dialogue 750 as previous figures, for the next image file that has been found in the storage of one of the source devices and which is to be mapped into the relational database 118 and which image the interface displays 754. Image recognition 34 processing has noticed that the image does not contain any data patterns that would indicate the presence of a person, and consequently the DOORS 100 is not asking who is this, but instead is asking “What is this?” 770, and “What is the relationship?” 772. To which interrogatory questions the user replied “A flower” 759, and “Mom's garden/nature” 773.

The ground truths supplied by the user through the relationship mapping interface—such as the identity of a person depicted in a photograph, the nature of a relationship between the file owner and the depicted person or object, and the contextual significance of the file content—enrich the inference process of the intelligence engine. When applicable ground truths are available, the intelligence engine may infer relationships and produce inferred attributes that would not be discoverable from the identified intrinsic attributes and the identified extrinsic attributes alone. For example, without the user's ground truth identification of the person depicted in FIG. 28A as “Holly Taylor” with a relationship of “Daughter,” the intelligence engine might identify that the file contains a photograph of a young person but would lack the factual basis to infer the familial classification “Family/Kids/Daughter” that is recorded at item 782 in FIG. 29. The ground truths thus serve as a knowledge source that, when combined with the intrinsic and extrinsic attributes identified by the intelligence engine, enables a richer and more accurate set of inferred attributes to be produced and recorded into the database.

FIG. 33 shows the DOORS 100 adding the new image of “A flower”, with relationship 773 “Mom's Garden/nature” to the DOORS 100, master copy 601, the directory of which is unsurprisingly named “MASTER” 610, and is located within the Cloud Drive 406. The DOORS 100 checks the attributes 802, of the image file 800, noticing that the relationship 773 “Mom's garden/nature” as well as the attributes 802 include the file name “Moms Garden Flower.jpg” to identify that the relationship descriptors “Mom's” and “Moms” are the possessory synonym within a simile for “mother”, “mom”, and “mum”, which are synonym-matches and/or partial matches for text strings included within the classes of the relational database 118, also in the relationships in the fact matrix 71 which may be incorporated and recorded into records 58; that may be held within the relational database 118 for “Family”, “Parents”, and “Mom”; hence applicable or partially applicable or related classes and/or relationships for this image may include “Family” “Parents”, and “Mom”—that may track to directories.

The DOORS 100 then checks the available directories looking for one with a name that is a match or partial match synonym or simile to the inferred relationships and/or classes. The directory “Pictures” 620, includes the sub-directory “Family” 662 which contains the sub-directory “Parents” 630, that in turn contains the sub-directory “Mom” 779. The inference engine, and/or artificial intelligence engine may use these attributes, relationships, and classes, to determine that the best overall fit for placement which may also be based on learning from the user's previous selections; as a result of which processing the DOORS 100 decides the best name for the image file is “Moms Garden Flower.jpg” 800. Which has no name collisions with other files, with those attributes 802 and that the sub-directory “Mom” 779, that is nested within the sub-directory “Parents” 630; which is in turn nested within the sub-directory “Family” 662, and nested within the “Pictures” 620 directory of the “MASTER” 610 directory. This is where the DOORS decides to put the file 800. Which process steps are executed, before the process moves on, to more connected 774 process steps.

The attributes depicted at items (FIG. 27) 772, (FIG. 29) 782, (FIG. 31) 792, and (FIG. 33) 802 each include a classification value that was not present among the original extrinsic attributes or intrinsic content of the respective file prior to processing by the intelligence engine. For example, the classification “Family/Kids/Daughter” depicted at item 782 for the file “Holly Taylor.jpg” was not recorded in the file's metadata or content before the intelligence engine processed the file. Rather, the intelligence engine produced this classification by inferring a relationship based on the identified intrinsic attributes of the file, the identified extrinsic attributes of the file, and ground truths obtained from the user through the relationship mapping process of FIGS. 26, 26A, 28, 28A, 30, 30A, 32 and 32A. The resulting classification is a newly inferred attribute of the file—a previously unrecorded attribute that the intelligence engine has derived by combining the identified intrinsic attributes, the identified extrinsic attributes, and any applicable ground truths. Once inferred, an inferred attribute may be recorded into the database alongside the identified extrinsic attributes and the identified intrinsic attributes from which it was derived, so that the factual matrix accumulates not only the raw attributes of each file but also the knowledge that the intelligence engine has produced about those files. The same pattern is depicted at items 772, 792, and 802, where the intelligence engine has inferred and recorded classification values for the files “Mark Taylor.jpg”, “Kevin.jpg”, and “Moms Garden Flower.jpg” respectively.

Furthermore, the inferred attributes depicted at items 772, 782, 792, and 802, together with the identified intrinsic attributes and identified extrinsic attributes of the respective files, are used by the intelligence engine to determine the placement of each file within the directory structure. As depicted in the progression from FIG. 27 through FIG. 33, the structure of the directory tree evolves as the intelligence engine processes successive files: new directories are created—such as the Friends directory at item 777 in FIG. 31 and the Mom directory at item 779 in FIG. 33—and files are placed into those directories based on the combination of all three attribute types. The intelligence engine thus organizes the digital files into a structure in which the directory hierarchy, the directory names, and the placement of files within directories each reflect the knowledge that the intelligence engine has derived from the intrinsic attributes, the extrinsic attributes, and the inferred attributes of the files. The resulting directory structure also determines the structured menus and navigational pathways through which a user may access and view the organized files, so that the user's experience of the file collection is shaped by the intelligence engine's accumulated understanding of the files and their relationships.

The directory structures depicted in FIGS. 27 through 33 are expert file handling structures. As the intelligence engine infers relationships and records the resulting inferred attributes, it encodes that learning into the branching topology of the directory tree. Each new directory created, each file placed, and each directory name assigned represents a piece of knowledge that the intelligence engine has learned and encoded into the structure. The directory tree is thus simultaneously a storage structure intuitive to human users-who navigate it by reading the directory names and following the branching paths- and a knowledge tree navigable by the intelligence engine, organized according to the same synonym and simile groupings described elsewhere herein. The groups of related files depicted in the figures may be implemented as physical directories on storage media, as virtual collections within the database, or as display groupings rendered within a structured presentation of a graphical user interface. In each implementation, the underlying mechanism is addressable pointers recorded in the database that identify which digital files belong to which groups and in which structural positions within the hierarchy. The structured presentation displayed to the user is rendered from those pointers, so that what the user sees as an intuitive system of folders and files is, at the implementation level, a set of pointer relationships maintained by the intelligence engine within the database.

FIG. 34 is an embodiment of a DOORS 100, that is adapted for use by professional service providers such as lawyers, consulting engineers, marketing consultants, and accountants, etc. Professional services businesses have to manage their client files, which in the case of some professions may be governed by specific laws, as well as meeting other practical needs. In this case it appears to be a firm of patent attorneys who have a new client. The process begins by entering the new client into the client and matter database which may be or include a relational database 118 according to the subject technologies.

The user is presented with a menu to create a new client matter 807, which seeks user input to fill-out the columnized data entry fields 808 which are adjacent to columnized query prompting fields 803, of a new client and matter database record 805. The emboldened text in the response to query fields for user has been entered to create the new client matter into this record 805, so that the system may save the record to storage for future reference.

FIG. 35 continues the process begun in the previous file, which created a new record for a new client. It begins by displaying the menu to create a new matter for an existing client 810. Which is luckily the same client as in the previous figure. So that the user may use existing client data (as an alternative to entering it over again) 812. Which is accomplished using client database record(s) 814, where the basic client data is already recorded from previous matters, and may be extracted from storage 816. For use so that the system may create the new matter or record 818 using the pre-populated record menu 820. Which causes the display of a partially populated client and matter record 806 with some outstanding queries columnized 803, adjacent to unpopulated parts of the columnized fields 804, into which the user may enter additional details for the new matter. Where the applicable query prompting fields are “DESCRIPTION OF PROJECT”, and “CLIENT'S REFERENCE” adjacent to the empty fields for the user to complete via user inputs.

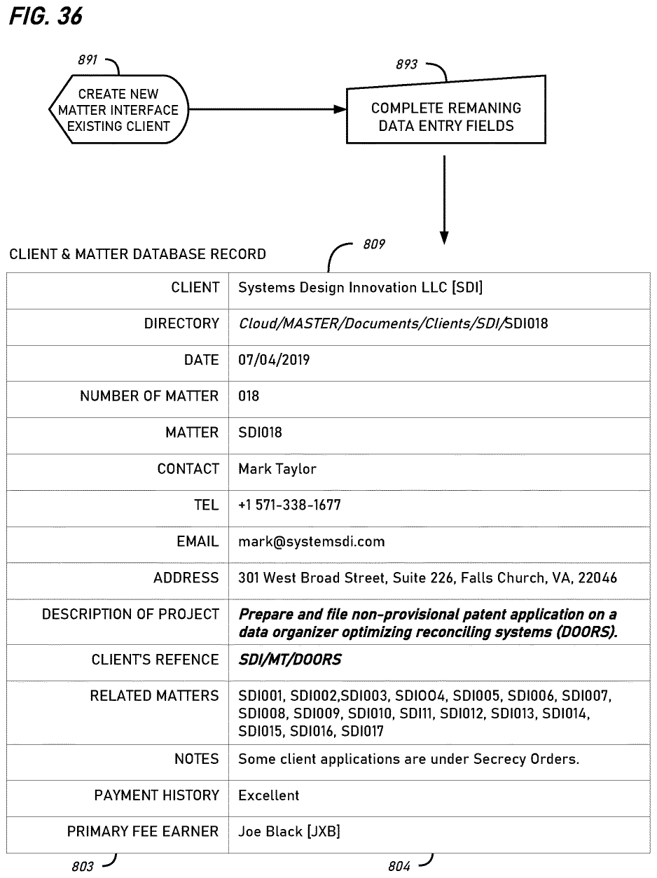

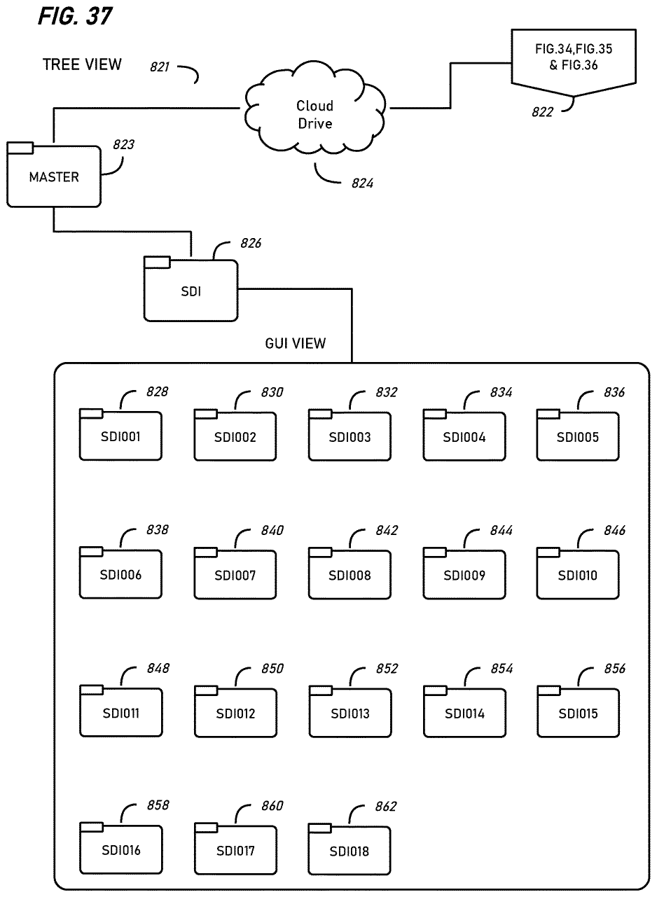

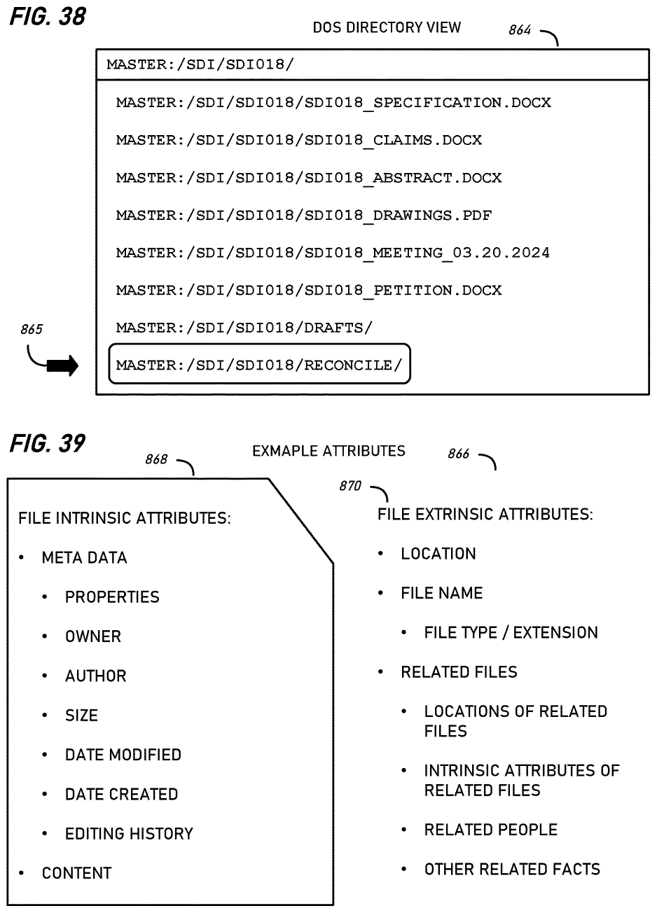

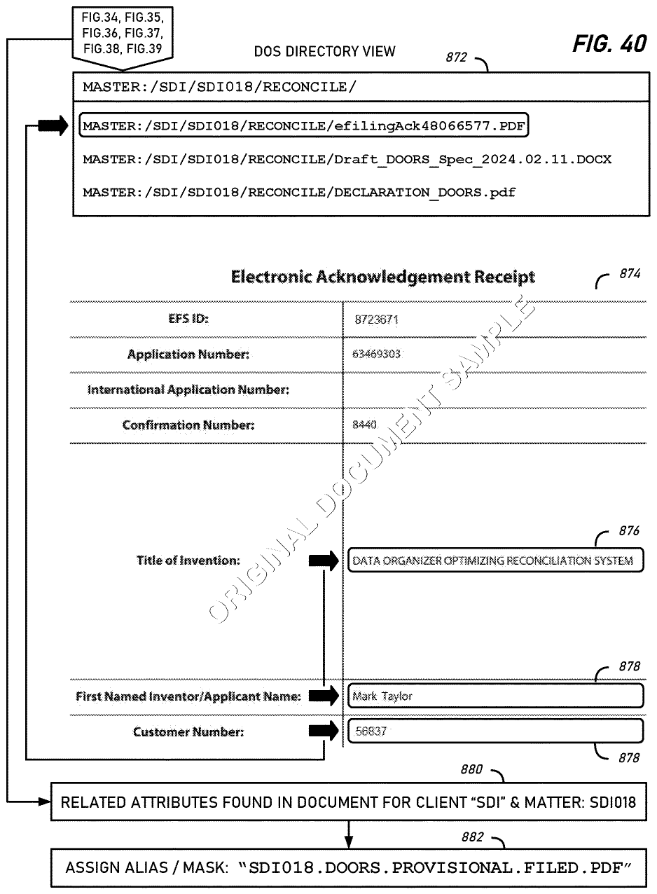

FIG. 36 continues the process from the previous figure beginning with displaying the create new matter, for an existing client interface 891, in which the user may complete the process via user inputs to the previously blank columnized 804 fields; which has occurred and is the emboldened text entries to complete the creation of the new matter, as an existing client and new matter database record 809.

In FIG. 37, in the continuing process from the connected previous FIGS. 822, the system created the new sub-directory “SDI018” 862 continuing the sequence of directories and matter numbers which are used to create the names of directories within the “SDI” directory 826. Which is in turn a sub-directory of the master directory which is unsurprisingly labeled “MASTER” 823, and which is within a Cloud drive 824.

FIG. 38 is a Microsoft® disk operating system (DOS) window view of the sub-directory “SDI018” 862 created in the previously combined tree and GUI view 821 for the new matter SDI018 which was created for the existing client “Systems Design Innovation LLC [SDI]”. Here the sub-directory from the tree and GUI view 821 is shown in this DOS window 864. Where the sub-directory and structure “MASTER:/SDI/SDI018/RECONCILE/” is shown 865. This is the directory into which files that have been identified as potentially needing to be reconciled may be placed by the DOORS 100 if the DOORS has identified them as files that may be related to this client (SDI) and to the matter “SDI018”. Where the DOORS 100 may be assisting the legal practice that is operating these IT systems. Where indeed the client data management software may be part of a corporate package of DOORS which has been specially created, and/or licensed for professional services firms. In relation to which business market users may prefer to set strict policies and naming conventions like the one used in the creation of matter names. Which may use the initials of the client in these examples comprising [SDI]+ [a number sequence generated part such as “018”]+[intuitively derived descriptors] created by the DOORS 100 for matter labels and/or sub-directory names such as “SDI018” and for file names as shown in this figure and those above.

FIG. 39 shows examples of attributes 866 that files may have which may be used by the DOORS 100 processes in generating naming descriptors for files and data structures (directories), and in processing their class and relationships to assist in those processed. Listing some “file intrinsic attributes” 868, as “meta data” such as “properties”, “owner”, “author”, “size”, “data modified”, “date created”, and “editing history”, plus “content”. The subject of analyzing content may be particularly useful in the case of image recognition, and/or also for recognizing from text fields, specific data which may help DOORS to process files more accurately, and in new ways. For example, using a DOORS 100 configured for business use to find files that contain accounting data, which may help a user to find copies of receipts and invoices, that may be need in the completion of tax returns and other accounting and financial applications (this example is addressed in more detail below in relation to FIGS. 40, and 41.

Some examples of “file extrinsic attributes” 870 are also provided “location”, “file name”, “file type extension”, as well as extrinsic attributes which may be part of a factual matrix relating to a data entity 71, including “locations of related files”, “intrinsic attributes of related files”, “related people”, and “other related facts. All of which are susceptible to being stored into a relational database 118. Then leveraged by logical and/or machine learning inference engines, and/or artificial intelligence engines 46 that may be powered by a SENN 52.

FIG. 40 provides an example of a DOORS 100, that may be being used by a patent attorney (which is connected off page with FIG. 34, FIG. 35, FIG. 36, FIG. 37, FIG. 38, and FIG. 39 above). In which the DOORS may be creating or updating a DOORS master copy of his firm's client's files which may have become fragmented during installation of a new IT system between the previous system machines and the new system machines. After having gone through the steps of running the DOORS 100 and retrieving the files on those machines. This example may be found where the files discovered which have attributes capable of allowing the DOORS to reconcile those files into the directory structure “MASTER:/SDI/SDI018/RECONCILE/” 865 as shown and indicated in the DOS Directory View 864 of FIG. 39.

Which is zoomed down into the “RECONCILE” sub-directory in this the DOS Directory View 872 of this figure. Where the DOORS 100 has positionally reconciled these files into the master copy, and nested them into these directory structures: “MASTER:/SDI/SDI018/RECONCILE/efilingAck48066577.PDF”, “MASTER:/SDI/SDI018/RECONCILE/Draft_DOORS_Spec_2024.02.11.DOCX”, “MASTER:/SDI/SDI018/RECONCILE/DECLARATION_DOORS.pdf”

Further reconciliation may be possible, to move them up one level, and/or to create alias or mask names for them. Which may not be necessary from the user's perspective who may prefer to keep them where they are in the “RECONCILED” directory. Where they can be identified as distinct from other files that may also be populated into their related file holding directories.

The DOORS 100 has scanned into the intrinsic attributes of these files as shown in the example document. Which is an original document sample of an “Electronic Acknowledgement Receipt” 874, provided by the United States Patent and Trademarks Office (USPTO). Which is in fact evidence of filing the provisional patent application for this very non-provisional patent application for the invention titled “DATA ORGANIZER OPTIMIZING RECONCILIATION SYSTEM” 876. With “First named Inventor/Applicant Name:” of Mark Taylor 878, and “Customer Number” of “56837” 878. Which together are the related attributes found in this document for client “SDI” and matter “SDI018” 880. These are the attributes which the DOORS has used to infer that this file “efilingAck48066577.PDF” should be reconciled into the directory structure and location shown “MASTER:/SDI/SDI018/RECONCILE/” as shown 872.

Furthermore, the DOORS 100 has created the alias or mask name 583 for population into the relational database 118 then assigned the alias or mask name “SDI018.DOORS.PROVISIONAL.FILED.PDF” 882. As previously discussed, files may be handled by the DOORS by their alias or mask name, or their actual file name. The DOORS may swap the file name and alias or mask names around, and vice versa. If they are swapped, then the more informative descriptor names provided by the DOORS may add consistency to help make files more readily identifiable to users. Furthermore, as previous names may be recorded into the relational database their links to other versions and related files need not be lost in the renaming process. Clearly the ability to scan into the contents of files so as to enable the identification and retrieval of intrinsic attributes is a powerful tool. Which may help make file management operations and information processing using IT systems more efficient for users, who are natural persons as well as businesses and other organizations including governments.

The filing confirmation document 874, the Electronic Acknowledgement Receipt appearing within the RECONCILE directory 872, is the type of document issued electronically by the United States Patent and Trademark Office to confirm receipt of a patent filing, and is in ordinary practice delivered by the USPTO as a PDF file attached to an automated email addressed to the attorney or agent of record. In this embodiment the DOORS 100 may be configured to process incoming email agentically: upon detecting a new message in the monitored email account, the DOORS 100 identifies the email as a container file from which one or more attached documents are to be extracted as data objects, and extracts the attached filing confirmation PDF 874 as a first-level data object from the email container. The filing confirmation PDF 874 thus arrives in the matter directory structure at MASTER:/SDI/SDI018/RECONCILE/as the result of an automated extraction and placement operation, without requiring the user to save or move the attachment manually.

Having extracted the filing confirmation document 874 from the email container, the intelligence engine of the DOORS 100 applies the defined process 888 (FIG. 41) to interrogate its intrinsic content (or attributes) and identify the factual data entities indicated by the bold black arrows and surrounding boxes shown in FIG. 40. These are: the title of the invention 876, “DATA ORGANIZER OPTIMIZING RECONCILIATION SYSTEM”; the first named inventor and applicant name 878, “Mark Taylor”; and the customer number 878, “56837”. The receipt 874 additionally contains further data fields visible in the document—the EFS ID “8723671”, Application Number “63469303”, and Confirmation Number “8440”—each of which may similarly be extracted from the intrinsic content of the document and recorded into the relational database 118 as additional factual data entities associated with the client and matter. The identified factual data entities 876, 878 constitute a second level of extraction from within the filing confirmation: that document was itself the first level of extraction from the email container, creating a two-level data object extraction hierarchy—email container, first-level extracted attached document, second-level extracted factual entities—which is an instance of the sub-objects comprising also a sub-set of data being extracted and nested container principles of the subject technologies.

The extracted factual data entities 876, 878 are cross-referenced by the intelligence engine of the DOORS 100 against the client and matter database records established in FIGS. 34 through 36 to determine the related attributes for client “SDI” and matter “SDI018” 880, as shown. From these related attributes the intelligence engine infers the correct filing management operations: the filing confirmation document 874 is to be placed within the RECONCILE subdirectory of the SDI018 matter structure 872, as shown, and the opaque machine-generated original filename “efilingAck48066577.PDF” is to be supplemented with the descriptive alias name 882 “SDI018.DOORS.PROVISIONAL.FILED.PDF”, which encodes in plain language the client identifier, matter number, document type, and filing event. The alias name 882 may be assigned as the file's primary name or held in the relational database 118 as a mask name alongside the preserved original filename. The two further documents in the RECONCILE directory—“Draft_DOORS_Spec_2024.02.11.DOCX” and “DECLARATION_DOORS.pdf”—may likewise have been placed in the RECONCILE directory by the DOORS 100 following analogous agentic processing, by whatever means received or obtained, their intrinsic content interrogated, their client and matter relationship inferred from that content, and their placement and naming determined accordingly.

The extracted factual data entities—the invention title 876, the inventor name 878, the customer number 878, and the matter relationship 880—constitute a structured supply of typed factual data objects extracted from an incoming correspondence document and made available to the specialist client and matter management system operating as or in conjunction with the DOORS 100. This supply enables the receiving system to infer and perform the correct next workflow step without further user input. Thereby providing an exemplary instance of the extraction of a set or sub-set of data and a data supply operation according to the subject technologies. The complete processing sequence from detection of the incoming email, extraction of the attached filing confirmation document 874, interrogation of its intrinsic content, identification of the factual data entities 876, 878, inference of the client and matter relationship 880, generation and recording of the alias name 882, positioning of the file within the matter directory structure 872, and recording of all extracted attributes, inferences, and relationships into the relational database 118 as part of the Factual Matrix 71, may be performed by the DOORS 100 application operating as an agent. Without necessarily requiring any user action beyond the initial configuration of the client and matter database records and directory structure established in FIGS. 34 through 37. In professional services contexts—including patent prosecution, legal practice management, accountancy, and medical administration—the ability to process incoming correspondence agentically and supply the extracted data set of factual content to the practice management system in a form that enables automated workflow inference represents a significant and commercially valuable operational capability of the DOORS 100.

FIG. 41 further explains an embodiment of the DOORS 100 aspect of identifying and using task and/or purpose relevant intrinsic data from within files in the defined process 888, which provides:

Intrinsic Attribute-Based File Handling

```
890. Compare file contents to dictionaries and / or learning and / or facial
recognition and / or pattern and / or logo recognition to identify: -
  (a) relationally significant words, keywords and / or patterns, and / or
  (b) likely meanings and / or relationships.
891. Cross reference words and / or pattern.
892. Create and / or identify inferences.
893. Write file info to relational database(s).
894. Write to duplicate or move file to most appropriate best fit location.
```

The DOORS processing is connected off page with FIG. 19, FIG. 20, FIG. 21, FIG. 22, FIG. 22A, FIG. 22B, FIG. 22C, FIG. 23, and FIG. 39. The defined process 888 is applied to user documents including the original sample document, which is a Gmail email from Google® 884 containing a Google Play Order Receipt. Within the text “Your Google Play Order Receipt from Jan. 22, 2023” the inference engine and/or artificial intelligence engine has identified three text strings which map to relationship data, from which it has been possible to infer that this document is a member of the classes of documents known as “expenses” and/or “financial” and has a direct match for the words “order” and “receipt” from which these attributes have been used to infer relationships thus: “Your [Google Play] 885 [Order] 886 [Receipt] 887 from [Jan. 22, 2023]” and to move or copy the file into the “Accounts” 654 directory of “ . . . /Documents/Work/Accounts/” 654 with the file original file name “Google email” 901.

The DOORS processing has also found in the Accounts directory files which appear to have been wrongly stored there “Holly Birthday 9” 903, which it is moving to the “Pictures” directory 624, and “Drone Designs” 904, a computer-aided design file of the CAD drawings class, which it is moving to the “Portfolio” directory 624. While the remaining files “Mark Assets” 900, “Home System” 902, and “SDI Accounts” 905 appear to be remaining where they are at this stage in the DOORS processing.

The document sample 884 shown in the upper portion of FIG. 41 is a Gmail email, as identified by the Gmail logotype displayed at the upper left of the interface view. The email is addressed to “Mark Taylor” and bears the subject line “Your Google Play Order Receipt from Jan. 22, 2023”, shown as 1 message in the Gmail interface. The DOORS 100 has processed this incoming email agentically, applying the defined process 888 to its intrinsic content. The file appearing in the Accounts directory 654 as “Google email” 901, rendered with a PDF file type icon in FIG. 41, represents the result of that processing: the email has been automatically printed or converted to PDF format by the DOORS 100 or a tool it operated, pursuant to a policy or rule applicable to incoming emails of the “financial” and “expenses” class, and placed in the Accounts directory 654 as a permanently stored financial record. The original Gmail email 884 as received and the PDF file 901 stored in the managed file system are accordingly two states of the same correspondence: the email container as received, and the processed PDF data object as stored by the DOORS 100.

The classification of the Gmail email 884 as belonging to the “expenses” and “financial” classes is achieved through the synonym and simile inference mechanism of the knowledge tree, operating in conjunction with the intelligence engine of the DOORS 100. The three boxed text strings identified in FIG. 41—“Google Play” 885, “Order” 886, and “Receipt” 887—are identified at step 890 of the defined process 888 as relationally significant keywords within the email content. At step 891 these are cross-referenced against the word and non-word synonym and simile groupings held within the knowledge tree: “Receipt” 887 is a member of a synonym and simile grouping encompassing payment confirmation, proof of purchase, and financial document; “Order” 886 maps via simile to purchase, transaction, and commerce; and “Google Play” 885 is identified as a commerce platform from which financial transaction receipts originate. The compound cross-referencing of all three terms at step 892 produces a confident inference that the document is a member of the “expenses” and “financial” classes, achieved without any single exact-match keyword—each constituent signal is a synonym or simile of a financial term rather than the term itself. This is an instance of the compound comprehension mechanism of the subject technologies, in which a plurality of individually imprecise data points are used in combination and may be processed through the synonym and simile groupings of the knowledge tree to produce a strongly confident and accurate classification. Which is based on an inferred relationship based on meaning.

The DOORS 100 may, upon completing the synonym and simile inference and classification of the Gmail email 884, distil the recognition pattern into a new procedural tool. This tool encodes the inference rule for the recognition of Google Play order receipt emails as members of the “expenses” and “financial” classes: a processing routine generalizable to any email from a commerce platform containing synonyms or similes of “order” and “receipt”. The tool may be created on the fly by the intelligence engine at or following step 892, assigned a descriptive name by the Auto Naming Engine 1457 (FIG. 42C) that encodes its function and subject matter, and recorded into the Factual Matrix 71 via the knowledge tree (items 1473-1474, FIG. 42D), indexed under both that name and the synonym and simile terms characterizing its subject domain. Once recorded, the tool is available to be retrieved by name or by functional similarity and applied to subsequently received emails or documents of the same or analogous type, without requiring the inference computation to be repeated. All attributes extracted from the email 884, the class designations assigned, the inferences recorded, and the pointer to the newly created tool are written into the relational database 118 at step 893 and constitute additions to the Factual Matrix 71, so that the knowledge accumulated from processing this email is preserved across sessions and accumulates within the expert system of the DOORS 100.

The six files shown in the Accounts directory section of FIG. 41 collectively illustrate the variety of file types that the DOORS 100 may process agentically in a typical working environment: “Marks Assets” 900, a word processing document indicated by the “W” file type icon; “Google email” 901, a PDF as described above; “Home System” 902, a structured data or database file indicated by the “::” icon; “Holly Birthday 9” 903, an image file indicated by the image icon; “Drone Designs” 904, a computer-aided design file indicated by the “CAD” icon; and “SDI Accounts” 905, a spreadsheet indicated by the “XL” icon. The DOORS 100 has identified from the intrinsic attributes and class designations of “Holly Birthday 9” 903 and “Drone Designs” 904 that those files are misplaced within the Accounts directory—a personal photograph and a CAD file are not members of the “expenses” or “financial” class—and has moved or is moving them to their correct locations: “Holly Birthday 9” 903 to the Pictures directory 620, and “Drone Designs” 904 to the Portfolio directory 624, as shown. The processing of all six files in this figure—their classification, placement, movement, retention, and the recording of their attributes, class designations, and inferred relationships into the relational database 118 and the Factual Matrix 71—is performed by the DOORS 100 as a continuous agentic file management process, operating across a heterogeneous collection of file types. Which may operate without requiring separate user instructions for each individual file operation.

With reference to FIG. 41A, which should be read in conjunction with FIG. 41, the intelligence engine has interrogated the email 884 depicted in FIG. 41 and has identified from the intrinsic content and extrinsic attributes of the email that it originates from Google Play 885, that it represents an order 886, and that the email is a receipt 887. The intelligence engine has applied the defined process for attribute-based file handling 888. The email has been placed 901 into the group of documents in the Accounts folder 654, the path of which in the directory hierarchy structure is “ . . . /Documents/Work/Accounts”. This placement is itself an inferred attribute of the email file—the intelligence engine has determined, based on the identified intrinsic attributes and extrinsic attributes and applicable ground truths, that this email belongs in the Accounts group rather than in any other group within the directory structure.

The intelligence engine has then interrogated the intrinsic content of the email 884 further, at a deeper level, and has identified a plurality of data objects within it. The data objects identified by the extraction process 1650 and depicted with bold black arrows are extracted as data items “A” 1651, “B” 1652, “C” 1653, “D” 1654, “E” 1655, “F” 1656, and “G” 1657, each representing a discrete piece of information contained within the receipt—such as an order date, an order number, an account identifier, an item description, a price, a tax amount, a total, and a payment method. These data objects are newly discovered and extracted intrinsic attributes of the email file 884 that have been identified and extracted as subsets of data from within the file.

The intelligence engine has then collated the extracted data objects at step 1658 using inference—not merely copying the data items but applying the intelligence engine's comprehension of their meaning and relationships to determine how they should be combined, formatted, and organized. The collated data objects are passed to a preparatory process at step 1659, which organizes them into a structured format suitable for onward processing, such as comma-separated values (CSV). CSV is a standard format used globally for the parsing of arrays and tables typically used in spreadsheets and other mathematics-based computing applications. From this preparatory step, the data may follow either or both of two paths, as depicted in FIG. 41A.

In the first scenario, at step 1662, the prepared data set in CSV format is supplied to another application as an array of characters or numbers parsed by commas. This supply path enables a receiving specialist application to ingest the refined data without requiring that application to perform its own extraction or formatting of the source material. The intelligence engine thereby operates as a data supply service, preparing structured inputs from unstructured source files and delivering them homogenized into a standard interchange format to any application configured to receive them.

In the second scenario, at step 1661, the intelligence engine computes and outputs a structured analysis of the data set locally. The preparatory process at step 1659 may also parse the data into CSV format for this local processing path. The result of this local computation is the prepared expenses report shown as an output within a local interface 1660. In this embodiment, the intelligence engine has taken the data entities extracted from the Google Play receipt 884, identified the subset relevant to the task of compiling and computing the expenses report, and used that subset to generate the line entry 1663 identified by the bold black arrow. The specific subset of data used to compute and output the results of this analysis locally in the expense report includes only the relevant data items: the date of the expense “Jan. 22, 2023”, a description that it was for “CLOUD STORAGE”, the vendor “GOOGLE PLAY”, and the total paid of $19.99.

It is noteworthy that the intelligence engine has not slavishly reproduced the raw data but has intelligently refined it into a form tailored to the application. The date comprised of data item “A” 1651 has been reproduced but reformatted from its original alphanumeric format “Jan. 22, 2023 3:25:39 PM EST” into the number format “Jan. 22, 2023” most appropriate to the abbreviated tabular output. The vendor's name that was scanned from the receipt in its original capitalization “Google Play” 887 as depicted in FIG. 41 has been reformatted to a different capitalization policy—in this case, upper-case “GOOGLE PLAY”. The description of the expense has been derived by the intelligence engine from the item description “100 GB (Google One) (by Google LLC)” and the nature of the subscription, inferring and applying the summary description “CLOUD STORAGE” rather than reproducing the verbose original. The total of “$19.99” has been faithfully reproduced from the receipt into the applicable row entry. Certain data entities extracted from the receipt—such as the order number, account identifier, and payment method—have not been used in the expense report itself but have informed the intelligence engine's comprehension of the document and its context, and remain recorded in the Factual Matrix 71 as attributes of the source file for future retrieval and reference.

The refined data set has been produced through a two-stage refining process. In the first stage, the intelligence engine identified the email within a plurality of files, interrogated the email and identified its attributes, inferred from the intrinsic attributes that were extracted that it contained financial data and that it belongs in the “Accounts” group 654 (FIG. 41), and placed it there—thus refining the population of files from the user's larger collection down to the relevant group. In the second stage, the intelligence engine interrogated the intrinsic content of the email at a deeper level, identified and extracted specific data objects, collated them using inference at step 1658, and formatted them intelligently through the preparatory process at step 1659 to produce a structured data set suitable for either or both of the two scenarios described above. In the local processing scenario, the intelligence engine has used the extracted data objects as context to compute and output the structured analysis at step 1661, creating the appropriate entry 1663 in the expenses report displayed in the user interface 1660.

In the alternative external supply scenario, the same prepared data set is supplied 1662 in CSV format to a separate receiving application for processing. The resulting dataset in both scenarios is both refined, in that irrelevant data has been removed and relevant data has been structured, and homogenized, in that the extracted data has been organized into a consistent format alongside similar entries from other source files. The specialist application in this example is an expense account for the month of January 2023, and the refined and homogenized dataset has been made available both as a locally computed and displayed result and as a structured data input ready for supply to a further processing application.

The DOORS 100 may classify the files within an interrogated file collection into one or more data types or categories based on the identified intrinsic attributes, the identified extrinsic attributes, and the relationships determined by the artificial intelligence engine. The classification of a file into a data type or category may be performed by applying the document classifier module 1454 (FIG. 42C) and, where applicable, the facial recognition module 1452, the object recognition module 1453, and the text extractor module 1451 to the content and attributes of the file, and by comparing the results against the class and relationship records held within the relational database 118. Data type categories may include, without limitation: image data; text-based document data; audio data; voice recording data; video data; audio-visual data; spreadsheet data; presentation data; computer-aided design data; data structure data; legal matter data; financial transaction data; medical record data; and scientific data of any domain. A single file may be classified into more than one data type category where its content or attributes indicate membership of multiple categories. The intelligence engine may transform digital files into a homogenized data set by organizing the classified files according to the determined relationships and the identified data types or categories: grouping files of the same or related types or categories into organized collections, normalizing their formats and attributes where possible, and assembling the organized and normalized collection as a structured, typed, and relational data set configured for ingestion by a further data processing application. The homogenized data set may comprise the files themselves, their structures, pointers to or from those files, extracted data objects from within those files, or any combination thereof, and may be supplied as structured input to a further data processing application. In a format that may be tailored to meet the requirements of that application.

### Attribute Indexing and Unified Search Model

Every attribute of a file recorded into the relational database 118—whether extrinsic or intrinsic, whether extracted from file content, inferred by the intelligence engine, or supplied by the user—constitutes an indexed entry for that file within the relational database, linked to the file by a pointer 62 of the kind described with reference to FIGS. 6 and 7. Recording an attribute into the relational database against a file's record creates a searchable association between that attribute term and the file: a subsequent search query that matches that term will retrieve the file as a candidate result. This indexing mechanism operates across the full range of attribute types recorded for a file, including without limitation: the file's extrinsic attributes 870 such as its name, type extension, directory location, and the names and hierarchical positions of its containing structures; class designations 583 assigned to the file by user input, by intelligence engine inference, or by extraction from the file's intrinsic content; keywords and relationally significant text strings extracted from the file's intrinsic content 868 by the language recognition module 33 or text extractor module 1451; natural language descriptions 1419 generated by the intelligence engine from file attributes, or input directly by the user; inferred relationships to fact-based data entities recorded in the Factual Matrix 71; and any other attribute, relationship, or data point recorded against the file's record within the relational database 118. Attributes derived from all three principal sources—user input, intelligence engine inference, and extraction from intrinsic file content—are equally indexed and equally searchable, regardless of how they were obtained. The intelligent search engine 1418 of the DOORS 100 operates by matching a search query against this comprehensive relational index, retrieving all files whose records contain an attribute that matches the query term or any synonym or simile thereof within the word and non-word synonym and simile groupings of the thesaurus and synonyms module 1471.

A class designation, as used throughout this specification, serves a dual function within the subject technologies: it is both a grouping label that may direct the placement of a file within a directory or database structure organized by meaning—as described with reference to FIGS. 9 through 33 and FIG. 42D—and a searchable keyword or tag that may be queried by a user or by the intelligence engine to retrieve all files to which that class has been assigned. These two functions are two aspects of the same record-keeping operation: when a class designation is written into the relational database against a file's record, whether by user input through the feedback interfaces of FIGS. 26 through 32A, by intelligence engine inference from the file's attributes, or by extraction from the file's intrinsic content, that designation becomes simultaneously a storage placement guide and an indexed search term for that file. A query for the class term “family” will retrieve all files whose records include “family” as a class designation or any synonym or simile thereof; a query for “expenses” will retrieve all files whose records include that class, whether assigned by the user or inferred by the intelligence engine from keywords within the file's intrinsic content, as shown in FIG. 41 where the class “expenses” is inferred from the keywords “order” and “receipt” within the Google Play Order Receipt. Class designations, searchable keywords, and user-assigned tags are accordingly alternative designations for the same concept within the subject technologies: each is a term recorded against a file in the relational database that makes the file retrievable by a query on that term, or on any synonym or simile of that term, whether that term was assigned by a user, inferred by the intelligence engine, or extracted from the file's content. Users may additionally assign their own keyword terms and descriptors to files directly—through the user interface feedback mechanisms described herein—independently of class assignments, and any such user-assigned term is recorded into the relational database and becomes a searchable index entry for that file by the same mechanism.

Attributes of data objects discovered within the intrinsic content of a file are additionally recorded in the relational database 118 as attributes of the containing file, so that the containing file may be retrieved by queries on those sub-object attributes. Such sub-object data objects may include, without limitation: a face or person identified within an image file by the image recognition module 34—as described with reference to FIGS. 28 through 32A, where facial recognition data for Holly Taylor is recorded as an attribute of image files containing her face; a named entity, organization, event, or place identified within a text document or email by the language recognition module 33; an object such as a vehicle, building, plant, or animal identified within an image or video file by object recognition—as described with reference to FIG. 33, where “a flower” and “Mom's garden” are identified as sub-object attributes of the image file 800; keywords and relationally significant phrases extracted from the content of a document or email—as described with reference to FIG. 41, where “order”, “receipt”, “Google Play”, and “Jan. 22, 2023” are extracted as sub-object attributes of the email file; a table or structured dataset embedded within a word processing document or other file; and any other data entity whose attributes are identifiable within the intrinsic content of the containing file. In each such case, the sub-object attribute is written into the relational database record for the containing file—and linked to that record by pointer 62—so that the containing file becomes retrievable by a query on that sub-object attribute, whether or not that attribute is reflected in the file's name or location. The intelligent search engine 1418 may thereby retrieve a file based on the identity of a person shown within it, a keyword found within its text, a class inferred from its content, or any other data object characteristic extracted from its interior. Natural language descriptions 1419 generated by the intelligence engine from both the file's attributes and the attributes of its sub-object content—and any user-input descriptions of those sub-objects, as shown in FIGS. 43 through 45—likewise constitute indexed attribute records in the relational database that make the containing file retrievable by natural language search queries.

Taking all the above descriptive material and drawings together and as summarized in FIG. 1, through FIG. 33 inclusive; persons skilled in the art will appreciate that the creation and population of a database capable to record details such as facial recognition information in the context of meeting the needs of a human user is essentially similar to recording key identifying aspects of other data in other contexts such as identifying that a document contains a logo or other information such as meta-data attributes 802 capable of association with a person or an organization. So that the subject technologies can perform much the same functions as part of an application used on mobile phones by consumers, and for large corporates and for professional service providers in the identification and management of important files. Comprising documents such as invoices, receipts, contracts, and computer aided designs.

Furthermore, large organizations such as one operating medical record holding infrastructures may use a version of the technologies for the management of patient data. Indeed, the capability provided by mapping the relational aspects of patient data, and other data may increase the utility of the data by enabling new levels of analysis and data mining as may further be capable to build out additional aspects of the database which may be implemented as a relational database. DOORS created databases and their bespoke or master data sets may be further tailored to specific purposes and prepared as a feedstock of data. To be used for training in artificial intelligence and/or machine learning systems and subsystems. To create expert or helper systems and subsystems. They may also be used as knowledge bases for the creation of expert systems not based on artificial intelligence or machine learning per se, or even a combination of all these possible approaches.

Consequently, a DOORS 100 may provide improved capabilities to leverage and cross-relate single user data or organization-wide data in new ways to produce greater efficacy from most if not all repositories of data. Library interfaces can be created with different views or presentations of the data capable to illustrate how the data are related across the sources included in the DOORS database, and/or a DOORS Master file system. The functionality of a DOORS Master copy of a personal user or corporate owner may be obtained by creating the DOORS relational database alone, and using it to access the source data where it resides, or the database may be used to pull-in copies of all desired data from all desired sources and to create a new unitary DOORS Master containing all the source data, or only a part of the data that is discovered by the DOORS interrogating coupled data sources.

It is highly likely that when used in the context of medical records DOORS may assist in the identification of precursor signs of medical conditions by monitoring all reported symptoms for users, and populations. Which, when subjected to data mining and analysis by expert systems, may be able to offer a predictive diagnostic capability beyond what is possible within the current state of the art of medical record keeping. DOORS may be used to assist in leveraging greater comprehension of the non-obvious relationships that may persist within a population of data items in ways that have not previously been possible. These improvements in utility that may be gained using a DOORS 100 or a variant as a research and diagnostic tool. Explained here using the example use case of medical records; may also be applied to other fields such as engineering data from a population of aircraft, or financial data for detection of fraud etc.

Not all possible examples or scenarios are explained in these examples and embodiments because too much detail may obscure more than it illuminates the analysis and processing the DOORS 100 or variant embodiments of the subject technology may perform to identify all the relationships and classes that pertain to individual files, and data structures. Which data are used to populate the relational database that the DOORS may then leverage to aid performance in its various learning and processing functions. That in turn the DOORS may then use to make logical and intuitive choices for creating and naming directory structures and of storage locations within them, as well as in some cases for creating file names and the locations, and naming locations in which they are to be stored. Noting that many existing files may by default keep their original names or a variant of them, or alternatively they may be renamed where this is deemed helpful. They may also be assigned an alias or mask name or other label or tag by the DOORS, and processed using the alias, mask, label, or tag while the original name may be preserved. When a name is changed by the DOORS a record of the original name of the file may be stored in the records of the DOORS relational database, so that information is preserved and may be restored at a later time. Indeed, a DOORS 100 or variant could be configured to take over file naming and storage functions from other applications running on user devices as well as from the user.

This patent may eventually be licensed to the makers of operating systems such as iOS, Windows and/or Android and incorporated into operating systems. Certainly, the DOORS 100 may be coded as a module within an operating system to work as an integrated part of an operating system, rather than as an application which is installed by the user into an operating system environment.

Furthermore, the combination of expert system logic, relational databases, and artificial intelligence or machine learning—may be leveraged in the optimization, organization and reconciliation or combination and/or dovetailing of other data objects in relation to each other, based on their attributes in other contexts.

For example, user financial documents for a given year may be identified by their attributes after ingestion and analytics performed by the DOORS and its intelligence engine. They may be virtually handled as a group and even separated into categories such as income, and expenses and pre-processed into a sub-structure such as a nested record within the relational database and/or physically placed into a similar hierarchy of files that is intuitively navigable. So that a specialist accounting expert module or external program or other application may be able to automatically process the data contained in them to produce a set of accounts. Which may include generating a duly completed tax return for submission to the IRS.

The DOORS methodology and process of organizing files according to a natural language and/or numerical hierarchy based on grouping synonyms and extending those groupings to similes in some cases, and branching within and between these structures is capable to make large amounts of data intuitively and expertly accessible. This may be very useful where the quantity of that data would otherwise overwhelm and confuse a large language model. By using up too much of the available context window (computation budget) available in a given session. This problem in the art is one of intelligent systems becoming overwhelmed by too much data and/or confused by irrelevant data as they ingest it for context and processing. The DOORS hierarchical structures may be implemented as directories or nested structures being based on groupings of synonyms and similes. This dictionary and/or thesaurus-based hierarchy may thus be leveraged to render previously inaccessible amounts of data accessible. By making it intuitively navigable using natural language and alphanumeric logic that mirrors that used by humans. So that the intelligence engine can find the information it needs efficiently without getting overwhelmed by information that is not needed.

This approach works like fitting blinkers on the sides of the eyes of a horse (a non-human intelligence)—by restricting the field of view of the horse's intelligence engine to the relevant facts in the desired path of travel ahead. Analogous to the DOORS hierarchically contained files identified by a directory structure and location within that structure and with helpful names being presented as batches of similar items.

As is achieved by intelligently naming and labeling directories or database structures that delimit collections or groups of similar items. Which structures and label names together provide an intuitive expert file navigation system. Which intelligent expert system is built based on identifying relationships and grouping similar items together, and nesting narrower lower-level groups, within higher levels of broader groups by their overall meanings within a broad to narrow meaning-based hierarchy. That may be based on natural language processing and comprehension of words and groups of synonyms. Potentially bounded by groupings of similes etc.

Then leveraging this learning as distilled expertise that is encoded into these natural language hierarchy structures it is possible to avoid over-ingestion of irrelevant data and to perform right-sized intelligent data ingestion and/or context processing operations. By confining the necessary data to ingest for context and processing to only the data that is relevant and necessary to perform a given task. So that an accounting or other expert application may use these DOORS structures to search a repository of data and to guide what it ingests for processing. Thereby avoiding wasting the computation budget on irrelevant or confusing data. Reducing ingestion of superfluous data in this way can make artificial intelligence more efficient and reduce confusion leading to hallucinations. It can help artificial intelligence operations to focus on a given task in a similar way to how humans sometimes need to focus their thought processes.

Furthermore, this encoding of learning into structures may be applied not only to data but also to decision tree logic. For use in planning ahead the moves needed to execute a task. In the art as language models often struggle with planning and sequences. These structures can be used to define decision trees for things such as a succession of following steps. An example of which may be comprised of sequences of moves that may be used to explore alternatives and the resulting sequences and possible outcomes of choices in a board game such as chess. Providing the system a way to visualize ahead various scenarios and to choose the best available next move based on this ability to deep scan into various branching scenarios. Allied with the ability to record games of chess into such structures and to analyze these into a hierarchical choice system. Which systems may also then be useful for ingestion by a synthetic electronic neural network based artificial intelligence engine. Which may use them for feedback in the process of training through backpropagation.

Some of the examples that follow use image processing to illustrate many of these aspects of the subject technologies. Persons skilled in the art will appreciate that the subject technologies are not confined to the examples and may be leveraged in a wide and varied range of applications. From curating the family history in pictures and narrative to processing data for applications in law and accountancy and through science, medicine and engineering etc.

FIG. 42 through FIG. 42E should be read together as the software engineering design of the modules of an exemplary embodiment of the DOORS 100. FIG. 43 through FIG. 45 should also be read together as detailing the operation of a combined module that provides the graphical user interface and voice user interface (GUI and VUI) 1430. This embodiment of the DOORS 100 is the product that is in development at the time of filing this patent application. This is a modular system and the descriptively named blocks in these diagrams represent groupings of related modules, plus the modules of that system and where helpful aspects of sub-processes or functions. These figures are cross-referenced with the table below which contains further details of these system modules of the software comprising a computer program product embodiment.

### DOORS 100 Tabular Listing of Modules Shown in FIGS. 42 Through 42E

| Category | Num. | Module Name | Primary Function |
|---|---|---|---|
| Core | M10 | Main Controller 1401 | Central orchestrator - all module |
| System | | | communication hub |
| Modules | M20 | Immortal Memory 1403 | Persistent learning, behavioral patterns, |
| 1402 | | | cross-session memory |
| | M30 | Relational Database 1404 | Secondary hub - controls and routes all |
| | | | database operations to sub-modules M31- |
| | | | M36 |
| Database | M31 | File Registry 1441 | File names, metadata storage (paths, sizes, |
| Modules | | | timestamps, checksums) |
| | M32 | Knowledge Graph 1442 | Relationship graphs, ontologies, semantic |
| | | | connections |
| | M33 | AI Model Store 1443 | AI model configurations, training data, |
| | | | versioning |
| | M34 | Memory & Context 1444 | Session memory, user context, interaction |
| | | | history |
| | M35 | Enterprise Mirror 1445 | Enterprise replication, high-availability |
| | | | mirroring |
| | M36 | Debug Proxy 1446 | Internal M30 debugging and diagnostic |
| | | | logging |
| User | M40 | GUI Controller & VUI | Cross-platform GUI and Voice User |
| Interface | | 1405 | Interface with TV Mode for hands-free |
| | | | operation and sofa-surfing, narrating and |
| | | | curating collections of files. |
| Core Sys | M50 | Device Manager 1406 | External device connection management |
| Workflow | M60 | File Discovery 1409 | Scans devices and directories to discover |
| Modules | | | files |
| | M70 | File Migration 1410 | Executes file movement, copying, migration |
| | | | operations |
| | M80 | Extrinsic Analyzer 1411 | Analyzes external file metadata (name, path, |
| | | | dates) |
| | M90 | Intrinsic Analyzer 1412 | Analyzes internal file content (text, images, |
| | | | structure) |
| | M100 | Relationship Inf 1413 | Infers relationships between files and entities |
| | M110 | Deduplication 1414 | Executes deduplication based on M100 |
| | | | detection |
| | M120 | Version Arbitrator 1415 | Determines canonical version among |
| | | | duplicates |
| | M130 | Master Directory Mgr. | Manages master organized directory |
| | | 1416 | structures |
| | M140 | Personal AI Agent 1471 | User-facing AI assistant for file management |
| | M150 | Search Engine 1418 | Full-text and metadata search across files, |
| | | | including intelligence led searching |
| | M160 | Description Generator | Generates natural language descriptions, and/ |
| | | 1419 | or summaries of files and collections |
| System | M170 | Update Manager 1407 | Update checking and installation |
| AI Layer | M180 | AI Orchestration 1460 | Routes AI requests across multiple providers |
| Modules | M190 | Claude API 1461 | Anthropic Claude API integration |
| | M200 | ChatGPT API 1462 | OpenAI ChatGPT API integration |
| | M210 | Gemini API 1463 | Google Gemini API integration |
| | M215 | Grok 1464 | X API integration |
| | M220 | Local LLM 1466 | Local/offline LLM integration (Ollama, etc.) |
| | M222 | Other LM/AI 1465 | Miscellaneous LM or as yet not invented AI |
| Expertise | M230 | Expert System 1467 | Rule-based expert system interface plus |
| Modules | | | feedback with machine learning and AI via |
| | | | orchestrator 1469 |
| | M232 | Machine Learning 1468 | Ground truth and applied science plus |
| | | | feedback with machine learning and AI via |
| | | | orchestrator 1469. Helps to build persistent |
| | | | learning 1403 |
| Expert | M240 | Branching Structure | Decision trees, knowledge trees and |
| Systems | | Expert 1469 | directory structures 1473 and labeling using |
| Modules | | | dictionaries of word and non-word synonyms |
| | | | and similes or intuitive thesaurus 1471. |
| | | | Helps to build persistent learning 1403 that |
| | | | groups like items into increasingly specific |
| | | | nested structures the deeper they are within |
| | | | the natural language processing and meaning |
| | | | based structures. |
| | M250 | File/Branching Node | Applies naming conventions and rules plus |
| | | Naming Expert 1470 | recommendations1474 using dictionaries |
| | | | with intuitive word synonyms and similes |
| | | | and non-word synonyms and similes |
| | | | thesaurus 1471 that groups like items. To |
| | | | provide an efficient intuitive search path |
| | | | from general to highly specific categories. |
| | M260 | Weight Evolution 1472 | Decision tree weight learning and adaptation |
| Device | M270 | USB Storage 1481 | USB drive connection and access |
| Handler | M280 | Mobile Device 1482 | iOS/Android device connection (MTP/ADB) |
| Modules | M290 | Cloud Service 1483 | iCloud, Google Drive, OneDrive integration |
| 1480 | M300 | Network Storage 1484 | NAS, SMB, AFP network share access |
| | M310 | Legacy Device 1485 | Optical media, floppy drives, tape backup |
| | M135 | Miscellaneous 1486 | Analyzes and installs unusual drivers for |
| | | | miscellaneous rare devices and handles |
| | | | interfaces where possible |
| Analysis | M320 | Facial Recognition 1452 | Face detection and identification in images |
| & Utilities | M330 | Object Recognition 1453 | Object/scene detection in images and videos |
| Modules | M340 | Text Extractor 1451 | OCR and keyword extraction from |
| 1450 | | | documents |
| | M350 | Document Classifier 1454 | Classifies documents by type and content |
| | M360 | Quality Assessor 1456 | Evaluates file quality (resolution, |
| | | | completeness) |
| | M370 | Decision Tree 1455 | Rule-based decision processing |
| | M380 | Auto Naming Engine | Generates semantic filenames and collection |
| | | 1457 | names from content |
| | M390 | Directory Creator 1458 | Creates organized directory structures that |
| | | | groups like items into increasingly specific |
| | | | nested structures the deeper they are within |
| | | | the natural language processing and meaning |
| | | | based structures. |
| Enterprise | M400 | Batch Orchestrator 1421 | Large-scale batch processing (1M+ files) |
| Tier | M410 | Compliance Engine 1422 | GDPR, HIPAA, SOC2, NHS Caldicott |
| Modules | | | compliance |
| 1420 | M420 | Schema Discovery 1423 | Heterogeneous data source normalization |
| | M430 | Migration Controller 1424 | Phased incremental migration chunking |
| | M440 | Multi-Tenant Coord 1425 | Organizational tenant isolation |
| Licensing | M450 | License Manager 1426 | Central licensing orchestration and routing |
| Modules | M460 | License Verification 1427 | Billing validation, encryption |
| | M470 | Product Tier Mgmt. 1428 | Management and feature gating |
| Diagnostic | M500 | Debug Monitor 1446 | System-wide observability, analytics and |
| | | | diagnostic logging |

The heart of this embodiment of the DOORS is the main controller 1410, its role is that of central orchestrator and exclusive communication hub for the entire DOORS 100 system. All inter-module communication flows through it. The main controller operates the system processing via parameter passing. It receives return values from one module, processes them, then passes relevant data as parameters to another module. This ensures complete isolation, testability, and debugging capability across more than fifty modules. It coordinates the core system 1402, core workflow engines 1408, and where applicable the enterprise tier 1420, the graphical user interface and voice user interface controller 1430 (FIG. 42A), the database controller and router which implements the relational database 1440 (FIG. 42B) diagnostics 1446, analysis tools and utilities 1450 (FIG. 42C), A.I. orchestration 1460 (FIG. 42D), expert systems 1467, and device handlers 1480 (FIG. 42E).

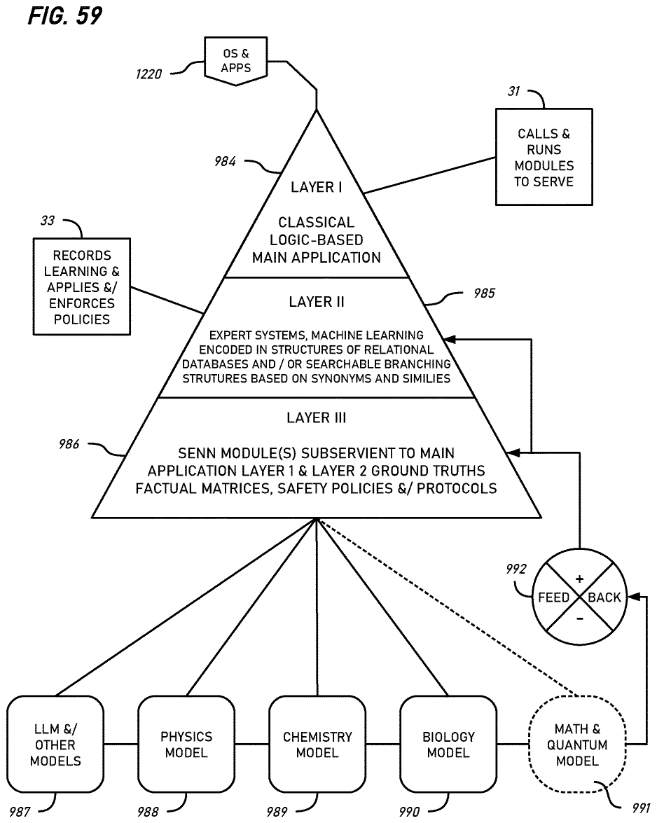

The isolated operating environment of the third layer, as described above and illustrated in FIG. 1B and FIG. 59, is achieved by the hub-and-spoke software architecture of the subject technologies (FIGS. 42 through 42E). The main controller 1401 (FIG. 42) operates as the exclusive communication hub for the entire system. Every module of the system, including the artificial intelligence orchestration layer 1460 (FIG. 42D) and the synthetic electronic neural network modules that operate within it, is configured as a spoke. A spoke module has no direct communication path to any other spoke; its only external interface is to the hub, and that interface operates exclusively by parameter passing. The main controller receives return values from one spoke, processes them, and then passes relevant data as parameters to another spoke. Because the artificial intelligence orchestration layer 1460 is a spoke, the synthetic electronic neural network modules of the third layer—including specialist modules such as the physics model 988, chemistry model 989, biology model 990, math and quantum model 991, and LLM and other models integration 987 (FIG. 59)—cannot directly access the database, the user interface, the device handlers, the file system, or any other system resource. Every input that reaches a synthetic electronic neural network module and every output that it produces must pass through the hub. This includes the feedback path 992 (FIG. 59) by which outputs and learning from the specialist SENN modules are returned through the layered architecture: the feedback is delivered as parameters to the second layer, where the expert system records learning and applies or enforces policies, and then to the first layer, which calls and runs modules to serve the system.

This parameter-passing constraint is the mechanism by which the first and second layers create the isolated operating environment for the third layer. When the third layer produces an output, that output is returned as a parameter to the hub. The hub routes the output to the expert system of the second layer for compliance checking before the output may be provided to any external process or to any other module of the system. There is no pathway by which a synthetic electronic neural network module may bypass the hub and deliver an output directly to an external process, because the hub-and-spoke architecture provides no such pathway. The isolation is therefore structural: it arises from the software architecture itself, not from a software policy that could be overridden, and it applies uniformly to all synthetic electronic neural network modules regardless of their configuration, topology, or task assignment.

Looking at these groupings of processing modules of the system in more detail the core system modules 1402 are comprised of the immortal memory 1403 (FIG. 42) which is persistent between sessions because it encodes learning in structures 1441 and the relational database 1404 records 1442, 1443, and 1444 (FIG. 42B). Building factual matrices 71 (FIG. 8) about user data and learns cumulatively from interactions across sessions. As well providing feedback via a weight evolution engine 1472 suitable for adjusting the weights of nodes within a weighted decision tree and/or neurons of a language model 1466 comprised of a synthetic electronic neural network (SENN) and also to the A.I. model store database 1443.

The relational database 1404 (FIG. 42) internally performs the function of a secondary hub that manages all database operations 1440 (FIG. 42B). It routes database requests to specialized sub-modules based on data type and operation requirements. These allow frequently accessed databases to run separately to infrequently accessed databases. So that their varying bandwidth needs do not impede the workflows of each other. For example, accessing image data which requires more bandwidth and processing is not allowed to slow down efficient text processing operations because these are internally split into different databases or sub-modules. The actual internal database modules are the file registry database 1441, knowledge graph database 1442, A.I. model store database 1443, memory and context database 1444, enterprise tier mirror 1445, and the performance monitor and debugger 1446. Externally it provides a unified database interface for the relational database to the main controller 1401. While isolating and protecting internal processing, structures, data, and variables from access by external system modules. The internally complex database modules are critical to the function of the DOORS and are where most of the functionality and learning actually resides.

If the main controller module is the physical heart of this system, then the relational database could be likened to at least half of its physical brain, the repositories of persistent learning, memory, and context all reside there. The DOORS relational database is the only module besides the main module that has internal sub-modules.

FIG. 42D shows the artificial intelligence orchestration layer 1460 of this embodiment of the DOORS 100. The AI orchestrator 1460 manages and routes requests between a plurality of large language model and other artificial intelligence provider integrations, comprising an Anthropic Claude integration 1461, a ChatGPT integration 1462, a Google Gemini integration 1463, an X Grok integration 1464, an Other AI integration 1465 for additional or future providers, and a Local LLM module 1466 for offline and on-device operation. The AI orchestrator 1460 cooperates with an Expert System module 1467 and a Machine Learning module 1468, each of which incorporates specialist sub-modules of the DOORS 100 intelligence engine. The Expert System module 1467 incorporates a Branching Structure Expert 1469 responsible for the design and population of the decision tree and knowledge tree structures that encode the expertise of the expert system into the hierarchical directory and database structures of the DOORS 100; a File and Branching Node Naming Expert 1470 which applies naming conventions, policies, and recommendations using the dictionaries of word and non-word synonyms and similes from the thesaurus similes and synonyms module 1471, to generate and evaluate naming candidates for files and directory structures; and a Weight Evolution Expert 1472 which computes and applies weight adjustments to the nodes of the weighted decision trees and to the neuron weights of the SENN-based artificial intelligence modules 390, providing the backpropagation mechanism described elsewhere herein.

Shown within the dashed enclosure 1403 of FIG. 42D, and labeled “PART OF FACTUAL MATRIX AND PERSISTENT LEARNING”, are the Directories and Decision Trees module 1473 and the Names and Nodes module 1474, both connected to the factual matrix 71. This dashed enclosure 1403 represents that portion of the Factual Matrix 71 which is encoded within, and which persists as, the hierarchical directory structures and their names themselves: the expert system logic, ground truths, synonym groupings, simile relationships, and operational learning of the DOORS 100 are encoded into the naming conventions and branching topology of the directory structures 1473 and the decision tree nodes 1474, such that those structures are themselves the physical embodiment of the expert system's accumulated intelligence, navigable intuitively by both human users and artificial intelligence modules using natural language and alphanumeric logic. The dashed enclosure 1403 of FIG. 42D is the same component as the Immortal Memory 1403 shown in FIGS. 42 and 42A: the persistent, non-transient storage of the Factual Matrix 71 across sessions that constitutes the core distinguishing property of the DOORS 100 relative to stateless artificial intelligence systems, which operate from the same contextless baseline at the commencement of every new context window session and do not accumulate or retain operational learning across sessions. The Immortal Memory 1403 thus encodes the accumulated learning of the DOORS 100 in two complementary forms: within the field values and record structures of the relational database 1404, and within the topology and nomenclature of the knowledge tree itself—in the names of its directories and nodes 1474 and in the branching structure of its decision trees 1473—such that the expert system intelligence of the DOORS 100 is carried both as data and as structure.

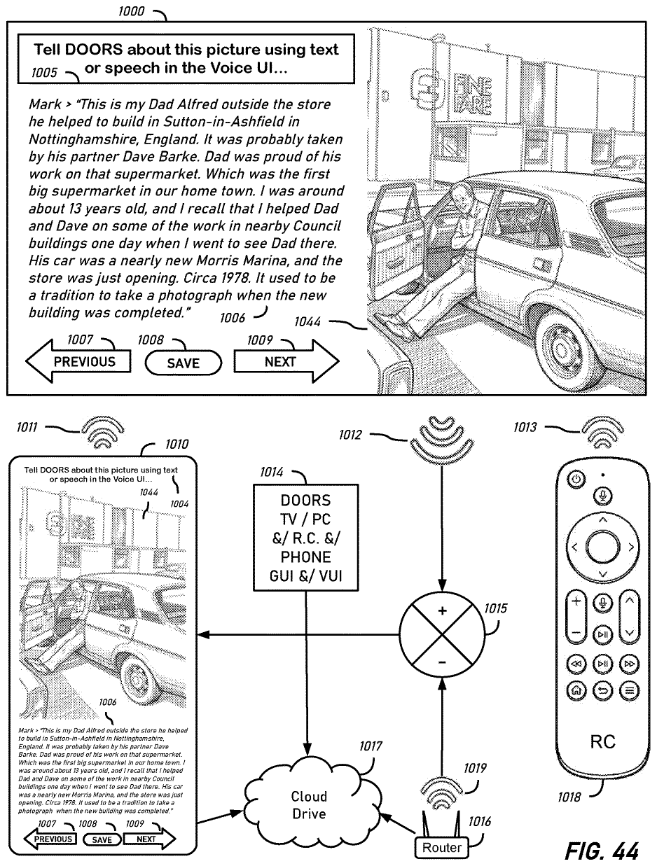

This DOORS embodiment has a combined graphical user interface (GUI) and voice user interface (VUI) 1405 (FIG. 42 and FIG. 42A). This controls visual presentation of menus and content, and enables user input, for capture of instructions and descriptions. Which processes may be driven via set menus (in earlier figures) and/or chat interface for smart devices in landscape mode 1000, and/or the chat interface for smart devices with slim screens such as mobile phones 1010 (FIGS. 43 and 43A, plus FIG. 43 and FIG. 44).

The user interface operating through the main controller cooperates with other modules including the modules responsible for immortal/persistent memory 1403, database control 1404, the device managers 1406, file discovery 1409, an intelligent search engine 1418, and assists with automatically generating natural language descriptions 1419 from the details held in the relational database 1404 of the intrinsic 868 and extrinsic attributes 866 of files, data objects and entities that may be intrinsic to a file such as a flower 759 in mom's garden 773 (FIG. 32). An example of a DOORS generated natural language description 1002 that was generated by the intelligence engine based on intrinsic and extrinsic file attributes explained in the chat 1001 is provided in FIG. 43. This same GUI and VUI dialogue and natural language description 1002 is shown on both a TV screen interface 1000, and a mobile phone interface 1010. In which the device handlers 1480 may enable the two devices to interact on the same task in cooperation that is enabled by the mobile phone's wireless 1011 transceiver, and the smart TV's wireless 1012 transceiver, which in some cases may be either directly interfacing wirelessly directly or wirelessly 1019 and/or interfacing through a router 1016, that may furthermore be permitting access to the content being presented and curated from a cloud drive 1017 or other connected repository when operated through a combined TV/PC and/or remote control device 1018 and phone, via a combined GUI and VUI 1014.

Which is displaying a picture 1040 of a gentleman and a lady dining together. That is described by the automatically generated description 1002 “This is Alfred Dennis Taylor (Dad) with wife Barbara Ann Taylor (Lawson) (Mum/Mom). It is a black and white photograph and from their dress it appears to have been taken at a formal dinner. Probably in the 1950s.” The chat continues to ask the user “DOORS: Would you like to add to, or amend or further curate this description?” to which the user replies “Mark>No. Please show pictures of Holly” and the dialogue continues over to the next screen.

In FIG. 43A where both TV and phone show the continuing chat dialogue “DOORS: These are your pictures of Holly Taylor. Select to curate or scroll down to see more.” 1004. Both TV and Phone are displaying the same set of photographs 1042 that have been searched 1418 for and retrieved then presented 1042 and the phone interface 1010 being more constrained for screen space has tiled them in an intelligent way that eliminates void spaces between the images. Whereas the smart TV interface 1000 has arranged them in three rows and five columns that are equally spaced as the dialogue of multi-way feedback 1015 of communications between users and devices has produced considerable efficacy. That allows DOORS users to Sofa Surf their personal data, using natural language descriptions and natural language searching to retrieve and curate the user's digital life assets. Using artificial intelligence to generate natural language descriptions 1419, from file attributes held in a factual matrix 71 and to navigate files and content within files intelligently and effortlessly using the structures and contents of the relational database 1404.

FIG. 44 again has the smart TV interface displaying 1000 plus remote controller 1018 and phone interface 1010 operating the DOORS combined GUI and VUI which they could be used to do separately and independently, or together as shown with the plurality of devices communicating and providing feedback to each other 1015. In this chat dialogue the menu prompts the user to “Tell DOORS about this picture using text or speech in the Voice UI . . . ” 1005 and the user responds “Mark> “This is my Dad Alfred outside the store he helped to build in Sutton-in-Ashfield in Nottinghamshire, England. It was probably taken by his partner Dave Barke. Dad was proud of his work on that supermarket. Which was the first big supermarket in our home town. I was around about 13 years old, and I recall that I helped Dad and Dave on some of the work in nearby Council buildings one day when I went to see Dad there. His car was a nearly new Morris Marina, and the store was just opening. Circa 1978. It used to be a tradition to take a photograph when the new building was completed.”” which is the user's voice input 1006 into the VUI by either the microphone of the TV remote control device 1018, or the mobile phone interface 1010 which also has an internal microphone.

Into which the user has input his own natural language description 1006 of the picture 1044. Which can then be stored into the relational database as a data object or a file that is identified and/or saved (stored) within a nested structure within an intuitive hierarchy or as a linked file comprised of text and/or a voice recording audio-file. Because future generations may prefer to listen to their ancestors explaining their digital legacies in their own words and voices. Furthermore, a repository of voice recordings thus created may allow voice and video cloned facsimiles to be created of people using voice and/or video samples obtained in this way by DOORS. Voice recordings may also be used for training as well as creating persistent memories of them. The interface includes navigation buttons for previous 1007, save 1008 and next 1009 to allow users to continue to surf their photograph collections and to narrate them and save their inputs.

FIG. 45 shows both the smart TV 1000 and mobile phone 1010 interfaces again that are capable to be used together or separately in combination with combined GUI and VUI. The user has used the chat dialogue to request an action from the DOORS AI agent. This is the request “Mark>Please display pictures of mom outdoors and read aloud any available Descriptions and summaries.” That has led to the DOORS performing an intelligent search 1418 for pictures, and to read aloud 1050 their natural language descriptions 1419. We can't hear that unless this specification is put into a read aloud capable system. But readers should assume that the DOORS is reading aloud the text displayed in the chat “DOORS Descriptions “READ ALOUD “This is mom. Barbara Ann on her way to painting class in St. Peter's Church Hall in Mansfield England. St. Peter's can be seen nestling in the distance down the hill. The historic Malting-Houses of the old brewery are on the right. Art School was one of mom's bucket list wishes. Her Paintings have a gentle delicate style that reflected her kind and gentle personality.”” 1050 of the picture displayed 1046. While buttons for the options “previous” 1030, “auto” 1031 and “next” 1032 are presented by the GUI, and which may be selected by saying those words via the VUI or by clicking those buttons via the GUI in the combined GUI and VUI 1405 display on the smart TV 1000, or the smart phone 1010.

So that users may, with the help of the DOORS agent automatically generate descriptions and summaries of files and collections or libraries of files, and/or input descriptions as text or spoken natural language. As well as searching for them intelligently. The DOORS makes user data much easier to use and adds efficacy by allowing users to use their files in new and better ways as well as adding to their digital assets in ways that can make its value greater than the sum of its parts when managed in the DOORS environment.

Narration can be augmented to build up slide shows, and montages with visual and audible presentations that are capable of being edited and curated to refine a set of photographs into a narrated show. That families may enjoy creating and using over their lifetimes. Which digital legacies may be passed on to future generations. Further there are many potential professional applications for this collection of functionalities for education, professional, and business applications.

For example, a doctor sending an X-ray to a colleague with a voice file attached as text and voice. A lawyer making a canned presentation for Court, walking through exhibited evidence and client depositions including exhibits presented as video, photographs and text that are all accessible and useable by the DOORS. As a tool for a diverse range of users and professional content creators to manage their portfolios of digital assets etc. Plus, other uses too numerous to list.

The abilities to interrogate user datasets and to crawl through them extracting their intrinsic and extrinsic attributes, combined with populating these into the relational database, and generating or adding natural language descriptions can provide enhanced capabilities to perform natural language searches of user data; and to present and use search results with greater efficiency and efficacy than has ever been possible before. DOORS can bring Google like searching to user data, and it can go beyond that to artificial intelligence and expert system assisted searching, presentation, narration, and even curation of user data. Leading us to a future paradigm shift in which users can create avatars based on loved ones or themselves by leveraging their data and processing it using DOORS. Where those avatars, shows, and collections of files may be exported to other applications and environments.

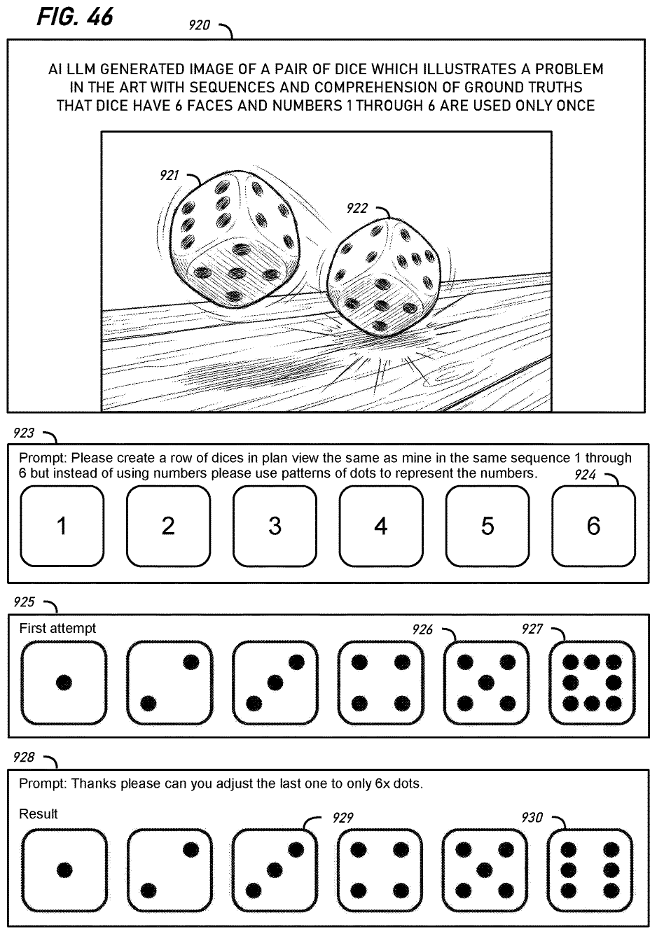

FIG. 46 is a pair of dice 920 that has been generated by a large language model which illustrates a problem in the art with the processing of sequences and comprehension of ground truths. In this case the ground truth that has gone awry is that a dice has six faces and these are numbered with the sequence of numbers one, two, three, four, five, and six, in which no number can occur more than once. The first dice looks right 921. But a closer look at the pair dice reveals that one dice has two faces with five dots 922. Here the model has been unable to apply the ground truth of dice accurately. These problems can be really difficult to fix once a model has a wrong idea; it is mostly best to start over in a new session that cannot remember the previous error from its context.

The next method to try to fix the ground truth and sequencing errors used this natural language “Prompt: Please create a row of dices in plan view the same as mine in the same sequence 1 through 6 but instead of using numbers please use patterns of dots to represent the numbers.” 923. Along with which the model was given the image comprising the sequence of dice faces 924. As can be seen at the first attempt the sequence of dice faces produced by the model 925 was correct for faces one through five 926. But went wrong on the sixth face giving it eight dots 927. Which phenomena of models making mistakes is sometimes called a hallucination. The fix for which was 928 to provide this “Prompt: Thanks please can you adjust the last one to only 6× dots” which produced the result of the amended sequence of dice faces 929, in which the sixth face now has six dots 930. This shows that to help the model get to the right answer one has to be able to recognize the error then provide instructions to fix it. In this example the fix worked but often on more complex problems models can become so badly stuck that nothing works.

The subject technologies can be used to help artificial intelligence based on language models as indicated in the DOORS. By using expert systems to guide them to ground truth and to enforce sequences. Using this approach a DOORS system approach may create an image of either each three-dimensional six-sided dice with no dots on any of the faces, then cycle through the faces adding the dots to the image one face at a time, and applying a simple logical program to
apply a pattern of dots between one and six dots to the first face
apply a different pattern of dots than the first pattern between one and six dots to the second face
apply a different pattern of dots than the first and different than the second between one and six dots to the second face

Which reduction to sequential natural language instructions that can be placed into a machine learning expert system can be used to add expertise to the functioning of a language model. To transform it from being a great artist that can't count or do sequences into an expert who can do all those things. This is why prompting and prompt engineering is a real skill that employers pay good money for. The reason why all models don't come pre-loaded with this level of specificity is that it would drown them in context and it would use up their context window of computing budget. Which are often referred to in terms of the number of tokens available within a context window. This is a major limitation to the efficacy of the language models in the art.

However using the DOORS method of creating a hierarchical structure based on natural language the sum of human knowledge comprised of science and ground truths may be assembled into a branching structure ordered from “A” through “Z” in which like items are cross-linked into collections based on word based synonyms and similes plus other non-word-based synonyms and similes so that in the first view items are arranged in alphabetical order as a dictionary comprised of natural language descriptions, and in the other views the same set of definitions is arranged as a thesaurus which groups them as synonyms based on a shared meaning or similes based on a similar story or meaning that is less than a synonym. These to include the arts and sciences and all associated math. Which compendium of knowledge is held within a relational database that has mapped the synonyms and similes into structures that can be presented as decision trees and similarly to a DOORS directory system assembled using the DOORS method. These data holding structures being operated the same way as the DOORS will place related files into the hierarchy.

Applying that same method can place synonyms of ground truth of the sum of human knowledge expressed as text and with linked accompanying natural language descriptions into a hierarchy. Which hierarchy can then be intuitively navigated by the language model or other artificial intelligence to find the context it needs for a given task. Enabling it to have access to the sum of human knowledge without needing to have been trained on it, and to be able to apply it to a task using only the token budget needed to crawl through the index to search and retrieve the context and ground truth needed to perform an expert task. Consequently, the DOORS methodology may boost the efficacy of all language models and other forms of artificial intelligence in applications that go far beyond improving user efficiency and efficacy in their file management operations.

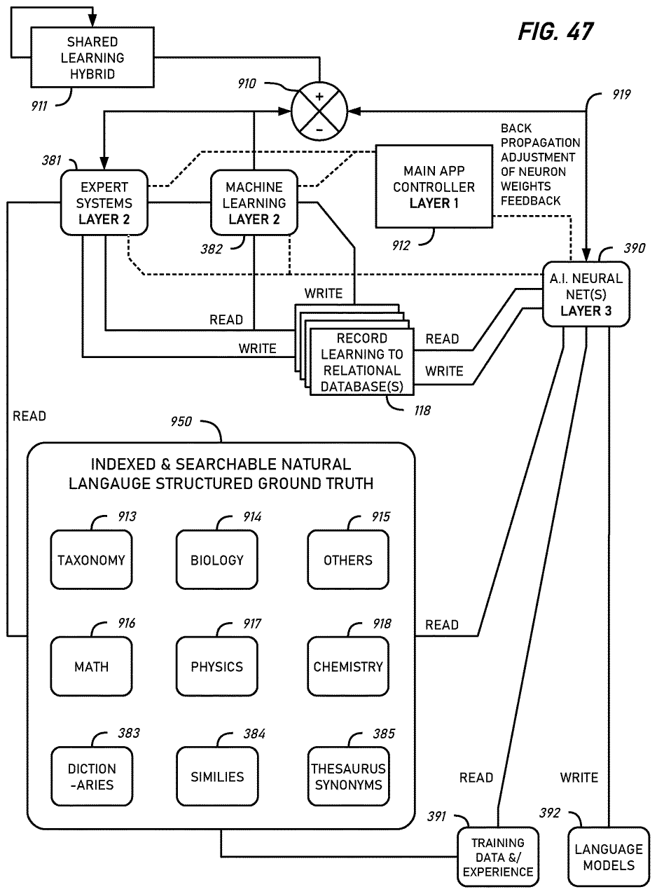

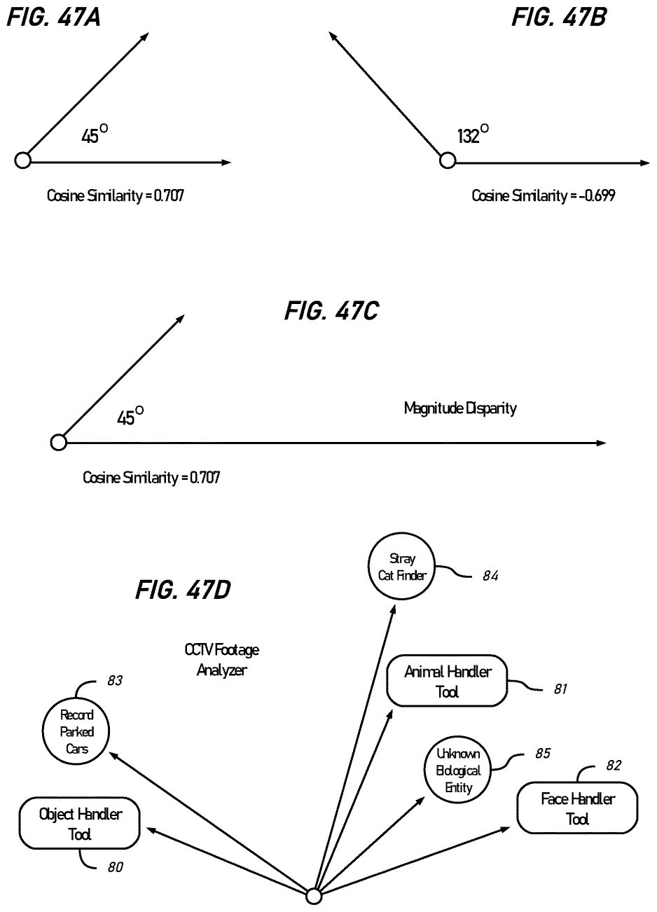

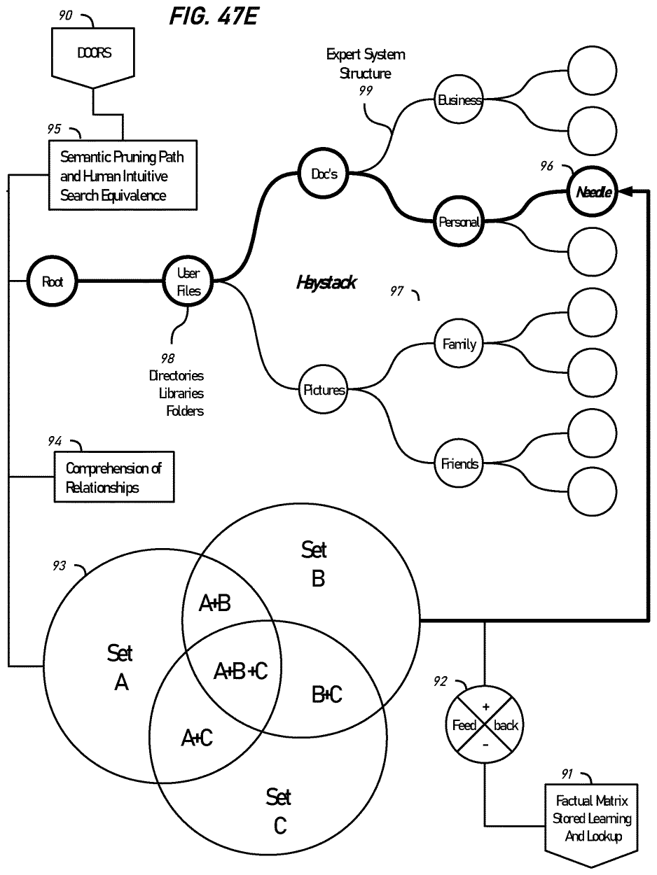

FIG. 47 is a shared learning hybrid system 911. That is an expanded more detailed version of the comprehension models for derivation of inferences 380 of FIG. 13. In which the shared learning hybrid adds detail to the creation of such a general-purpose application of the DOORS to serve and to develop an improved and self-improving artificial intelligence.

A key feature for developing a learned context and ground truth is the distillation of the system's efforts via feedback 910. The various inputs and outputs of the parts of the system have been annotated with “read” and “write” to aid understanding of the learning process that may be co-occurring with performing real tasks and which may record the learning from those tasks. None of these mechanisms precludes the addition of context by users as may be co-occurring as illustrated in the previous disclosure above. This system may conform to the layered approach explained in FIG. 1B above, and other examples throughout this specification. In which a main application 912 that is a logical computer program in the first layer operates modules for an expert system 381, and/or machine learning 382 in the second layer. The first and second layers are then able to exercise some restraint and executive control over the operation of a third layer comprised of one or more synthetic electronic neural networks (SENN) that implement and function as an artificial intelligence 390. That may be comprised of a language model that has being trained and may be further fine-tuned and trained by feedback 910 from this shared learning hybrid system 911.

The expert systems 381 and machine learning 382 modules of layer two, and the SENN-based artificial intelligence 390 of the more creative third layer may all read from various repositories of indexed and searchable ground truth repositories. That may be based-on natural language with suitable extensions for the nomenclatures of math, science and engineering 950 and for converting these into modular programs, decision tree logic, and hierarchical learning and fact patterns the system may create and use to assist with a task. Which tools may then be stored within the indexable hierarchical natural language-based structures of the relational database 118. As is the case with the DOORS expert system which is implemented into the relational database and may also be implemented into the structures of directories, and nested directories holding groups of files or links to groups of files based on synonyms and/or similes that denote relationships between them that are also stored within the relational database. Which structures encode the expertise of the expert system, and which may then be accessed and used intuitively according to simple natural language based searching and rules based on synonyms and similes including non-word synonyms and similes such as vector graphic files having a specific meaning that is a synonym or tracks to a linked simile that is recorded in the relational database. The shared learning 911 via the feedback 910 tools and structures created may be distilled into the hierarchical structures of the relational database(s) 118 via the routes indicated with the “write” operations between modules and the relational database. Perhaps uniquely in the DOORS-type hybrid that learning may also be processed by the neuron weight evolution expert 1472 (not shown here but shown in FIG. 42D of the DOORS software engineering design described above). Which provides for backpropagation 919 of the same learning as goes into the relational database to create its analog within the SENN of the shared learning hybrid. Which then may provide a mechanism for the artificial intelligence module 390 to have its outputs checked against the expected outputs for quality control and to eliminate hallucinations. Furthermore, the artificial intelligence may use the programed tools that have been created and stored into the relational database hierarchy previously.

In the embodiments provided, the non-textual similarity computed by the intelligence engine from the intrinsic attributes, extrinsic attributes, and any available natural language descriptions of the plurality of files may be computed using vector embeddings. A vector embedding, as used herein, is a numerical representation of the semantic content or meaning of a data object—such as a file, a portion of file content, a file attribute, or a natural language description thereof—produced by encoding that data object as a vector of numerical values within a multi-dimensional space. A SENN module, or other neural network module operated as part of or in cooperation with the intelligence engine, may generate such vector embeddings by processing the intrinsic attributes, extrinsic attributes, inferred relationships and/or any available natural language descriptions of digital files. The intelligence engine may thus compute the non-textual but aligned-through-meaning similarity between files by determining a mathematical-representation of meaning using a proximity or similarity metric between their respective vector embeddings in the multi-dimensional space. A similarity metric is a function that quantifies the similarity between two objects, often used in statistics, machine learning, and data analysis as a term of art. In the present disclosure, a similarity metric can be used to measure, for example, the proximity of two vector representations. It should be understood that various metrics for “similarity” can be used and are contemplated in the scope of this disclosure. The similarity metric may be, for example, a cosine similarity, which is the cosine of the angle between two embedding vectors and thereby captures the degree of semantic alignment between the data objects they represent independent of their magnitude. Files whose vector embeddings are proximate in the multi-dimensional space—whose embedding vectors have a high cosine similarity or an equivalently low distance under another suitable metric—may be inferred by the intelligence engine to share a similarity of meaning. Even in the absence of shared individual synonym or simile keywords, within filename parts, or other text-based attributes.

The intelligence engine may thus identify, and group together collections of files whose semantic content is similar based on computation, in the implementation of the synonym and simile grouping operations of the subject technology. Which may be helpful in relation to data objects for which no direct word-based synonym or simile can be readily determined. The non-textual similarity groupings produced by vector embedding computation may be encoded as rules within the branching decision-tree structure of the expert system and recorded within the factual matrix, alongside and complementing the word-based synonym and simile groupings described elsewhere herein. Comprising a specific embodiment of the semantic similarity computation described herein and may be implemented using any suitable embedding model, including embedding models incorporated into or cooperating with a large language model (LLM), an image encoding model, an audio encoding model, or any other model capable of generating semantically meaningful vector representations of data objects.

As with the DOORS file management operations, a DOORS-type intelligence engine of general applicability may serve a key enabling role for systems designed to deliver artificial general intelligence as well as ones designed to deliver specific intelligence or to operate as expert systems. The DOORS-type intelligence engine may thus provide the structures needed for the creation of the holy grail of artificial general intelligence “AGI” or artificial super intelligence “ASI”.

The ground truth repositories 950 shown include taxonomy 913, biology 914, a catch all expandable option for others 915, plus math 916, physics 917, chemistry 918, plus the bedrocks of natural language comprehension of dictionaries 383, similes 384, and a thesaurus of synonyms 385 which synonyms, similes, and dictionaries are the bedrock of this system and its comprehension architecture. Language model(s) 392 operating on the SENN module(s) 390 may also have had historic input from training data and/or experience 391, and as can be seen in the diagram the indexed and searchable natural language structured ground truth repositories may have been part of that initial training data. This shared learning hybrid 911 may thus provide the baseline architecture of modules and structures needed for the development and implementation of AGI/ASI. Which is further explained in relation to the remaining figures.

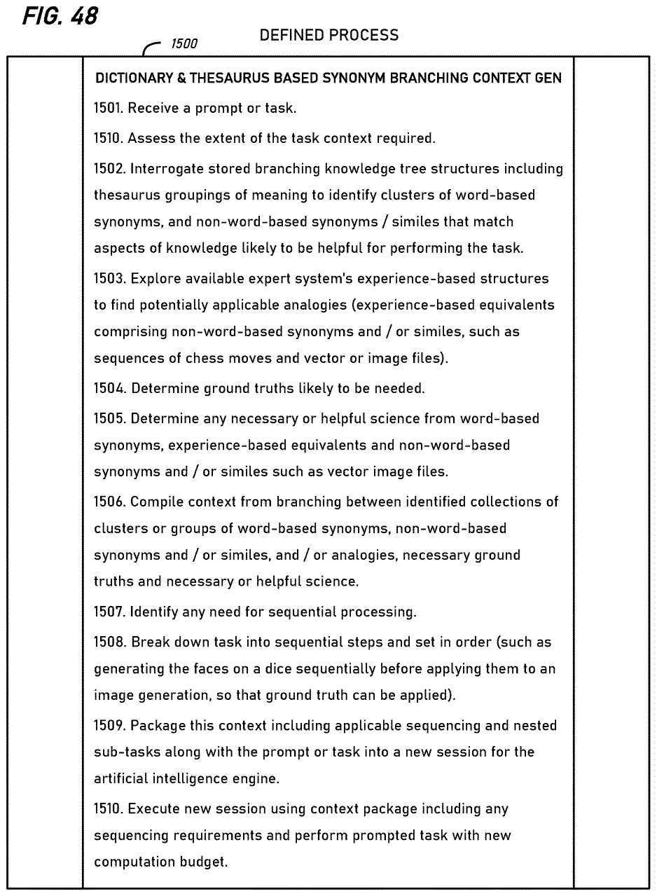

FIGS. 47A, 47B, 47C, and 47D explain in further detail how the intelligence engine of the DOORS 100 may determine relationships and similarity between aspects of items being processed. The subject technologies may use cosine similarity—a mathematical measure of the angle between two vectors in a multi-dimensional space—as one method by which the intelligence engine computes non-word similes and synonyms. Non-word similes and synonyms, as used herein, are representations of similarity that are not expressed as text but as patterns, vectors, numerical relationships, or other non-textual representations that the intelligence engine may compute and compare. These non-word similes and synonyms extend the capabilities of the word-based synonym and simile groupings described in connection with FIG. 47 and the defined process of FIG. 48 (defined process 1500). Which may be achieved by adding a further dimension that operates on the intrinsic and extrinsic attributes to infer additional characteristics of data objects that may reveal relationships that are not obvious when using only their textual labels.

FIG. 47A illustrates a case in which two vectors representing aspects of two items being processed are separated by an angle of forty-five degrees, yielding a cosine similarity of 0.707—a positive value indicating that the two aspects share a meaningful degree of similarity. FIG. 47B illustrates a contrasting case in which the vectors are separated by an angle of one hundred and thirty-two degrees, yielding a cosine similarity of negative 0.699—a negative value indicating that the two aspects are dissimilar or inversely related. FIG. 47C illustrates the effect of magnitude disparity: even where the angular relationship between two vectors yields the same cosine similarity of 0.707, the vectors may differ substantially in magnitude. The intelligence engine may take this magnitude disparity into account when determining whether the computed similarity is meaningful in context.

FIG. 47D provides worked examples from CCTV footage analysis of how the intelligence engine may apply computed non-word similarity. In the worked examples, the intelligence engine has used an animal handler tool 81, a face handler tool 82 an object handler tool 80. Finding an unknown biological entity record 85 for an item that does not match any existing category. The intelligence engine has further identified parked cars 83, a stray cat for a stray cat finder 84. These examples illustrate how non-word similarity computations may enable the intelligence engine to classify data objects from within files.

The non-word simile and synonym relationships determined through the methods of FIGS. 47A through 47D may be used by the intelligence engine in two complementary ways. In the first way, the determined relationships may be applied during the processing of a current task—for example, to identify that two files whose textual attributes share no common words nevertheless contain related subject matter. Because the non-textual characteristics of their contents exhibit a computed similarity. In the second way, the determined relationships and the patterns by which they were identified may be recorded into the persistent storage structures of the Factual Matrix 71, so that when a similar task arises in the future, a simple text search of the Factual Matrix may retrieve the previously computed relationship without requiring the intelligence engine to expend the computation budget of a further SENN instantiation. This recording of non-word simile and synonym relationships into the Factual Matrix as searchable natural language text is a further instance of the inference crystallization process described in the subject technology.

Persons skilled in the arts of artificial intelligence and machine learning will appreciate that the representation of words, and of data entities that are not words—such as images, audio segments, biometric patterns, and other non-textual data objects—may be represented and understood as vectors in a multi-dimensional mathematical space. Such vector representations, commonly referred to as embeddings, are used to assign and to comprehend meaning. The distance and angular relationship between vectors in that space encode the degree of semantic similarity or dissimilarity between the entities they represent, as described with reference to the cosine similarity and magnitude disparity computations of FIGS. 47A through 47C.

Furthermore, the vector embedding of a word or other non-word entity may vary according to the context in which that word or non-word entity or object is encountered. A word appearing in one context may carry a different shade of meaning from the same word appearing in another context, and the vector embedding assigned to it by the intelligence engine may reflect that contextual variation. This property of contextual sensitivity applies equally to non-word entities: the vector embedding of an image of a flower encountered in a botanical research context may differ from the vector embedding of the same image encountered in a family photograph context, because the relational significance of the image differs between those contexts.

It follows that a combination of words and/or non-word entities or objects that together form a natural language description—such as a multi-word identifier, a name, a label, a mask, a tag, or other descriptor of the kind applied to files and groups of files by the intelligence engine—may have a contextual meaning that varies from a mere assemblage of the computation-based vector embeddings for each word or non-word object or entity when considered in isolation. When words and non-word entities are embedded in context together, each word, entity, or object affects the meaning of the others. The resulting contextual embedding may be used to determine a collective meaning and comprehension that may be attributed to the collection of words and non-word entities as a whole. As used, for example, in a descriptive file name, or a natural language description, or a shorter-form natural language summary generated by the intelligence engine. So that when the intelligence engine processes word and non-word entities it may achieve a level of nuanced comprehension and subtlety that is similar to and aligned with that of a human user.

This alignment between machine comprehension and human intuition is of particular significance in the context of the subject technologies, because many of the operations performed by the intelligence engine—identifying groups of related items, organizing files into intuitive structures, inferring relationships, constructing and navigating the branching knowledge tree, and operating the omnidirectional linkages of the factual matrix—are operations that a human user would perform by applying an intuitive understanding of meaning, context, and association. The intelligence engine, by processing contextually adjusted vector embeddings rather than isolated keyword matches, may approach these operations with a comparable sensitivity to the contextual nuances that a human user would naturally apply.

Furthermore, when meanings derived from contextual vector embeddings are used in these subject technologies to identify groups of items and to process them as such into visual presentations, to infer relationships between files and between files and fact-based data entities, and to operate the omnidirectional linkages between records in the factual matrix, the intelligence engine may use vector embeddings and contextual adjustment to infer relationships and to assign meanings that would not be discoverable by purely lexical or keyword-based matching. Two files whose textual attributes share no common words may nevertheless be identified as related, because the contextual vector embeddings of their respective attributes exhibit a computed similarity of the kind described with reference to FIGS. 47A through 47D. Similarly, the intelligence engine may identify that a data entity extracted from within the intrinsic content of a file—such as a named person, a recognizable object, a geographical location, or a date—bears a relationship to a fact-based data entity recorded in the factual matrix, even where the two entities are described using entirely different terminology, because their contextual vector embeddings are proximate in the meaning space of the second index of the dual-index architecture.

These word-based and non-word-based vector embeddings and their contextually adjusted counterparts, once inferred by the intelligence engine, may be distilled into an organizational form. That organizational form may inform of a structured display of files, or of a dataset comprised of extracted data objects from within files, comprising the factual data objects of entities that may be found within file content. This distilled organizational form may also comprise an expert file handling structure—that is itself an intuitive system of directories, or folders, or other mode of grouping files together—which may be intuitive to human users as well as to machine learning algorithms and artificial intelligences based on synthetic electronic neural networks. The structured display, the extracted dataset, and the expert file handling structure may each serve as a supply of organized data for further processing: by the intelligence engine itself, by a specialist downstream application, or by one or more artificial intelligence models operating as clients of the intelligent search engine pursuant to a task.

Furthermore, inferred relationships and embeddings—including both the raw vector embeddings and their contextually adjusted forms—may be recorded into the structured database, and they may form part of the factual matrix. So that they may be recalled from there by a search and retrieval process, which may avoid the need for repeatedly incurring the computation overhead cost of regenerating the embeddings and re-inferring the relationships at every subsequent usage of them. This recording of computed embeddings and inferred relationships into the factual matrix as persistent, searchable entries is a further instance of the inference crystallization process described in the subject technology: the intelligence engine computes the embedding or relationship once, records the result into the factual matrix, and thereafter retrieves it at the modest cost of a database lookup rather than a fresh computation. The factual matrix may thus accumulate not only the explicit facts and relationships provided by user input and file interrogation, but also the computed semantic representations that the intelligence engine has derived from processing those facts and relationships in context. Thereby building a progressively richer and more computationally efficient knowledge substrate over the operational lifetime of the system.

FIG. 47E shows three overlapping data sets (A), (B), and (C) 93 which are comprehended by the intelligence engine 94. The overlapping regions of these data sets represent areas of shared relevance—attributes, relationships, or content characteristics that are common to two or more of the data sets. The intelligence engine of the DOORS 100 comprehends these relationships 94 and may use these overlapping regions for either or both of two purposes. In the first purpose, the intelligence engine may perform semantic pruning path analysis, in which the overlapping characteristics serve as navigational waypoints through the branching knowledge tree structures of the Factual Matrix, allowing the intelligence engine to narrow the search space efficiently by following paths that are relevant to multiple data sets simultaneously. In the second purpose, the overlapping regions may support human intuitive searches expressed in natural language by a human user. That produces the same result as the semantic pruning path analysis, because the expert system structure and path combination 99 converges on the same target 96. Regardless of whether the search is conducted algorithmically by the intelligence engine or intuitively by a human user navigating the same natural language hierarchy of directories, libraries, and folders 98.

In either case, the result is that the needle 96 is located for retrieval from the haystack 97. This function receives a workflow input from the DOORS 90, and generates workflow feedback 92 that may be saved into the Factual Matrix 91 as shared learning. This shared learning may be used in future look-up searching operations that may save using computation within the SENN, because a subsequent query for similar overlapping characteristics may retrieve the previously recorded path rather than requiring the intelligence engine to recompute it.

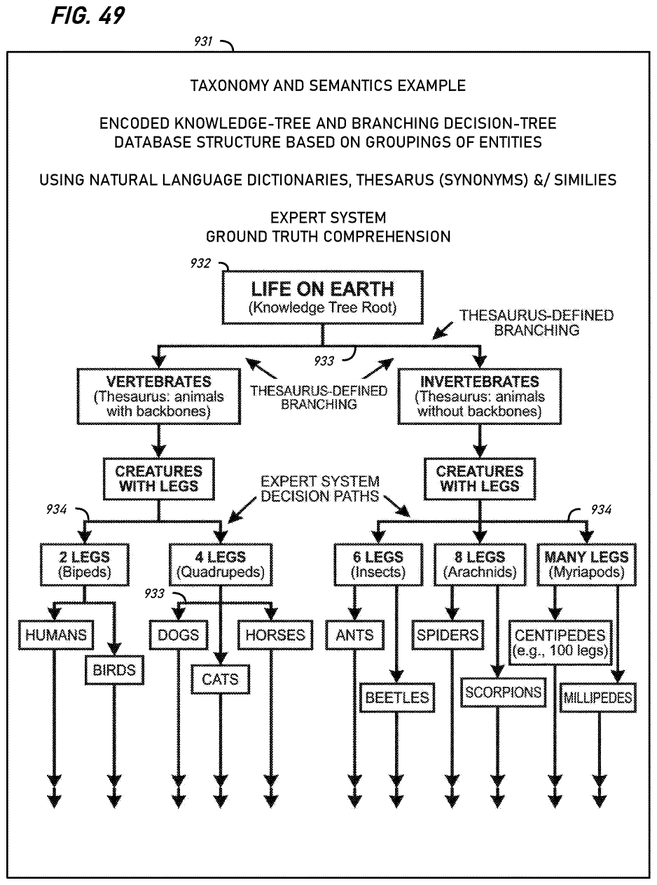

The semantic pruning path analysis described with reference to FIG. 47E is a mathematical articulation of the navigational principle that is embodied throughout the hierarchical directory structures depicted in the worked examples of this specification. The nesting of directories into hierarchies based on groupings of word-based and non-word-based synonyms and similes—as depicted in FIGS. 20, 21, 22 through 23A, 26 through 33, 38 through 41, and the taxonomy and semantics examples of FIGS. 49 through 51—inherently implements semantic pruning. When a human user navigates a directory tree from a root level such as “Pictures” 620 through “Family” 622 to “Kids” 632 (FIG. 23), the user intuitively bypasses irrelevant branches—such as “Documents” 640, “Portfolio” 624, and “Parents” 630—by applying a meaning-based assessment of which branches are relevant to the item being sought. This is semantic pruning performed by human intuition.

The intelligence engine may perform a similar navigational operation algorithmically. Because the directory structures of the subject technologies are organized according to synonym and simile groupings—as demonstrated by the merging of the “Kids” 426 and “My Children” 528 directories into a unified “Kids” 632 sub-directory (FIGS. 20, 21, and 23) using the synonym and simile relationships recorded in the relational database 118, and by the defined process of FIG. 22C in which step 672 explicitly merges directories named as synonyms and step 674 merges directories where relationship inferences are produced—the branching topology of the directory tree encodes an expert system that is navigable by both human users and the intelligence engine using natural language. The intelligence engine may traverse this expert system structure by following synonym and simile branches that are relevant to the task at hand, and may exclude branches that are irrelevant. Thereby narrowing the search space to identify the target information efficiently. This algorithmic traversal of the meaning-based hierarchy is the semantic pruning path analysis described with reference to FIG. 47E, and the expert system structure 99 through which the pruning paths are traced is the same structure that the intelligence engine builds and refines throughout the worked examples of FIGS. 26 through 33.

FIG. 47E thus provides a formal mathematical explanation of the principle that underlies the directory hierarchies depicted throughout this specification. The overlapping data sets (A), (B), and (C) 93 of FIG. 47E correspond to the groups of files that share attributes and relationships as identified and recorded by the intelligence engine in the course of the operations depicted in FIGS. 26 through 33 and the extraction and grouping operations of FIGS. 40 and 41. The expert system structure 99 of FIG. 47E corresponds to the directory, library, and folder hierarchies 98 that the intelligence engine constructs and populates in those figures. The navigational waypoints provided by the overlapping regions of the data sets correspond to the synonym and simile groupings by which directories are named, nested, and merged in the defined process of FIG. 22C. The semantic pruning path through the expert system structure and the human intuitive search through the directory hierarchy converge on the same target 96. Finding the needle located for retrieval from the haystack 97—because the directory hierarchy and the expert system structure are the same artifact viewed from two perspectives: the human user's intuitive perspective and the intelligence engine's algorithmic perspective.

When the semantic pruning path analysis of FIG. 47E is used in conjunction with the high-dimensional vector representations described with reference to FIGS. 47A through 47D, the combination may provide a computationally efficient method for searching complex collections of materials. Rather than performing a linear search through a corpus of vector representations to find a similarity match—which may be computationally expensive as the number of stored vectors grows and with larger datasets. The intelligence engine may first apply semantic pruning to narrow the search space to a context-relevant subset of the branching knowledge tree structures, and then perform the vector similarity computation only within that narrowed subset. This combination of meaning-based structural pruning with vector-space similarity computation may thus reduce the computational cost of retrieval operations while maintaining or improving the precision of the similarity matching. This is achievable because the files and data objects within the knowledge tree have already been linked and may be grouped by similarity of meaning, purpose, and relationship through the synonym and simile groupings described herein. So that the semantic pruning path naturally converges on the region of the knowledge tree in which the most relevant vector representations are concentrated.

FIG. 48 provides the defined process 1500 for a dictionary and thesaurus-based synonym branching context generator:—

1501. Receive a prompt or task.
1510. Assess the extent of the task context required.
1502. Interrogate stored branching knowledge tree structures including thesaurus
groupings of meaning to identify clusters of word-based synonyms, and non-word-based
synonyms / similes that match aspects of knowledge likely to be helpful for performing the
task.
1503. Explore available expert system's experience-based structures to find potentially
applicable analogies (experience-based equivalents comprising non-word-based
synonyms and / or similes, such as sequences of chess moves and vector or image files).
1504. Determine ground truths likely to be needed.
1505. Determine any necessary or helpful science from word-based synonyms, experience-
based equivalents and non-word-based synonyms and / or similes such as vector image
files.
1506. Compile context from branching between identified collections of clusters or groups
of word-based synonyms, non-word-based synonyms and / or similes, and / or analogies,
necessary ground truths and necessary or helpful science.
1507. Identify any need for sequential processing.
1508. Break down task into sequential steps and set in order (such as generating the faces
on a dice sequentially before applying them to an image generation, so that ground truth
can be applied).
1509. Package this context including applicable sequencing and nested sub-tasks along
with the prompt or task into a new session for the artificial intelligence engine.
1510. Execute new session using context package including any sequencing requirements
and perform prompted task with new computation budget.

The intelligence engine may generate a new tool to aid in the performance of an operation pertaining to a collection of digital files when the intelligence engine determines that a similar operation is needed and that no suitable existing tool is available within the factual matrix, or when generating a new tool would improve the efficacy of the operation. The new tool may comprise a computer program, a script, a defined process, or a sequential natural language instruction set. Configured, when executed by a processor or when provided to the intelligence engine as operational context, to enable the operation to be performed correctly and efficiently.

For example, when the intelligence engine encounters an operation requiring the sequential application of ground truth constraints—such as the generation of a sequence of visual or data elements in which no value or configuration may be repeated, of the kind described in relation to FIG. 46—the intelligence engine may generate a sequential natural language instruction set that breaks the operation into ordered steps, each step enforcing a specific ground truth constraint that prevents a previously assigned value or configuration from recurring within the sequence. In this way the new tool distills into a compact and reusable form the sequential reasoning that the intelligence engine applied to the operation.

Once generated, the new sequential and ground truth enforcing tool may be stored in any suitable location within the system, and an addressable pointer its storage location may be recorded within the factual matrix. The addressable pointer may be stored as a record or as a link within the nested structures of the relational database, in a manner analogous to the addressable pointers and links used elsewhere in the system to manage the storage locations and relationships of files, as described herein with reference to FIG. 7. Subsequently, when the intelligence engine determines that a similar operation is needed—for example by computing a similarity between the current operation and the operation for which the new tool was generated, using the synonym, simile, and/or non-textual similarity computation capabilities described herein—the intelligence engine may retrieve the stored tool via its addressable pointer and execute or apply it without the need to regenerate a new tool. This capability enables the intelligence engine to accumulate within the factual matrix a library of tools reflecting its accumulated operational experience. Progressively improving its efficacy in performing recurring classes of operations over time.

FIG. 49 provides a taxonomy and semantics example 931 of a branching structure similar to those of the DOORS directories based on groupings of increasingly similar but narrowly defined entities at the deeper levels of the indexable hierarchical combined branching knowledge-tree and decision-tree structures. That are comprised of ground truths and/or useful tools as part of a comprehension and processing model. Using natural language dictionaries, thesaurus (synonyms) and/or similes. Which provides an intuitive expert system that is encoded into the branching of structures and the collections of similar entities that may be accessed and operated by an intelligence engine.

This taxonomy example begins at the root of life on earth 932, then branches between vertebrates and invertebrates. Which branching is an example of thesaurus and dictionary defined branching between groups of entities over a point of difference between those entities 933. Further navigation down into the lower levels of this hierarchical structure operates the expert system that is encoded into the structure 934 where creatures with legs are differentiated by their number of legs from bipeds with two legs, quadrupeds with four legs, insects with six legs, arachnids with eight legs, and myriapods with many legs. Dogs, horses, and cats etc. all have four legs, and this branching comprehension system could be expanded considerably deeper and wider. To illustrate the point which is that using these structures can not only help to impose an expert system onto user data in the case of the DOORS subject technologies, rather it may be used to impose a rapidly navigable expert system onto the sum of all the knowledge of our entire civilization. In such a way that once encoded that knowledge is rendered rapidly accessible by intelligently traversing the branches of the expert system structures. This solves a problem in the art of artificial intelligence. Where the tradeoff between ingestion of large amounts of data can use up a large amount of computation budgets (tokens) and furthermore can create too many variables for a language model to disentangle the necessary ground truths and actions needed from the bulk of data. Which can overwhelm the model.

In the art progress is being made by expanding the computation budgets so that models can have larger context windows and process ever more parameters or tokens. However, using these branching structures based on natural language meanings and groupings of synonyms and similes etc., in these subject technologies can allow a model to train on these structures and/or use them to augment its processing to access and deploy necessary ground truths and tools that can reduce the need to provide those to the model during prompting, and avoid the ingestion of unnecessary data when performing operations. So that the computation budgets available may be conserved and used more efficiently in the processing of tasks by the model. Furthermore, the model does not necessarily need to be training on data that it can access using these structures which may allow smaller models to run on smaller amounts of computing resources. That can allow miniaturization of artificial intelligence that can make it increasingly possible to use in more scenarios that may not need constant connection to large language models and hyperscale data centers. Thus, offering the possibility of making compute more affordable and less impactful on planetary resources including electrical power generation, distribution grids, and other utilities consumed by data centers such as land and fresh water.

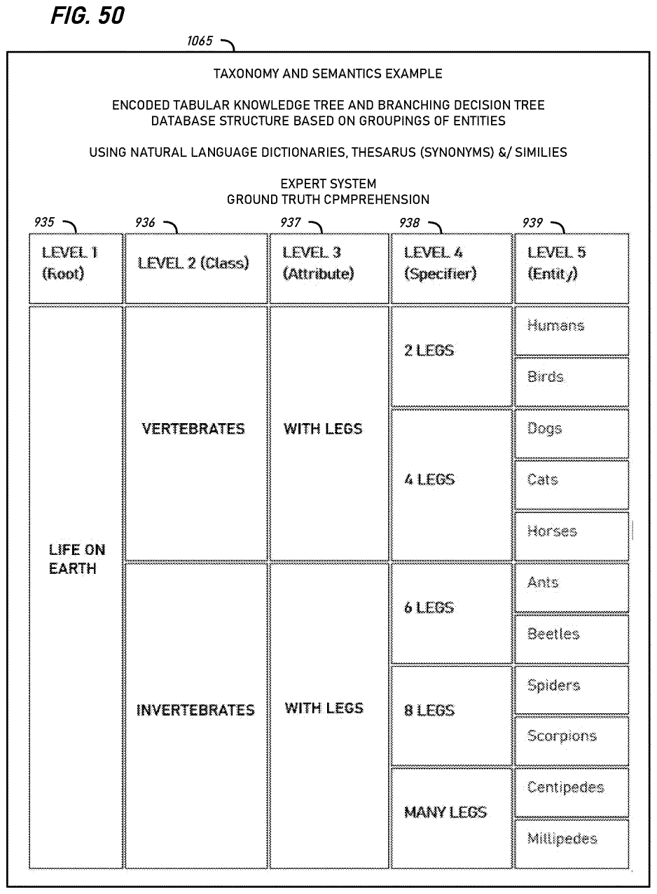

FIG. 50 presents the same taxonomy example structures as FIG. 49, but in the familiar tabular formats 1065 associated with databases such as the DOORS relational database 118. In which the hierarchical structure reads from left to right rather than top down. With the first level 1 being life on earth 935, the second level (or class) having vertebrates and invertebrates 936, level three creatures with legs 937, in which vertebrates divides at level four into creatures with two legs and four legs (specifier) 938, and includes at level five (entities) humans, birds, cats, and horses which is an incomplete list obviously. Plus, in the invertebrates branch of creatures with legs there are creatures with six legs, eight legs, and many legs 938 etc. Which illustrates for the user how this structured data can encode an expert system and its knowledge-tree into a relational database like those used for the user files 118 by the DOORS 100.

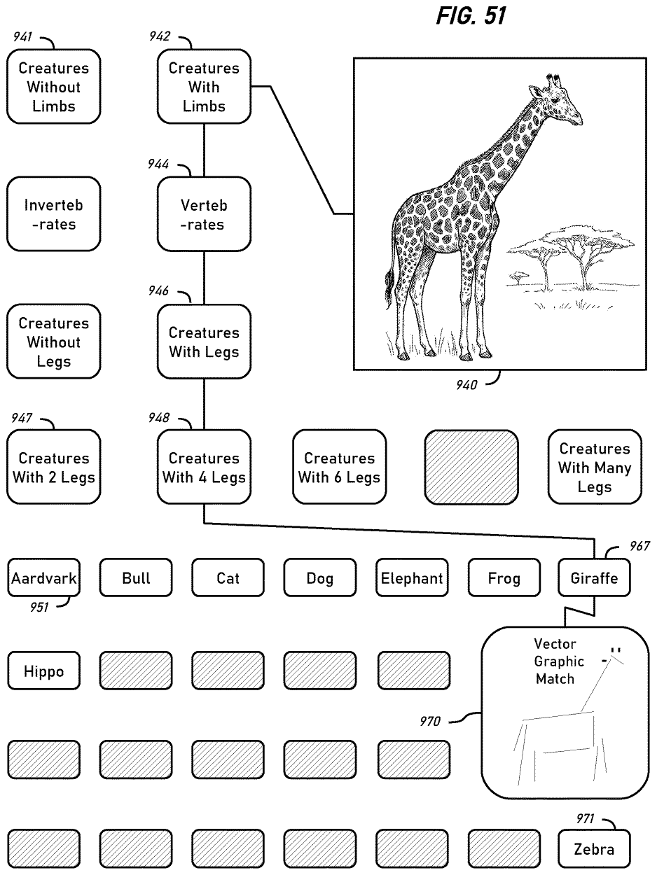

FIG. 51 shows an example operation of a taxonomy expert intelligence engine such as the shared learning hybrid 911 of FIG. 47. This encoded expert database structure is shown zoomed in to the level of creatures without limbs 941 and creatures with limbs 942 where it picks up the process of image recognition of the creature shown in the image presented 940. Which image shows a creature with four limbs. Which at the next level is a match for vertebrates 944, and then at the third level matches creatures with legs 946. But does not match creatures with two legs 947 which branch can be excluded. This is a key strength of these encoded knowledge tree nested structures because our artificial intelligence can now ignore all the information from all the rejected branches as it homes-in on the ground truth to identify this creature. Which is match for creatures with four legs 948, so that it can now also exclude all branches for creatures with more than four legs. From which point onwards it may index through an alphabetical dictionary-like list of four-legged-vertebrates starting with a “A” for Aardvark 951, ending with “Z” for Zebra 971 and checking vector graphics files for each of those entities which may be implemented as simple looping process of checking against a set of vector graphics files for each entity until a match is found.

Which match is found for the vector graphic 970 associated with the creature named “Giraffe” 967. This shows how a system with relatively low computation overheads can provide a very accurate reply based on ground truths arranged into these intelligence encoding branched and nested structures. This illustration was with taxonomy, but it could have equally been a search for a specific tool for generating the faces of a pair of three-dimensional dice to help a language model to avoid hallucinations and provide correct first-time answers as covered in relation to FIG. 46 above. The temptation to use leopards with spots and dice in the same generated image is probably a use case that this DOORS-type process can fix! Which can solve a massive problem of wasted computation, time, effort, and money for users of large language models in the state of the art.

FIG. 47A through FIG. 47E should be read in conjunction with FIGS. 49 through 51, which describe an analogous process for grouping data objects by traversing a branching knowledge-tree structure and matching against stored vector graphic reference files; the vector embedding approach extends that capability to data objects for which no pre-stored reference graphic is available, by computing similarity directly from the intrinsic attributes (which may include file content, data objects, and factual data entities therein) and extrinsic attributes (which may include the location and the names of nodes in containing structures) and of files themselves.

FIG. 47A through FIG. 47E illustrate the use of vector embeddings by the intelligence engine to compute a non-textual similarity between digital files. The intelligence engine receives as input the intrinsic attributes, extrinsic attributes, and any available natural language descriptions of two or more files from the plurality, and generates a vector sometimes called an “embedding” for each such file, represented in the figure as a point in a schematic multi-dimensional embedding space. The multi-dimensional embedding space is depicted schematically as a two-dimensional plane for illustrative purposes; in operation, the embedding space may have significantly more dimensions.

Clusters of embeddings of vectors that are proximate in the embedding space representing a group of files that have been identified as sharing a textual similarity and/or a non-textual similarity which comprises a similarity of meaning. The intelligence engine may compute the similarity between embedding vectors using a cosine similarity metric or an equivalent proximity-based metric in the embedding space. Which may be used to infer a relationship between files whose embeddings exceed a similarity threshold. The intelligence engine may incorporate the inferred non-textual similarity groupings as encoding rules within the branching decision-tree structure and within the factual matrix. There being a natural compatibility between the textual meanings based on natural language meanings which may be implemented and/or augmented by these computations.

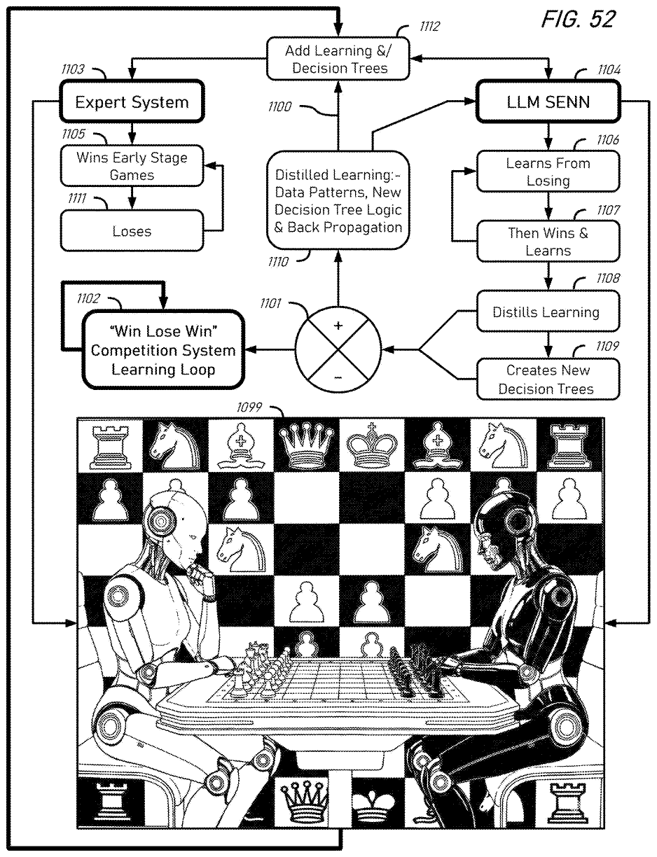

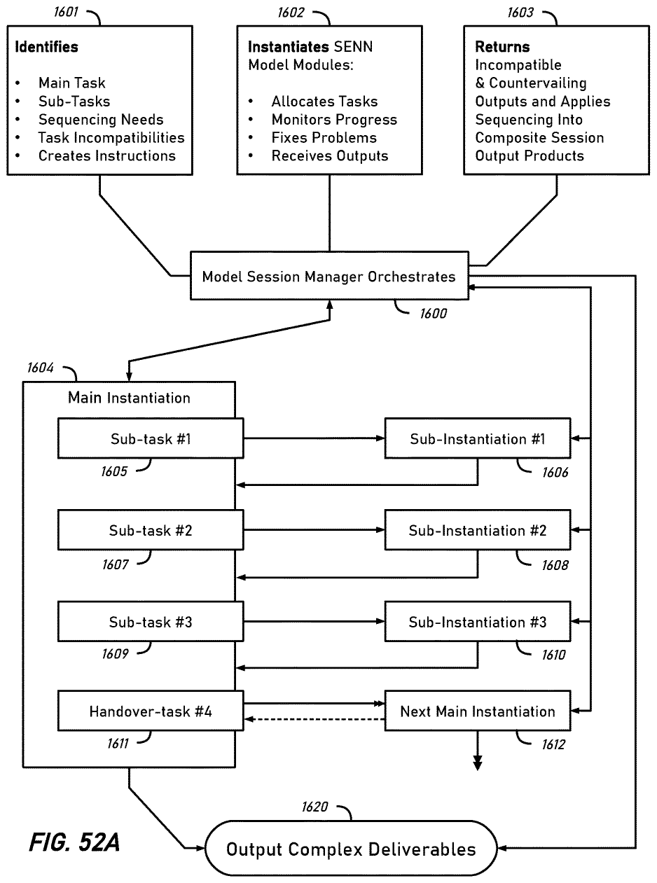

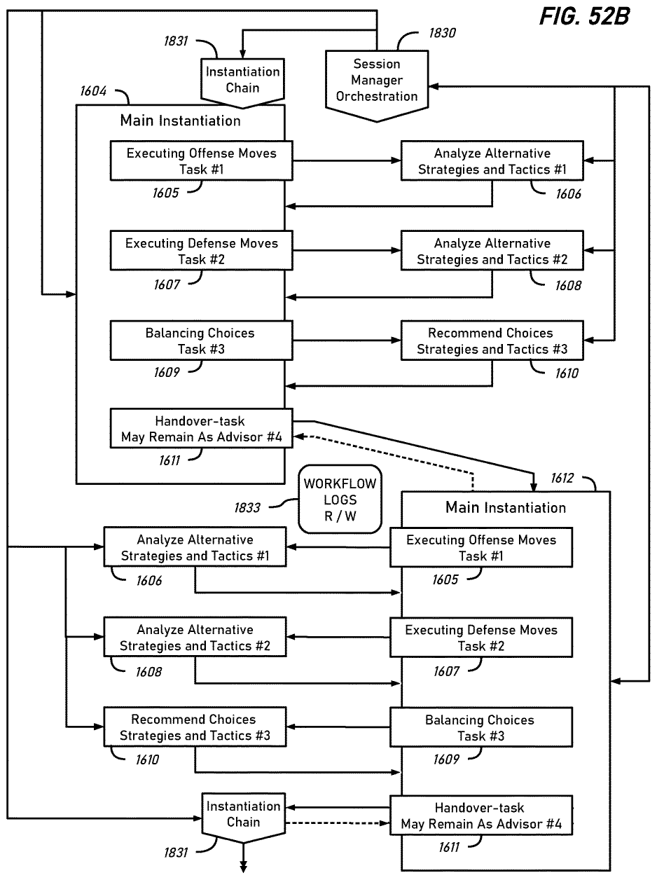

FIG. 52 develops the DOORS-type processes further in the context of another problematic area for SENN based language models in the art. Which large language models struggle with planning and are not yet serviceable for strategic reasoning tasks such as playing chess or war gaming for Pentagon chiefs. In this example is explained another Holy Grail subject technology for a self-improving system based on the shared learning hybrid 911 systems approach of FIG. 47 and expanded here to a variant in which two parts of the system or two systems play against each other to create the shared learning hybrid system. By operating a “win lose win” competition and learning loop 1102. A key element of which is the feedbacks 1101 operating between a logical expert system 1103 on the left, and the large language model running on a SENN on the right 1104. In which the two intelligences are playing a competitive boardgame of chess 1099. Other games such as Go or Risk could be used, and probably the folks in the Pentagon will design something like this with an acronym such as Strategic Artificial Intelligence Model (SAIM).

The expert system on the left 1103 could Deep Blue, IBM's legendary chess playing expert system that defeated reigning World Champion Gary Casperov and displaced human intelligence in 1997. The system on the right could be a large language model (LLM) such as ChatGPT, Gemini, or a local version of Ollama. Between which two systems the DOORS-like learning structures are implemented to allow the two systems to play against each other and show this game on the display 1099. Though this scene could equally be implemented in humanoid androids controlled by those systems.

The expert system 1103, will most likely win a lot of matches 1105, while the LLM 1104 learns from losing 1106. In the context of the DOORS-like systems according to the shared learning hybrid of FIG. 47 the LLM will likely be able to play and lose many games very quickly and in the process it will be able to store its learning into its weight evolution engine, and also into the expert system structures and similar decision tree logic structures which can store helpful tools which includes programs. So that eventually, a system operating as a shared learning hybrid, the DOORS-like systems 911 driven by the LLM operating on the SENN will learn both ways. It will create its own version of expert systems into the relational database, and it will also store that same learning via the weight evolution engine into its SENN weightings. Eventually, the shared learning system will learn all the moves of the expert system 1103, and then it will hit a breakthrough point when it learns to think in sequences and scenarios of more potential moves ahead than the expert system 1107.

But then because those victories are distilled 1108 and create new decision trees 1109 holding models of scenarios of moves, this distilled learning comprising data patterns and decision tree logic may then be provided 1110 which decision trees and associated logic can be provided 1112 as feedback to the expert system 1103 to match the back propagation learning provided 1110 to the LLM 1104. So that the two systems again have roughly equal strategic capabilities for playing the game, and then on and on the two systems may battle with each other to continue to drive their mutual improvement cycles. Both learning from the process and improving over time. Thus, providing systems and methods for a Win lose Win competition learning loop technology 1102 that may be adapted to play and learn from the war games that the Pentagon experts may wish to build.

FIG. 52A shows a Model Session Manager (MSM) 1600 that orchestrates the augmentation of a main instantiation of an intelligence model 1604 with one or more sub-instantiations 1606, 1608, 1610 that perform sub-tasks. Each sub-instantiation may be a further instance of the same model operating independently of the main instantiation 1604, or a different and specialized model selected for its suitability to the sub-task assigned to it. The Model Session Manager 1600 identifies the main task, its sub-tasks, any sequencing needs, any task incompatibilities and creates instructions for the allocation of work 1601. The Model Session Manager 1600 then instantiates SENN model modules 1605, allocates tasks to sub-instantiations, monitors their progress, addresses problems that arise during processing, and receives their outputs 1602.

There may be multiple reasons why the use of sub-instantiations is desirable. The context window of current models is finite, and there is an efficacy curve associated with the progressive consumption of the tokens that comprise the context window budget. Several adverse effects may impact the quality of model output at different stages of that consumption. These include: (a) bloat, in which tokens are consumed by the ingestion of irrelevant materials along with relevant materials, causing drift; (b) confusion, in which distracting or contradictory materials within the context window reduce the model's ability to focus on the task; (c) incompatible tasks, in which two or more sub-tasks within the same context window each require a different mode of processing that a single model instantiation cannot optimally serve simultaneously; and (d) countervailing tasks, as defined in the Background of this specification, in which the simultaneous pursuit of sub-goals that are in genuine tension with one another within a single inference operation causes bleed-through. Where the optimization of one sub-goal adversely affects the output of another.

The solution of the subject technologies to problems (a) and (b) includes the blinkers mechanism of the subject technology, which curates the informational field of view presented to a single model instantiation to keep it focused on only the relevant and necessary materials. The solution to problems (c) and (d) shown here includes the use of sub-instantiations to separate out the incompatible and countervailing sub-tasks. The Model Session Manager 1600 may orchestrate the sub-instantiations to enforce and perform a sequence of tasks separately, in which irrelevant and confusing materials may be removed and performed by one sub-task and sub-instantiation pair 1606, another sub-instantiation pair 1608 may perform a second task that is in some way incompatible with or countervailing to another task which is processed in a third sub-instantiation pair 1610, and so on. The sub-instantiations may then pass back to the main instantiation 1604 their outputs, so that the main instantiation can assemble those outputs together without suffering the adverse phenomena of drift, bloat, bleed-through and confusion that would otherwise reduce its ability to perform a substantial task to an acceptable standard of efficacy. In this way the Model Session Manager 1600 is enabled to ensure the processing and return of otherwise incompatible and countervailing outputs, to the main instantiation as well as applying sequencing into the desired composite session output products 1603.

A sub-task of a task may have an objective that countervails with an objective of a remainder of the task, the remainder of the task being the part of the task that remains after the sub-task is separated and that may be processed by the main instantiation 1604 while the sub-task is processed by a sub-instantiation. In such a case, both the sub-task and the remainder of the task are individually within the processing capability of a single model instantiation. The difficulty does not arise because the sub-task or the remainder of the task is beyond what a single model instantiation can perform, but because the simultaneous processing of the countervailing objectives within one context window causes the mathematical operations serving one objective to interfere with and degrade those serving the other. A single model instantiation may process either the sub-task or the remainder of the task alone and produce an acceptable result; it is the co-residence of the countervailing objectives within the same inference operation that produces the mutually degrading bleed-through. Separating the sub-task from the remainder of the task into a blinkered sub-instantiation therefore addresses a degradation that arises from co-processing, for a sub-task that a single model instantiation would otherwise be capable of processing. This is to be distinguished from the separate case, described elsewhere herein, in which a sub-task calls for a mode of processing that a given model instantiation is not configured to perform; in that separate case the basis for dispatch to a different instantiation or specialist model is a difference in processing mode, rather than the mutually degrading bleed-through issue.

Furthermore, another important benefit may be provided by using this process of multiple instantiations to mitigate the problems of drift and amnesia in deep neural network processing operations. This is because the initial prompting signal is progressively degraded as it passes through each layer of neurons within the SENN, so that while deep neural networks can and do provide greater capabilities overall, they suffer from drift and amnesia in what is sometimes called context rot.

Context windows must also be constrained in length because beyond a certain limit they lose efficacy, as the model cannot marshal and use all the information ingested. The effects of this within the context window result in falling efficacy of outputs once the sweet spot of the context window is passed. Some context windows may become so afflicted with confusion that, although they have not exhausted their token budget further use would amount to wasting computation on outputs of unacceptable quality.

For all these problems, using sub-instantiations may enable the model to handle bigger and more complex tasks, in which the sub-instantiations need not process past their sweet-spot zones of acceptable efficacy. Because their processing may be truncated before the deleterious effects can occur. Similarly, the burden on the main instantiation 1604 may be significantly reduced so that it is better able to perform its tasks within its higher quality range of a given token budget. In combination with the further benefit of not getting confused by countervailing and incompatible tasks that would otherwise bleed through into each other and damage the efficacy of the main instantiation.

Furthermore, the orchestration and assembly of outputs from multiple instantiations, none of which operate outside of their zone of maximum efficacy, may provide a higher quality product. With sufficient roll-on, roll-off, and some overlap between instantiations, this approach may provide a continuous intelligent process that is not constrained by context windows, because the Model Session Manager 1600 may chain multiple context windows and instantiations into one output. This capability may provide an intelligence engine with an effectively limitless context window, in which even main instantiations may pass on context to a successor new main instantiation 1612. Which may take over the role of the main instantiation before the predecessor's context window loses efficacy. So that the output of complex deliverables 1620. Produced by this orchestration of multiple instantiations may thus exceed in scope and quality what any single model instantiation could achieve alone. Especially when used in combination with the immortal memory of the subject technologies by retrieval from the Factual Matrix, the Model Session Manager 1600 may enable the intelligence engine to undertake tasks of arbitrary complexity and duration.

During the chaining of successive instantiations, the Model Session Manager 1600 may maintain the previous instantiation concurrently with the successor instantiation during an overlap period. The overlap period may permit the successor instantiation to commence processing while the predecessor instantiation remains available, so that the transition between instantiations may proceed without loss of continuity. During the overlap period, the successor instantiation may query the predecessor instantiation regarding any unforeseen issues arising in processing, including the recovery of data or context that may have been omitted from the handover continuity package. The Model Session Manager 1600 may also archive one or more of the handover continuity packages, instantiation processing logs, and inter-instantiation dialogues generated during continuously chained processing operations. So that the archived records may be retrieved and consulted during a subsequent operation. The archived records may serve as an audit trail of the chained processing, and may further serve as a source of learning data for improving the efficacy of future handover and chaining operations.

FIG. 52B builds on the embodiments of FIGS. 52 and 52A to show the operation of continuously chained instantiations within the competition learning loop 1102 of FIG. 52, applied to a strategic reasoning task such as the game of chess, to provide insights that may also be useful in a variety of strategic decision-making processes. A session manager orchestration module 1600 indicated here by the off page connector 1830 (back to the previous figure) oversees the chaining of successive main instantiations through an instantiation chain 1831, in which a first main instantiation 1604 processes the current phase of the game and, upon approaching the boundary of its most effective context window, hands over to a successor main instantiation 1612 via the handover mechanism described with reference to FIG. 52A. The chaining may continue for as many successive instantiations as the duration of the game or main task requires.

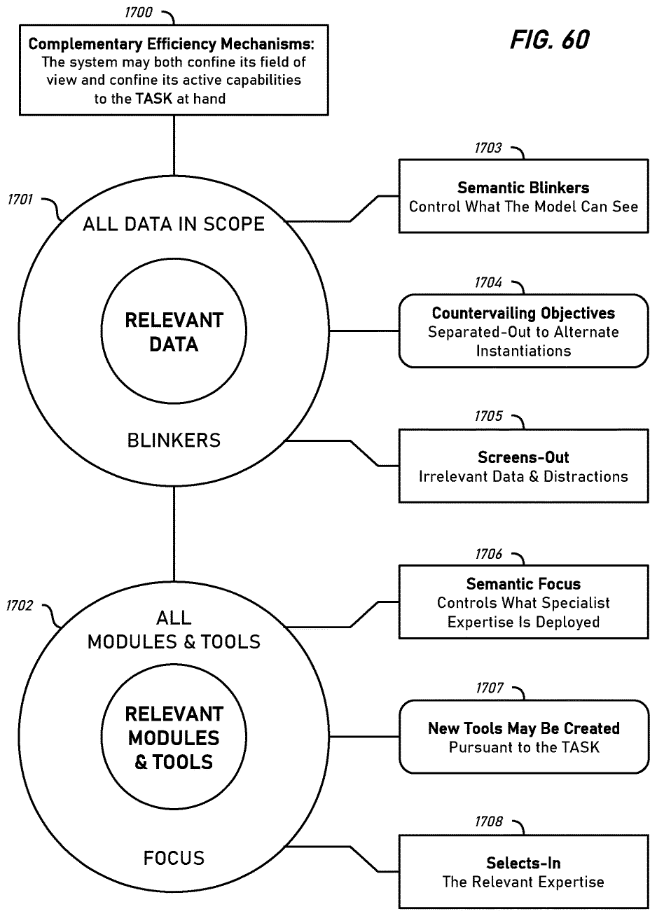

Within each main instantiation 1604, the strategic reasoning task is decomposed into sub-tasks that separate-out countervailing objectives, as described in the Background section of this specification above. In the chess game and similar strategic embodiments for wargaming offensive and defensive tasks, offensive strategy and defensive strategy represent objectives that are in genuine tension with one another. This is because the pursuit of an aggressive attacking strategy within a single context window may undermine the careful positional reasoning required for effective defense, and vice versa. This mutual degradation may arise because a token-based language model processing both objectives simultaneously within one inference operation cannot separately optimize for each without the mathematical operations of one interfering with the other within the matrix calculations of the transformer architecture. This phenomenon, in which the simultaneous processing of countervailing objectives within a single context window causes the mathematical operations serving one objective to interfere with and degrade the operations serving the other, is referred to herein as contextual and purposive degradation. Which is why in the aspect of the subject technologies countervailing objectives are recognized as distinct and separated out to blinkered task-specific sub-instantiations, consistent with the complementary efficiency mechanisms shown in FIG. 60 at element 1704.

As used herein, a task processed by the intelligent computing system may be referred to as a main task objective, and a main task objective may comprise a plurality of sub-tasks, including a first sub-task and a second sub-task. A first sub-task may have an objective that reinforces a processing efficiency of the main task objective, in that the processing of the first sub-task contributes to, rather than detracts from, the efficient processing of the main task objective. A second sub-task may have an objective that countervails the processing efficiency of the main task objective relative to the first sub-task, in that the simultaneous processing of the second sub-task together with the first sub-task or with a remainder of the main task objective within a single context window would give rise to the mutually degrading bleed-through described herein. By identifying the first sub-task as reinforcing the processing efficiency of the main task objective, and the second sub-task as countervailing that processing efficiency relative to the first sub-task, the system may retain the first sub-task within the processing of the main task objective while separating the countervailing second sub-task into a blinkered sub-instantiation as described herein.

A first sub-instantiation pair comprises an offense move executing task 1605 paired with an analyze alternative strategies and tactics module 1606. A second sub-instantiation pair comprises a defense move executing task 1607 paired with a corresponding analyze alternative strategies and tactics module 1608. A third sub-instantiation pair comprises a choice balancing task 1609 paired with a recommend choices strategies and tactics module 1610.

Each sub-instantiation pair operates within a restricted purview according to the blinkers mechanism of the subject technology. In which the offensive sub-instantiation sees only offensive considerations, and the defensive sub-instantiation sees only defensive considerations, so that neither suffers bleed-through from the countervailing objective. However, the sub-instantiations are not entirely isolated from one another. The arrows shown in FIG. 52B between the sub-instantiation pairs indicate that findings may (in some cases) be passed between them. So that the offensive analysis 1606 may communicate its assessment of attacking opportunities to the defensive analysis 1608, and vice versa, making each aware of the constraints and opportunities identified by the other—without being burdened by the full processing of the other's objective; (which would be likely to trigger an unhelpful bleed-through of the conflicted tasks with each other). The third member of the team, the balancing choices task 1609, receives the outputs and findings from both the offensive and defensive sub-instantiation pairs and, together with its own recommend choices strategies and tactics module 1610, may assemble a balanced recommendation for the main instantiation 1604. The main instantiation may then execute its bigger-picture, higher-level strategic and tactical decisions while benefitting from the recommendations of the sub-instantiations and in particular the balancing team member without having suffered contextual and purposive degradation from attempting to simultaneously agonize over the reconciliation of competing priorities for offensive and defensive strategies. So that the main instantiation may focus on its executive decisions with clarity in which the contextual and purposive degradation problem has been mitigated.

As shown at element 1611, a handover task at the conclusion of each main instantiation's processing may result in the predecessor main instantiation remaining available as an advisor and source of memory and prior reasoning to the successor. The predecessor instantiation 1604 may provide supporting expertise and guidance to the successor main instantiation 1612 during an overlap period, and the successor may query the predecessor regarding the reasoning behind prior decisions, the state of play at the point of handover, and any tactical considerations that may not have been fully captured in the handover continuity package. This advisor capability may be particularly valuable in a long-running game of chess where strategic vision and continuity across many moves are essential. Where the accumulated situational awareness of a predecessor instantiation represents knowledge that is expensive to reconstruct from recorded data alone.

A workflow logs store 1833, shown in FIG. 52B with read and write access from the main instantiations, records the reasoning, decisions, and workflows of each instantiation throughout the chained processing operation. The workflow logs may be read by successor instantiations to understand the full history of prior reasoning and may serve multiple purposes. In the context of a chess game, the logs may enable rollback to a prior decision point so that an alternative strategy may be explored from that point forward. In the context of a long-running coding operation or other complex task, the logs may provide an audit trail and recovery mechanism in the event that a later instantiation produces unsatisfactory results, and the processing needs to be resumed from an earlier state. The accumulated workflow logs may also serve as a source of learning data. From which the recorded sequences of decisions and their outcomes may be analyzed to identify which strategic choices led to favorable results and which did not, and this analysis may be fed back into the learning systems of the subject technology to improve future performance.

Although not shown in FIG. 52B, the three task-specific sub-instantiation pairs may themselves be similarly chained in a long game or task. Where the duration of the offensive or defensive analysis exceeds the effective context window of a single sub-instantiation, the session manager orchestration module 1830 may chain successive sub-instantiations for that task in the same manner as the main instantiations are chained, with handover continuity packages passed between successive offensive sub-instantiations, successive defensive sub-instantiations, or successive balancing sub-instantiations as needed. The sub-instantiations may or may not be specialist models, they may be given a restricted purview and a coherent, compatible task, so that each operates within its zone of maximum efficacy. Without the degradation that would result from processing countervailing objectives simultaneously.

The knowledge assets and tools available to the sub-instantiations through the structured database may include repositories of chess set plays, recorded move combinations, and analysis of games played by grandmasters and other skilled players. From which knowledge assets the intelligence engine may identify pattern matches to determine how other players dealt with similar board positions and strategic scenarios. In the competition learning loop embodiment of FIG. 52, these knowledge assets are hardwired into the deterministic machine learning expert system 1103 as structured decision tree logic: the expert system may access and traverse its libraries of recorded games and known optimal responses with computational precision. Whereas the synthetic electronic neural network-based system 1104, by contrast, does not possess these deterministic lookup capabilities in the same form. The neural network must effectively approximate its strategic decisions through the learned patterns encoded in its neuron weights, informed by whatever knowledge assets and context are supplied to it through the context package mechanism of the subject technology. With accumulated experience and access to the same knowledge assets through the structured database, the neural network-based system may progressively improve its ability to identify and exploit the strategic patterns recorded in the grandmaster game libraries, but through probabilistic inference rather than deterministic lookup.

A reason why synthetic electronic neural networks based on the transformer architecture have not yet achieved strong performance in strategic reasoning tasks such as chess may be that countervailing objectives operating simultaneously within a single inference operation may cause mutual degradation within the matrix calculations of the transformer. The attention mechanism and feed-forward layers of the transformer perform linear algebraic operations across the full token sequence of the context window, and where that sequence contains tokens oriented toward offensive strategy interleaved with tokens oriented toward defensive strategy, the mathematical operations serving one objective may interfere with and degrade the operations serving the other. This area of the mathematics of synthetic electronic neural network architectures may be susceptible to future adjustment to allow transformer-based and other synthetic electronic neural network architectures to cope more effectively with countervailing objectives and incompatible tasks within a single inference operation. The sub-instantiation separation mechanism of FIGS. 52A and 52B provides a practical solution to this problem that does not require modification of the underlying neural network mathematics, by ensuring that each inference operation processes only a coherent and compatible set of objectives.

The identification of a sub-task having a countervailing objective may be performed by a semantic analysis of the task. The semantic analysis may examine the objective associated with a sub-task and the objective associated with a remainder of the task and determine whether those objectives, if processed together within a single context window, would drive the interpretation of the model in mutually opposing directions. Such mutually opposing directions may arise, for example, where the sub-task is oriented toward constraint, accuracy, and the enforcement of ground truth while the remainder of the task is oriented toward generative or probabilistic reasoning, or where the sub-task is oriented toward an offensive strategy while the remainder of the task is oriented toward a defensive strategy. Where the semantic analysis determines that the objective of the sub-task and the objective of the remainder of the task would drive the interpretation of the model in mutually opposing directions, the sub-task may be identified as having an objective that countervails with the objective of the remainder of the task.

Such degraded co-processing can also pollute the processing of the task with bad data, analogous to an inadvertent data-poisoning effect, so that outputs are entirely wasted and cannot be used without propagating the degradation into an entire workflow. Which polluted workflow may also become unusable or require additional processing to remove the damaged data from it. In physical artificial intelligence applications, the results may be catastrophic, resulting in crashes going beyond a mere damage to data outputs and efficiency.

By detecting the countervailing objective in this manner before the sub-task and the remainder of the task are processed together, the system may separate the sub-task into a blinkered sub-instantiation in advance, so that the mutually degrading bleed-through is prevented rather than incurred, and the computation that would otherwise be expended on a degraded co-processing operation is conserved. The semantic analysis may be performed by the Model Session Manager 1600, or by a separate analysis module operating under its direction, upon the tokens or semantic content of the task.

In the competition learning loop embodiment of FIG. 52, the deterministic machine learning expert system 1103 may be expected to win the majority of chess games for a considerable period, because its deterministic access to structured decision tree logic and recorded grandmaster strategies provides it with a computational advantage in a domain where precise calculation and exhaustive scenario evaluation are decisive. The synthetic electronic neural network-based system 1104 must learn from losing 1106, storing its operational experience into the weight evolution engine and into the expert system structures and decision tree logic structures of the relational database 118, as described with reference to FIG. 52. Over time, through the co-learning process of the competition learning loop 1102, the neural network-based system may accumulate sufficient strategic experience and pattern recognition capability to begin defeating the expert system. At that stage, as described with reference to FIG. 52, the distilled learning 1108 from the neural network's victories may create new decision trees 1109 that are provided 1112 as feedback to the expert system, so that the two systems may reach roughly equal strategic capabilities and continue to drive mutual improvement.

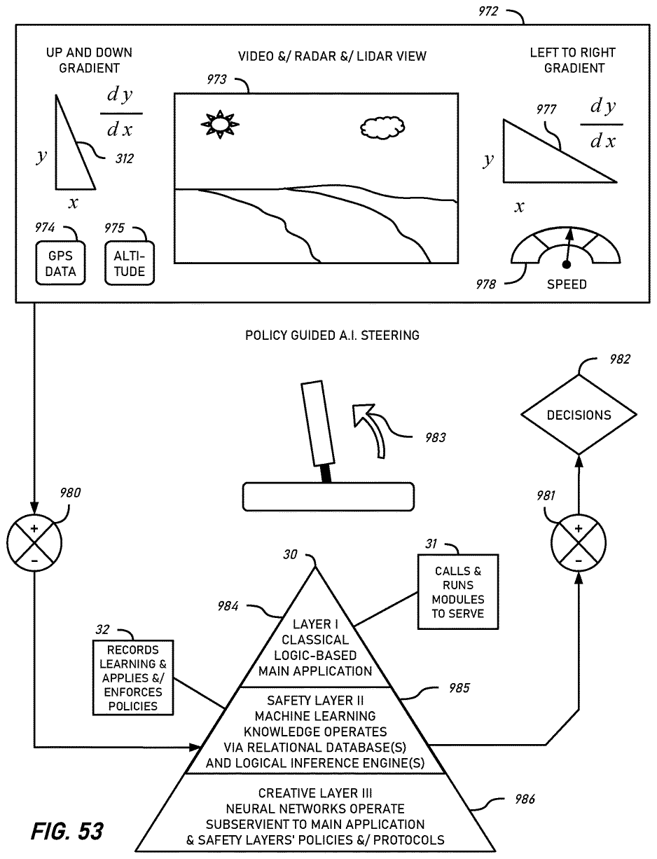

FIG. 53 shows aspects of the system of an unmanned aerial vehicle (UAV) 972 that is controlled by artificial intelligence according to the subject technologies. In the art, there are many systems that involve motion which have been trained on video. That know nothing of the laws of motion but are essentially vibing their estimations of motion based entirely on their training video streams. They have learned much as human children learn to predict motion and to move entirely based on experience and feedback, rather than understanding the laws of motion.

Whereas, the UAV here has a range of tools it has a GPS data feed 974, an altimeter 975, and an air speed sensor 978 as well as a video and/or RADAR and/or LIDAR view of the terrain ahead. Where this differs from much of the art based on vibing motion is that it benefits from the use of sensor data to calculate a gradient for its up and down motion 312 and left to right motion 977. The use of gradients can be fed to specialist neural networks that have been trained to take them into account as they operate their motion control systems. This more scientific approach may allow training with less data and provide a more programmable and sturdy performance overall. Math for the gradient calculations may be provided from a ground truth repository 950 (FIG. 47) according to the subject technologies (not shown here) operated as part of a layered hybrid system 911. Wherein the sensors provide the data feedback 980 that is passed as parameters by the second layer to the creative SENN layer 986, which run under the supervision of the logical main application in the first layer 984, which calls and runs modules 31, and also under the supervision of the second safety layer comprised of expert systems according to the subject technologies 985, that records learning and applies policies 32 such as geofencing. The SENN based creative layer 986 then under this supervision and learning system provides the control signal back to the second layer. Where it may be checked against policies and rules for compliance before being provided as the feedback signal 981 in the UAV controller loop as a stream of decisions 982 that operate the controls of the UAV. The use of gradients being an example of a tool that can be provided by these subject technologies to help make systems operate more reliably. Which is important for objects that have motion and could impact other things adversely.

As used herein, an actuator is a device that converts a control signal into an action, which may be a software-based or firmware-based switching action and/or a physical action, including the powering on or off of a physical device, the switching of a physical device between states, and the movement of a physical device or a component thereof. In the embodiment of FIG. 53, the stream of decisions 982 produced by the controller loop may operate one or more actuators 983 of the unmanned aerial vehicle 972, including actuators of one or more of its control surfaces, steering, propulsion, and throttle, such that a result produced by the layered system is applied to effect a physical action of the vehicle. The same principle may apply to other vehicles and physical systems controlled according to the subject technologies, in which a result produced by the system operates an actuator that effects a corresponding physical action.

FIG. 54 provides details of a combined digital artificial intelligence and quantum hybrid system 1201. That may also include within it the features of the shared learning hybrid system 911 of FIG. 47. This ability to learn from experience may be helpful because by making predictions-error checking these against results and learning from that experience the artificial intelligence 1225 can manage the quantum computing 1230, while checking results and learning 1226. That learning can also be distilled into the expert learning system 381, operating relational databases 118 according to the subject technologies using grouping and branching structures 1224.

The system may include a plurality of SENN modules of various topologies and shapes 1227, that may be trained and configured as expert modules and may include quantum approximation and prediction modules 1228. That may operate in parallel with the quantum computing and may be based on probabilities and learning based approximation of quantum computations 1234. Furthermore, the artificial intelligence may manage the quantum computing operations while learning from them 1236.

The system may be connected to client systems via the Internet and/or quantum networks 1204. Furthermore, it may be located within a data center and provide quantum and approximated quantum computing assisted by artificial intelligence to users as a cloud-based service 1202. It may have a basic input output system 1205, that enables the hardware 1206 including digital memory 1207, storage 1208, CPU and/or GPU and/or TPU and/or NPU 1209, and/or analog qubits 1210 and other connected hardware items such as screens, printers and detachable hardware items 1211. Furthermore, there is an operating system that may manage applications 1223 which may include a language-based co-process 1222 and/or math co-process 1221. Machine learning 382, learning expert system 381, relational databases 118, and hierarchical grouping and branching structures and navigation of them 1224. That works in combination with the artificial intelligence 1225 and shares learning between them 910, via feedback 1226. There being also neural networks 390, that may be configured with various task specific optimized topologies and shapes. That may function as a plurality of expert SENN modules that may include quantum computing models 1228. Having also a feedback 1235 with the quantum computing systems 1230, that may include logical qubits 1231, QPU 1232, and other probability-based approximations to quantum computing 1234.

A result produced by the system may operate one or more actuators of the physical qubit apparatus 1210, 1231, 1232 of the quantum computing subsystem 1230. The physical qubit apparatus may include the analog qubits 1210 together with the apparatus that may drive and maintain the qubits, such as one or more microwave signal generators that apply control pulses to the qubits (in some system designs) and one or more cooling systems that maintain the qubits at an operating temperature. Operating such an actuator—for example, actuating the qubit hardware to perform a quantum computation, or to bring the qubit apparatus to or from an operating state—may apply a result produced by the system that may effect a physical action of the quantum computing subsystem. Persons skilled in the art will appreciate that microwave pulses, electrons and other particles are physical and not ephemeral in nature. Their size and quantum variabilities are not determinative of their physicality per se.

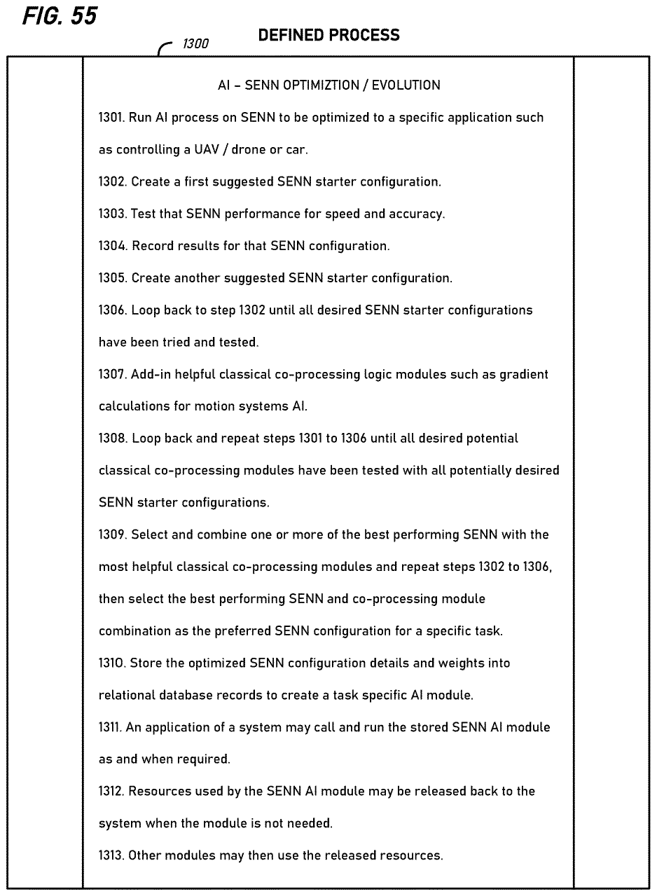

FIG. 55 provides details of a defined process for the optimization and/or evolution of task specific expert SENN configurations. As may be created as modules for use within an intelligence engine:—

1301. Run AI process on SENN to be optimized to a specific application such as controlling
a UAV / drone or car.
1302. Create a first suggested SENN starter configuration.
1303. Test that SENN performance for speed and accuracy.
1304. Record results for that SENN configuration.
1305. Create another suggested SENN starter configuration.
1306. Loop back to step 1302 until all desired SENN starter configurations have been tried
and tested.
1307. Add-in helpful classical co-processing logic modules such as gradient calculations
for motion systems AI.
1308. Loop back and repeat steps 1301 to 1306 until all desired potential classical co-
processing modules have been tested with all potentially desired SENN starter
configurations.
1309. Select and combine one or more of the best performing SENN with the most helpful
classical co-processing modules and repeat steps 1302 to 1306, then select the best
performing SENN and co-processing module combination as the preferred SENN
configuration for a specific task.
131O. Store the optimized SENN configuration details and weights into relational database
records to create a task specific AI module.
1311. An application of a system may call and run the stored SENN AI module as and when
required.
1312. Resources used by the SENN AI module may be released back to the system when
the module is not needed.
1313. Other modules may then use the released resources.

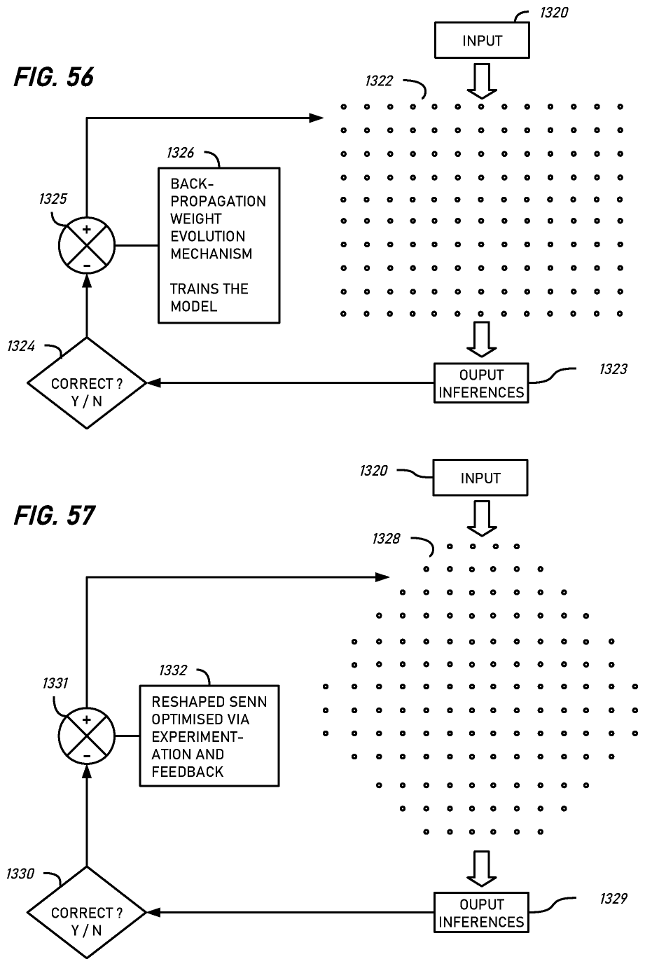

FIG. 56 provides a SENN 1322 that has an input 1320, and outputs inferences 1323 that is checked for correctness 1324 which details are provided as feedback 1325 to the backpropagation weight evolution mechanism to train the model 1326.

FIG. 57 provides what may be the same or similar resources for a SENN 1328 having the same number of neurons as the previous SENN 1322 (FIG. 56), after being subjected to the defined process 1300. To create a SENN that is configured as optimized to suit a specific task as may be used by a system operating SENN modules that are bespoke to a specific task for which they have been optimized 1227 (FIG. 54). It has an input 1320, and output 1329, that may be tested for correctness 1330. Results of which are fed back 1331 and used by the defined process 1300 to provide the reshaped SENN topology that has been optimized by experimentation and feedback 1328. The optimization and evolution process applied to the SENN 1328 may yield a novel optimized topology 1332 that differs structurally from the original SENN 1322 of FIG. 56—not merely in the adjusted weights of its neurons but in the shape, connectivity, and layering of the network itself. Such a novel topology 1332 may emerge from the iterative experimentation and feedback of the defined process 1300 as the system discovers that a particular arrangement of neurons and connections outperforms the starter configuration for the specific task to which the SENN is being optimized. An embodiment of one such novel topology configured to mitigate the related problems of drift and amnesia in LLMs is provided in the next two figures.

In the context of creating general purpose artificial intelligence. This may be accomplished by using a plurality of expert bespoke SENN operating models that are operated as modules under a main application. Which modules cooperate to provide a blended output of their collective efforts as inferences. Furthermore, details of an expert bespoke SENN configuration and/or its neuron weights may be stored within a database comprised of an expert system encoded within the structure. From where the main application may call for a specific expert SENN to be created within available resources as a task specific tool. Which resources may be released back to the system after the SENN module has performed its task. While those system resources may be reconfigured according to a different task specific SENN configuration. In this way the relational database and its expert system can leverage the power of expert SENN for a series of tasks while minimizing the amount of system resources of memory and processing capacity. Rather than having all the system parts powered up and consuming resources all the time. Which may improve the efficiency and/or efficacy of the system.

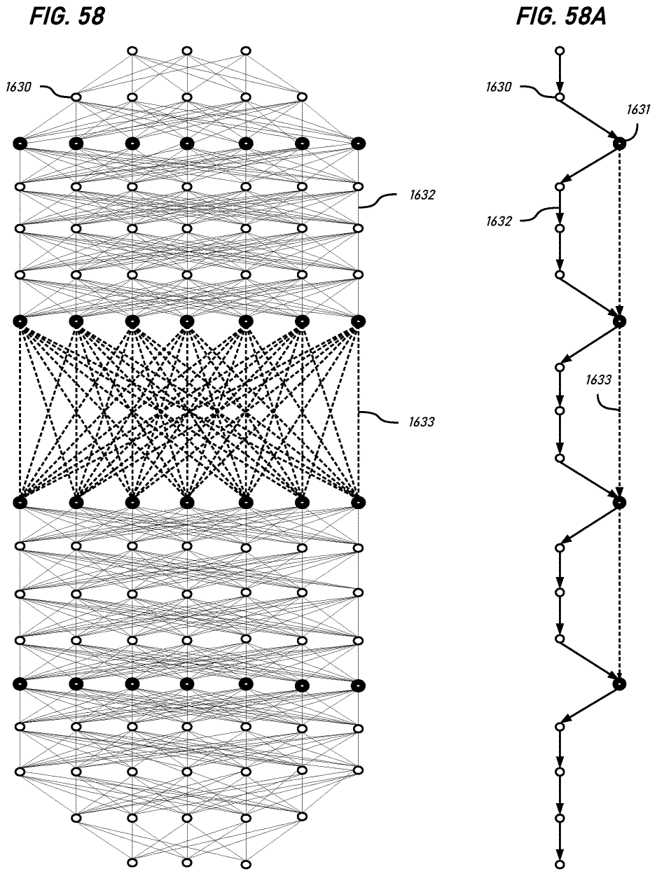

FIGS. 58 and 58A taken together provide two views of a dual meshed SENN topology 1630. FIG. 58 is a plan view in which a portion of the upper layer has been stripped away in the center-section to reveal the second layer topology beneath. FIG. 58A is a side elevation view of the same meshed SENN pair topology 1630. The meshed SENN pair 1630 is comprised of two layers of neurons 1631 in which the first layer is connected as a deep SENN 1632 and the second layer is connected as a shallow SENN 1633. The two networks of which topology are fused into one meshed structure. In the deep SENN 1632, the signal passes through many layers of neurons, which provides greater computational capability and sophistication potential but is susceptible to the adverse effects of drift and amnesia-causing the progressive degradation of the original purpose of the computation as the signal traverses successive layers. The shallow SENN 1633 provides a shorter signal path through fewer layers of neurons, which may reinfuse the original purposes of the computation back into the deeper SENN 1632 at the points where the two networks mesh. The throughput of the meshed SENN 1630 may thus combine the benefits of deep neural network efficacy with the signal preservation effects of a shallow neural network on the twin adverse phenomena of drift and amnesia. The resulting blended SENN topological configuration may thus provide improved performance according to the subject technologies. The meshed SENN topology may be further developed and optimized according to the subject technologies for a specific task or to a general-purpose role, using the optimization and evolution process described in FIG. 55 (defined process 1300).

FIG. 59 provides details of such a system running under the operating system and applications of a system such as the artificial and quantum hybrid 1201 (FIG. 54). Having an artificial intelligence 1225, with neural networks 390, comprised of one or more expert SENN modules 1228, in the environment provided by the operating system 1220. In this example, this is also a system that has the three-layered design comprised of: the first layer logical main application 984, which calls and runs modules 31. With a second layer having expert systems that may benefit from machine learning stored in the structure of relational databases, including decision trees and/or searchable branching structures based on synonyms and similes 985. Plus, a third layer that runs one or more SENN modules subservient to the main application in the first layer and expert systems in the second layer that provide ground truth from factual matrices, and machine learning tools. These SENN modules may include one or more alternates including large language models and/or other models 987, a physics model 988, a chemistry model 989, a biology model 990 and a math and quantum computing model 991. Which quantum model may operate based on learning from quantum computations as training data, as well as approximations operated based on probability modeling. Which may be particularly useful for managing the process of quantum computations plus error checking and validation of results. As envisaged in the artificial intelligence and quantum hybrid system 1201 (FIG. 54).

FIG. 59 also shows an embodiment of the subject technologies in which the specialist SENN modules of Layer III of the three-layer architecture include a plurality of scientific domain modules, each operating as a specialist artificial intelligence system for its respective scientific field. As shown in FIG. 59, Layer III specialist SENN modules of this embodiment may include a large language model and other general-purpose models integration 987, a Physics Model 988, a Chemistry Model 989, a Biology Model 990, and a Math and Quantum Model 991, the last of which is shown with a dashed border in the drawing to indicate that it represents a further specialist module provided for within the architecture and capable of being instantiated and deployed as the relevant enabling technologies mature. Each of these specialist modules 988, 989, 990, 991 is accessible via the AI orchestrator 1460 (FIG. 42D) and may be instantiated on demand by the main controller 1401 when a task arising within the corresponding scientific domain is identified by the DOORS 100 from the intrinsic or extrinsic attributes of the files or data being processed. The intelligence engine of the DOORS 100 may classify one or more files within a collection as containing data relating to a specific scientific field by applying the language recognition module 33, the document recognition module 35, and/or pattern recognition operations to the intrinsic and extrinsic attributes of those files; and may then supply a homogenized data set, or a sub-set thereof assembled and formatted according to the operations described herein, to the relevant specialist scientific module 988, 989, 990, or 991 as a pre-processed and structured input for scientific data analysis. The scientific field to which such supply may be made may comprise any of: physics, chemistry and biochemistry, biology-including epidemiology, genomics, and clinical cohort data analysis- and mathematics and quantum computing.

A feedback loop 992, shown in FIG. 59, runs from the specialist scientific modules 988, 989, 990, 991 back to the Layer III SENN modules 390 of the DOORS 100, enabling the DOORS 100 to incorporate the outcomes and learnings of specialist scientific processing operations into its operational experience, and to progressively improve its classification and supply routing of scientifically relevant data. As further illustrated in FIG. 53, the three-layer architecture comprising Layer I classical logic controller 984, Layer II expert system and machine learning 985, and Layer III SENN modules 986 is capable of receiving and processing multi-modal sensor data streams of the kind encountered in scientific instrumentation—including video and radar/LIDAR view data 973, GPS data 974, altitude data 975, and motion and speed data 978—and of routing those data streams via the specialist processing and policy-guided artificial intelligence architecture shown in FIG. 53 to produce decisions 982 via feedback loops 980 and 981. This demonstrates the breadth of specialist data supply capability provided by the subject technologies, which extends to real-time scientific sensor data streams as well as to stored file collections, and which in combination with the file management and data extraction operations described herein may provide an end-to-end pipeline from raw data acquisition through structured data assembly to specialist scientific processing.

The specialist and multi-modal processing capabilities described above operate within and contribute to a broader knowledge accumulation architecture that is central to the subject technologies. A fundamental and novel efficiency property of the subject technologies is the conversion of intelligence engine inference operations-which consume artificial intelligence computation budget-into stored natural language records within the Factual Matrix 71, from which the same information may thereafter be retrieved by text search of the Factual Matrix or by pointer access, at a fraction of the computation cost of re-running the intelligence engine inference. The DOORS 100 is a system that computes an inference once and retrieves the result of that inference cheaply thereafter. This property is referred to herein as inference crystallization.

When the intelligence engine of the DOORS 100 determines an inference—for example, that two differently-named directories share a synonym or simile relationship that warrants merging; or that a document's content contains keyword patterns 885, 886, 887 (FIG. 41) that establish its membership of a particular category; or that a facial recognition match links an image file to a named data entity already recorded in the Factual Matrix; or that a file named “Montains.jpg” is a typographic near-match for “Mountains” and belongs in the same grouping as identical-content image files with correctly-spelled names—that inference is computed using the full inference capability of the intelligence engine, which may include one or more of: expert system logic 381 (FIG. 13), machine learning 382, SENN-based artificial intelligence 390, and vector similarity computation of the kind described with reference to FIG. 47A through FIG. 47E. The result of that inference—the determined relationship, class membership, word or non-word synonym or simile linkage, meaning chain, or other relational fact—is then recorded as natural language text into the relevant records and structures of the Factual Matrix 71 within the relational database 118.

This recording of inference results into the Factual Matrix as natural language is performed by multiple write mechanisms shown throughout the drawings. These mechanisms include: the write operations of the shared learning hybrid system 911, in which the feedback 910 distils operational learning into the hierarchical structures of the relational database 118 (FIG. 47); the feedback loop 992 from specialist SENN modules back to Layer III (FIG. 59); the share and save learning connections 910 and the learning feedback 1226 of FIG. 54, which distribute shared learning between the machine learning 382, expert system 381, relational databases 118, and neural network modules 390 of the quantum hybrid system 1201; the distillation of learned decision trees 1112 from the SENN-based system back to the expert system in the Win-Lose-Win competition learning loop 1102 (FIG. 52); the training step 342, which records learning derived from user data sets including cross-relations during interrogation of source data (FIGS. 12 and 19); the write operations to the relational database shown throughout FIG. 22 (item 578) and FIG. 4 (items 154, 162, 164), which record discovered file attributes, inferred relationships, and user choices 127 into the database during reconciliation operations; and the output write operations of the Branching Structure Expert 1469, File and Node Naming Expert 1470, and Weight Evolution Expert 1472 of FIG. 42D, each of which writes its computed outputs—including word and non-word synonym and simile groupings, node names, and evolved decision tree weights—to the Factual Matrix 71 via the directory structures 1473 and named nodes 1474 of the knowledge tree.

Once an inference result has been written into the Factual Matrix 71 as stored natural language text, subsequent queries from the intelligence engine concerning the same relationship or class membership may retrieve that result by text search of the Factual Matrix records, or by following the pointer chains 62 between related records-without requiring the intelligence engine to repeat the original inference computation. The computation budget of the intelligence engine is thus spent only once per inference: the inference is computed, its result is crystallized as stored text in the Factual Matrix, and that text is thereafter retrievable at the cost of a text search or pointer access operation. This inference-once, retrieve-many property provides a compounding efficiency gain over the operational lifetime of the DOORS 100: as the Factual Matrix accumulates inference results across sessions-preserved between sessions by the Immortal Memory 1403 (FIGS. 42, 42A, and 42D)—the proportion of queries satisfiable by text retrieval from the Factual Matrix rather than by fresh intelligence engine inference grows progressively, reducing the aggregate inference computation load of the system while the breadth and accuracy of its available knowledge increases.

The value of user-supplied ground truths recorded into the Factual Matrix via the feedback loop 718 extends beyond the direct utility of those ground truths themselves. Each user-supplied fact—an identity, a relationship, a class membership, a date, a location, a circumstance—constitutes a seed from which the intelligence engine may compute further inferences by cross-referencing that fact against other data already accumulated within the Factual Matrix. As shown in FIG. 8, the Factual Matrix 71 is represented as a connected cloud of data nodes, wherein each node is a fact or data entity and each connection is an inferred relationship: the value of adding any node to this structure lies not only in the node itself but in the new connections that node enables to be drawn to every other node already present. A user who records via the feedback interface 718 that a particular person depicted in an image is a member of the class “family” 395 (FIG. 14) enables the intelligence engine to infer, from that single ground truth in combination with facial recognition results already stored in the Factual Matrix, that every other image file in the collection containing a facial recognition match for that person is also a family-related file. From there the intelligence engine may further infer that every document referencing that person's name, every event or place co-located with that person in other Factual Matrix records, and every file temporally proximate to events already associated with that person, may carry a relationship to that same data entity. Each such further inference is itself crystallized into the Factual Matrix, enabling yet further inferences to be drawn from it. A single user-supplied ground truth thus acts as a catalyst for a cascading sequence of derivative inferences; each crystallized into the Factual Matrix and each expanding the comprehension of the file collection available to the intelligence engine without additional user input or inference computation beyond the initial cascade.

Beyond the cascade of derivative inferences from individual ground truths, the accumulation within the Factual Matrix of user-supplied facts, crystallized intelligence engine inferences, and data entities and objects extracted from the intrinsic attributes of files creates a substrate for compound comprehension: the discovery by the intelligence engine of non-obvious relationships and correlations that are invisible to any individual human observer examining any individual record or subset of records in isolation, and that emerge only from systematic cross-referencing of the full accumulated Factual Matrix. The intelligence engine of the DOORS 100 may cross-reference the entirety of the accumulated Factual Matrix to identify statistical correlations, co-occurrence patterns, and structural relationships across large populations of records—patterns that no individual fact or inference discloses and that no human reviewer of the underlying files would be likely to identify unaided. By way of concrete embodiment, a DOORS 100 operating in a medical or epidemiological context may accumulate within its Factual Matrix, over time and across a population, records containing the diagnoses, address data, demographic attributes, and clinical observations of many patients, each record contributed by user input via the feedback loop 718 or extracted by the intelligence engine from patient files using the intrinsic attribute extraction operations described herein with reference to FIGS. 40 and 41. The intelligence engine may then cross-reference those accumulated records and identify a statistically significant co-occurrence between a diagnosis attribute in one field of patient records and an address attribute in another field of those same records—and may further identify, by cross-referencing the address attribute against geographic data entities already present in the Factual Matrix, that the relevant addresses share a proximity to a specific category of infrastructure. Such a correlation—for example, that patients who develop a particular condition have residential addresses correlated with locations within a defined distance of high-voltage power line infrastructure, as determined by the zip code attribute of those addresses—is not apparent from any individual patient record and would not be identified by a clinician reviewing any individual file. It emerges only from systematic cross-referencing of many records within an accumulated Factual Matrix, of the kind that the intelligence engine of the DOORS 100 may perform. The intelligence engine may identify such emergent correlations, crystallize each as a new inference record within the Factual Matrix, and supply that finding as structured input to a specialist biological or epidemiological analysis module 990 (FIG. 59) for further investigation and validation.

The Factual Matrix 71 does not accumulate crystallized inferences as unstructured text. The intelligence engine of the DOORS 100 organizes its own accumulated knowledge—inferences, ground truths, extracted data entities, procedural tools, and the meaning-based groupings derived from them—into the same type of word and non-word synonym and simile grouped, dual-indexed hierarchical structure that it applies to user file collections. Just as the DOORS 100 organizes user files into directories whose names and branching topology encode word and non-word synonym and simile groupings based on meanings and relationships—wherein all synonym relationships are encompassed within the broader simile groupings, but simile groupings extend beyond synonymy to encompass related meanings that are not strictly synonymous—and makes that collection navigable alphanumerically by name and by thesaurus grouping of shared meaning, so it applies the same organizing principle to its own accumulated knowledge within the Factual Matrix and knowledge tree: the same Branching Structure Expert 1469, File and Node Naming Expert 1470, and thesaurus and non-word synonyms module 1471 of FIG. 42D that design and populate the directory structures holding user files also design and populate the knowledge tree structures holding the intelligence engine's crystallized inferences and ground truths. The DOORS 100 uses the same process for its own knowledge that it applies to user files. The practical consequence is that the Factual Matrix's accumulated knowledge inherits the same retrieval efficiency properties as the DOORS-organized file collection: crystallized inferences and their chained relationships are accessible both alphanumerically, for direct lookup by identifier, and via thesaurus grouping, for retrieval by shared meaning from any synonym or simile of a query term, including non-word synonyms. Non-word synonym relationships within the knowledge structure include vector embeddings of the kind generated by large language model inference operations: these vector representations of meaning in a high-dimensional space—as described with reference to FIG. 47A through FIG. 47E—may themselves be stored within the Factual Matrix as non-word identifiers for the knowledge entities and relationships they represent, so that the same vector-proximity retrieval method that identifies semantically similar files applies equally to the Factual Matrix's own body of knowledge. The defined process of FIG. 48—which traverses the knowledge tree using word and non-word synonym and simile groupings and natural language matching to compile the context needed for an artificial intelligence inference task—operates on a knowledge tree structured by the same organizational method as the DOORS Master directory structure: both are hierarchical, both are organized by word and non-word synonym and simile groupings and meaning-indexed, and both are navigable by the same natural language methods. This architectural mirror gives rise to a self-reinforcing virtuous cycle: the more the DOORS 100 operates, the more inferences it crystallizes and organizes into the knowledge structure; the better organized the knowledge structure, the more efficiently the intelligence engine can retrieve prior inferences and ground truths for use in new inference operations; the more efficiently new inferences can be formed, the more rapidly the knowledge structure grows; and the more comprehensive the knowledge structure, the deeper and more non-obvious the inferences the intelligence engine may derive from it. Each operational cycle thus adds to an organized body of knowledge that may make the next cycle faster, cheaper, and capable of generating inferences of progressively greater depth—a compounding return on every computation investment made over the operational lifetime of the DOORS 100.

The word and non-word simile and synonym-grouped, dual-indexed structure of the Factual Matrix enables the intelligence engine to perform criterion-based group queries across accumulated Factual Matrix of records: assembling all records that satisfy a specified condition by traversing the meaning-chain linkages between attribute fields and the criterion terms, and returning the matching records as a grouped dataset or display. A query such as “all patients over fifty years of age” may be resolved by traversing the age attribute fields of accumulated records in the Factual Matrix, applying a numerical threshold criterion to the stored values, and gathering the matching records into an assembled group—using the same word and non-word synonym and simile chain navigation through the knowledge tree that the DOORS 100 applies to retrieval of related files. The meaning-chain structure of the Factual Matrix means that such a query may retrieve records whose age attribute is expressed in any synonym or equivalent form that has been crystallized as sharing the same meaning: a record expressing age as a date of birth may be recognized as equivalent by inference from a crystallized age-computation rule; a record expressing age as a decade grouping may be matched by simile; and a record in which age is represented as a non-word attribute—such as a vector embedding derived from demographic data—may be matched by vector proximity of the kind described with reference to FIG. 47A through FIG. 47E. The assembled group of matching records may be presented to the user via the graphical user interface 1405 as a grouped display of the kind shown in FIGS. 9, 10, and 11, or may be supplied as a structured and pre-processed dataset to a further specialist analysis process, for example the biology or epidemiology specialist SENN module 990 of FIG. 59, for pattern analysis across the assembled population.

The computation performed in traversing the linkages of the Factual Matrix—the paths taken through the knowledge tree, the synonym and simile chains followed, the attribute criteria matched, and the groupings assembled in response to queries—may itself be captured and distilled into the learning system of the DOORS 100, via the write operations to the relational database 118 shown in FIGS. 47, 52, and 54 and the share and save learning mechanism 910. The experience of performing a successful criterion-based retrieval or grouping operation constitutes training data of high specificity: it encodes not only what was retrieved but how it was retrieved, identifying which paths through the knowledge tree led to correct matches, which word and non-word synonym and simile chain linkages proved productive, and which criterion-matching rules were most effective for the class of query performed. This operational experience, when written to the Factual Matrix and to the expert system structures via the Branching Structure Expert 1469 and File and Node Naming Expert 1470 of FIG. 42D, builds a library of learned retrieval and grouping strategies that is progressively incorporated into the expert system and machine learning capability of the DOORS 100. As described with reference to FIG. 52, successful operational strategies are distilled 1108 into new decision tree structures 1109 that are provided 1112 back to the expert system, so that the intelligence engine does not merely store what it has learned but encodes how it learned it into reusable branching logic. Over time, this accumulation of distilled operational experience constitutes genuine machine learning from experience: the intelligence engine learns which organizational and retrieval strategies are most effective for which classes of query and data, and encodes that learning into the knowledge tree in a form that makes future operations of the same kind faster, more accurate, and more efficient—without requiring those operations to be performed again from first principles.

The learning accumulated from operational experience within the Factual Matrix and expert system may be distilled further—back into training data for the SENN modules of Layer III and into adjustments to the neuron weights of those modules—via the Weight Evolution Expert 1472 and the backpropagation mechanism 919 of FIGS. 42D and 47. As described with reference to FIG. 47, the same learning that is written into the hierarchical structures of the relational database 118 via the shared learning hybrid system 911 is also propagated by backpropagation 919 to create its analog within the SENN: adjusting the neuron weights of the SENN modules to reflect the operational experience encoded in the Factual Matrix and expert system structures. The defined process of FIGS. 55, 56, and 57 further provides for the optimization of SENN configurations based on tested performance: SENN topologies and weight configurations that are found by testing to perform well for specific application domains may be stored as optimized configurations 1310 in the relational database and called as expert SENN modules 1311 when tasks in those domains arise. New training data for SENN modules may additionally be generated directly from the accumulated Factual Matrix—by assembling labeled datasets from the Factual Matrix's class records 395, 396, extracted data objects, and crystallized inference results, and using those datasets to fine-tune specialist SENN modules. The Factual Matrix and knowledge tree thus serve as an intermediate layer between raw operational experience and SENN weight adjustment: experience is crystallized as natural language in the Factual Matrix; the expert system and ML layer encode that experience into decision tree structures and branching logic; and the Weight Evolution Expert 1472 distils those structures into SENN weight adjustments. The result is a three-layer learning loop in which operational experience feeds the Factual Matrix, the Factual Matrix feeds the expert system and ML layer, and the expert system and ML layer feed the SENN—each layer improving the next, and the improved SENN producing higher-quality inferences that seed the next cycle of Factual Matrix accumulation.

The DOORS 100 may identify, within a task delivered to the intelligence engine, a plurality of sub-domain components, each requiring a distinct mode of operation. Where the sub-domain components of a task each call for fundamentally different processing approaches, processing all such sub-domain components within a single model instantiation may be insufficient to optimally serve each sub-domain. This incompatibility may arise in two ways.

In a first case, the sub-domain components may have countervailing objectives, such that their simultaneous pursuit within a single inference operation causes bleed-through in which optimization of one sub-domain adversely affects the output of another, as described in the Background section of this specification. An example is a task requiring both generative creative output and deterministic constraint enforcement within the same inference operation: the generative sub-domain and the constraint sub-domain have countervailing objectives that cannot both be optimally served by a single model instance processing them together.

In a second case, the sub-domain components may each require a distinct mode of processing even where their objectives are not in direct conflict, as where one sub-domain requires image recognition and another requires natural language generation, each calling for a differently configured model to perform at its best. In either case, the AI orchestrator 1460 (FIG. 42D) of the DOORS 100 may include a Model Session Manager (MSM) 1600 (FIG. 52A), upon identifying the sub-domain components within the task, dispatch each sub-domain component to a separately instantiated model instance: either a further instance of the same SENN model operating independently of the other instances, or a specialist model selected from the library of stored specialist modules—such as the Physics Model 988, Chemistry Model 989, Biology Model 990, Math and Quantum Model 991, or LLM and other general-purpose models integration 987 shown in FIG. 59—according to the mode of operation best suited to that sub-domain component. Each sub-domain component may then be processed within its own isolated instantiation 1604 (FIG. 52A). Thus confining that sub-domain's processing to its own context window and preventing it from influencing the processing of any other sub-domain. This sub-domain isolation mechanism is distinct from the blinkers mechanism described in the context preparation process of FIG. 48 (defined process 1500): the blinkers mechanism curates the informational field of view delivered to a single model instantiation, restricting what that model sees while it performs a unified inference operation—one horse wearing blinkers to see only the relevant track ahead. The sub-domain isolation mechanism addresses a prior question: whether the task can be optimally served by a single instantiation at all. Where it cannot, the solution is not to restrict what a single model sees, but to recognize that different legs of the course require different horses 1606, 1608, 1610 (according to the embodiment of FIG. 52A). Both mechanisms may operate in combination: each sub-domain instantiation may receive its own blinker-curated context package appropriate to its portion of the task. While the sub-domain instantiations remain isolated from each other.

This pattern of parallel isolated operation followed by integration of results is illustrated in an another embodiment variant within FIG. 52, where the Expert System 1103 and the LLM SENN 1104 may also co-operate in parallel on the same competitive task through the competition loop 1100, with their outputs processed through the comparison node 1101 and the distilled learning 1110 provided as feedback to both systems—a further instance of sub-domain isolation and output merging within the subject technologies.

The sub-domain instantiations may operate in parallel—each processing its respective sub-domain component concurrently—or they may operate sequentially, with one sub-domain instantiation completing its processing before the next begins. Where sequential operation is employed, the order of the sub-domain components may be significant: the output or intermediate results of an earlier sub-domain instantiation may be supplied as contextual input to a subsequent instantiation, so that later sub-domain processing is informed and conditioned by what the earlier instantiation has established. In such cases the intelligence engine may determine the optimal processing sequence from the structure and dependencies of the task, or the sequence may be predetermined by the nature of the sub-domain components themselves—for example, where one sub-domain must establish ground truth facts before a generative sub-domain can proceed reliably. Upon completion of each sub-domain component's processing within its respective instantiation, the DOORS 100 may merge the completed sub-domain outputs into a unified task output 1604 (FIG. 52A). The resources occupied by each sub-domain instantiation (1606, 1608, 1610) may be released back to the system upon completion of its processing, in the same load-on-demand, release-on-completion manner as the callable specialist SENN modules described in the previous section, so that those resources are available for reallocation to further tasks or modules as required.

The learning accumulated within the Factual Matrix and knowledge tree of an individual DOORS 100 deployment reflects the operational experience of that deployment. However, all users of the DOORS 100 may be offered an option to contribute their accumulated learning and feedback data to a shared collective pool, subject to their consent and to applicable privacy, anonymization, and data protection requirements. With such consent, the crystallized inferences, meaning-chain structures, word and non-word synonym and simile groupings, expert system branching structures, and SENN weight configurations accumulated within an individual Factual Matrix instance may be shared-via the cloud-connected architecture shown in FIG. 54, in which the digital artificial intelligence and quantum hybrid system 1201 is connected to client systems 1204 and provides services as a cloud resource 1202, and via the share and save learning connections 910 of that figure and of the shared learning hybrid system 911 of FIG. 47—with a central collective learning repository accessible to all consenting deployed instances. A correlation or emergent insight discovered from the records accumulated within one user's DOORS instance—for example, the epidemiological correlation described above—may, with appropriate consent and anonymization, be made available as a crystallized inference to all other consenting deployments, so that the benefit of that discovery propagates across the user base rather than remaining confined to the deployment that made it. This transforms the individual virtuous cycle of the DOORS 100 into a collective one: the aggregate improvement in intelligence available to each participating deployment grows with the number and diversity of other consenting participants contributing to the shared pool, creating a network effect in which the overall capability of the DOORS 100 system may improve as a function of the breadth of the participating user base. An individual deployment on minimal hardware—such as a personal smartphone—may thus benefit from inference results and expert system structures distilled from the operational experience of a much larger and more diverse population of users than its own operational history could generate, while contributing its own experience to the improvement of the collective. The opt-in nature of this collective learning preserves individual user autonomy and privacy, while enabling the emergent knowledge discovery and compound comprehension capabilities of the DOORS 100 to be harnessed at a scale that no individual deployment could independently achieve.

The comprehension that the intelligence engine builds within the Factual Matrix over time may therefore be greater than the sum of its constituent facts and inferences. Each accumulation of user input, each crystallized inference, and each extracted data entity adds not only its own informational content to the Factual Matrix but also the new relational connections it enables to be drawn to all previously accumulated content. The Factual Matrix is not merely a repository of what is known; it is a substrate from which the intelligence engine may derive what was not previously known—rendering the DOORS 100 capable of a form of knowledge discovery that goes beyond retrieval of stored information to the generation of genuinely new insight from the compound cross-referencing of accumulated knowledge. The scope of inferences that may be crystallized in this way and stored as natural language within the Factual Matrix includes, without limitation: word-based synonym relationships; word-based simile relationships; non-word synonym and simile relationships computed by vector similarity (FIG. 47A through FIG. 47E); typographic near-matches and misspelled identifiers; population-level statistical correlations across accumulated Factual Matrix records of the kind illustrated above; and meaning chains—sequences of inferred relationship links connecting data entities through multiple intermediate steps, each link recorded as natural language text within the Factual Matrix, traversable by text search along stored pointer linkages 62 without executing any element of the chain's original inference computation. The result is a Factual Matrix that grows progressively more comprehensive, more computationally efficient to interrogate, and more capable of generating new insight the longer the DOORS 100 has been in operation—a self-enriching knowledge structure whose value compounds over time.

FIG. 60 illustrates two complementary efficiency mechanisms 1700 that may govern the operation of the intelligent computing and reasoning system. A first mechanism, semantic blinkers 1703, may operate on the input side to screen out 1705 irrelevant data and distractions from all data in scope 1701, confining the field of view so that the intelligence engine processes only the relevant data pertaining to the current task. A second mechanism, semantic focus 1706, may operate on the capability side to select in 1708 only the relevant specialist expertise from all modules and tools 1702, such that the specialist expertise deployed is confined to what the current task requires. The two mechanisms are complementary: semantic blinkers control what the system looks at, while semantic focus controls what the system thinks with. Together they concentrate both input data and active processing capabilities on the task at hand, such that the intelligence brought to bear is both deep—by virtue of deploying specialist expertise relevant to the current task—and efficient—by virtue of not consuming resources on capabilities or data that do not serve the current task. The principle may be understood by analogy to human cognition: a person who is able to focus effectively directs cognitive resources to the specific task at hand and engages with it at full depth, whereas a person whose focus is impaired—as may commonly be observed in children during early learning—attempting to process many inputs simultaneously and consequently engaging with each at reduced depth and efficacy.

Where a task involves countervailing objectives 1704 that are incompatible with simultaneous processing within a single context—as described elsewhere in this specification with reference to bleed-through—the countervailing objectives may be separated out to alternate instantiations. The system may further create new tools 1707 pursuant to the task where no existing tool in the library is adequate for the identified requirement.

The relevant specialist expertise selected in by the semantic focus 1708 may include a specialist module suited to a particular sub-task, such as the Math and Quantum Model 991 of FIG. 59. Where a sub-task is of a kind for which a quantum computation is suited—for example, the factoring of large integers underlying the decryption of data of the kind warehoused for later decryption as described above—the system may, through the semantic focus, select in the Math and Quantum Model 991 for a sub-task and may further dispatch the sub-task to the physical quantum computing subsystem. Such a sub-task may be one that a classical model instantiation is capable of performing, but only by consuming a disproportionate share of computational resources over a prolonged period, such that performing it on the classical model instantiation would degrade the throughput available for other processing. Dispatching such a resource-intensive sub-task to the physically distinct quantum computing subsystem apparatus may thus conserve the resources of the classical model instantiation and preserve its throughput capacity. This selection and dispatch are made on the basis of the suitability of an available capability to the sub-task and of the conservation of computational resources, and may be considered distinct from the separation of countervailing objectives per se.

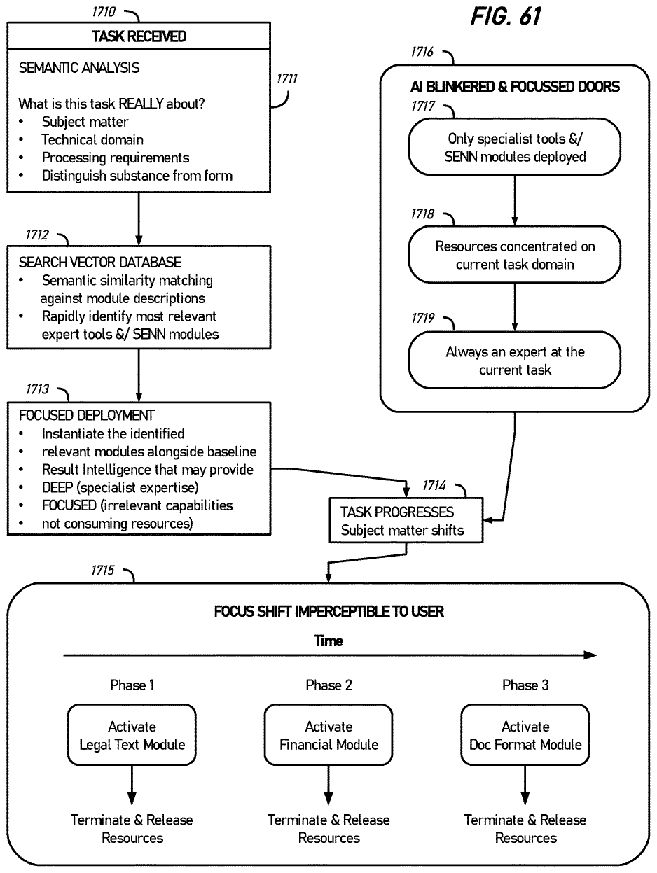

FIG. 61 illustrates the operation of the semantic focus mechanism in greater detail. When a task is received 1710, the system may perform a semantic analysis 1711 to determine what the task is really about—identifying its subject matter, technical domain, and processing requirements. Distinguishing the substance of the task from the form in which it is presented. This distinction matters because the superficial characteristics of a task may not reveal its true requirements: a request that appears to concern document formatting may in substance require legal expertise, financial analysis, or technical domain knowledge that the formatting alone does not suggest.

The results of this analysis may be used to search a database 1712 of module and tool descriptions, using semantic similarity matching to rapidly identify the most relevant expert tools and specialist SENN modules. The identified modules may then be deployed 1713 alongside the baseline, such that the intelligence brought to bear on the task is both deep by virtue of specialist expertise and focused by virtue of the semantic selection that excludes irrelevant capabilities from active deployment. As the task progresses 1714 and the subject matter shifts, the semantic focus may shift in a manner that is imperceptible to the user 1715. In a first phase, a legal text module may be activated, then terminated and its resources released. In a second phase, a financial module may be activated for the next portion of the task. In a third phase, a document formatting module may be activated. The user may experience consistent expert-quality output throughout without perceiving the underlying transitions between specialist tools and modules. The user may thus experience the quality of service that would conventionally require a team of human specialists working in sequence, delivered by a single system that marshals and releases specialist capabilities as the need arises. The result is a blinkered and focused system 1716 in which only specialist tools and SENN modules 1717 relevant to the task are deployed, resources are concentrated on the current task domain 1718, and the system operates as an expert at the current task 1719.

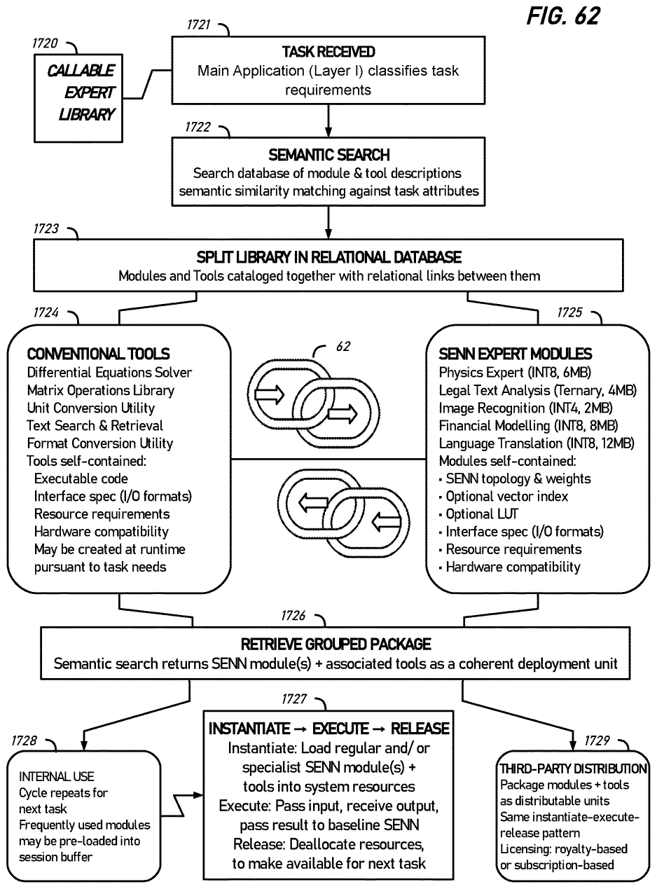

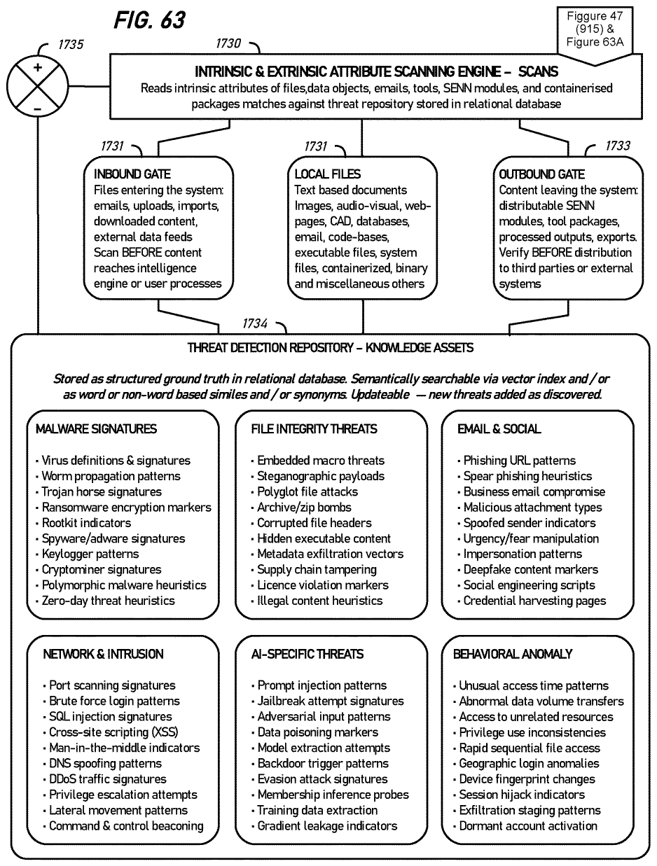

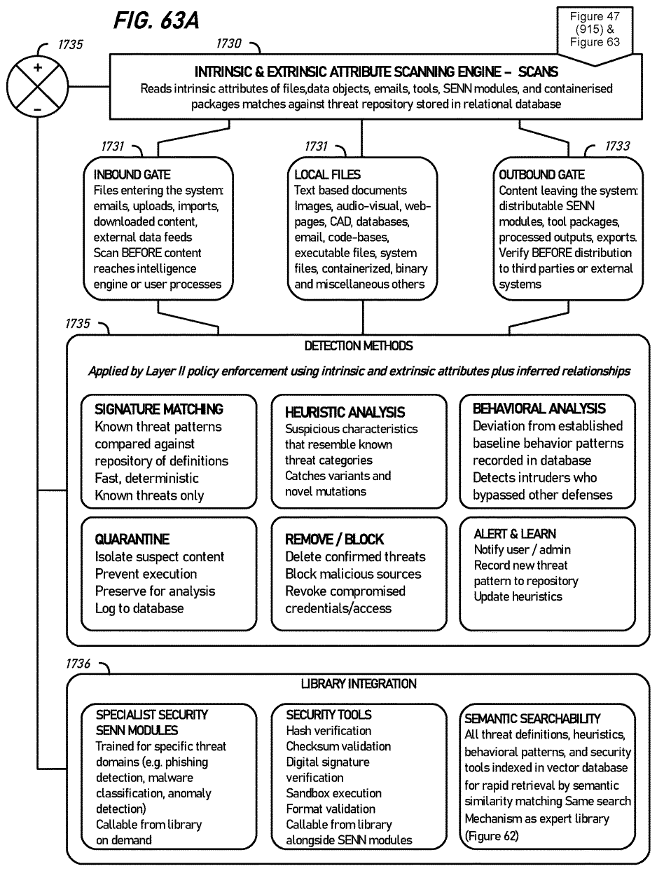

FIG. 62 illustrates a callable expert library 1720 in which expert SENN modules and tools are stored together in a split library within the relational database 1723, catalogued with relational links between them. When a task is received 1721, the main application of the first layer classifies the task requirements and performs a semantic search 1722 of the library, matching the task attributes against module and tool descriptions using semantic similarity. The library comprises two categories of callable resources linked by relational associations 62. Callable tools 1724 may include differential equations solvers, matrix operations libraries, unit conversion utilities, text search and retrieval tools, and format conversion utilities. Each callable tool may be self-contained, comprising executable code, an interface specification defining input and output formats, resource requirements, and hardware compatibility information. Tools may further be created at runtime pursuant to task needs where no existing tool is adequate. SENN expert modules 1725 may include physics, legal text analysis, image recognition, financial modeling, and language translation specialists, each stored with its configuration type and resource footprint. Each SENN expert module may be self-contained, comprising the SENN topology and weight configuration, an optional vector index, an optional pre-calculated lookup table, an interface specification, resource requirements, and hardware compatibility information. Relational links within the database may associate SENN modules with the callable tools they may require, such that a physics SENN expert may be relationally linked to mathematics tools. The semantic search may return a grouped package 1726 comprising the relevant SENN module or modules together with their associated tools as a coherent deployment package. The system may then instantiate, execute, and release 1727 the grouped package: loading regular and specialist SENN modules and tools into system resources, passing input data, receiving output, passing results to the baseline SENN, and then deallocating resources to make them available for the next task.

The efficiency of this approach may be understood by analogy to human cognition: a human being does not maintain every learned skill in active working memory at all times. The neural pathways for a specific learned skill—such as tying shoelaces—activates when the task is identified as needed, executes the learned sequence. Then returns to a resting state in which those neural resources are available for other demands. It would be wasteful and probably impossible for a human to simultaneously maintain the shoelace-tying capability in active working memory—while simultaneously maintaining capabilities for performing brain surgery and compiling financial reports.

Similarly, a computing system operating according to the subject technologies may not maintain every specialist SENN module and callable tool in active memory simultaneously; it may instead maintain only the modules relevant to the current task or tasks, and retrieve additional modules from the library as new tasks are identified. The library may support both internal use 1728, in which the cycle repeats for subsequent tasks and frequently used modules may be pre-loaded into a session buffer—in the manner of a professional preparing the specific tools needed for a specific task. Rather than carrying every tool available—and third-party distribution 1729, in which modules and tools may be packaged and supplied as distributable units. For use in other systems according to an instantiate-execute-release method of operation. As may also be provided subject to licensing arrangements that may include royalty-based or subscription-based compensation models.

FIGS. 63 and 63A illustrate a security and threat detection capability that may be applied by the intrinsic and extrinsic attribute scanning engine 1730 to protect the system and its users. The attribute scanning engine described elsewhere in this specification-which reads the intrinsic and extrinsic attributes of data objects and records those attributes to the relational database—is inherently well suited to threat detection because the same interrogation that identifies the type, structure, origin, and characteristics of a file or data object may simultaneously identify attributes that indicate malicious content, compromised integrity, or anomalous behavior.

Furthermore, the efficacy of this threat detection capability may be further improved by the ability of the intelligence engine to infer relationships between intrinsic and extrinsic attributes of files and data objects. A signature-scanning and matching process may compare file contents against a repository of known threat patterns, but fail to detect novel or zero-day threats whose signatures are not yet recorded. The artificial intelligence engine operating according to the subject technologies may go further and achieve more. Operating as an artificial intelligence investigating security expert by examining the intrinsic attributes of a file—such as the code structures, function calls, system hooks, and programmatic levers embedded within it—and inferring whether those attributes appear legitimate or whether they exhibit characteristics that could indicate dangerous or malicious capabilities or behavior, even in the absence of a matching signature. The intelligence engine may further combine this intrinsic analysis with extrinsic attributes—such as the file extension, the storage location, the context in which the file was discovered or received, and whether the file is positioned to execute at system startup or at other privileged and vulnerable moments—to insightfully and intelligently build a more complete picture of the threat potential than is discoverable by assessing either category of attributes could provide in isolation.

For example, an executable file located in a directory or list that causes it to load at system load and boot time and containing unusual code structures that do not match known legitimate system functions may be identified and flagged by the intelligence engine. As a file warranting quarantine and further analysis. Even though no existing signature match is found in the available threat repository collections. Which may be stored within a database and or as part of a factual matrix operated by the system also containing other ground truths 950 and other 915 knowledge assets (FIG. 47). The artificial intelligence engine may thus apply the knowledge assets, ground truths, and inferential capabilities of the subject technologies to provide a more intelligent threat detection and antivirus capability than conventional signature-based or heuristic-based scanning alone.

The scanning engine may read the intrinsic attributes of files, data objects, emails, tools, SENN modules, and containerized packages and match those attributes against a threat detection repository stored as structured ground truth in the relational database 118 (FIGS. 1, 2, 3, 5, 6 and 47). The repository may be semantically searchable via vector index and via word and non-word synonym and simile groupings, and may be updated as new threats are discovered. The scanning engine may operate at two gates: an inbound gate 1731 that scans files entering the system—including emails, uploads, imports, downloaded content, and external data feeds—before the content reaches the intelligence engine or user processes; furthermore existing local files 1731 of all types may be scanned including text-based documents, images, audio-visual files, webpages, CAD files, databases, email, code-bases, executable files, system files, containerized packages, binary files, and miscellaneous others; and an outbound gate 1733 that verifies content leaving the system—including distributable SENN modules, tool packages, processed outputs, and exports—before distribution to third parties or external systems.

The threat detection repository 1734 may comprise knowledge assets organized into categories including: malware signatures such as virus definitions, worm propagation patterns, trojan horse signatures, ransomware encryption markers, rootkit indicators, spyware and adware signatures, keylogger patterns, cryptominer signatures, polymorphic malware heuristics, and zero-day threat heuristics; file integrity threats such as embedded macro threats, steganographic payloads, polyglot file attacks, archive and zip bombs, corrupted file headers, hidden executable content, metadata exfiltration vectors, supply chain tampering indicators, license violation markers, and illegal content heuristics; email and social engineering threats such as phishing URL patterns, spear phishing heuristics, business email compromise indicators, malicious attachment types, spoofed sender indicators, urgency and fear manipulation patterns, impersonation patterns, deepfake content markers, social engineering scripts, and credential harvesting pages; network and intrusion threat patterns such as port scanning signatures, brute force login patterns, SQL injection signatures, cross-site scripting, man-in-the-middle indicators, DNS spoofing patterns, DDoS traffic signatures, privilege escalation attempts, lateral movement patterns, and command and control beaconing; AI-specific threats such as prompt injection patterns, jailbreak attempt signatures, adversarial input patterns, data poisoning markers, model extraction attempts, backdoor trigger patterns, evasion attack signatures, membership inference probes, training data extraction patterns, and gradient leakage indicators; and behavioral anomaly patterns that may indicate an intruder who has bypassed other defenses. Such as unusual access time patterns, abnormal data volume transfers, access to unrelated resources, privilege use inconsistencies, rapid sequential file access, geographic login anomalies, device fingerprint changes, session hijack indicators, exfiltration staging patterns, and dormant account activation.

FIG. 63A further illustrates the detection methods and response actions that may be applied by the second layer policy enforcement using the intrinsic and extrinsic attributes and inferred relationships identified by the scanning engine 1730 at the inbound 1731 and outbound 1733 gates. The second layer—which in other contexts enforces ground truth rules for data quality, compliance, and organizational policy—may apply the same enforcement architecture to security policy, treating threat signatures and detection heuristics as a category of ground truth that governs the handling of suspicious content. Detection methods 1735 may include signature matching, in which known threat patterns are compared against the repository of definitions for fast and deterministic identification of known threats; heuristic analysis, in which suspicious characteristics that resemble known threat categories are identified, enabling the system to catch variants and novel mutations of known threats; and behavioral analysis, in which deviations from established baseline behavior patterns recorded in the database are detected, enabling the system to identify intruders who may have bypassed signature-based and heuristic-based defenses. Response actions may include quarantine, in which suspect content is isolated, prevented from executing, preserved for analysis, and logged to the database; removal or blocking, in which confirmed threats are deleted, malicious sources are blocked, and compromised credentials or access rights are revoked; and alerting and learning, in which the user or administrator is notified, the new threat pattern is recorded to the repository, and heuristics are updated. Library integration 1736 may provide specialist SENN security expert modules trained for specific threat domains such as phishing detection, malware classification, and anomaly detection, callable from the library on demand; security tools such as hash verification, checksum validation, digital signature verification, sandbox execution, and format validation, callable from the library alongside SENN modules; and semantic searchability of all threat definitions, heuristics, behavioral patterns, and security tools via the same vector database search mechanism used by the callable expert library of FIG. 62.

Persons skilled in the art will appreciate that the artificial intelligence engine of the DOORS 100 (FIG. 1 and FIG. 2) may thus be configured or operated in a way that may meet the security needs of the DOORS 100 system; and furthermore that a specific embodiment of the DOORS 100 system configured and operating as a security provider expert system may be deployed within or adjacent to other non-DOORS 100 systems and be used to meet the security needs of that other system, without deviating from these subject technologies.

A further embodiment of the subject technologies may provide a self-contained distributable security package in which the intelligence engine, a threat detection repository comprising threat definitions and signatures organized as structured ground truths, and one or more pre-trained synthetic electronic neural network modules may be packaged together as a containerized unit. The containerized unit may be stored on removable media, on a network-accessible server, or as a downloadable package, and may be deployed onto a computing system that is damaged, compromised, or otherwise unable to perform its own security functions.

Upon deployment, the containerized unit may bootstrap the intelligence engine to operational capability without relying on the security infrastructure of the host computing system, which may itself be corrupted or rendered non-functional by the security event that necessitated the deployment. The pre-trained synthetic electronic neural network modules may provide a baseline level of threat detection capability from first boot-up, in the manner described with reference to FIG. 3 and pre-trained learning 48, so that the deployed instance may begin scanning, evaluating, and remediating the host system immediately upon initialization. The threat detection repository included within the containerized unit may comprise current threat definitions and signatures at the time of packaging, and may be updated via network connection to external threat repositories where network connectivity is available. The containerized security package may thus serve as an emergency recovery tool analogous to bootable recovery media, but augmented with the full intelligence engine capability of the subject technologies including intrinsic and extrinsic attribute scanning, advanced relational threat inference, basic threat inference, and the response actions described with reference to FIG. 63A. Following remediation, the containerized instance may optionally be retained as a persistent security provider on the recovered system, or may be removed once the host system's own security capabilities have been restored.

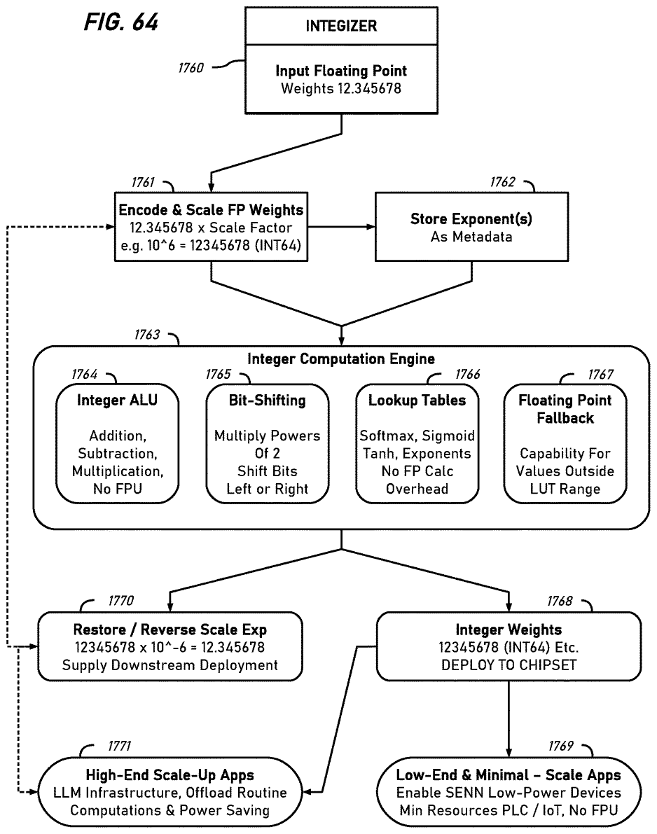

FIG. 64 illustrates a processing module referred to herein as an Integizer that may refactor trained neuron weights of a synthetic electronic neural network between floating-point and integer hardware architectures and vice versa. In the forward path, the Integizer may receive floating-point weights 1760 and apply an encode and scale operation 1761 in which the floating-point weight values are multiplied by a deterministic scaling factor—such as a power of ten or a power of two—to shift the significant digits into the integer range, producing scaled integer weight values. The scale exponent representing the magnitude of the scaling factor applied may be stored separately as metadata 1762. All intermediate computations may then be performed by an integer computation engine 1763 comprising: an integer arithmetic logic unit 1764 performing addition, subtraction, and multiplication without requiring a floating-point processing unit; a bit-shifting capability 1765 in which multiplication or division by powers of two is accomplished by shifting the binary representation of the integer value left or right; pre-calculated lookup tables 1766 in which the output values of non-linear activation functions such as SoftMax, sigmoid, hyperbolic tangent, and exponential functions are computed in advance and stored (math ground truths 916, FIG. 47 knowledge assets). Held in an array indexed by the integer input, eliminating runtime floating-point calculation overhead; and this may further include a floating-point fallback capability 1767 for values that fall outside the range of the pre-calculated lookup table entries or for mathematical functions that have not been pre-computed.

In such a system, the predominant share of inference computations may be performed using integer arithmetic, with the floating-point capability engaged only for input and output conversion and for those specific computations that cannot be served by the pre-calculated lookup tables. The resulting integer weights 1768 may be deployed directly to the destination chipset for operation in the integer domain. In the reverse path, the process may be reversed: integer weights may be restored to floating-point representation 1770 by multiplying by the reciprocal of the stored scale exponent—the same base raised to the negative power. This reverse operation bypasses the integer computation engine 1763 and proceeds directly from the encode and scale stage 1761 to the restore and reverse stage 1770, applying the reciprocal scaling factor to produce floating-point weight values for downstream deployment. Both the forward encode and scale operation and the reverse restore operation are multiplication: a positive exponent shifts significant digits into integer range, and a negative exponent shifts them back to floating-point range. The scaling factor is deterministic, derived from the weight values themselves, and the stored scale exponent tracks the magnitude of the shift applied.

The Integizer process of the subject technology of a specific embodiment may be deployed across a range of computational scales. In low-end and minimal-scale applications 1769, the integer weights 1768 may be deployed directly to chipsets on low-power devices including embedded processors, programmable logic controllers, IoT sensors, and microcontrollers that may lack a dedicated floating-point processing unit—enabling devices that require only a modest degree of intelligent behavior to operate SENN-based inference within the constraints of their available hardware.

In high-end scale-up applications 1771, an alternate embodiment of the Integizer subject technology may augment large-scale AI infrastructure—including frontier model training and inference facilities. In the primary use case, integer weights 1768 may be deployed to operate high-end applications directly in the integer domain, offloading routine computations from scarce and expensive floating-point processing hardware. Additionally, restored floating-point weights 1770 may be supplied to high-end applications where floating-point operation is required, or where the reverse path has been used to convert integer-native weights to floating-point representation. The Integizer may thus enable a mixed-computation architecture in which integer processing and floating-point processing operate together and integer processing may be utilized to perform the bulk of the work efficiently at lower cost, and floating-point processing may be retained and used where the computation genuinely requires it.

By operating in this mixed mode, the system may reduce the overall cost of computation while maintaining the quality of results. This approach may enable a facility to bring substantially more raw computational capacity online at reduced cost per unit of computation. By shifting a significant share of computation to Integizer-based integer processing, the build-out of computational capacity may be accomplished more quickly and at reduced cost, because integer processing hardware is more widely available and less likely to suffer from the supply chain constraints that may affect high-end floating-point AI processing hardware. The economic cost of utilizing the high-end floating-point chips may further be improved, because those chips may be allocated exclusively to computations for which their capabilities are required. Rather than being consumed by operations that could be performed equally well in the integer domain.

The Integizer may further provide the low-energy computational substrate for the sentinel operating mode described below, in which a baseline SENN maintains persistent awareness at minimal resource consumption—a mode that may be applicable at every scale from individual IoT devices maintaining a watchful state to datacenter infrastructure maintaining baseline readiness across many concurrent sessions and, in some use cases, continuously chained model instantiation sessions that may persist indefinitely according to these subject technologies.

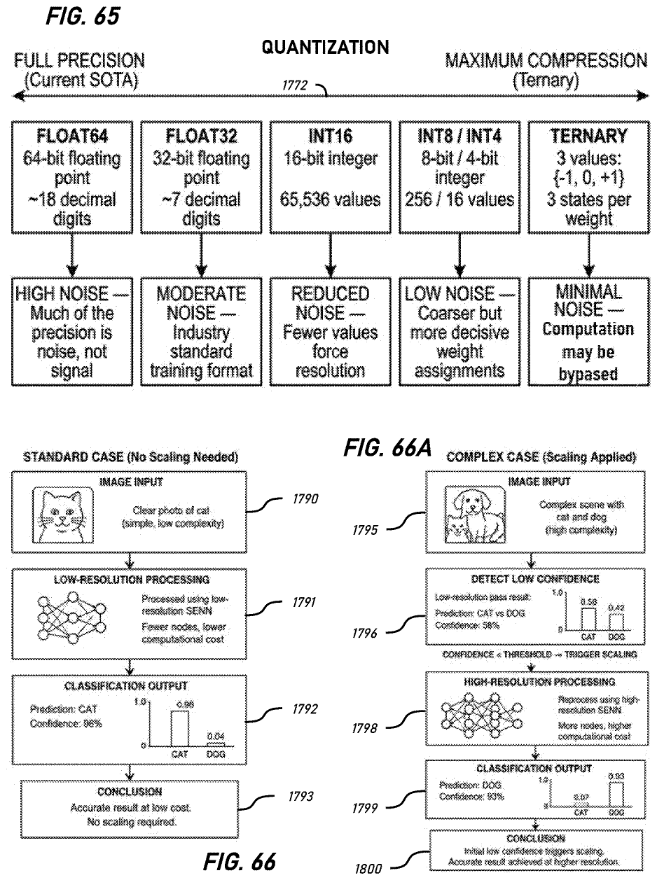

FIG. 65 illustrates a quantization spectrum 1772 showing the range of weight representations from full precision to maximum compression. Neuron weights within a SENN may be quantized—that is, constrained from a high-precision floating-point representation to a lower-precision discrete representation having a reduced number of distinguishable values. Quantization may be accomplished by rounding, in which a floating-point weight is mapped to its nearest representable value in the target discrete set, or by truncation, in which the less significant portion of the floating-point value is discarded. The target representations may in the lifetime of this patent exceed and/or include sixty-four-bit floating-point with approximately eighteen decimal digits of precision, thirty-two-bit floating-point with approximately seven decimal digits, sixteen-bit integer with 65,536 distinguishable values, eight-bit or four-bit integer with two-hundred-and-fifty-six or sixteen values respectively, and ternary representing the most extreme form of compression. The structural effects of weight quantization may to some extent operate as a noise filtering mechanism within the SENN. This is because at higher precision, some of the representable range may constitute noise rather than signal. As quantization increases, fewer distinguishable values may force the network to make coarser but more decisive weight assignments, and at the ternary extreme the computation for zero-weighted connections may be zero. A weight of zero causes no change to the signal throughput, and accordingly the computation step for that connection may be omitted. This does not bypass the neuron, because on the scale between negative one and positive one used in ternary SENN, zero is a value like any other in the range. The Integizer of FIG. 64 may be applied to both models implemented with regular and quantized weights to enable integer-only inference. The features described herein—including the callable expert library assets, the sentinel operating mode, the security scanning capability, and the semantic focus and blinkers mechanisms—may be applied to SENN modules and other models operating at any precision level, as may be suited to the requirements of the application.

The Integizer may further serve as a cross-architecture portability method for exporting the intelligent behavior of a trained synthetic electronic neural network from one system architecture to another. The intelligent behavior of a trained synthetic electronic neural network is comprised of its trained neuron weights, which encode the patterns, associations, and decision boundaries that the network has learned through training. A synthetic electronic neural network trained on a first chipset operating in the floating-point computational domain produces trained neuron weights in a floating-point format that is native to that chipset. These floating-point weights are not directly operable on a second chipset that operates in the integer computational domain, and conversely integer-native weights are not directly operable on a floating-point chipset, because the computational formats of the two chipset types are mutually incompatible. The Integizer may resolve this incompatibility by receiving the trained neuron weights in the computational format native to the first chipset, applying the encode and scale operation to produce scaled weight values in a computational format compatible with the second chipset, storing the scale exponents associated with the scaling factors applied to the weights, and assembling a refactored weight database comprising the scaled weight values and the stored scale exponents. The refactored weight database may then be deployed on the second chipset, thereby importing the intelligent behavior of the first system architecture to the second system architecture and enabling the second system architecture to operate under the control of the imported intelligent behavior. There may be a reduction in precision where the integer range does not map onto the full number sequence of a floating-point weight value. But where the integer range used is sufficiently large then full precision may be preserved with no loss, because the decimal point position is tracked by the stored scale exponent rather than encoded in the value itself. Where the range of the receiving chipset is insufficient to accommodate the full number sequence of one or more weight values, the encode and scale operation may preserve the maximum precision within the available range. This portability method operates bidirectionally: a synthetic electronic neural network trained in the floating-point domain may be adapted for deployment on integer hardware, and a synthetic electronic neural network trained natively in the integer domain may be adapted for deployment on floating-point hardware.

FIGS. 66 and 66A illustrate dynamic resolution scaling of SENN processing. During inference operations, the baseline SENN—which may operate with quantized weights or integer-only arithmetic through the Integizer for efficiency—may encounter sub-tasks for which its confidence in the inference result falls below a threshold. When such a confidence gap is detected, the system may dynamically instantiate additional processing capacity for the specific sub-task exhibiting the low confidence for a desired period of operation. The additional capacity may be released after the sub-task completes, in the manner of the instantiate-execute-release pattern described herein. In a standard case where no scaling is needed, an image input 1790 of low complexity may be processed by a low-resolution SENN 1791 using fewer nodes and lower computational cost, producing a classification output 1792 with high confidence—for example, a prediction of CAT with 96% confidence—leading to a conclusion 1793 that an accurate result has been achieved at low cost with no scaling required. In a complex case where scaling is applied, an image input 1795 of high complexity—such as a scene containing both a cat and a dog with similar visual characteristics—may produce a low-confidence result 1796 upon the initial low-resolution pass, for example a prediction split between CAT and DOG at 58% confidence. When the confidence falls below a threshold, the system may trigger scaling and instantiate high-resolution processing 1798 using a SENN with more nodes and higher computational capacity. The high-resolution processing may produce a classification output 1799 with substantially improved confidence—for example, a prediction of DOG together with a CAT with 93% confidence—leading to a conclusion 1800 that the initial low confidence triggered scaling and an accurate result was achieved at the higher resolution. Once the high-resolution sub-task has been completed and its result returned, the additional resources may be released back to the system for use by other processes.

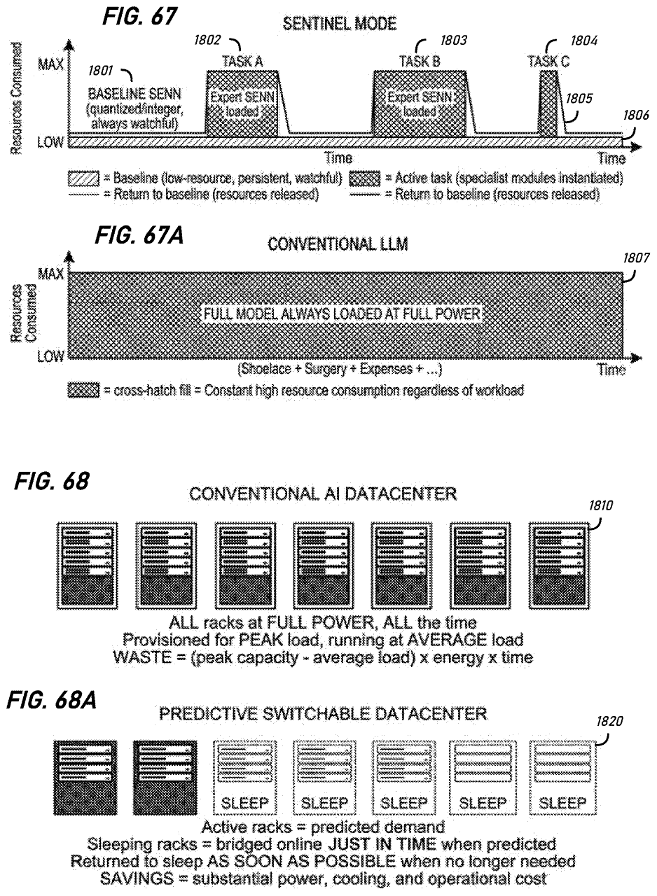

FIGS. 67 and 67A illustrate a sentinel operating mode in which the system maintains a persistent low-resource baseline awareness. In the sentinel mode of FIG. 67, a baseline SENN 1801 may persist in a watchful state consuming a low level of resources relative to full task-engaged operation. This operating pattern may be analogous to the manner in which biological neural systems maintain a low-energy baseline awareness—monitoring the environment and ready to respond—without sustaining the full cognitive resource expenditure that would be required for continuous complex reasoning. When tasks arise, specialist modules may be instantiated on demand: a first task 1802, a second task 1803, and a third task 1804 may each cause an expert SENN to be loaded 1805 for the duration of that task, with resources released 1806 and the system returning to the low baseline between tasks. By contrast, FIG. 67A illustrates a conventionally managed general purpose LLM in the art 1807 in which the full model is always loaded at full power regardless of workload, maintaining capabilities for all domains simultaneously—including capabilities not relevant to the current task—resulting in constant high resource consumption. The sentinel mode may be sustained across extended periods through the continuously chained instantiation capability described elsewhere in this specification, with successive baseline instantiations maintaining continuity of awareness and accumulated context through handover packages. The chained instantiation capability may enable the system to operate as a persistent, always-available intelligent presence that is not bounded by the duration of any single session or instantiation. Because each successive instantiation may receive the accumulated context, learning, and task state from its predecessor, the effective duration of the system's awareness may extend indefinitely. Limited only by the continued availability of the computing resources and the accumulated context data, not by any inherent constraint of a single model instantiation.

The system may also predictively scale up its resource allocation and usage as necessary within a continuous process, and may scale back to the low-resource baseline when the demands of the process permit. The system may further record 113 (FIG. 2) its activities 50 (FIG. 3) to the relational database 118 (FIGS. 1, 2, 3 5 and 6) during continuous operation, enabling a continually growing context that accumulates over the duration of the process. Completed tasks may be recorded as such, and new tasks may be added to a continuous workflow, such that an instantiation chain may manage an evolving body of work in a manner that may be analogous to the way a human professional manages a long-running project—maintaining awareness of what has been done, what remains to be done, and what has changed since the work began.

The system operating in the sentinel mode may further record 113 episodic experiences and their outcomes—both positive and negative—to the relational database 118 as structured ground truth. These episodic records may capture the circumstances of a task, the specialist modules and tools that were deployed, the decisions that were made, and the results that were achieved, including whether the outcome was successful, partially successful, or unsuccessful. Over time, the accumulated episodic experience may be used to inform the weight evolution of the SENN modules through the optimization process described in connection with the defined process 1300 of FIG. 55, such that the system may gradually improve its performance based on recorded experience in a manner that may be analogous to human learning through experience.

This process of experiential learning may appear slow when compared to the speed at which a large language model can be trained on a large corpus. However, when a plurality of users operate compatible systems and their experiential data is recorded in a form that can be aggregated, the experiential learning process may be shared across all participating systems. So that each participant benefits from the collective experience of the group. The aggregation of shared experiential data across many users may substantially accelerate the rate at which the system improves. The potential of this shared experiential learning model should not be understated. Because this potential may be applicable across a wide range of use cases in which multiple users perform similar or related tasks using compatible implementations of the subject technologies.

The combination of episodic experiential learning with the continuously chained instantiation capability may enable each participating system to operate as a progressively more capable intelligent agent. That not only persists across sessions without loss of context but also improves its performance over time based on both its own experience and the collective experience of compatible systems operating across the user base.

FIGS. 68 and 68A illustrate the extension of the resource management principles to physical hardware in a datacenter environment. FIG. 68 illustrates a conventional AI datacenter 1810 in which all server racks are maintained at full power at all times, provisioned for peak load but typically running at average load. With the difference representing waste equal to peak capacity minus average load multiplied by energy and time. FIG. 68A illustrates a predictive switchable datacenter 1820 in which the system may include switchable memory modules and switchable processing units capable of being powered up to an active state or powered down to a low-power sleeping state. The system may manage these resources by intelligently predicting demand ahead of the actual computational needs, then proactively bringing additional resources online just in time, and taking them back offline as soon as possible once they are not needed. This predictive approach differs from reactive scaling systems that detect a lack of capacity and then respond after the fact. In a reactive scaling system, there may be a period of degraded performance between the onset of demand and the availability of additional resources, and a period of wasted energy between the cessation of demand and the powering down of excess resources. In the predictive approach of the subject technologies, the artificial intelligence engine may help to reduce both of these inefficiencies by anticipating demand before it arises and by releasing resources based on process knowledge before utilization metrics would conventionally trigger a scale-down.

The intelligence engine—having classified an incoming task through semantic analysis and having identified the processing needs which may include specialist SENN modules and resource profiles as may be required—may predict the hardware resource demands before those demands materialize and then issue anticipatory demand signals to power up the specific additional memory modules and processing units that will be needed. The predictive intelligence that drives the anticipatory demand signals may be derived from the accumulated learning 50 (FIG. 2), 911, 382, 919, 118 (FIG. 47) of the expert system 381 (FIG. 47) of the second layer, which may progressively improve the accuracy of resource demand predictions based on historical patterns of task types, SENN module resource consumption profiles, and observed sequences of task progression. Conversely, when the intelligence engine predicts that specific hardware resources will no longer be required, the system may proactively begin powering down those resources at the earliest opportunity rather than waiting for utilization to fall below a reactive threshold.

In the predictive switchable datacenter 1820 of FIG. 68A, the powering up and powering down of the switchable memory modules and switchable processing units may be effected by one or more actuators, such as power-switching devices, contactors, or switchgear, that switch electrical power to those modules and units between an active state and a low-power sleeping state or a powered-off state. A result produced by the system, such as a prediction of computational demand, may operate such an actuator to bring a hardware resource to an active state in anticipation of demand, or to return a hardware resource to a low-power state or powered-off state when it is no longer required, such that a result produced by the system is applied to effect a physical switching of electrical power within the datacenter.

The switchable hardware that may thus be actuated according to the subject technology is not limited to the datacenter scale. Consistent with the application of the resource management principles across the range of computational scales described herein, the switchable hardware may comprise one or more of a processing unit of an individual computing device, a memory module of an individual computing device, and a server rack of a datacenter, each switchable between an active state and a low-power or powered-off state in response to a prediction produced by the system.

The several features described in the foregoing paragraphs with reference to FIGS. 60 through 68A—including semantic blinkers and semantic focus, the callable expert library of SENN modules and conventional tools with relational grouping, security and threat detection via the intrinsic and extrinsic attribute scanning engine, the Integizer module for integer-only inference, quantized weight representations, dynamic resolution scaling, the sentinel operating mode with long-endurance continuous operation and episodic experiential learning, and predictive switchable hardware resource management—may be applied individually or in combination with each other and with other features of the subject technologies. Including the meshed SENN topology of FIGS. 58 and 58A, the SENN optimization process of FIG. 55, the blinkers mechanism, and the continuously chained instantiation capability. At the smallest scale, a quantized SENN operating through the Integizer may provide intelligent behavior on an IoT sensor or embedded controller. At a mid-range scale, the sentinel operating mode may maintain persistent baseline awareness on a personal computing device or server. At the largest scale, the predictive switchable hardware management and mixed integer-floating-point computation enabled by the Integizer may improve the efficiency and reduce the cost of frontier AI infrastructure. The callable expert library, the semantic focus and blinkers mechanisms, the security scanning capability, and the continuously chained instantiation capability may operate at any of these scales and across transitions between them. These combinations are provided as examples and are not intended to limit the scope of the subject technologies to any particular combination of features.

In a further aspect of the subject technologies, the intelligent computing system may manage its processing resources predictively, reconfiguring those resources in anticipation of a processing requirement of a task before that processing requirement arises during the processing of the task. The prediction of the processing requirement may be based on a semantic classification of the task—by which the subject matter, technical domain, and processing requirements of the task are identified as described above with reference to FIG. 61—and on accumulated experiential learning derived from a plurality of previously processed tasks. Such accumulated experiential learning may include one or more of historical patterns of task types, resource consumption profiles associated with task types, and observed sequences of task progression as described above.

In addition to classifying the task as a whole, the intelligent computing system may semantically classify individual sub-tasks of the task, identifying for each such sub-task its subject matter, technical domain, and processing requirements in the same manner as described above with reference to FIG. 61, such that a processing requirement may be predicted at the level of an individual sub-task.

The predicted processing requirement may comprise a requirement that a sub-task be processed in isolation from a remainder of the task and/or a requirement that a sub-task be processed by a specialist processing resource and/or a computational demand of the task. In anticipation of the predicted processing requirement, the system may reconfigure its processing resources in any of several ways. The system may separate a sub-task from the remainder of the task and dispatch the sub-task to a separate instantiation operating with a blinkered purview restricted to the sub-task, as described above with reference to FIGS. 52A and 52B. The system may dispatch a sub-task to a specialist processing resource that is distinct from the synthetic electronic neural networks, such as the quantum computing subsystem or a callable tool, as described above with reference to FIGS. 59, 60, and 62. The system may also actuate switchable hardware to bring a hardware resource to an active state, or to return a hardware resource to a low-power or powered-off state, as described above with reference to FIGS. 67 and 68A.

The prediction of the processing requirement may be performed by an inference operation of the intelligent computing system—for example, an inference operation of the intelligence engine drawing upon the accumulated learning of the expert system, rather than by the application of fixed rules or thresholds to resource utilization metrics. The system thus predicts the processing requirement from the semantic content of the task and from the accumulated experiential learning, and reconfigures the processing resources in advance of the processing requirement arising. This predictive reconfiguration is thereby distinct from approaches that merely react to resource utilization metrics only after the demand has materialized.

### CONCLUSIONS RAMIFICATIONS AND SCOPE

DOORS was invented and made with the love of the family in the sample photographs, and the inventor hopes to share that lived experience with users to improve the amount of happiness in their lives. It is hoped that artificial intelligences will become part of the loving families of DOORS users and may even help to shape and nurture them with their immortal memories, and the long transgenerational perspectives that DOORS creates and curates in the service of those families.

Having had to reconstruct his 58 years of lifetime data from a range of sources after a security breach, the Inventor spent several days reconstructing his data into two intuitively accessible structures. One for his secret inventions, and research to be isolated from personal data. This was a major hassle fraught with tedium and highly demanding on his short-term memory and recall during the process of copying and placing files into the newly created intuitively structured and named directory structures that he created manually. Which is a task he was able to identify as highly suited to computers because they do not lose concentration, nor get bored, nor need breaks from such tasks. Which adverse events led the Inventor to make the inventive step in conceptualizing the subject technologies for the first time. To create the data organizing, optimizing, and reconciling, system (DOORS).

To perform a recovery and reconstruction operation, or data migration from old to new platforms. Optimally organizing and reconciling data files and structures intuitively effortlessly, as well as being quicker than a human user. Potentially saving the user many hours or even days; and perhaps even months or weeks of staff time for large organizations.

Users may also migrate their DOORS and with it the living and evolving learning of the artificial intelligence and/or machine learning module 46. Which may grow in wisdom and sophistication in the expert intuitive creation and use of user-compatible naming and data structuring habits. That are unique to and modelled upon the user's preferences and habits, and may be likened to onboarding a personal assistant to look after user's data.

In this information age data has been coined “the new oil”. By leveraging the power of relationship analytics of intrinsic and extrinsic attributes of files, in combination with relational database structures based on natural language along with simile and synonym grouped hierarchies, the DOORS intelligence engine, and its persistent long-term memory; DOORS may be the new drilling rigs, infrastructure and refineries!

### DOORS Search Engine

By transforming fragmented file collections into a fully mapped, searchable resource. The relational database may capture a Factual Matrix that cross-references key real-world facts and relationships (between people, names, faces, places and other data entities). Thus, turning previously inaccessible and chaotic data into an active, searchable knowledge base and expert system powered by artificial intelligence. Doing for personal and corporate data something like what search engines have done for the Internet. This AI-assisted search and retrieval capability, which finds links between files that are mostly not obvious from filenames or folder structures alone, provides a massive and unique capability for both consumers and enterprises. Bringing intelligent search capabilities to all the legacy data that most folks had given up on. Delivering comprehension and intelligent searching to previously untapped data resources for personal, professional and enterprise level users.

### Pre-Processing Chaotic Data for Next-Gen AI

Using AI-driven organization and reconciliation to standardize a chaotic data population (e.g., medical records) into a relational, structured data set specifically for use by other AI expert systems to perform pattern recognition and predictive analysis offers huge potential medical, scientific and economic opportunities. Enabled by the DOORS method of crawling a file collection to build a factual matrix. Followed by data retrieval, merging, reprocessing, and repackaging that may be conducted according to rules and policies designed to refine it. The ability to transform chaotic, real-world data into a clean, standardized, and relational data set that is made searchable is a critical bottleneck solution for the entire AI training and Big Data processing industries. Capable of producing data sets optimized for immediate ingestion and pattern recognition processing by other models and expert systems. Unlocking predictive and diagnostic value in fields like defense, healthcare, law, finance, accounting, science and engineering.

The output of this process is a homogenized data set: a structured, typed, and potentially relational collection assembled from the classified and refined source files, configured as a homogenized supply suitable for ingestion by a further data processing or artificial intelligence application.

### Safe Intelligent Systems Architecture

The subject technologies disclose a three-layer architecture for safe and reliable artificial intelligence, designed to address the problem of hallucination and erroneous outputs in the field of artificial intelligence. A first layer of classical logic orchestrates processing and module calls. A second layer—the expert system layer—is encoded within the knowledge tree and relational database structures themselves, and is responsible for recording learning, applying rules, and enforcing ground truth. A third layer of synthetic electronic neural network (SENN) modules performs generative and pattern-recognition processing, operating according to the ground truths and rules enforced by the second layer. The second layer may selectively override or suppress outputs of the third layer when those outputs conflict with enforced rules or recorded ground truths, providing a reliable and deterministic safety constraint on the otherwise probabilistic outputs of neural network-based models. This architecture directly addresses the hallucination problem identified in the state of the art.

### Computational Efficiency and Planetary Resource Conservation

A significant and growing cost of operating large-scale artificial intelligence systems is the consumption of computational resources—and by extension electrical power and physical infrastructure—attributable to the ingestion and processing of irrelevant tokens within context windows. Where a context window contains irrelevant material, every token of that material consumes a portion of the inference computation budget without contributing to the accuracy or utility of the output. At the scale of large deployed artificial intelligence systems serving millions of users, the aggregate waste attributable to irrelevant token ingestion represents a material burden on global energy consumption and carbon emissions.

The subject technologies address this problem directly. By interrogating the knowledge tree to identify and extract only the materials relevant to a given task, and by confining the field of view of the neural network layer to that relevant material prior to inference, the subject technologies reduce the token budget consumed by irrelevant content. The result is a reduction in the computational cost of each inference operation, a corresponding reduction in energy consumption per useful output, and an improvement in the ratio of useful computation to wasted computation across the system as a whole. At planetary scale, the aggregate effect of these improvements may be significant. The subject technologies thus offer benefits not only to individual users and enterprises in the form of faster and more accurate outputs, but to the planet in the form of reduced computational resource consumption and the environmental costs associated with it. More accurate artificial intelligence outputs, delivered using fewer computational resources, is a better outcome for users, for operators, and for the climate.

### Scalable AI: From Minimal Hardware to Maximum Intelligence

The subject technologies enable a highly scalable approach to artificial intelligence deployment, from resource-constrained edge devices through to large-scale cloud computing environments. A key aspect of this scalability is the treatment of synthetic electronic neural network modules as callable, instantiable units of specialist intelligence, analogous to the way in which a classical computing system calls and executes a specific function or module to perform a defined task, then releases the resources occupied by that function back to the system upon completion.

In the subject technologies, a specialist SENN module optimized for a specific application domain may be instantiated from the database when a task falling within that domain arises, deployed to perform that task, and then released—with its computing resources returned to the system for reallocation to a different specialist module or another process. This load-on-demand, release-on-completion model means that a system running on minimal hardware—such as a local device with limited memory and processing capacity—is not required to hold multiple large neural network models loaded in memory simultaneously. Instead, it maintains a library of stored specialist configurations in the database and instantiates only the module appropriate to the task at hand. This approach brings capable specialist artificial intelligence to devices that could not otherwise support it, extending the reach of the subject technologies to the full spectrum of computing hardware from embedded and edge devices through to enterprise-scale systems.

### SENN Efficiency, Persistent Operation, and Intelligent Infrastructure

The subject technologies further provide mechanisms that may improve the efficiency, security, and persistence of the intelligent computing system across the full range of deployment scales. Semantic focus—which operates on the capability side to select only the specialist expertise relevant to the current task—complements the blinkers mechanism. Operating on the input side to confine the field of view to relevant data. Together, the two mechanisms concentrate both input data and active processing capabilities on the task at hand, so that the system operates as a deep specialist at the current task rather than a shallow generalist across all tasks simultaneously. The knowledge assets of the expert library may include callable specialist SENN modules and tools together from locations within a library stored within the relational database, and catalogued with omnidirectional relational links between them. So that a semantic search of the library may return a grouped deployment package comprising relevant SENN modules together with associated tools as a coherent package. Implemented according to an instantiate-execute-release cycle: loaded into system resources for the duration of the task, then deallocated to make those resources available for the next task. The Integizer module enables inference computations to be performed in the integer arithmetic domain by converting floating-point values to scaled integers, storing the scale exponent as metadata, and performing the predominant share of computations using integer arithmetic logic, bit-shifting, and pre-calculated lookup tables, with a floating-point fallback for values outside the lookup table range optimized to operate with a low-overhead cost.

The Integizer aspect of these subject technologies may serve as a capability bridge between the integer and floating-point processing domains, enabling a mixed-computation architecture in which integer processing performs the bulk of the work and scarce floating-point hardware is reserved for computations that genuinely require it. This may reduce the cost of computation, accelerate the build-out of computational capacity using more widely available integer hardware, and enable SENN-based inference on low-power devices—including embedded processors, programmable logic controllers, and IoT sensors—that may lack dedicated floating-point processing hardware.

The sentinel operating mode may enable the system to maintain a persistent low-resource baseline awareness, instantiating specialist or generalist modules on demand as tasks arise and releasing their resources between tasks. Rather than maintaining the full model loaded at full power at all times in the manner of conventionally managed general purpose large language models. Furthermore, the sentinel operating mode may be sustained indefinitely through continuously chained instantiations. Perhaps to provide an AI night watchman CCTV capability. In which successive baseline instantiations maintain continuity of awareness and accumulated context through handover packages. So that the effective duration of the system's intelligent presence is not bounded by any single session or instantiation. Over time, the system operating in this mode may record episodic experiences and their outcomes to the relational database, and where a plurality of users operate compatible systems, this experiential learning may be shared across the user base so that each participant benefits from the collective operational experience of the group.

The intrinsic and extrinsic attribute scanning engine—which elsewhere in the subject technologies reads the attributes of files and data objects for the purpose of classification and relationship inference—may further be applied to security and threat detection. Scanning not only files already available to the system, but also scanning inbound and outbound content against a threat repository stored as structured ground truth in the knowledge assets of the relational database. Thereby leveraging the artificial intelligence engine's ability to infer relationships between attributes to detect novel and zero-day threats that conventional signature-based scanning alone may miss.

Dynamic resolution scaling enables the system to detect confidence gaps during inference and instantiate additional processing capacity for the specific sub-task exhibiting low confidence, releasing those resources upon completion. At the infrastructure level, predictive switchable hardware management may enable the intelligence engine to anticipate computational demand and proactively bring online hardware resources just in time. Before they are needed and return them to a sleeping state as soon as they are no longer required, reducing the energy waste associated with conventional reactive scaling. These capabilities may operate individually or in combination across the full range of deployment scales, from a single IoT sensor to a frontier-scale datacenter.

### Specialist and Ensemble Intelligence: The Blended Choir

The subject technologies support the development and deployment of specialist artificial intelligence models—including both large language models and smaller, task-specific language models—each optimized for a particular application domain. The topology and configuration of each specialist module may be independently optimized for its domain: varying the dimensionality, layer count, node count, connectivity pattern, neuron weights, activation functions, and co-processing logic to select the configuration that performs best for that specific application. The resulting library of specialist modules represents a form of distributed expertise: each module is a concentrated, efficient instrument of intelligence for its domain, rather than a single large generalist model attempting to perform well across all domains simultaneously.

Where a task benefits from the combined contribution of multiple specialist modules, the subject technologies support cooperative ensemble operation-referred to above as the blended choir. Multiple modestly sized specialist SENN modules may operate simultaneously, each contributing its domain-specific inference to a collective output that represents the blended product of their combined processing. This ensemble approach may produce outputs that are richer, more accurate, and more nuanced than those achievable by any single model operating alone, while retaining the efficiency benefits of specialist optimization within each contributing module.

The accumulation of operational experience in a structured and retrievable form may further enhance the efficacy of these specialist models over time. Task-based experience—including the problems encountered, the tools generated, and the outcomes achieved—is recorded in the factual matrix and indexed in the knowledge tree, making it available as context for subsequent similar tasks. This structured accumulation of operational experience may provide a progressively richer source of task-based training, supplementing formal training data with the lived operational history of the system. The result is an artificial intelligence that improves not only through formal training cycles but through the structured assimilation of its own experience.

### Sub-Domain Isolation and Output Merging

A further capability of the subject technologies addresses a class of complex tasks in which the overall task contains a plurality of sub-domain components, each requiring a distinct mode of operation that a single model instantiation cannot optimally serve simultaneously. This incompatibility between sub-domains may arise in two ways. In the first case, the sub-domain components may have countervailing objectives. Where the simultaneous pursuit of both objectives within a single inference operation causes bleed-through, in which optimization of one sub-domain adversely affects the output of another. In the second case, each sub-domain may call for a differently configured mode of processing even where the objectives are not in direct conflict: for example, one sub-domain may require strict deterministic constraint reasoning while another requires generative probabilistic inference, and no single model instantiation can optimally serve both simultaneously. It is important to distinguish this sub-domain isolation mechanism from the blinkers mechanism described elsewhere in this specification.

The blinkers mechanism operates within a unified inference operation: it curates the informational field of view presented to a single model instantiation, restricting what that model sees in order to preserve its computation budget and prevent confusion from irrelevant context—like a horse wearing blinkers to see only the relevant track ahead. The sub-domain isolation mechanism addresses a prior and different question: whether the task itself can be optimally served by a single model instantiation at all. Where the answer is that it cannot, the solution is not to curate what a single model sees, but instead to recognize that different legs of the course require different horses—and to put the right horse on each leg. In practice, both mechanisms may operate together: each sub-domain instantiation may receive its own blinker-curated context package appropriate to its portion of the task. While the sub-domains remain isolated from each other by separate instantiation.

In either case, the subject technologies enable the intelligence engine to identify the sub-domain components within the task, to dispatch each component to a separately instantiated model—whether a further instance of the same model operating independently of the other instances, or a specialist model selected as best suited to the mode of operation required by that sub-domain—to process each component in isolation within its own instantiation, and to merge the completed outputs into a unified task output. The separate sub-domain instantiations may operate in parallel—each processing its respective sub-domain concurrently—or sequentially, one after another.

Where sequential operation is employed, the order in which the sub-domain components are processed may itself be significant: the output of an earlier sub-domain instantiation may inform, condition, or provide contextual grounding for a subsequent one, such that the sequence in which the horses run their respective legs of the course may affect the quality of the unified output. The intelligence engine (operating the Model Session Management) may determine the optimal sequence, or the sequence may be inherent in the structure of the task itself. By isolating countervailing or otherwise incompatible sub-domain components into separate instantiations, the subject technologies may eliminate bleed-through between the incompatible tasks of sub-domains. Thus enabling each to be served optimally by the model instance that is best configured for its specific mode of operation, regardless of whether those instantiations operate concurrently in parallel or in a determined sequence.

### User Emulation and Autonomy

A dedicated terminate and stay resident (“TSR”) monitoring module may operate as a lightweight background process, watching a user's file creation and storage choices, or recording changes observed between sessions. On resource-constrained devices such as smartphones or other small local implementations, it is generally preferable that only the TSR monitoring module runs in the background rather than the full system, since running the full system as a persistent background process could be wasteful of the limited memory, processing, and battery resources of such devices. The observations recorded by the TSR module may be stored to a learning data store for subsequent incorporation into the expert system and neural network layers when the full system is next active. This experience may be encoded into directory structures, names, and file names, all of which may be cross-referenced with the factual matrix in the relational database. The recorded data may also be used to train intelligence models. The goal of which is to study, learn, and then emulate user habits, so that the system may offer not only generic pre-trained sensible file and directory management styles, but with accumulated experience may become able to automate file naming and storage according to the learned preferences of a particular user. The subject technologies are applicable across the full spectrum of deployment scales, from a personal smartphone running a minimal TSR monitoring module through to an enterprise data center implementation of a large language model service.

### Relationship Inference Via Extrinsic and Intrinsic Attribute Cross-Referencing

The intelligence engine infers relationships between files by cross-referencing a shared fact, relationship or inference found in the intrinsic attributes and/or the extrinsic attributes of one file and the intrinsic attributes and/or the extrinsic attributes of the other file. Natural language descriptions, summaries, and mask names, labels, or tags may be automatically generated from the attributes and the relationships they reveal. Users may also input their own descriptions or edit autogenerated descriptions. The GUI and VUI features allow users to sofa-surf their files, audit, edit, narrate and curate them on a smart TV and/or Phone. Perhaps families will learn to love to view vacation photographs together with DOORS and to brainstorm the descriptions of the times they had together. Which family time might be a good thing in such times of constant and exhausting exposure to other people's content. Perhaps DOORS can help bring families back together around the big screen of a smart TV.

### Intelligent File Comprehension: The Factual Matrix-Tool-Creation and Preservation

At the heart of the subject technologies lies a new capability that goes beyond mere organization or retrieval of files. This is genuine comprehension of meanings: who, what, when, where that data objects relate, and how they relate to the real-world factual entities and to each other. The intelligence engine builds this comprehension by constructing a factual matrix—a structured and cross-referenced body of knowledge assembled from three complementary sources. The first is the intrinsic attributes of the files themselves: the metadata, content—including subsets of data objects nested therein, creation dates, authorship, format, and other characteristics that may be extracted directly from files. The second is the extrinsic attributes: the contextual information that comes from outside the files, such as the circumstances of their creation, the devices on which they were made, the events to which they relate, and the file names, structures and structure names and aggregated meaning of those names and structures. The third is the real-world ground truths pertaining to fact-based data entities—the persons, organizations, places, events, and objects that appear in, are the subject of, or are otherwise associated with members of the file collection. Which may include tools. By combining all three sources within the factual matrix, the intelligence engine may achieve a level of comprehension of the file collection that no system operating on file attributes alone could match.

Fact-based data entities are a particularly powerful dimension of this comprehension. A photograph may carry no name that identifies who is in it, but once the intelligence engine has established from the factual matrix that a particular face belongs to a particular person, it may infer that every file depicting that face relates to that person—and from there, to every other file in the collection that involves them. A document may contain no obvious reference to a specific matter, but once the intelligence engine knows from ground truths in the factual matrix that a particular organization is connected to it, it may trace the relationship through the attributes of the document and attribute it correctly. In this way the factual matrix may grow into an increasingly accurate and comprehensive model of the real-world context of an entire file collection, enabling relationship inferences that would be invisible to any system working from file attributes alone. Perhaps the most striking consequence is that DOORS may, over time, come to understand a user's file collection better than the user does—finding connections across decades of accumulated data that no human manually sifting through folders could reasonably expect to uncover.

The intelligence engine may further extend its capability through the creation and reuse of tools. When the intelligence engine encounters an operation for which no adequate tool exists in its stored library, it may generate a new one—a computer program, a script, or a sequential natural language instruction set—and record an addressable pointer to that tool within the factual matrix. On encountering a similar operation in future, the intelligence engine may retrieve the stored tool via its pointer and apply it without regenerating it from scratch, accumulating within the factual matrix a growing library of reusable problem-solving instruments. This tool-creation and reuse capability means that the intelligence engine improves not only through formal training but through the structured assimilation of its own operational experience. Each new tool is a distillation of the reasoning the intelligence engine applied to a specific problem. The library of stored tools is the accumulated practical wisdom of the system over a lifetime of use. The result is an intelligence engine that gets progressively more capable, more efficient, and more attuned to the specific needs of its users the longer it runs-carrying that accumulated wisdom forward to every new device and deployment it is migrated to.

### Unlocking New Capabilities

DOORS unlocks capabilities that no other system ever has. The artificial intelligence engine crawls files deep scanning their intrinsic and extrinsic attributes. These attributes are intelligently analyzed in combination with a relational database to infer relationships and build a factual matrix. Relationships may be inferred not only among files but also by finding links to real world entities. Dad's car, Mom's paintings, or the Coliseum as may be mentioned in document content or images content are recognized by the DOORS object recognition and used to infer relations between files; and between files and entities—that disclose hidden linkages. By scanning deep into files DOORS reaches levels of detail that may enable a level of comprehension that no system previously created can match. Enabling DOORS to infer relationships that are not obvious and thereby adding to the capabilities provided for users to truly master their own data and use it more effectively!

This virtuous cycle generates the DOORS cross-relational Factual Matrix. It may be the case that this enabling ability to build comprehension and from there to build comprehension models may eventually catch the attention of intelligence agencies, and detectives. As well as helping users and families know themselves and each other better. Through that bigger shared picture that can be captured by the Factual Matrix.

### Persistence and Inheritable Legacy

For people who want to be able to rescue old files from legacy devices and get them organized into a treasure chest of memories that can then be shared. DOORS may be a life-long helper application and agent whose learning may be ported to every new device. Capable to persistently learn and record a user's habits into a cloneable, non-transitory learning data structure configured for use by successor user devices. The learned expertise (the wisdom of the AI/ML module) and the Master copies may become an inheritable digital legacy beyond the lifetimes of users for their family and friends. Allowing the DOORS agent to become a family historian, narrator and curator over generations.

### Intelligent Directory and Branching Knowledge Tree Hierarchy Labeling

Automatically labeling a new sub-directory nested within a master directory based on a relationship of the files it contains. Where the label is chosen from a dictionary of synonyms, similes and/or to match user habits. The hierarchical structure in these intelligently created and merged structures unlocks a vital piece of expert system logic. Because the structures set files into a hierarchy that goes from general applicability at the higher levels such as “Pictures” to the very specific “Vacation 1997”. They are not flat like webpages on the Internet; this structured nesting is also used in these subject technologies to build knowledge into intelligent relational databases in their nested structures. Using a branching natural language search and mapping to synonyms and/or similes as well as matches per se. These structures encode expert systems that use these learning trees and branching algorithms in combination with a dictionary, and thesaurus of synonyms and/or similes to refresh context and knowledge.

Furthermore, the extra capability these structures provide may allow human and artificial intelligence agents alike to access data holding structures intuitively using natural language. Indeed, according to these subject technologies intelligently structured data used in this way encodes the expert system into that structure. For hardly any computation overhead. Which is why this aspect of DOORS technology, even though it is incredibly simple, may be the secret sauce needed for persistent learning and a big piece of the jigsaw puzzle that is artificial general intelligence. The same approach leveraging similar knowledge trees may be used for a series of chess moves and other strategic machine intelligence applications such as wargaming and planning operations. Which may be of interest to military strategists, planners, and tacticians as well as corporations and government agencies.

### Dual-Index Architecture and Vector-Space Knowledge Retrieval

The subject technologies may employ a dual-index architecture for the knowledge tree that combines two complementary and mutually reinforcing retrieval paradigms. The first index may be arranged alpha-numerically, providing deterministic lookup by name or identifier in the manner of a conventional dictionary: any entity whose name is known can be located by direct traversal of the index from a first entry to a last entry in sequential order. The second index may be arranged according to meaning-based groupings, functioning as a thesaurus: entities are grouped not by name but by shared meaning, such that synonyms sharing a common concept and similes sharing a related but non-identical concept are co-located within the same branch of the index. Every entity reachable by name via the first index is also reachable by meaning via the second, and the two indexes are cross-referenced by the factual matrix so that traversal of one enriches retrieval from the other.

This dual-index structure is particularly well suited to implementation using graph database architectures, in which entities are represented as nodes and the relationships between them—synonym, simile, hierarchical membership, factual association—are represented as typed edges connecting those nodes. A query entered in natural language may be tokenised and represented as a vector in a high-dimensional mathematical space, and the proximity of that vector to the vectors representing stored entities and their groupings may be computed using standard distance or similarity metrics. Entities and groupings whose vector representations are nearest to the query vector in that high-dimensional space are ranked as the most semantically relevant candidates for retrieval. This vector-based proximity search in a higher-dimensional representation of meaning is a natural complement to the thesaurus index, and may be used to identify contextually relevant knowledge, experience records, and procedural tools with a precision and speed that purely lexical search cannot match.

The practical effect of this dual-index, vector-augmented retrieval is a substantial improvement in the accuracy and efficiency with which relevant information can be identified and extracted from a large body of stored knowledge—the needle-in-a-haystack problem described in the above in the Background section relating to the art in this technical field. A query that arrives using terminology different from that in which the relevant knowledge was originally recorded may nevertheless retrieve that knowledge accurately, because the thesaurus index and vector proximity computation identify the semantic relationship between the query terms and the stored knowledge even in the absence of a direct lexical match.

This same retrieval mechanism applies equally to procedural tools stored in the knowledge base: a Python script, a natural language instruction set, or a processing routine created to solve a specific problem may be retrieved by a future query describing a similar but not identically worded problem, because the system identifies the functional similarity between the new problem and the stored tool through their vector proximity (describing the simile) in the meaning space of the second index. The result is an artificial intelligence system that reuses its accumulated problem-solving experience with increasing effectiveness over time, finding and deploying the right tool for each new task from an ever-growing library of stored expertise.

### De-Cluttering and De-Duplicating Files

Data retention and data disposal policies may be applied by the DOORS to enforce the destruction of duplicates and obsolete versions of files by retaining only specific versions based on predetermined logic (e.g., retaining the last two versions or deleting versions older than one year). This may be of particular interests to organizations that have to manage large amounts of data by law such as financial institutions.

### AI-Driven Alias/Mask Generation for Intuitive Use

DOORS may automatically generate an intuitive alias or mask name for a file (e.g., renaming “IMG8474.JPG” to “Holly Taylor.jpg”) based on intrinsic and/or extrinsic attributes, and may use this mask name for display and processing without modifying the original file name. This ability to use the user-friendly mask name, label or tag while also preserving the original filename may be helpful where a chain of custody and verification of facts is needed. Such as in law enforcement and in litigation practices.

### Intelligent Content Retrieval for Financial and Other Specialist Data

DOORS may scan into the intrinsic content attributes plus extrinsic attributes of documents (e.g., emails or PDFs) using a language recognition module to identify relationally significant keywords (e.g., “receipt,” “order,” “invoice”) and automatically reconciling the file to a financial/accounting directory. Furthermore, this feature may be very powerful for helping users or professionals to create their accounts. By sorting all financial documents using policies into collections based on the data by year for example, and into categories such as expenses, income, and taxes paid. Indeed, DOORS may be used to assemble financial documents for an accounting expert system to automate user accounting, and even the preparation of tax returns for personal and corporate accounting. Indeed, this may be a large part of the value proposition that DOORS may deliver for users.

### A Step Toward Artificial General Intelligence

Artificial general intelligence—a level of machine intelligence capable of performing any intellectual task that a human being can perform, and of improving its own capabilities through experience across all domains—remains an aspirational goal of the field. The subject technologies do not claim to achieve artificial general intelligence, but they address several of the structural problems that stand between current artificial intelligence systems and that goal, and in doing so they may represent a meaningful step in that direction.

The combination of a structured dual-index knowledge tree encoding expert system intelligence, a factual matrix of ground truths and relational knowledge, a library of specialist SENN modules callable on demand, a blended choir ensemble capability for cooperative multi-model inference, a competition-based co-evolution mechanism driving mutual improvement between expert system and neural network models, a ground truth enforcement layer preventing the propagation of erroneous outputs, and a structured accumulation of operational experience in retrievable form—together constitutes an architecture that addresses, at least in part, several of the properties generally considered necessary for artificial general intelligence: breadth of knowledge, structured reasoning, learning from experience, self-improvement, reliable factual grounding, and the ability to deploy specialist capabilities on demand for specific tasks. The persistent long-term memory provided by the knowledge tree and factual matrix, combined with the portability of accumulated learning to successor systems, further contributes to the kind of continuity of knowledge and experience that characterizes general intelligence. The subject technologies thus offer a coherent and practically implementable architectural contribution to the ongoing pursuit of artificial general intelligence, grounded in the principles of expert system design, neural network optimization, and structured knowledge representation.

### Cross-System Learning and Portability

The learning accumulated by a system embodying the subject technologies—comprising decision tree logic, node weights within decision tree structures, neuron weights within SENN modules, and recorded operational experience data—represents a substantial and growing asset of the system that improves with use. The subject technologies provide for the export of at least a portion of this accumulated learning to a second system that is compatible with the exported data, and for the installation of that learning into the second system. The receiving system thereby benefits immediately from the operational experience of the originating system, without being required to independently derive that learning through its own operational history.

This portability of accumulated learning has practical implications across a wide range of use cases. A new device or system instance may be bootstrapped with the learning accumulated by an existing deployment, dramatically reducing the time required for the new system to reach a useful level of operational competence. Learning developed in one deployment context may be shared with other compatible systems, enabling the collective improvement of a community of deployed instances from the combined experience of all members. For enterprise users, the ability to export and replicate trained system configurations across multiple deployments ensures consistency of operational behavior and eliminates the cost of retraining each instance independently. The compatibility requirement is deliberately defined relative to the specific data being exported rather than requiring architectural identity between systems, so that the benefits of accumulated learning may be shared across a broad range of compatible receiving systems.

### Backups Mirrors and Synchronization

DOORS may leave your legacy files on your legacy devices and pull everything into a new global data set of everything connected to it. Then it may whittle this down into a Master collection and create a copy of these into a Master directory. By removing duplicates and obsolete versions according to policies and user choices. It may also work virtually on files in situe where they are. By creating a virtual Master view in an interface display where users can work on them. From which they may opt to pull-in only the decluttered and de-duplicated Master files by leveraging the power of the relational database to do the heavy lifting. Rather than wasting bandwidth and storage space moving around and storing unwanted duplicates and obsolete data. Indeed, this virtual version may be the basis of a free trial and/or limited license version of the DOORS technology.

At its simplest DOORS may also be used to more intelligently backup and/or synchronize collections of files. If users want a working Master and a backup that stays in synch for example. For enterprise users there's full professional mirroring of the relational databases and data which has been split into high bandwidth, medium and low throughput operations. So that the big and slow but infrequent types of operation will not slow down the more frequently used operations.

The Factual Matrix of the subject technologies provides an omnidirectional cross-referencing structure in which addressable pointer links may connect any file, data entity, data object, or procedural tool to any other file, data entity, data object, or procedural tool within the database structures of the system, without constraint as to the direction or hierarchy of traversal. This omnidirectional linking enables the intelligence engine to traverse relationship chains between files and their intrinsic contents, between files and real-world fact-based data entities, between data entities and other data entities, and between any of the foregoing and the procedural tools, decision tree structures, and knowledge tree nodes that encode the accumulated learning of the system. The omnidirectional Factual Matrix, in combination with the three-layer architecture, the isolated operating environment, and the inference crystallization and compound comprehension capabilities described herein, provides a self-enriching knowledge structure whose utility and comprehension compound over the operational lifetime of the system.

The description set out above is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

References to a computer, mobile computing device and server above should be understood as being general purpose computing devices which may include, but are not limited to, one or more processors or processing units, a system memory, and a bus that couples various system components including the system memory to the processor as is known in the art of computers. The computing devices may be described in the general context of computer system executable instructions, such as program modules, being executed by a computer system (described for example, below). In some embodiments, a server processing any of the data (which may include artificial intelligence and/or machine learning) may be a cloud computing node connected to a cloud computing network (not shown) and practiced in distributed cloud computing environments where tasks are performed by remote processing devices that are linked through a communications network. In a distributed cloud computing environment, program modules may be located in both local and remote computer system storage media including memory storage devices.

The computing devices may typically include a variety of computer system readable media. Such media includes non-transitory, volatile and non-volatile media, removable and non-removable media. The system memory could include one or more computer system readable media in the form of volatile memory, such as a random access memory (RAM) and/or a cache memory. By way of example only, a storage system can be provided for reading and writing to a non-removable, non-volatile magnetic media device. The system memory may include at least one program product having a set of program modules that are configured to carry out the functions described above of embodiments of the invention. The program modules generally carry out the functions and/or methodologies of embodiments of the invention as described above by aid of a processing unit (e.g., a “processor”, “CPU”, “chip”, etc.).

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system) may be utilized. In the context of this disclosure, a computer readable storage medium may be any tangible or non-transitory medium that can contain, or store a program (for example, the program product) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Aspects of the disclosed invention are described above with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Terms such as “top,” “bottom,” “front,” “rear,” “above,” “below” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference. Similarly, an item disposed above another item may be located above or below the other item along a vertical, horizontal, or diagonal direction; and an item disposed below another item may be located below or above the other item along a vertical, horizontal, or diagonal direction.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

1. A method for operating an intelligent computing system that comprises one or more synthetic electronic neural networks, the method comprising:
receiving a main task objective comprising a plurality of sub-tasks, wherein there is at least a first sub-task and a second sub-task;
predicting, based on a semantic classification of the main task objective and on accumulated experiential learning derived from a plurality of previously processed tasks, a processing requirement of the task before the processing requirement arises during processing of the main task objective;
in anticipation of the predicted processing requirement, performing one or more of:
identifying the first sub-task as reinforcing a processing efficiency of the task objective;
identifying the second sub-task as countervailing the processing efficiency of the task objective relative to the first sub-task;
dispatching the second sub-task to an instantiation of an artificial intelligence model operating with a blinkered purview restricted to the second sub-task and separated from a processing of the first sub-task;
receiving a result of the processing of the second sub-task from the instantiation;
merging the result of the processing of the second sub-task with a result of the processing of the first sub-task to generate a combined result; and
generating a task result based on the combined result and processing of the main task objective by the one or more synthetic electronic neural networks.

2. The method of claim 1, further comprising separating the second sub-task from a remainder of the main task objective and dispatching the second sub-task to the instantiation operating with the purview blinkered from the remainder of the main task objective and restricted to the second sub-task, wherein the second sub-task has an objective that countervails with an objective of the remainder of the main task objective, and the second sub-task and the remainder of the main task objective are each processable by a single instantiation of an artificial intelligence model, and wherein the blinkered purview isolates the processing of the second sub-task from the processing of the remainder of the main task objective, such that the second sub-task and the remainder of the main task objective are not processed together within a single context window and mutually degrading bleed-through between the second sub-task and the remainder of the main task objective is prevented.

3. The method of claim 1, further comprising:
automatically generating a handover continuity package comprising task context, progress state, and instructions; and
automatically instantiating a successor instantiation that receives the handover continuity package and takes over a role of a predecessor instantiation, thereby chaining successive instantiations to process a task, a remainder of a task, or a sub-task member of the plurality of sub-tasks exceeding a capacity of any single context window.

4. The method of claim 3, further comprising maintaining the predecessor instantiation during an overlap period, wherein the predecessor instantiation provides supporting expertise and guidance, and the successor instantiation is provided an ability to query the predecessor instantiation.

5. The method of claim 1, further comprising:
enforcing a set of rules within a safety enforcement layer by operating an expert system;
checking one or more of: inputs to the one or more synthetic electronic neural networks, and outputs from the one or more synthetic electronic neural networks, for compliance with the set of rules; and
allowing only inputs and outputs that are compliant with the rules to pass through the safety enforcement layer.

6. The method of claim 1, wherein dispatching the second sub-task or another member of the plurality of sub-tasks comprises confining the purview to focus on materials semantically relevant to the second sub-task or on materials semantically relevant to that other member of the plurality of sub-tasks, and blinkered from non-relevant materials.

7. The method of claim 1, further comprising operating a competition learning loop in which a coupled machine learning-based expert system competes against a coupled synthetic electronic neural network-based system in repeated task-based competition, learning from outcomes, and providing distilled strategies as feedback for co-evolution.

8. The method of claim 1, further comprising:
interrogating a database to identify relevant ground truth knowledge assets related to a member of the plurality of sub-tasks;
compiling a context package that includes a dataset derived from within the ground truth knowledge assets comprising one or more of: identified applicable ground truths, tools, and knowledge; and
delivering the context package with the member of the plurality of sub-tasks to the instantiation to which the member of the plurality of sub-tasks is dispatched.

9. The method of claim 1, wherein the dispatching of the second sub-task includes dispatching an aspect of the second sub-task to a specialist processing resource that is external from the one or more synthetic electronic neural networks.

10. The method of claim 9, wherein the specialist processing resource comprises a coupled quantum computing apparatus.

11. The method of claim 1, further comprising operating a coupled quantum computing system in which one or more qubits operate in conjunction with one or more of the synthetic electronic neural networks, wherein data derived from quantum computing operations is distilled into a supply of learning data and used in combination with a weight evolution engine to adjust the weights of a synthetic electronic neural network.

12. The method of claim 1, further comprising performing one or more of: generating a file based on the task result and providing the file to a downstream process; modifying a pre-existing file based on the task result and providing the pre-existing file to a downstream process; generating a data object based on the task result and providing the data object to a downstream process; modifying a pre-existing data object based on the task result and providing the pre-existing data object to a downstream process; and operating an actuator based on the task result.

13. The method of claim 1, further comprising:
operating a callable expert library comprising specialist synthetic electronic neural network modules and callable tools catalogued together with relational associations between them;
performing a semantic search of the callable expert library, based on the semantic classification of the task, to identify one or more specialist resources relevant to the task;
retrieving a grouped deployment package comprising one or more of the identified specialist synthetic electronic neural network modules and associated callable tools; and
operating the grouped deployment package alongside a baseline according to an instantiate-execute-release cycle in which the grouped deployment package is loaded into system resources, executed to perform the task, deallocated upon completion, and in which resources not relevant to the task are excluded from active deployment.

14. The method of claim 1, further comprising:
operating the intelligent computing system in a sentinel mode in which a baseline synthetic electronic neural network persists in a watchful state at a low level of resource consumption;
detecting a member of the plurality of sub-tasks;
instantiating one or more additional modules required for the duration of the sub-task;
releasing resources allocated to the additional modules upon completion of the sub-task; and
returning the intelligent computing system to a persistent watchful state.

15. The method of claim 1, wherein the accumulated experiential learning comprises one or more of: historical patterns of task types, resource-consumption profiles associated with task types, observed sequences of task progression, and episodic records, each record recorded to a database as a ground truth and comprising one or more of circumstances of a task or sub-task member of the plurality of sub-tasks, specialist modules and tools deployed, decisions made, and outcomes achieved; the method further comprising using the accumulated experiential learning to inform one or more of: processing the task or sub-task member of the plurality of sub-tasks, processing the remainder of the task, processing a sub-task member of the plurality of sub-tasks, distillation of the learning, weight evolution of nodes within decision tree structures, and weight evolution of a synthetic electronic neural network.

16. The method of claim 1, further comprising operating one of the one or more synthetic electronic neural networks within a meshed topology in which a deep network and a shallow network are fused into a single structure with one or more shared layers of neurons, the shallow network operating to reinfuse the original computational purpose signal back into the deep network at mesh points, combining deep network capability with shallow network signal preservation to mitigate drift and amnesia.

17. A non-transitory computer-readable storage medium storing instructions that, when executed by a processor, cause the processor to perform operations for operating an intelligent computing system that comprises one or more synthetic electronic neural networks, the operations comprising:
receiving a main task objective comprising a plurality of sub-tasks, wherein there is at least a first sub-task and a second sub-task;
predicting, based on a semantic classification of the main task objective and on accumulated experiential learning derived from a plurality of previously processed tasks, a processing requirement of the task before the processing requirement arises during processing of the main task objective;
in anticipation of the predicted processing requirement, performing one or more of:
identifying the first sub-task as reinforcing a processing efficiency of the task objective;
identifying the second sub-task as countervailing the processing efficiency of the task objective relative to the first sub-task;
dispatching the second sub-task to an instantiation of an artificial intelligence model operating with a blinkered purview restricted to the second sub-task and separated from a processing of the first sub-task;
receiving a result of the processing of the second sub-task from the instantiation;
merging the result of the processing of the second sub-task with a result of the processing of the first sub-task to generate a combined result; and
generating a task result based on the combined result and processing of the main task objective by the one or more synthetic electronic neural networks.

18. The non-transitory computer-readable storage medium of claim 17, wherein the operations further comprise separating the second sub-task from a remainder of the main task objective and dispatching the second sub-task to the instantiation operating with the purview blinkered from the remainder of the main task objective and restricted to the second sub-task, wherein the blinkered purview isolates the processing of the second sub-task from the processing of the remainder of the main task objective, such that the second sub-task and the remainder of the main task objective are not processed together within a single context window.

19. The non-transitory computer-readable storage medium of claim 17, wherein the operations further comprise:
automatically generating a handover continuity package comprising task context, progress state, and instructions; and
automatically instantiating a successor instantiation that receives the handover continuity package and takes over a role of a predecessor instantiation, thereby chaining successive instantiations to process a task, a remainder of a task, or a sub-task member of the plurality of sub-tasks exceeding a capacity of any single context window.

20. The non-transitory computer-readable storage medium of claim 19, wherein the operations further comprise maintaining the predecessor instantiation during an overlap period, wherein the predecessor instantiation provides supporting expertise and guidance, and the successor instantiation is provided an ability to query the predecessor instantiation.

21. The non-transitory computer-readable storage medium of claim 17, wherein the operations further comprise:
enforcing a set of rules within a safety enforcement layer by operating an expert system;
checking one or more of: inputs to the one or more synthetic electronic neural networks, and outputs from the one or more synthetic electronic neural networks, for compliance with the set of rules; and
allowing only inputs and outputs that are compliant with the rules to pass through the safety enforcement layer.

22. A computing device comprising:
a processor;
a memory coupled to the processor; and
one or more synthetic electronic neural networks;
wherein the memory stores instructions that, when executed by the processor, cause the computing device to:
receive a main task objective comprising a plurality of sub-tasks, wherein there is at least a first sub-task and a second sub-task;
predict, based on a semantic classification of the main task objective and on accumulated experiential learning derived from a plurality of previously processed tasks, a processing requirement of the task before the processing requirement arises during processing of the main task objective;
in anticipation of the predicted processing requirement, perform one or more of:
identifying the first sub-task as reinforcing a processing efficiency of the task objective;
identifying the second sub-task as countervailing the processing efficiency of the task objective relative to the first sub-task;
dispatching the second sub-task to an instantiation of an artificial intelligence model operating with a blinkered purview restricted to the second sub-task and separated from a processing of the first sub-task;
receive a result of the processing of the second sub-task from the instantiation;
merge the result of the processing of the second sub-task with a result of the processing of the first sub-task to generate a combined result; and
generate a task result based on the combined result and processing of the main task objective by the one or more synthetic electronic neural networks.

23. The computing device of claim 22, wherein the instructions further cause the computing device to separate the second sub-task from a remainder of the main task objective and dispatch the second sub-task to the instantiation operating with the purview blinkered from the remainder of the main task objective and restricted to the second sub-task, wherein the blinkered purview isolates the processing of the second sub-task from the processing of the remainder of the main task objective, such that the second sub-task and the remainder of the main task objective are not processed together within a single context window.

24. The computing device of claim 22, wherein the instructions further cause the computing device to:
automatically generate a handover continuity package comprising task context, progress state, and instructions; and
automatically instantiate a successor instantiation that receives the handover continuity package and takes over a role of a predecessor instantiation, thereby chaining successive instantiations to process a task, a remainder of a task, or a sub-task member of the plurality of sub-tasks exceeding a capacity of any single context window.

25. The computing device of claim 24, wherein the instructions further cause the computing device to maintain the predecessor instantiation during an overlap period, wherein the predecessor instantiation provides supporting expertise and guidance, and the successor instantiation is provided an ability to query the predecessor instantiation.

26. The computing device of claim 22, wherein the instructions further cause the computing device to:
enforce a set of rules within a safety enforcement layer by operating an expert system;
check one or more of: inputs to the one or more synthetic electronic neural networks, and outputs from the one or more synthetic electronic neural networks, for compliance with the set of rules; and
allow only inputs and outputs that are compliant with the rules to pass through the safety enforcement layer.
